(19) United States
(12) Patent Application Publication
(10) Pub. No.: US 2026/0297271 A1
(43) Pub. Date: Oct. 1, 2026

(54) In Situ Functionalized Symmetric Skinless Mixed Matrix Membrane Adsorbers with Embedded Polymeric Particles and Networks, and Related Compositions, Methods, and Systems

(71) Applicant: CALIFORNIA INSTITUTE OF TECHNOLOGY, Pasadena, CA (US)

(72) Inventors: Mamadou Diallo, Pasadena, CA (US); Orland Bateman, South Pasadena, CA (US); Julia A Kornfield, Pasadena, CA (US); Rohit Srikanth, Pasadena, CA (US)

(21) Appl. No.: 19/387,420

(22) Filed: Nov. 12, 2025

Related U.S. Application Data
(60) Provisional application No. 63/719,552, filed on Nov. 12, 2024.

(51) Int. Cl. C08J 5/18; C08J 5/00; C08J 9/00; C08L 27/16

(52) U.S. Cl. CPC C08J 5/18; C08J 5/005; C08J 9/0061; C08L 27/16

(57) ABSTRACT

Described herein are in-situ functionalized symmetric and skinless membrane adsorbers, compositions, systems, and methods. The adsorbers feature a porous polymeric body with a symmetric, skinless microfiltration (MF) morphology, enabling high fluid flux. Embedded within this body are polymeric microparticles (e.g., PEI). A fabrication method involves generating intermediate microparticles within an organic dope solution, followed by an in-situ functionalization step. This step uses organic-compatible reagents (to covalently attach diverse functional groups (AEX, CEX, HIC, Fluorophilic) to the particles before casting. The final functionalized dope is solidified using a controlled, gradual demixing process to achieve the symmetric, skinless morphology. These high-flux, selective adsorbers are suitable for removing target solutes, such as bioprocessing impurities or environmental contaminants like PFAS.

### CROSS REFERENCE TO RELATED APPLICATIONS

The present application claims priority to U.S. Provisional Application No. 63/719,552 entitled “Mixed Matrix PVDF Microfiltration Membranes with In-situ Synthesized Polyethyleneimine Particles as a Platform for Flow Through, High Capacity and Selective Anion Exchange Membrane Adsorbers for Downstream Bioprocessing” filed on Nov. 12, 2024, with docket number CIT-9237-P the disclosure of which is incorporated by reference in its entirety. The present application may also be related to US Application Ser. No. 13/754,883 entitled “Filtration Membranes and Related Compositions, Methods and Systems” filed on Jan. 30, 2013 with Docket No. P1127-US and to PCT Patent Application PCT/US2012/050043 entitled “Filtration Membranes, and Related Nano and/or Micro fibers, Composites, Methods and Systems” filed on Aug. 8, 2012 with attorney docket P1069-PCT which in turn claims priority, each of the above mentioned applications is incorporated herein by reference in its entirety.

### STATEMENT OF GOVERNMENT GRANT

This invention was made with government support under Grant No. CBET1911972 awarded by the National Science Foundation. The government has certain rights in the invention.

### FIELD

The present disclosure relates to filtration membranes and related compositions, methods and systems. In particular the present disclosure relates to in situ functionalized symmetric and skinless mixed matrix membrane adsorbers with embedded microparticles and/or nanoparticles and related compositions methods, and systems which can be used in applications such as environmental and industrial separations.

### BACKGROUND

Development of efficient membranes has been a challenge in the field of fluid filtration, in particular when aimed at environmental and industrial separations (e.g. water purification and resource recovery).

Filtration membranes have become the core components of a broad range of sustainability applications and technologies including (i) energy conservation and storage (e.g. fuel cells and batteries), (ii) water reuse and desalination (e.g. reverse osmosis, nanofiltration and ultrafiltration) and (iii) gas separations (e.g. CO₂ and H₂ separations). Current commercial polymeric membranes often carry a single function, i.e. salt rejection by a reverse osmosis membrane or proton transport by a polymer electrolyte membrane.

Whether for human consumption, agriculture or industry, several methods are commonly used for filtration including reverse osmosis (RO), nanofiltration (NF), ultrafiltration (UF) and microfiltration (MF) and additional methods identifiable by a skilled person.

Despite production and elaboration of several filtration concepts/technologies proposed as improvements or alternatives to the above mentioned approaches, development of efficient, cost-effective and/or environmental friendly filtration membranes and adsorptive membranes has been a challenge in particular when directed at efficient and scalable manufacturing methods combining high solute binding capacity and selectivity with robust salt tolerance, high convective throughput with low fouling and allowing effective purification remains an ongoing pursuit.

### SUMMARY

Provided herein are in situ functionalized symmetric skinless mixed matrix membrane adsorbers with embedded polymeric particles and optionally networks along with related compositions, methods, and systems that have with adsorptive capacity and tunable selectivity and allow in several embodiments to perform high-flux, low-fouling adsorption of a diverse and tunable range of target solutes in a liquid and in particular of water or aqueous solutions. Accordingly, the in situ functionalized symmetric skinless mixed matrix membrane adsorbers and related compositions, methods, and systems can have various applications such as industrial and environmental separations.

According to a first aspect, an in situ functionalized membrane adsorber is described. The membrane adsorber comprises a porous polymeric body formed from a base polymer, and a plurality of polymeric microparticles and/or nanoparticles embedded within the porous polymeric body. The membrane adsorber is characterized by a symmetric and skinless morphology.

The skinless morphology is defined by the membrane adsorber's porous polymeric body having a surface (e.g., a surface exposed during coagulation) and a bulk region, wherein a surface areal void fraction measured at the surface differs by no more than 30% from a mean bulk areal void fraction measured within the bulk region.

The symmetric morphology is defined by the bulk region having a thickness and a mean bulk areal void fraction calculated across the thickness, wherein a local areal void fraction or average pore dimension of the bulk region, when measured at different depths through the thickness, varies by no more than 50% from the mean bulk areal void fraction or mean average pore dimension calculated across the thickness.

The in situ functionalized membrane adsorber comprises a plurality of in-situ functionalized polymeric microparticles embedded within said porous polymeric body, and comprise functional groups selected from the group consisting of: Strong Base (SB) Anion Exchange (AEX) groups, Cation Exchange (CEX) groups, Hydrophobic Interaction Chromatography (HIC) groups, Chelating groups and Fluorophilic groups.

Functionally, this skinless and symmetric structure is confirmed in some embodiments by exhibiting a high fluid permeability characteristic of microfiltration (MF) membranes, such as a pure water flux exceeding at least 500 L/m²/hr. per bar of applied pressure (LMH/bar) at standard conditions.

According to a second aspect, an in situ functionalized membrane adsorber is described. The in situ functionalized adsorber membrane comprises a porous polymeric body formed from a base polymer, and a plurality of polymeric microparticles and/or nanoparticles embedded within said porous polymeric body. The porous polymeric body may comprise a porous polymeric aggregate or a matrix of polymeric fibers. The membrane is characterized by a symmetric and skinless morphology.

The skinless morphology is defined by the membrane adsorber's porous polymeric body (whether aggregate or fibrous) having a surface and a bulk region, wherein a surface areal void fraction measured at the surface differs by no more than 30% from a mean bulk areal void fraction measured within the bulk region.

The symmetric morphology is defined by the bulk region having a thickness, wherein a local areal void fraction or average pore dimension of the bulk region, when measured at different depths through the thickness, varies by no more than 50% from a mean areal void fraction or mean average pore dimension calculated across the entire thickness of the bulk region.

The in situ functionalized membrane adsorber comprises a plurality of in-situ functionalized polymeric microparticles embedded within said porous polymeric body, and comprise functional groups selected from the group consisting of: Strong Base (SB) Anion Exchange (AEX) groups, Cation Exchange (CEX) groups, Hydrophobic Interaction Chromatography (HIC) groups, Chelating grouexps and Fluorophilic groups.

Functionally, this skinless and symmetric structure is characterized in some embodiments by exhibiting high fluid permeability characteristic of microfiltration (MF) membranes, quantifiable as a pure water flux/permeability exceeding 500 L/m²/hr. per bar of applied pressure (LMH/bar) at standard conditions.

According to a third aspect, a method of making an in situ functionalized membrane adsorber with in-situ generated polymeric particles is described. The method comprises providing a blend comprising a base polymer substantially soluble in a base polymer solvent, a particle precursor having a portion substantially insoluble in the base polymer solvent to provide a dispersion of segregated domains, and the base polymer solvent, wherein the base polymer solvent has a base polymer solvent Hildebrand solubility parameter (δs).

The method further comprises contacting the blend with a crosslinker and/or an initiator capable of reacting with the particle precursor with the contacting performed for a time and under a condition to permit the in situ formation of microparticles and/or nanoparticles, thus providing an intermediate dope solution comprising a dispersion of polymeric microparticles and/or nanoparticles, optionally comprising in-situ functionalized polymeric microparticles and/or nanoparticles.

The method also comprises before casting contacting the intermediate dope solution with a functional reagent or a mixture of functional reagents comprising functional groups selected from the group consisting of: Strong Base (SB) Anion Exchange (AEX) groups, Cation Exchange (CEX) groups, Hydrophobic Interaction Chromatography (HIC) groups, Chelating groups and Fluorophilic groups, for a time and under a condition to allow formation of in-situ functionalized microparticles or nanoparticles in the in situ functionalized membrane casting dispersion.

The method also comprises casting the in situ functionalized dope solution comprising said in-situ functionalized microparticles or nanoparticles to form a nascent membrane and inducing phase separation by a controlled, gradual demixing process to form the in-situ functionalized membrane adsorber, said membrane adsorber having a symmetric and skinless morphology. In particular the demixing can be performed by
(a) a thermodynamically-controlled process, comprising contacting the nascent membrane with a liquid nonsolvent, said liquid nonsolvent having a nonsolvent Hildebrand solubility parameter (δns), and wherein the absolute difference between said δs and said δns is 7 (cal/cm³)½ or less;
(b) a time-controlled process, comprising contacting the nascent membrane with a nonsolvent vapor for an exposure time of at least 5 minutes; and/or
(c) a temperature-controlled process, comprising gradually cooling the nascent membrane at a controlled cooling rate, said cooling rate ranging from 0.5 K/min to 11 K/min, preferably ranging from 0.5 K/min to 2.5 K/min
   to form a in situ functionalized skinless symmetric membrane adsorber with embedded microparticles and/or nanoparticles.

In some embodiments, contacting the blend further comprises contacting the blend with a functionalizing chemical compound or polymer and/or a functionalizing polymer precursor for a time and under condition to allow in situ formation of microparticles and/or nanoparticles with covalently attached functional compounds or polymer networks.

According to a fourth aspect, a system of making an in situ membrane adsorber with in-situ synthesized polymeric particles and optionally polymer networks is described. The system comprises a base polymer for a membrane matrix; a particle precursor capable of forming a dispersion of segregated domains in a base polymer solvent; and a crosslinker and/or an initiator capable of reacting with the particle precursor.

The system further comprises a functional reagent for reacting with the polymeric microparticles and/or nanoparticles in-situ within the base polymer solvent to form said in-situ functionalized membrane adsorber. In various embodiments, said functional reagent is an organic-compatible functional reagent selected from the group consisting of reagents capable of forming: Strong Base (SB) Anion Exchange (AEX) groups, Cation Exchange (CEX) groups, Hydrophobic Interaction Chromatography (HIC) groups, Chelating groups and Fluorophilic groups. For example, the functional reagent may be selected from the group consisting of: an alkylating reagent, such as bromoethane; an epoxide, such as styrene oxide; a sultone, such as 1,3-propanesultone; and a fluorinated reagent, such as a fluorinated epoxide or a fluorinated alkyl halide.

In some embodiments the system can further comprise the base polymer solvent, wherein the base polymer is substantially soluble in the base polymer solvent and the base polymer solvent has a base polymer solvent Hildebrand solubility parameter (δs). The system further comprises a nonsolvent to promote phase separation and subsequent membrane formation, the nonsolvent having a nonsolvent Hildebrand solubility parameter (δns), wherein the absolute difference between the base polymer solvent Hildebrand solubility parameter (δs) and the nonsolvent Hildebrand solubility parameter (δns) is 7 (cal/cm³)^{1/2} or less.

According to a fifth aspect, an in situ functionalized skinless and symmetric membrane adsorber is described. The in situ functionalized skinless and symmetric membrane adsorber comprises a plurality of nanofibers and/or microfibers, each nanofiber or microfiber comprising polymer nanoparticles and/or microparticles embedded therein.

In the in situ functionalized skinless and symmetric membrane adsorber, each nanofiber and microfiber of the plurality comprises a base polymer and, in some embodiments, a functionalizing polymer, the functionalizing polymer attaching the polymeric nanoparticles and/or microparticles to form a polymeric network within the nanofibers and/or microfibers. In the filtration membrane, the polymeric nanoparticles and/or microparticles and/or the polymeric network present reactive sites on the nanofibers and/or microfibers to allow selective filtration of a chemical capable of interaction with the reactive sites.

The skinless and symmetric filtration membrane, comprises the plurality of nanofibers and/or microfibers, constitutes a porous polymeric body having a surface and a bulk region, wherein a surface areal void fraction measured at the surface differs by no more than 30% from a mean bulk areal void fraction measured within the bulk region.

Furthermore, in the skinless and symmetric filtration membrane, the bulk region has a thickness, and wherein a local areal void fraction of the bulk region measured at different depths through the thickness varies by no more than 50% from the mean bulk areal void fraction calculated across the thickness.

The in situ functionalized membrane adsorber comprises a plurality of in-situ functionalized polymeric microparticles embedded within said porous polymeric body, and comprise functional groups selected from the group consisting of: Strong Base (SB) Anion Exchange (AEX) groups, Cation Exchange (CEX) groups, Hydrophobic Interaction Chromatography (HIC) groups, Chelating groups and Fluorophilic groups.

In some embodiments, the plurality of nanofibers and/or microfibers is arranged in a mesh structure forming a layer comprised in the membrane, alone or in combination with additional layers. In some embodiments, the plurality of nanofibers and/or microfibers are arranged in a substantially parallel configuration, and wherein, in some of these embodiments, one or more nanofibers and/or microfibers of the plurality are hollow.

According to a sixth aspect, a process for providing an in situ functionalized skinless and symmetric nanofiber or microfiber with in-situ generated polymeric particles is described. The process comprises mixing a base polymer substantially soluble in a base polymer solvent (the base polymer solvent having a Hildebrand solubility parameter (δs) with a polymeric particle precursor, and the base polymer solvent to provide a blend.

The process further comprises contacting the blend with a functionalizing polymer, a crosslinker and/or an initiator capable of reacting with the polymer particle precursor, the contacting performed for a time and under a condition to permit the in situ formation of crosslinked microparticles and/or nanoparticles (such as crosslinked dendritic microparticles and/or nanoparticles), thus providing an intermediate dope solution comprising a microparticles and/or nanoparticles dispersion.

The method also comprises before electrospraying and/or electrospinning contacting the intermediate dope solution with a functional reagent or a mixture of functional reagents comprising functional groups selected from the group consisting of: Strong Base (SB) Anion Exchange (AEX) groups, Cation Exchange (CEX) groups, Hydrophobic Interaction Chromatography (HIC) groups, Chelating groups and Fluorophilic groups, for a time and under a condition to allow formation of in-situ functionalized microparticles or nanoparticles in the in situ functionalized dope solution.

The process further comprises electrospraying and/or electrospinning the in situ functionalized dope solution and inducing phase separation, by a controlled, gradual demixing of the spun to form a in situ functionalized symmetric membrane asborber. In particular the demixing the dope solution can be performed by
(a) a thermodynamically-controlled process, comprising contacting the nascent membrane with a liquid nonsolvent, said liquid nonsolvent having a nonsolvent Hildebrand solubility parameter (δns), and wherein the absolute difference between said δs and said δns is 7 (cal/cm³)½ or less;
(b) a time-controlled process, comprising contacting the nascent membrane with a nonsolvent vapor for an exposure time of at least 5 minutes; and/or
(c) a temperature-controlled process, comprising gradually cooling the nascent membrane at a controlled cooling rate, said cooling rate ranging from 0.5 K/min to 11 K/min, preferably ranging from 0.5 K/min to 2.5 K/min
   to provide in situ functionalized skinless and symmetric nanofibers or microfibers.

According to a seventh aspect, an in situ functionalized skinless and symmetric bicomposite membrane adsorber is described. The bicomposite membrane adsorber comprises a plurality of nanofibers and/or microfibers attached to a polymer matrix formed by a porous polymeric aggregate, wherein the porous polymeric aggregate comprises a polymeric particle component embedded therein. In some embodiments, the plurality of nanofibers and/or microfibers of the bicomposite membrane comprise nanofibers and/or microfibers with embedded microparticles and/or nanoparticles.

In the in situ functionalized skinless and symmetric bicomposite membrane adsorber, at least one of the polymer matrix or the plurality of nanofibers and/or microfibers defines a porous polymeric body having a surface and a bulk region, wherein a surface areal void fraction measured at the surface differs by no more than 30% from a mean bulk areal void fraction measured within the bulk region; and wherein the bulk region has a thickness, and a local areal void fraction of the bulk region measured at different depths through the thickness varies by no more than 50% from the mean bulk areal void fraction calculated across the thickness.

In in situ functionalized the skinless and symmetric bicomposite membrane adsorber, the polymeric microparticles and/or nanoparticles embedded in the base polymer are functionalized microparticles and/or nanoparticles presenting functional groups capable of selective interaction, such as weak-base (WB) and strong-base (SB) anion exchange (AEX) groups [e.g., primary, secondary, tertiary, or quaternary amines), weak-acid (WA) and strong-acid (SA) cation exchange (CEX) groups (e.g., carboxylates or sulfonates), neutral organic groups with tunable hydrophobicity/hydrophilicity (e. g., mono-functional epoxy alkanes or aromatics), chelating groups (e.g., reacting moieties with carboxyl, thiol, hydroxyl, amidoxime, guanidino, imidino functional groups, etc.) or other reactive sites identifiable by a skilled person.

According to an eighth aspect, a method and a system for removing target solutes from a fluid are described.

The method comprises providing an in-situ functionalized skinless symmetric membrane adsorber as described herein, said membrane adsorber comprising a porous polymeric body having a symmetric skinless microfiltration (MF) morphology and a plurality of in-situ functionalized polymeric microparticles embedded therein. Said in-situ functionalized microparticles comprise functional groups selected from the group consisting of: Strong Base (SB) Anion Exchange (AEX) groups, Cation Exchange (CEX) groups, Hydrophobic Interaction Chromatography (HIC) groups, Chelating groups and Fluorophilic groups.

The method further comprises contacting said membrane adsorber with a fluid containing one or more target solutes, to remove the one or more target solute from the fluid by adsorption onto said functional groups.

The system for removing target solutes from a fluid comprises, as its central component, an in-situ functionalized skinless symmetric membrane adsorber. Said membrane adsorber comprises a porous polymeric body having a symmetric skinless microfiltration (MF) morphology and a plurality of in-situ functionalized polymeric microparticles embedded therein, wherein said in-situ functionalized microparticles comprise functional groups selected from the group consisting of: Strong Base (SB) Anion Exchange (AEX) groups, Cation Exchange (CEX) groups, Hydrophobic Interaction Chromatography (HIC) groups, Chelating groups and Fluorophilic groups.

The system further comprises a housing configured to hold said membrane adsorber, an inlet in fluid communication with a first side of the membrane adsorber to receive a fluid containing one or more target solutes and an outlet in fluid communication with a second side of the membrane adsorber to discharge a permeate stream having a reduced concentration of said one or more target solutes.

In some embodiments of any in situ functionalized skinless and symmetric membrane adsorber described herein, the membrane can further comprise a functional polymer covalently and/or non-covalently linked to the embedded microparticles and/or nanoparticles to form a polymer network of the filtration membrane.

In some embodiments of any in situ functionalized skinless and symmetric membrane adsorbers described herein, the polymeric microparticles and/or nanoparticles can be reacted with functionalizing monomers and/or functionalizing polymers to form a polymeric network attached to the microparticle and/or nanoparticles. In some embodiments, the functionalizing polymer is covalently attached and in particular crosslinked to the MNPs.

The skinless and symmetric morphology of the in situ functionalized membranes adsorber, in combination with the in situ functionalized embedded polymeric micro/nanoparticles, and related methods and systems provide in several embodiments significant advantages over conventional asymmetric, skinned membranes. This structure, lacking a dense flow-restricting skin layer, enables operation in the microfiltration (MF) regime, characterized by exceptionally high fluid flux (e.g., >1000 L/m²/hr at 2 bar) at low operating pressures. This high flux is essential for flow-through applications, such as membrane chromatography for product polishing in downstream bioprocessing, where high throughput is required. Furthermore, the absence of a dense skin layer mitigates the fouling propensity often associated with protein, virus, particle and colloid adsorption and pore blockage at the surface of asymmetric ultrafiltration (UF) membranes.

The symmetric and open porous structure of the in situ functionalized skinless and symmetric membranes adsorber and related methods and systems in several embodiments allow solutes (e.g., in a feed stream) convective access to the functional micro/nanoparticles distributed throughout the entire bulk region of the membrane, rather than restricting interaction primarily to a surface skin layer. This enables the full and efficient utilization of the embedded polymeric MNPs, which, as described, can be prepared with different sizes, shapes, and morphologies. The chemistry of the membrane embedded MNPs can be tuned in-situ prior to casting, by selecting specific organic-compatible functional reagents, to create a diverse platform of functionalities which comprise Strong Base (SB) Anion Exchange (AEX) groups, Cation Exchange (CEX) groups, Hydrophobic Interaction Chromatography (HIC) groups, Chelating groups and Fluorophilic groups, making them highly attractive as building blocks for high-flux and low-fouling multifunctional membrane adsorbers.

Accordingly, situ functionalized skinless and symmetric membranes adsorber and related methods and systems provide a manufacturing platform based in-situ functionalization of symmetric and skinless membrane wherein polymeric microparticles are chemically modified within the organic dope solution prior to casting or electrospinning to provide Strong Base (SB) AEX, Cation Exchange (CEX), Hydrophobic Interaction Chromatography (HIC), Chelating or Fluorophilic adsorbers—. The manufacturing platform is based on the unexpected discovery that in-situ chemical functionalization with those groups can be performed without destroying the delicate thermodynamic balance required for the subsequent controlled, gradual demixing process (e.g., step (c)). that uniquely and synergistically combine the high-flux, low-fouling properties of a symmetric microfiltration skinless membrane morphology with the high-capacity, tunable selectivity of a membrane adsorber.

In situ functionalized skinless and symmetric membranes adsorber with embedded in situ functionalized polymeric micro/nanoparticles and related methods and systems herein described can be used in connection with applications wherein water filtration in particular when aimed at selective filtration is desired. Exemplary applications comprise fluid purification, and in particular water filtration, water purification and in particular water treatment and additional applications associated with industrial/environmental separations, including chemical and/or biological purifications, which are identifiable by a skilled person. Exemplary applications also comprise water reuse, industrial wastewater treatment, chemical and biological purifications. Additional applications comprise chemical and/or biological purifications and catalysis wherein selective adsorption, inclusion or removal/conversion of one or more solutes/compounds is desired.

The details of one or more embodiments of the disclosure are set forth in the accompanying drawings and the description below. Other features, objects, and advantages will be apparent from the description and drawings, and from the claims.

### BRIEF DESCRIPTION OF DRAWINGS

The accompanying drawings, which are incorporated into and constitute a part of this specification, illustrate one or more embodiments of the present disclosure and, together with the detailed description and the examples, serve to explain the principles and implementations of the disclosure.

FIG. 1 shows a chart illustrating the static binding capacity (SBC) for BSA in water as a function of normalized crosslink density (NCD) for membranes prepared with ECH, EGA, and BCAH crosslinkers.

FIG. 2 shows a chart with photographs illustrating the bench scale equipment and NIPS procedure used to fabricate symmetric skinless mixed matrix membranes with in-situ synthesized and functionalized polymeric microparticles.

FIG. 3 shows photographs illustrating the VIPS procedures and bench scale system used to produce symmetric skinless mixed matrix membranes with in-situ synthesized and functionalized polymeric microparticles.

FIG. 4 is a photograph of a custom-built cross flow filtration system used for water flux measurements.

FIG. 5 shows photographs of the bench scale lab incubator system and UV spectrophotometer used to conduct the measurements of membrane protein static binding capacity (SBC)

FIG. 6 shows photographs of a custom-built dynamic binding capacity (DBC) measurement system, including the flow-through cell (FIG. 6, panel A) and sample holder (FIG. 6, panel B).

FIG. 7 presents a panel of scanning electron micrographs (SEMs) showing cross-sectional morphologies of mixed matrix membranes prepared with different PEI loadings using IPA (FIG. 7 panels a-c), water (FIG. 7 panels d-f), or NMP:H₂O (FIG. 7panels g-i) as the nonsolvent.

FIG. 8 presents a panel of SEMs showing surface morphologies of mixed matrix membranes prepared with different PEI loadings using IPA (FIG. 8 panels a-c), water (FIG. 8 panels d-f), or NMP:H₂O (FIG. 8 panels g-i) as the nonsolvent.

FIG. 9 shows a schematic showing the casting solution-non-solvent interface at t=0 (FIG. 9 panels a, c and e) and t-tg (FIG. 9 panels b, d and f) with TEP, IP, NMP H₂O PVDF and PEI.

FIG. 10 shows Wide-Angle X-ray Scattering (WAXS) patterns for membranes cast in IPA with varying PEI loadings.

FIG. 11 shows WAXS difference patterns (PEI-containing membrane minus scaled neat membrane) for membranes cast in IPA.

FIG. 12 shows WAXS patterns for membranes cast in water with varying PEI loadings.

FIG. 13 shows WAXS difference patterns (water-cast membrane minus IPA-cast membrane) for varying PEI loadings.

FIG. 14 shows WAXS patterns for membranes cast in NMP:H₂O with varying PEI loadings.

FIG. 15 shows WAXS difference patterns (NMP:H2O-cast membrane minus IPA-cast membrane) for varying PEI loadings.

FIG. 16 presents graphs plotting water flux as a function of time for membranes prepared using IPA (FIG. 16, panel a), H2O (FIG. 16, panel b), and NMP:H2O (FIG. 16, panel c) as nonsolvents, at different PEI loadings.

FIG. 17 presents a panel of SEM images showing cross-sectional morphologies of membranes prepared with different crosslinkers (ECH FIG. 17, panel a, EGA FIG. 17, panel b, BCAH FIG. 17, panel c) at NCD 0.5.

FIG. 18 presents a panel of SEM images showing cross-sectional morphologies of membranes prepared using BCAH crosslinker at different NCDs (0.25 FIG. 18, panel a, 0.5 FIG. 18, panel b, 1.0 FIG. 18, panel c).

FIG. 19 shows a bar graph detailing salt tolerance and static BSA binding capacity of membranes 54H and 54E in water.

FIG. 20 shows BSA dynamic binding breakthrough curves for membrane 54H in 50 mM TRIS buffer as a function of feed flow rate.

FIG. 21 shows BSA dynamic binding breakthrough curves for membrane 54H at a constant feed flow rate (4 MV/min) as a function of salinity (NaCl concentration) in 50 mM TRIS buffer.

FIG. 22 shows dynamic binding capacities for membrane 54H at three different flowrates and 5 different buffer conditions, highlighting trends in salt tolerance behavior.

FIG. 23 shows a chart illustrating a one-pot and single step phase inversion casting process (panel A) for the preparation of mixed matrix PVDF-PEI membrane adsorbers with in-situ synthesized PEI microparticles using 3 different crosslinkers and (panel B) the chemical structures for the alternative crosslinkers, Bis(2-chloroethyl)amine hydrochloride (BCAH) and Diethylene glycol diacrylate (EGA).

FIG. 24 presents a panel of SEM images showing surface morphologies of mixed matrix PVDF-PEI membranes prepared with different PEI loadings using IPA (FIG. 24 panels a-c) or water (FIG. 24 panels d-f) as the nonsolvent and ECH crosslinker. FIG. 24, Panel A, 6.0 wt. %-IPA cast; FIG. 24, Panel B, 38.0 wt. %-IPA cast; FIG. 24, Panel C. 54.0 wt %-IPA cast; FIG. 24, Panel D, 6.0 wt %-water cast; FIG. 24, Panel E, 38.0 wt %-water cast and FIG. 24, Panel F, 54.0 wt %-water cast.

FIG. 25 presents a panel of SEM images showing cross-sectional morphologies of mixed matrix PVDF-PEI membranes prepared with different PEI loadings using IPA (FIG. 25 panels a-c) or water (FIG. 25 panels d-f) as the nonsolvent and ECH crosslinker. FIG. 25, Panel A: 6.0 wt. %-IPA cast; FIG. 25, Panel B: 38.0 wt. %-IPA cast; FIG. 25, Panel C: 54.0 wt. %-IPA cast;

FIG. 25, Panel D: 6.0 wt. %-water cast; FIG. 25, Panel E: 38.0 wt. %-water cast and FIG. 25, Panel F: 54.0 wt. %-water cast.

FIG. 26 is a graph plotting water flux as a function of time for membranes prepared using IPA or H2O as nonsolvents, at different PEI loadings with ECH crosslinker.

FIG. 27 presents a panel of SEM images showing cross-sectional morphologies of PVDF-PEI membranes prepared with different crosslinkers (ECH FIG. 27, panel A, BCAH FIG. 27, panel B, EGA FIG. 27, panel C) at CD≈2.

FIG. 28 presents a panel of SEM images showing cross-sectional morphologies of PVDF-PEI membranes prepared using BCAH crosslinker at different crosslink densities (CD≈1 FIG. 28, panel A, CD≈2 FIG. 28, panel B, CD≈4 FIG. 28, panel C).

FIG. 29 is a graph plotting static binding capacity (SBC) for BSA in water as a function of crosslink density for membranes prepared with ECH, BCAH, and EGA crosslinkers.

FIG. 30 illustrates conceptual reaction schemes between PEI and different crosslinkers (ECH, BCAH, EGA) and depicts resulting polymer network structures at different crosslink densities.

FIG. 31 is a bar chart comparing SBC for BSA in distilled water and various TRIS buffer solutions (with different NaCl concentrations) for PVDF-PEI membranes prepared with BCAH (54H) and EGA (54E) crosslinkers at CD≈2.

FIG. 32 presents BSA dynamic binding breakthrough curves for membrane 54H in 50 mM TRIS buffer as a function of feed flow rate.

FIG. 33 presents BSA dynamic binding breakthrough curves for membrane 54H at a constant feed flow rate (4 MV/min) as a function of salinity (NaCl concentration) in 50 mM TRIS buffer.

FIG. 34 shows a chart illustrating a one-pot and single step phase inversion casting process for the preparation of symmetric skinless mixed matrix PVDF AEX membrane adsorbers with in-situ synthesized and quaternized ECH crosslinked PEI microparticles.

FIG. 35 shows a chart illustrating the reaction scheme used to quaternize ECH crosslinked PEI microparticles in a dope dispersion to fabricate a mixed matrix PVDF membrane (QPEI100 membrane) with in-situ synthesized strong-base (SB) AEX microparticles using bromoethane as alkylating reagent.

FIG. 36 shows a chart illustrating the use of optical coherence tomography (OCT) to measure the thicknesses of the mixed matrix PVDF SB (QPEI100) and WB (ECH Control) membranes.

FIG. 37 shows the measured contact angles of the mixed matrix PVDF SB (QPEI100) and WB (ECH Control) membranes.

FIG. 38 shows the FTIR-ATR spectra of the mixed matrix PVDF SB (QPEI100) and WB (ECH Control) membranes.

FIG. 39 shows the SEM micrographs of the top surfaces and cross sections of the mixed matrix PVDF SB (QPEI100) and WB (ECH Control) membranes.

FIG. 40 shows a chart summarizing the results of the protein (BSA) SBC measurements in 50 mM TRIS buffer and saline TRIS buffer (50 mM TRIS+100 mM NaCl).

FIG. 41 shows a chart illustrating a one-pot and single step phase inversion casting process for the preparation of symmetric skinless mixed matrix PVDF AEX membrane adsorbers with in-situ synthesized and functionalized BCAH crosslinked PEI microparticles.

FIG. 42 shows a chart illustrating the reaction scheme used to functionalize BCAH crosslinked PEI microparticles in a dope dispersion using styrene oxide as functional reagent to fabricate a mixed matrix PVDF membrane (SO100) with in-situ synthesized polymeric microparticle adsorbents.

FIG. 43 shows a chart illustrating the use of OCT to measure the thicknesses of the mixed matrix PVDF (SO100) and WB (BCAH Control) membranes.

FIG. 44 shows the measured contact angles of the mixed matrix PVDF SB (SO100) and WB (BCAH Control) membranes.

FIG. 45 shows the FTIR-ATR spectra of the mixed matrix PVDF (SO100) and WB (BCAH Control) membranes.

FIG. 46 shows the SEM micrographs of the top surfaces and cross sections of the mixed matrix PVDF (SO100) and WB (BCAH Control) membranes.

FIG. 47 shows a chart summarizing the results of the protein (BSA) SBC measurements in DI water and 50 mM TRIS+1.0 M ammonium sulfate [(NH₄)₂SO₄].

FIG. 48 lists additional commercially available epoxy alkanes that can be used as functional reagents to tune and modulate the hydrophobicity of the symmetric and skinless mixed matrix membranes of the disclosure with in-situ synthesized HIC microparticle adsorbers.

FIG. 49 shows a reaction scheme illustrating the functionalization of BCAH crosslinked PEI microparticles with sodium 4-vinylbenzene sulfonate via a Michael addition reaction to form cation exchange (CEX) microparticle adsorbers.

FIG. 50 shows a chart illustrating a one-pot and single step phase inversion casting process for the preparation of symmetric skinless mixed matrix PVDF AEX membrane adsorbers with in-situ synthesized CEX microparticle adsorbers.

FIG. 51 is a bar graph showing contact angle measurements comparing a control membrane prepared with BCAH and a functionalized CEX membrane.

FIG. 52 presents scanning electron micrographs showing the cross-section and top surface morphologies of a functionalized CEX membrane.

FIG. 53 presents scanning electron micrographs showing the top surface and cross-section morphologies of a symmetric skinless mixed matrix membrane prepared utilizing a vapor induced phase separation (VIPS) process.

FIG. 54 shows photographs of granular activated carbon (GAC), ion exchange (IX) resins, and alternative adsorbents evaluated for PFAS removal.

FIG. 55 illustrates a process flow diagram for the one-pot preparation of mixed matrix membranes including an in-situ quaternization step using alkyl bromides.

FIG. 56 illustrates a general reaction scheme for the in-situ quaternization of ECH crosslinked PEI microparticles using an alkyl or benzyl halide to produce PFAS-selective anion exchange microparticle adsorbers, and lists selected non-PFAS fluorinated reagents used to tune selectivity.

FIG. 57 shows a reaction scheme for the in-situ quaternization of tertiary amines within ECH crosslinked PEI microparticles using 1-bromo-2-fluoroethane as an alkylating reagent to target ultrashort chain PFAS.

FIG. 58 shows a reaction scheme for the in-situ quaternization of tertiary amines within ECH crosslinked PEI microparticles using 1-chloro-4-fluorobutane as an alkylating reagent to target short chain PFAS.

FIG. 59 shows a reaction scheme for the in-situ quaternization of tertiary amines within ECH crosslinked PEI microparticles using 4-fluorobenzyl chloride as an alkylating reagent to target long chain PFAS.

FIG. 60 shows an example of a ultrafiltration system using the functionalized CEX membrane.

FIG. 61 shows a photograph of the Thorlabs Ganymede optical coherence tomography (OCT) system used for membrane thickness measurements in exemplary embodiments of the present disclosure.

### DETAILED DESCRIPTION

Provided herein are in situ functionalized skinless and symmetric mixed matrix membranes adsorber with embedded in situ functionalized polymeric particles and optionally networks along with related compositions, methods and systems that allow in several embodiment to perform selective filtration of a liquid and in particular of water.

The term “membrane adsorber” (also referred to as a “membrane adsorber” or “adsorptive membrane”) as used herein refers to a filtration membrane that is used to separate target solutes from a fluid stream primarily through adsorption.

The term “filtration” as used herein refers to the mechanical or physical operation which can be used for separating components of a homogeneous or heterogeneous solutions. Types of filtration can be classified by the approximate sizes of chemicals to be separated and can include particle filtration, or PF (>10 μm); microfiltration, or MF (0.1-10 μm); ultrafiltration, or UF (0.01-0.1 μm); nanofiltration, or NF (0.001-0.01 μm); and reverse osmosis, or RO (<0.001 μm).

The term “chemicals” as used herein indicates a substance with a distinct composition that is produced by or used in a chemical process. Exemplary chemicals comprise particles, molecules, metals, ions, organic compounds, inorganic compounds and mixture thereof as well as any additional substance detectable through chemical means identifiable by a skilled person. In particular, in some embodiments, the chemicals can comprise solutes dissolved in a fluid (e.g. water), and in particular dissolved ions.

The term “membrane” as used herein refers to a porous structure that is capable of separating components of a homogeneous or heterogeneous fluid. In particular, “pores” in the sense of the present disclosure indicate voids allowing fluid communication between different sides of the structure. More particular in use when a homogeneous or heterogeneous fluid is passed through the membrane, some components of the fluid can pass through the pores of the membrane into a “permeate stream”, some components of the fluid can be retained by the membrane and can thus accumulate in a “retentate” and/or some components of the fluid can be rejected by the membrane into a “rejection stream”. Membranes can be of various thicknesses, with homogeneous or heterogeneous structure. Membranes can be comprised within, for example, flat sheets or bundles of hollow fibers. Membranes can also be in various configurations, including but not limited to spiral wound, tubular, hollow fiber, and other configurations identifiable to a skilled person upon a reading of the present disclosure (see, for example the web page kochmembrane.com/Learning-Center/Configurations.aspx). Membrane can also be classified according to their pore diameter. According to IUPAC, there are three different types of pore size classifications: microporous (dp<2 nm), mesoporous (2 nm<dp<50 nm) and macroporous (dp>50 nm). In particular, in some instances, membranes can have pores with a 0.5 nm to 1.0 mm diameters. Membranes can be neutral or charged, and particles transport can be active or passive. The latter can be facilitated by pressure, concentration, chemical or electrical gradients of the membrane process.

In a membrane adsorber unlike traditional filtration membranes that separate components by physical size exclusion or “sieving,” the porous membrane device is characterized by having functional chemical groups or ligands, such as ion exchange or affinity ligands, attached to the surfaces of its pores or embedded within its porous matrix. In a typical operation, a fluid mixture is passed convectively through the porous structure of the membrane, and target molecules with a specific affinity for the functional groups are captured and bound to these sites, while other components pass through. This allows membrane adsorbers to combine the high convective throughput of filtration with the high selectivity of affinity-based separation, overcoming the diffusion-based limitations of traditional packed-bed chromatography columns.

In several embodiments, a filtration membrane herein described comprises porous polymeric body formed from a base polymer, and a plurality of polymeric microparticles and/or nanoparticles embedded within the porous polymeric body

As used herein, a “base polymer” refers to the primary polymeric component that forms the main structural matrix or scaffold of the filtration membrane. The base polymer is typically selected for its ability to be processed into a porous structure, such as by phase inversion, and for its mechanical strength and chemical stability. The base polymer is distinct from the “particle precursor” (e.g., PEI) or the functional “polymeric microparticles and/or nanoparticles” that are embedded within the resulting porous polymeric body. Non-limiting examples of suitable base polymers include, but are not limited to, polyvinylidene fluoride (PVDF), polyacrylonitrile (PAN), polysulfone (PS), polyethersulfone (PES), polyimides (PI), and copolymers or blends thereof.

As used herein, a “porous polymeric body” refers to the solid, porous structure formed from the base polymer that constitutes the framework of the filtration membrane. The porous polymeric body defines the pores of the membrane and provides the scaffold within which the polymeric microparticles and/or nanoparticles are embedded. The porous polymeric body may take various morphologies depending on the manufacturing method. For example, the porous polymeric body may comprise a porous polymeric aggregate (e.g., a structure comprising interconnected spherulites, globules, or a sponge-like matrix) resulting from a phase inversion process, or a matrix comprised of polymeric fibers resulting from a process such as electrospinning.

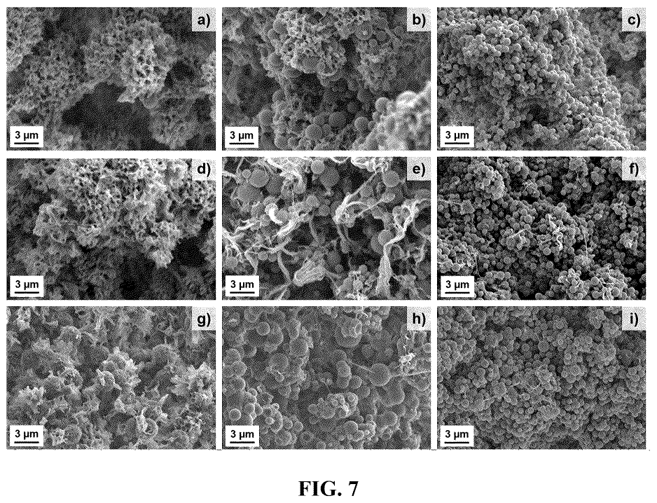

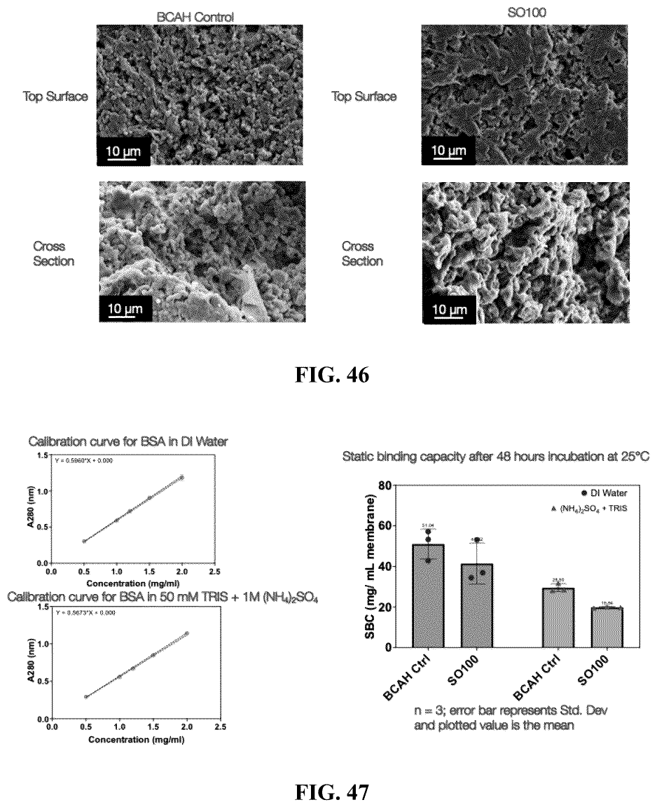

The term “polymer aggregate” or “polymeric aggregate” or “aggregate” as used herein refers to aggregations of linear polymer molecules that form an amorphous network structure. The amorphous network structure can provide structural support to the filtration membranes and pores through which desired substances can pass from one side of the membrane to the other. Exemplary polymer aggregates can be seen, for example, in FIGS. 7, 8, 17, 18, 24, 25, 27, 28, 39, 46, 52 and 53 of the present disclosure. In particular, in some embodiments, the pores provided by the polymer aggregate of the polymer matrix can permit the passage of some molecules (e.g. solvent molecules such as water) while preventing the passage of others (e.g. solute molecules such as proteins) by adsorption onto the membrane functional polymer microparticles/nanoparticles and/or polymer networks thus configuring the membrane as a flow through membrane adsorber.

The term “fiber” as used herein indicate a material that is a continuous filament or is in a discrete elongated piece, similar to a length of thread. In particular, “nanofiber” as used herein refer to fibers with a diameter less than approximately 1000 nm and the term “microfiber” as used herein refer to fibers with a diameter between approximately 1 μm to approximately 10 μm in size.

The term “polymeric microparticles”, “polymeric nanoparticles”, ““polymeric nanomaterials” or as used herein refers to particles of covalently linked and in particular cross-linked polymeric molecules in which the covalently linked or cross-linked polymeric molecules form aggregate nanostructures and/or microstructures with a controlled composition, architecture, and/or size. In particular, in some embodiments, the polymeric molecules forming the polymeric particle precursor to be covalently linked or cross-linked to form particles can be linear polymeric molecules such as, for example, poly(methacrylic acid). In other embodiments, the polymeric molecules forming the polymeric particle precursor can be or further include dendritic nanomaterials such as, for example, poly(ethyleneimine) (PEI) or 2,2-bis(methylol) propionic acid (MPA) hyperbranched macromolecule.

The term “dendritic nanomaterials” or “dendritic nanoparticles” ‘or “dendritic microparticles” refers to highly branched dendritic macromolecules linked in aggregate nanostructures and/or microstructure with a controlled composition, architecture, and/or size. The term “highly branched dendritic macromolecule” as used herein indicates a macromolecule whose structure is characterized by a high degree of branching that originates from a central core region. Exemplary highly branched dendritic macromolecules comprise dendrimers, hyperbranched polymers, dendrigraft polymers, dendronized linear polymers, tecto-dendrimers, core-shell (tecto) dendrimers, hybrid linear dendritic copolymers, dendronized polymers and additional molecule identifiable by a skilled person (see e.g. US 2006/0021938, US 2008/0185341, US 2009/0001802, US 2010/0181257, US 2011/0315636, and US 2012/0035332 each incorporated by reference in its entirety, also describing method of making highly branched dendritic macromolecules). Exemplary dendritic nanomaterials can include, for example, any highly branched dendritic macromolecules or mixtures thereof, in dendrimer-based supramolecular assemblies, 3-D globular nanoparticles or dendritic nano/microparticles identifiable by a skilled person (see, for example, US 2006/0021938, US 2008/0185341, US 2009/0001802, US 2010/0181257, US 2011/0315636, and US 2012/0035332 each incorporated by reference in its entirety).

In particular in some embodiments of the filtration membranes herein described a polymeric nanomaterial forming particles (e.g. polymeric and/or dendritic microparticles and/or nanoparticles) can be embedded in the porous polymeric body of the polymer matrix.

The term “embed” or “embedded” as used herein refers to a spatial relationship of an item relative to a structure in which the item is at least partially enclosed within the structure. In particular, when used in connection to spatial relationship of nanoparticle with reference to a polymer matrix, the term “embed” refers to the nanoparticles being at least partially enclosed by the matrix in a suitable configuration within the polymeric aggregate. In particular, in some embodiments the nanoparticles can be attached (e.g. through covalent bonds or through non-covalent interactions such as, for example, van Der Waals forces) to the polymer molecules forming the porous aggregate in particular in correspondence to pores of the porous aggregate structure of the polymer matrix. (see e.g. FIGS. 7, 8, 17, 18, 24, 25, 27, 28, 39, 46, 52 and 53 of the present disclosure.)

In embodiments herein the membrane is characterized by a symmetric and skinless morphology. The skinless morphology is defined by the membrane's porous polymeric body having a surface (e.g., a surface exposed during coagulation) and a bulk region, wherein a surface areal void fraction measured at the surface differs by no more than 30% from a mean bulk areal void fraction measured within the bulk region.

The term “areal void fraction” refers to the proportion of a defined cross-sectional area of a polymeric body that is occupied by voids, pores, or other unfilled spaces, as opposed to the solid polymeric material. The areal void fraction provides a two-dimensional representation of the porosity of the polymeric body and characterizes the distribution and density of void regions within a given plane of the material. It expresses the ratio of the total area of the voids intersected by a given cross-section to the total area of that cross-section, thereby describing the extent to which the polymeric structure is porous when viewed in two dimensions. The areal void fraction is indicative of the permeability, gas diffusion capacity, and mechanical properties of the polymeric body, and may vary across the material depending on the method of fabrication, curing, or post-treatment.

The areal void fraction of a polymeric body may be determined by a variety of direct or indirect measurement techniques. In one method, a representative cross-section of the polymeric body is obtained, for example by microtoming, fracturing, or sectioning, and the exposed surface is examined using optical or electron microscopy. The resulting image is analyzed to differentiate the polymeric phase from the void regions, and the total area of the voids is divided by the total observed area to obtain the areal void fraction. The analysis may be carried out using digital image segmentation, thresholding, or contrast-based algorithms. In another method, non-destructive imaging techniques such as X-ray computed tomography, scanning acoustic microscopy, or optical coherence tomography are employed to reconstruct a cross-sectional map of the internal structure, from which the areal void fraction is calculated as the ratio of void area to total area. In certain embodiments, the areal void fraction may also be inferred from bulk measurements of density, refractive index, or acoustic transmission, combined with known material properties of the solid polymer phase. Computational models or numerical simulations of the polymeric microstructure may also be used to estimate the areal void fraction by integrating local phase data over a defined cross-section.

The term “surface areal void fraction” refers to the fraction of the surface area of the polymeric body that is occupied by surface-connected pores or void openings. The surface areal void fraction characterizes the surface porosity and determines the extent of exposed pore channels available for interaction with external media, coatings, or infiltrants. This parameter may be determined by surface imaging techniques such as scanning electron microscopy, confocal optical microscopy, or atomic force microscopy, followed by image analysis to quantify the area of surface voids relative to the total surface area. The surface areal void fraction may influence the wettability, adhesion, or surface energy of the polymeric body and may be controlled by surface treatment, plasma etching, or coating processes.

The term “local areal void fraction” as used herein denotes the areal void fraction determined for a specific region or localized portion of the polymeric body. The local areal void fraction represents a spatially resolved measure of porosity, capturing variations in void distribution and density that may arise from nonuniform cooling, differential polymerization, or localized deformation. Measurement of the local areal void fraction may be accomplished by mapping the structure through high-resolution imaging or tomographic techniques and analyzing discrete subregions of the image or model to compute the local ratio of void area to total area within that region. This localized parameter provides insight into gradients or anisotropies in the pore distribution of the polymeric body.

The term “mean bulk areal void fraction” refers to the areal void fraction averaged over the entire cross-section of the polymeric body, thereby providing a single representative value of the overall porosity of the material. The mean bulk areal void fraction is obtained by integrating or summing the local areal void fractions across the full cross-sectional area and dividing by the total area. This averaged value provides a macroscopic descriptor of the porous character of the polymeric structure and can be correlated with functional properties such as fluid permeability, mechanical strength, or thermal conductivity.

In general, the areal void fraction and its derivatives as defined herein provide quantitative measures of the two-dimensional porosity of a polymeric body. These parameters describe the structural openness and distribution of voids within the polymer matrix and are fundamental to understanding and controlling the physical, mechanical, and transport properties of the material.

The morphological characteristics of the filtration membranes, including the “skinless” and “symmetric” features, may be characterized using scanning electron microscopy (SEM) coupled with image analysis.

For this analysis, membrane samples are first dried, for example at room temperature and subsequently under vacuum. To analyze the bulk region, a membrane cross-section is prepared, typically by cryogenic fracture, which involves immersing the dried sample in liquid nitrogen and then fracturing it. Both the top surface and the fractured cross-section are then coated with a thin conductive layer, such as platinum/palladium (Pt/Pd), using a sputter coater to prepare them for imaging. The prepared samples are imaged using a Field Emission Scanning Electron Microscope (FE-SEM) to capture the porous structure of the surface and the cross-section.

The resulting micrographs are analyzed using image analysis software. To determine the “areal void fraction” or porosity, a grayscale threshold is applied to the 2D image to differentiate the solid polymer matrix from the pore voids, and the percentage of the total area occupied by these voids is calculated. The “surface areal void fraction” can be measured from micrographs of the membrane's top surface. The “mean bulk areal void fraction” can be measured from micrographs of the membrane's cross-section, often by averaging measurements taken at multiple depths through the thickness. Similarly, the “average pore dimension” can be measured from the SEM micrographs by identifying and measuring the dimensions of a statistically significant number of pores (e.g., 100) and calculating the average.

As used herein, the term “skinless” refers to a membrane morphology where the surface (e.g., the surface exposed during coagulation) lacks a dense, flow-restricting skin layer. This is characterized by the membrane's porous polymeric body having a surface areal void fraction that is substantially similar to its mean bulk areal void fraction.

In some embodiments, the surface areal void fraction, as measured by the methods described herein, differs by no more than 30% from the mean bulk areal void fraction. In other embodiments, the surface areal void fraction differs by no more than 25% from the mean bulk areal void fraction. In preferred embodiments, the surface areal void fraction differs by no more than 20% from the mean bulk areal void fraction. In more preferred embodiments, the surface areal void fraction differs by no more than 15%, or by no more than 120%, from the mean bulk areal void fraction. In particularly preferred embodiments, the surface areal void fraction differs by no more than 5%, or by no more than 2%, from the mean bulk areal void fraction.

As used herein, the term “symmetric” refers to a membrane morphology wherein the porous structure of the bulk region is substantially uniform throughout its thickness. This is characterized by measuring a local areal void fraction or an average pore dimension at different depths through the thickness of the bulk region.

The symmetric morphology is defined by the bulk region having a thickness and a mean bulk areal void fraction calculated across the thickness, wherein a local areal void fraction or average pore dimension of the bulk region, when measured at different depths through the thickness, varies by no more than 50% from the mean bulk areal void fraction or mean average pore dimension calculated across the thickness.

In some embodiments, this local areal void fraction or average pore dimension, when measured at different depths, varies by no more than 50% from the mean bulk areal void fraction or mean average pore dimension calculated across the entire thickness. In other embodiments, the variation is no more than 40%. In preferred embodiments, the variation is no more than 30%. In more preferred embodiments, the variation is no more than 25%, or by no more than 20%, from the mean value calculated across the thickness.

Functionally, this skinless and symmetric structure is confirmed in some embodiments by exhibiting a high fluid permeability characteristic of microfiltration (MF) membranes, such as a pure water flux exceeding 500 L/m²/hr. per bar of applied pressure (LMH/bar) at standard conditions. The typical pure water permeabilities of MF membranes vary from 500 to 1,000 LMH)/bar.

In some embodiments, this skinless and symmetric structure is confirmed by the SEM images of the membrane top surfaces and cross sections showing similar microstructure and morphologies throughout the surfaces and cross sections of the membranes that are consistent with those of a mixed matrix MF membrane adsorber.

In embodiments herein described the concentration of microparticles and/or nanoparticles functionalized with a polymeric network in the membranes can be between about 1 and 50 wt % of the membrane weight as determined by, in particular, in some embodiments, the concentration of microparticles and/or nanoparticles in the matrix can be between about 1 and 10 wt %. In particular, in other embodiments, the concentration of the microparticles and/or nanoparticles in the matrix can be greater than about 10 wt %, and more particularly greater than about 20 wt %, and more particularly greater than about 40 wt %. in some embodiments the microparticles and/or nanoparticles concentration can be up to about 50%. In some embodiments, the concentration of microparticles and/or nanoparticles can be between about 25% to about 50%, above 50%, and also between about 50% and about 60%. In some embodiments, the concentration of microparticles and/or nanoparticles can be between about 35 to 57 wt. percent (see Examples section).

In some embodiments, the microparticles and/or nanoparticles can have a homogeneous distribution throughout the membrane wherein similar numbers of nanoparticles are observed within same sized areas (e.g. in SEM images at the same magnification) throughout different portions of the membrane (see, e.g. Example section). In particular, in some embodiments, some (greater than about 5%) the microparticles and/or nanoparticles can be present as clusters of nanoparticles as can be observed by imaging the membrane (e.g. with SEM images of the membrane). In other embodiments, the particles can be discrete and not detectable as clusters (see, e.g. Example section).

In particular, in some embodiments, the filtration membranes include embedded microparticles, nanoparticles and/or clusters approximately 1-3000 nm in size as can be determined, for example, by SEM, TEM and AFM imaging (see e.g. Examples section).

In particular, in some embodiments, the filtration membranes herein described can have pores formed by the polymer aggregates forming the polymer matrix that range in size from approximately 0.5 microns to 10 microns as can be observed by imaging the membrane, for example, by SEM (see e.g. Examples section).

In some embodiments, the polymer matrix and polymeric microparticles or nanoparticles can be brought together to form membranes comprising the polymer matrix and polymeric microparticles and/or nanoparticles such that the polymeric microparticles and/or nanoparticles are embedded in the polymer matrix. In particular, in some embodiments, the formation of the membranes with embedded polymeric nanoparticles can be accomplished by allowing formation of polymeric nanoparticle in situ.

In particular, in some of those embodiments, a method for making a filtration membrane in situ herein described comprises preparing a blend comprising the base polymer that will form the polymeric aggregate and the polymer that will form the polymeric microparticle and/or nanoparticles in a suitable solvent or mixture of solvents; adding to the blend a functionalizing polymer that will form the polymeric network for a time and under condition to allow the related attachment e.g. crosslinking to the polymeric microparticles and/or nanoparticles Embodiments wherein formation of polymeric nanoparticles is performed in situ allow under appropriate conditions formation of homogeneous membrane having a concentration of particles up to about 50% and/or in which fractal formation of nanoparticle is not detectable. In addition, or in the alternative to the particle distribution, concentration and configuration, filtration membrane obtainable by in situ formation can have further controllable features identifiable by a skilled person upon reading of the present disclosure.

In some embodiments, the method to prepare a filtration membrane herein described in situ comprises preparing a base polymer solution by dissolving the target amount of base polymer in a suitable and good/compatible solvent. In particular, in in situ method a good/compatible solvent is a solvent where the base polymer is substantially soluble wherein the term “substantially soluble” as used herein with reference to a polymer and a solvent and/or a composition indicates the ability of the polymer to dissolve in the solvent and/or composition. Accordingly, the backbone of the base polymers as herein described can be substantially soluble in a good solvent when the polymer backbone and the good solvent have similar Hildebrand solubility parameters (8) which is the square root of the cohesive energy density:

$$δ = \sqrt{\frac{Δ {H}_{v} - RT}{{V}_{m}}}$$

wherein 4Hv is equal to the heat of vaporization, Ris the ideal gas constant, Tis the temperature, and Vm is the molar volume. Similarly two solvents or more solvents are compatible when they have similar solubility parameters. In particular, similar solubility parameters between a polymer or a portion thereof and a solvent and/or composition, and similar solubility parameters between two or more solvents can be found when the absolute value of the difference between their solubility parameters is within 1-10% (see also Tables 1 to 3 herein).

A polymer or portion thereof in accordance with the present disclosure is partially soluble in a certain solvent or composition, when the polymer or portion thereof has partially similar solubility parameters with the solvent or compositions. Analogously two or more solvents are partially compatible one with the other when the two or more solvents have partially similar solubility parameters. Partially similar solubility parameters are found when the absolute value of the difference between their solubility parameters is within 5 to 10% (see also Tables 1-3 herein).

A polymer or portion thereof in accordance with the present disclosure is substantially insoluble in a certain solvent or composition, when the polymer or portion thereof has dissimilar solubility parameters with the solvent or compositions. Analogously two or more solvents are substantially incompatible one with the other when the two or more solvents have dissimilar solubility parameters. Dissimilar solubility parameters are found when the absolute value of the difference between their solubility parameters is higher than 10% (see also Tables 1-3 herein).

A skilled person will realize that the ability of the backbone to dissolve in the solvent can be verified, for example, by placing an amount of the homopolymer or copolymer to be used in the solvent or composition as herein described, and observing whether or not it dissolves under appropriate conditions of temperature and agitation that are identifiable to a skilled person.

In particular, an exemplary reference providing solubility parametes is the website www.sigmaaldrich.com/etc/medialib/docs/Aldrich/General_Information/polymer_solutions.Par. 0001.File.tmp/polymer_solutions.pdf [1] at the time of filing of the present disclosure (see Tables 1-3). More particularly, a skilled person will know that Sigma-Aldrich and other chemical companies provide exemplary tables showing exemplary solubility paramenter values for various non-polar compositions and polymers. A skilled person can also refer to sources such as the Polymer Handbook to find solubility parameter values Brandrup, J., et al., “Polymer handbook”. Vol. 1999. 1999: Wiley New York [2].

TABLE 1
Table II. Solubility Parameters for Plasticizers
and Solvents (Alphabetical Sequence)

| | δ | H-Bonding |
|---|---|---|
| Solvent | (cal/cm³)½ | Strength³ |
| Acetone | 9.9 | m |
| Acetonitrile | 11.9 | p |
| Amyl acetate | 8.5 | m |
| Aniline | 10.3 | s |
| Benzene | 9.2 | p |
| Butyl acetate | 8.3 | m |
| Butyl alcohol | 11.4 | s |
| Butyl butyrate | 8.1 | m |
| Carbon disulfide | 10.0 | p |
| Carbon tetrachloride | 8.6 | p |
| Chlorobenzene | 9.5 | p |
| Chloroform | 9.3 | p |
| Cresol | 10.2 | s |
| Cyclohexanol | 11.4 | s |
| Diamyl ether | 7.3 | m |
| Diamyl phthalate | 9.1 | m |
| Dibenzyl ether | 9.4 | m |
| Dibutyl phthalate | 9.3 | m |
| Dibutyl sebacate | 9.2 | m |
| 1,2-Dichlorobenzene | 10.0 | p |
| Diethyl carbonate | 8.8 | m |
| Diethyl ketone | 8.8 | m |
| Di(ethylene glycol) monobutyl ether | 9.5 | m |
| (Butyl Carbitol ®) | | |
| Di(ethylene glycol) monoethyl ether | 10.2 | m |
| (Carbitol ®) | | |
| Diethyl ether | 7.4 | m |
| Diethyl phthalate | 10.0 | m |
| Di-n-hexyl phthalate | 8.9 | m |
| Diisodecyl phthalate | 7.2 | m |
| N,N-Dimethylacetamide | 10.8 | m |
| Dimethyl ether | 8.8 | m |
| N,N-Dimethylformamide | 12.1 | m |
| Dimethyl phthalate | 10.7 | m |
| Dimethylsiloxanes | 4.9-5.9 | p |
| Dimethyl sulfoxide | 12.0 | m |
| Dioctyl adipate | 8.7 | m |
| Dioctyl phthalate | 7.9 | m |
| Dioctyl sebacate | 8.6 | m |
| 1,4-Dioxane | 10.0 | m |
| Di(propylene glycol) | 10.0 | s |
| Di(propylene glycol) monomethyl ether | 9.3 | m |
| Dipropyl phthalate | 9.7 | m |
| Ethyl acetate | 9.1 | m |
| Ethyl amyl ketone | 8.2 | m |
| Ethyl n-butyrate | 8.5 | m |
| Ethylene carbonate | 14.7 | m |
| Ethylene dichloride | 9.8 | p |
| Ethylene glycol | 14.6 | s |
| Ethylene glycol diacetate | 10.0 | m |
| Ethylene glycol diethyl ether | 8.3 | m |
| Ethylene glycol dimethyl ether | 8.6 | m |
| Ethylene glycol monobutyl ether | 9.5 | m |
| (Butyl Cellosolve ®) | | |
| Ethylene glycol monoethyl ether | 10.5 | m |
| (Cellosolve ®) | | |
| Furfuryl alcohol | 12.5 | s |
| Glycerol | 16.5 | s |
| Hexane | 7.3 | p |
| Isopropyl alcohol | 8.8 | m |
| Methanol | 14.5 | s |
| Methyl amyl ketone | 8.5 | m |
| Methylene chloride | 9.7 | p |
| Methyl ethyl ketone | 9.3 | m |
| Methyl isobutyl ketone | 8.4 | m |
| Propyl acetate | 8.8 | m |
| 1,2-Propylenecarbonate | 13.3 | m |
| Propylene glycol | 12.6 | s |
| Propylene glycol methyl ether | 10.1 | m |
| Pyridine | 10.7 | s |
| 1,1,2,2-Tetrachloroethane | 9.7 | p |
| Tetrachloroethylene (perchloroethylene) | 9.3 | p |
| Tetrahydrofuran | 9.1 | m |
| Toluene | 8.9 | p |
| Water | 23.4 | s |

²“Polymer Handbook”, Eds. Brandrup, J.; Immergut, E. H.; Grulke, E. A., 4th Edition, John Wiley, New York, 1999, VII/675-711. Aldrich Catalog Number Z41,247-3.
³H-Bonding: p = poor; m = moderate; s = strong

TABLE 2
Table III: Solubility Parameters (δ) for Plasticizers
and Solvents (Increasing δ value sequence)

| | δ | H-Bonding |
|---|---|---|
| Solvent | (cal/cm³)½ | Strength⁴ |
| Dimethylsiloxanes | 4.9-5.9 | p |
| Diisodecyl phthalate | 7.2 | m |
| Hexane | 7.3 | p |
| Diamyl ether | 7.3 | m |
| Diethyl ether | 7.4 | m |
| Dioctyl phthalate | 7.9 | m |
| Butyl butyrate | 8.1 | m |
| Ethyl amyl ketone | 8.2 | m |
| Ethylene glycol diethyl ether | 8.3 | m |
| Butyl acetate | 8.3 | m |
| Methyl isobutyl ketone | 8.4 | m |
| Methyl amyl ketone | 8.5 | m |
| Amyl acetate | 8.5 | m |
| Ethyl n-butyrate | 8.5 | m |
| Ethylene glycol dimethyl ether | 8.6 | m |
| Carbon tetrachloride | 8.6 | p |
| Dioctyl sebacate | 8.6 | m |
| Dioctyl adipate | 8.7 | m |
| Isopropyl alcohol | 8.8 | m |
| Diethyl carbonate | 8.8 | m |
| Propyl acetate | 8.8 | m |
| Diethyl ketone | 8.8 | m |
| Dimethyl ether | 8.8 | m |
| Toluene | 8.9 | p |
| Di-n-hexyl phthalate | 8.9 | m |
| Ethyl acetate | 9.1 | m |
| Diamyl phthalate | 9.1 | m |
| Tetrahydrofuran | 9.1 | m |
| Dibutyl sebacate | 9.2 | m |
| Benzene | 9.2 | p |
| Tetrachloroethylene (perchloroethylene) | 9.3 | p |
| Di(propylene glycol) monomethyl ether | 9.3 | m |
| Chloroform | 9.3 | p |
| Dibutyl phthalate | 9.3 | m |
| Methyl ethyl ketone | 9.3 | m |
| Dibenzyl ether | 9.4 | m |
| Ethylene glycol monobutyl ether | 9.5 | m |
| (Butyl Cellosolve ®) | | |
| Di(ethylene glycol) monobutyl ether | 9.5 | m |
| (Butyl Carbitol ®) | | |
| Chlorobenzene | 9.5 | p |
| Methylene chloride | 9.7 | p |
| Dipropyl phthalate | 9.7 | m |
| 1,1,2,2-Tetrachloroethane | 9.7 | p |
| Ethylene dichloride | 9.8 | p |
| Acetone | 9.9 | m |
| 1,2-Dichlorobenzene | 10.0 | p |
| Diethyl phthalate | 10.0 | m |
| Ethylene glycol diacetate | 10.0 | m |
| Di(propylene glycol) | 10.0 | s |
| Carbon disulfide | 10.0 | p |
| 1,4-Dioxane | 10.0 | m |
| Propylene glycol methyl ether | 10.1 | m |
| Di(ethylene glycol) monoethyl ether | 10.2 | m |
| (Carbitol ®) | | |
| Cresol | 10.2 | s |
| Aniline | 10.3 | s |
| Ethylene glycol monoethyl ether | 10.5 | m |
| (Cellosolve ®) | | |
| Pyridine | 10.7 | s |
| Dimethyl phthalate | 10.7 | m |
| N,N-Dimethylacetamide | 10.8 | m |
| Cyclohexanol | 11.4 | s |
| Butyl alcohol | 11.4 | s |
| Acetonitrile | 11.9 | p |
| Dimethyl sulfoxide | 12.0 | m |
| Di(ethylene glycol) | 12.1 | s |
| N,N-Dimethylformamide | 12.1 | m |
| Furfuryl alcohol | 12.5 | s |
| Propylene glycol | 12.6 | s |
| 1,2-Propylenecarbonate | 13.3 | m |
| Methanol | 14.5 | s |
| Ethylene glycol | 14.6 | s |
| Ethylene carbonate | 14.7 | m |
| Glycerol | 16.5 | s |
| Water | 23.4 | s |

⁴H-Bonding: p = poor; m = moderate; s = strong
Carbitol and Cellosolve are registered trademarks of Union Carbide Corp.

TABLE 3
Table IV. Solubility Parameters for Homopolymers⁵

| Repeating Unit | | Repeating Unit | |
|---|---|---|---|
| (Alphabetical | δ | (Increasing δ | δ |
| Sequence) | (cal/cm³)½ | Value Sequence) | (cal/cm³)½ |
| Acrylonitrile | 12.5 | Tetrafluoroethylene | 6.2 |
| Butyl acrylate | 9.0 | Isobutyl methacrylate | 7.2 |
| Butyl methacrylate | 8.8 | Dimethylsiloxane | 7.5 |
| Cellulose | 15.6 | Propylene oxide | 7.5 |
| Cellulose acetate | 27.8 | Isobutylene | 7.8 |
| (56% Ac groups) | | | |
| Cellulose nitrate | 14.8 | Stearyl methacrylate | 7.8 |
| (11.8% N) | | | |
| Chloroprene | 9.4 | Ethylene | 8.0 |
| Dimethylsiloxane | 7.5 | 1,4-cis-Isoprene | 8.0 |
| Ethyl acrylate | 9.5 | Isobornyl methacrylate | 8.1 |
| Ethylene | 8.0 | Isoprene, natural rubber | 8.2 |
| Ethylene terephthalate | 10.7 | Lauryl methacrylate | 8.2 |
| Ethyl methacrylate | 9.0 | Isobornyl acrylate | 8.2 |
| Formaldehyde | 9.9 | Octyl methacrylate | 8.4 |
| (Oxymethylene) | | | |
| Hexamethylene | 13.6 | n-Hexyl methacrylate | 8.6 |
| adipamide (Nylon 6/6) | | | |
| n-Hexyl methacrylate | 8.6 | Styrene | 8.7 |
| Isobornyl acrylate | 8.2 | Propyl methacrylate | 8.8 |
| 1,4-cis-Isoprene | 8.0 | Butyl methacrylate | 8.8 |
| Isoprene, natural rubber | 8.2 | Ethyl methacrylate | 9.0 |
| Isobutylene | 7.8 | Butyl acrylate | 9.0 |
| Isobornyl methacrylate | 8.1 | Propyl acrylate | 9.0 |
| Isobutyl methacrylate | 7.2 | Propylene | 9.3 |
| Lauryl methacrylate | 8.2 | Chloroprene | 9.4 |
| Methacrylonitrile | 10.7 | Tetrahydrofuran | 9.4 |
| Methyl acrylate | 10.0 | Methyl methacrylate | 9.5 |
| Methyl methacrylate | 9.5 | Ethyl acrylate | 9.5 |
| Octyl methacrylate | 8.4 | Vinyl chloride | 9.5 |
| Propyl acrylate | 9.0 | Formaldehyde | 9.9 |
| | | (Oxymethylene) | |
| Propylene | 9.3 | Methyl acrylate | 10.0 |
| Propylene oxide | 7.5 | Vinyl acetate | 10.0 |
| Propyl methacrylate | 8.8 | Methacrylonitrile | 10.7 |
| Stearyl methacrylate | 7.8 | Ethylene terephthalate | 10.7 |
| Styrene | 8.7 | Vinylidene chloride | 12.2 |
| Tetrafluoroethylene | 6.2 | Acrylonitrile | 12.5 |
| Tetrahydrofuran | 9.4 | Vinyl alcohol | 12.6 |
| Vinyl acetate | 10.0 | Hexamethylene adipamide | 13.6 |
| | | (Nylon 6/6) | |
| Vinyl alcohol | 12.6 | Cellulose nitrate | 14.8 |
| | | (11.8% N) | |
| Vinyl chloride | 9.5 | Cellulose | 15.6 |
| Vinylidene chloride | 12.2 | Cellulose acetate | 27.8 |
| | | (56% Ac groups) | |

⁵Values reported are for homopolymers of the Repeating Unit. Reported δ values vary with the method of determination and test conditions. Averaged values are given in this table.

Additional exemplary empirical solubility parameters (e.g. Flory Huggins are identifiable by a skilled person (see, e.g., Brandrup, J., et al., “Polymer handbook”. Vol. 1999. 1999: Wiley New York [2]. and other available references known or identifiable by one skilled in the art)) Exemplary good solvents for the exemplary base polymer PVDF comprise Tetrahydrofuran, Methyl Ethyl Ketone, Dimethyl formamide, Dimethyl acetamide, Tetramethyl urea, Dimethyl Sulfoxide, Triethyl phosphate, N-Methyl-2-Pyrrolidone. Additional indication concerning good solvents for a PVDF polymer can be found in F. Liu et al./Journal of Membrane Science 375 (2011) 1-27 [3]. A skilled person can determine if other solvents would be good solvents for PVDF or if other base polymers or other polymers (e.g. functionalizing polymers their precursor, polymeric particle precursors) would be substantially soluble in these solvents or other solvents or compositions by applying the same calculations using the particular solubility parameters for the particular solvent and/or composition.

Exemplary linear polymers that can be used as building blocks for the base polymer of membranes with in-situ generated polymeric particles and polymeric networks include polyvinylidene fluoride (PVDF), polyethersulfone (PES), polysulfone (PSf), polyacrylonitrile (PAN) and polyamides (PAM) and additional polymer of formula (I) herein described. Good solvents for these polymers are expected to comprise n-methyl-2-pyrrolidone (NMP), dimethyl formamide (DMF), dimethyl acetamide (DMAc), triethyl phosphate (TEP), dimethyl sulfoxide (DMSO), 1-butylpyrrolidin-2-one and dihydrolevoglucosenone.

The method further comprises adding a particle precursor in the base polymer solution to obtain a blend and in particular a dispersion of particle precursor in the base polymer solution. Given a certain base polymer solution, a particle precursor can be selected to have: a portion substantially soluble in a solvent (or mixture of solvents) compatible with that used to dissolve the base polymer and a portion substantially insoluble with said solvent. Accordingly, the particle precursor can be selected for the ability to form dispersed/segregated domains and in particular aggregates of surfactant molecules (e.g. micelles) dispersed in the base polymer solution as will be understood by a skilled person. Exemplary expected membrane particle precursors include functional monomers/polymers, block copolymers: branched polymers/dendrimers and in particular can include a polymer according to Formula (I), Formula (XI) or Formula (XVI). Preferred particle precursors include aliphatic amines, aromatic amines, anhydrides, polyamines (linear, branched and dendritic) and epoxides and other compound presenting hydroxyl groups.

In some embodiments preparing a base polymer solution and adding a particle precursor is performed to control the sizes of the segregated domains of precursor particles, which on their turn control the sizes of the in-situ synthesized microparticles and/or nanoparticles. In particular, with the in situ method microparticles and/or nanoparticles can be synthesized which have a diameter in a range of from approximately 10-100 nm to approximately 2-4 μm and depend on several factors including the (i) chemistry and molecular weight of the particle precursor, (ii) intensity and duration of mixing (e.g. sonication versus slow stirring) and (ii) the addition of a dispersion stabilizer (e.g. surfactant). For example, a mixture of (i) base polymer and solvent, (ii) particle precursor formed by a monomer/oligomer of [molecular weight (Mn) of 100-1000] and (iii) a surfactant (e.g. sodium dodecyl sulfate) is expected to be sonicated to prepare a membrane casting solution containing segregated domains of particle precursors of 10-100 nm in sizes. In contrast, the slow stirring of a mixture of base polymer and solvent and (ii) monomer/polymer [Molecular weight (Mn) of 300-100000] is expected to be required to prepare a membrane dope containing segregated domains of particle precursors of sizes ranging from 0.5 to 4 μm depending on the specific combination of based polymer, polymer particles precursor and/or stirring conditions.

The method to prepare an in-situ membrane with functionalized polymer further comprises adding crosslinker and/or an initiator capable of reacting with the polymer particle precursor to the blend to synthesize the polymeric particles in a membrane casting solution formed by a base polymer a solvent, polymeric particle precursor and the crosslinker and/or/initiator.

A cross-link is a bond that links one polymer chain to another. They can be covalent bonds or ionic bonds. Exemplary crosslinkers include diacrylates, dimethacrylates, diepoxides, dihalides, diisocyanates, diacyl chlorides, dianhydrides.

Preferred crosslinkers include diepoxides, dihalides, diacyl chlorides and dianhydrides with small molecular weights (Mn of 90-300). Preferred crosslinker monomers include epoxides, acrylics, amines, acid chlorides and others that can be used to prepare polymeric particles in solutions herein described. Exemplary crosslinkers for particle formation herein described comprise the compounds described in Table 4 corresponding to Table 2 of U.S. Pat. No. 7,459,502 [4].

TABLE 4

| Structure | Mw |
|---|---|
| 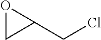 | 92.52 |
| 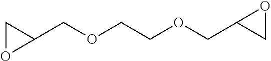 [SMILES: C(COCC1CO1)OCC1CO1] | 124.19 |
| 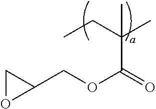 | |
| 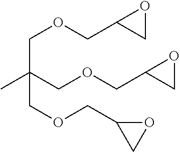 [SMILES: CC(COCC1CO1)(COCC1CO1)COCC1CO1] | 302.37 |
| 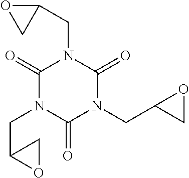 [SMILES: O=c1n(CC2CO2)c(=O)n(CC2CO2)c(=O)n1CC1CO1] | 297.27 |
| 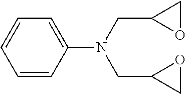 [SMILES: c1ccc(N(CC2CO2)CC2CO2)cc1] | 277.32 |
| 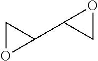 | 86.09 |
| 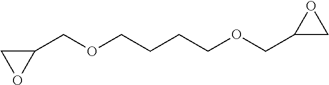 [SMILES: C(CCOCC1CO1)COCC1CO1] | 202.25 |
| 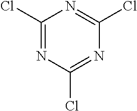 | 184.41 |
| 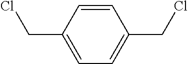 | 175.06 |
| 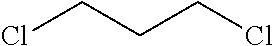 | 112.99 |
| 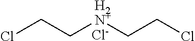 | 178.49 |
| 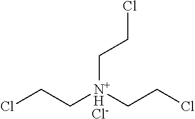 | 240.99 |
| 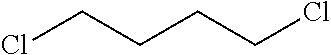 | 127.01 |
| 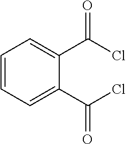 [SMILES: O=C(Cl)c1ccccc1C(=O)Cl] | 203.02 |
| 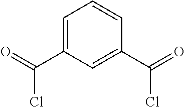 [SMILES: O=C(Cl)c1cccc(C(=O)Cl)c1] | 203.02 |
| 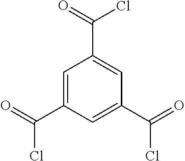 [SMILES: O=C(Cl)c1cc(C(=O)Cl)cc(C(=O)Cl)c1] | 265.48 |
| 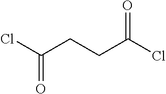 | 154.98 |
| 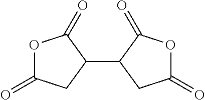 [SMILES: O=C1CC(C2CC(=O)OC2=O)C(=O)O1] | 198.13 |
| 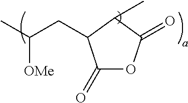 | |
| 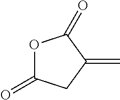 | 112.08 |
| 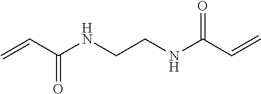 | 168.2 |
| 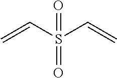 | 118.16 |
| 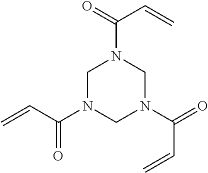 [SMILES: C=CC(=O)N1CN(C(=O)C=C)CN(C(=O)C=C)C1] | 249.27 |
| 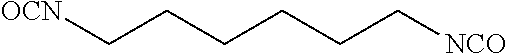 | 168.19 |
| 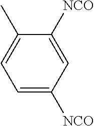 | 174.16 |
| 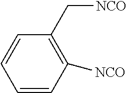 | 188.18 |
| 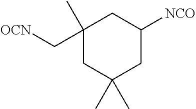 | 222.28 |
| 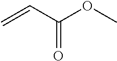 | 86.09 |
| 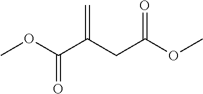 | 158.16 |
| 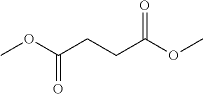 | 146.14 |
| 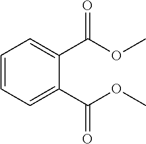 | 194.19 |
| 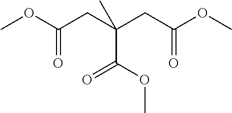 | 234.2 |
| 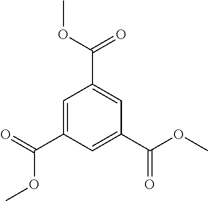 [SMILES: COC(=O)c1cc(C(=O)OC)cc(C(=O)OC)c1] | 252.22 |
| 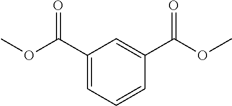 | 194.19 |
| 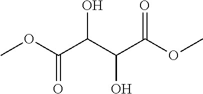 | 178.14 |
| 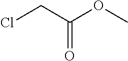 | 108.53 |

An initiator, indicates a source of any chemical species that reacts with a monomer (single molecule that can form chemical bonds) to form an intermediate compound capable of linking successively with a large number of other monomers into a polymeric compound. The most widely used initiators produce free radicals (reactive atoms or groups of atoms that contain odd numbers of electrons); examples include peroxides and aliphatic azo compounds used to polymerize vinyl chloride, methyl methacrylate, and other monomers. Acid-forming systems such as boron trifluoride with traces of water react with a monomer to produce a positively charged (cationic) intermediate. Such initiation is used in the conversion of isobutylene to butyl rubber. Reaction of metallic sodium and biphenyl produces an anionic initiator that causes formation of polymer chains with reactive sites at both ends; these may be further treated with a different monomer to yield block copolymers. For example, Polypropylene and high-density polyethylene are prepared by use of Ziegler catalysts, which are initiators composed of organometallic compounds and metallic halides, such as triethylaluminum and titanium tetrachloride.

An exemplary initiator capable of reacting with a polymeric particle precursor herein described is benzyl chloride. Additional initiators can be identified by a skilled person in view of information known to a skilled person (see e.g. M. Talha Gokmen, Filip E. Du Prez*Progress in Polymer Science 37 (2012) 365-405 [5]) and the content of the present disclosure. Additional methods and techniques to make polymeric particles known to a skilled person (e.g. Strathmann, Introduction to Membrane Science and Technology. Wiley-VCH Verlag: Weinheim, 2011 [6], and V. Mittal, (Ed). Advanced Polymer Nanoparticles-Synthesis and Surface Modifications. CRC Press; Boca Raton (Florida), 2011, Chap 1, 1-28 [6]) can also be adapted to in situ particle formation by modifications that allow to avoid precipitation.

In embodiments herein described the in situ functionalized skinless and symmetric membrane adsorber comprises in situ functionalized polymeric microparticles and/or nanoparticles embedded in the base polymer are functionalized microparticles and/or nanoparticles presenting functional groups capable of selective interaction.

The term “functionalized” when used with respect to polymers or polymer particles, refers to the condition in which the polymer or its constituent surface, chain, or particle structure has been chemically modified to attach one or more “functional groups”” that impart specific chemical, physical, or interfacial properties beyond those of the unmodified material.

The term “functional group” as used herein indicates specific groups of atoms within a molecular structure that are responsible for the characteristic chemical reactions and chemical properties of that structure. Exemplary functional groups include hydrocarbons, groups containing halogen, groups containing oxygen, groups containing nitrogen and groups containing phosphorus and sulfur all identifiable by a skilled person. In particular, functional groups in the sense of the present disclosure include a halide, carboxylic acid, amine, triarylphosphine, azide, acetylene, sulfonyl azide, thio acid and aldehyde. In particular, for example, the first functional group and the second functional group can be selected to comprise the following binding partners: carboxylic acid group and amine group, carboxylic acid and ether group, amine group and nitrile group, azide and acetylene groups, azide and triarylphosphine group, sulfonyl azide and thio acid, aldehyde and primary amine, and an amine group and a fluorine. Additional functional groups can be identified by a skilled person upon reading of the present disclosure. As used herein, the term “corresponding functional group” refers to a functional group that can react or interact (e.g. through non-covalent electrostatic attraction) with another functional group. Thus, functional groups that can react or interact with each other can be referred to as corresponding functional groups. In embodiments where the corresponding functional groups are in the polymer forming the polymer matrix and in the polymer forming the nanoparticle, the corresponding functional groups react to form a covalent bond, a hydrogen bond or other bond functional to the attachment of the polymer forming the polymer matrix and the polymer forming the nanoparticle identifiable by a skilled person upon reading of the present disclosure.

The term “in-situ functionalization” as used herein is an attachment performed in-situ, wherein a specific functional reagent is added to that intermediate dope solution. This functional reagent then reacts with a reference item to attach a functional group This entire attachment process is performed “in-situ”—meaning, it is completed within the liquid organic dope solution prior to the final casting or spinning step—to create the final in situ functionalized membrane adsorber.

The term “attach” or “attachment” as used herein, refers to connecting or uniting by a bond, link, force or tie in order to keep two or more components together, which encompasses either direct or indirect attachment such that, for example, a first compound is directly bound to a second compound or material, and the embodiments wherein one or more intermediate compounds, and in particular molecules, are disposed between the first compound and the second compound or material. In particular, in some embodiments, the polymeric nanomaterial can be associated with the polymer matrix by, for example, by being physically embedded in the polymer matrix, by being covalently bonded to the polymeric component, or through a combination of both.

Functionalization of polymer particles can thus be achieved through attachment of the functional groups by covalent bonding, grafting, surface treatment, adsorption, or incorporation of reactive moieties that enable targeted interactions with other chemical species, substrates, or phases.

Accordingly, in some embodiments, functionalization typically involves the introduction, substitution, or transformation of chemical groups along the polymer backbone, side chains, chain ends, or pendant groups. These functional groups can comprise hydroxyl, carboxyl, amino, thiol, sulfonic, phosphonic, epoxy, halogen, or alkene groups, as well as complex moieties such as polyethylene glycol chains, fluorinated segments, or ionic functionalities. The purpose of such modification is to alter the polymer's reactivity, hydrophilicity, compatibility with other materials, charge density, or ability to participate in subsequent crosslinking, coupling, or binding reactions.

In embodiments including functionalization of polymer particles, the term functionalized denotes that the surface or outer region of the particle has been provided with reactive or interactive chemical groups capable of engaging in specific chemical or physical interactions. Functionalized polymer particles may thus possess surface groups that allow for binding to other polymers, anchoring to substrates, adsorption of metal ions, bioconjugation, or catalytic activity. Functionalization of polymer particles may be achieved during synthesis—by copolymerization with monomers bearing reactive functionalities, or post-synthetically through surface modification, such as plasma treatment, graft polymerization, silanization, oxidation, or reaction with coupling agents.

In some embodiments, functionalization can be selective, limited to a surface or interface region, or may occur throughout the bulk of the polymeric structure. The extent and type of functionalization govern the interfacial energy, dispersion stability, and interaction strength of the polymer or particle with its surrounding medium. For example, functionalized polymer particles bearing hydrophilic or charged groups may be stably dispersed in aqueous media, while hydrophobically functionalized particles may preferentially associate with organic or nonpolar environments.

In some embodiments, the functionalization of polymer particles is performed to provide the polymer with functional groups capable of selective interactions, which refers to chemical moieties or substituent groups incorporated into a molecule, polymer, or particle surface that possess the inherent ability to engage in specific, preferential, and often reversible interactions with a defined class of chemical species, molecular structures, or physical environments. These interactions arise from the intrinsic chemical reactivity, polarity, charge, or coordination characteristics of the functional group and are distinguished by their selectivity—that is, their tendency to associate or react more strongly with certain target species than with others under comparable conditions.

Functional groups capable of selective interactions are typically characterized by the presence of donor or acceptor sites, ionic or polar domains, or geometric features that enable the formation of selective interactions such as hydrogen bonding, ionic pairing, acid-base association, dipole-dipole alignment, x-x stacking, coordination to metal ions, or specific covalent coupling reactions. The selectivity may derive from chemical complementarity (for example, carboxyl and amine groups forming ionic or hydrogen-bonded pairs), from size or shape matching (as in host-guest or molecular recognition systems), or from differential affinity governed by the solvent environment, pH, or electronic configuration of the interacting species.

In the context of functionalized polymers or polymer particles, functional groups capable of selective interaction may include, by way of example, carboxyl, hydroxyl, amino, thiol, sulfonic, phosphonic, carbonyl, or epoxy groups, as well as heterocyclic or aromatic groups bearing electron-donating or -withdrawing substituents. These groups may be designed to preferentially bind or attract complementary groups on other molecules, ions, or surfaces, thereby imparting to the polymeric material the ability to recognize, capture, or immobilize specific chemical entities. For instance, thiol or amine functional groups may selectively coordinate with transition metal ions, quaternary ammonium groups may selectively bind anionic species, and fluorinated groups may selectively associate with nonpolar or hydrophobic domains including emerging and newly regulated drinking water contaminants such as per- and polyfluoroalkyl substances (PFAS) “forever chemicals” including perfluorooctanoic acid (PFOA) and perfluorooctane sulfonic acid (PFOS).

The expression “selective interaction” in this context encompasses both chemical selectivity, in which specific chemical reactions or associations occur only with particular species, and physical selectivity, in which interactions are governed by polarity, hydrophobicity, or steric complementarity rather than by covalent bonding. Functional groups capable of selective interaction thus provide a mechanism for molecular discrimination, allowing the polymeric or particulate material to exhibit controlled adhesion, adsorption, recognition, or transport behavior in multiphase systems.

Accordingly, a functional group capable of selective interaction is defined as a chemically or structurally distinct moiety that confers to a polymer or polymer particle the ability to preferentially and reproducibly associate with one or more specific target species through covalent, ionic, hydrogen-bonding, coordinative, or other physicochemical forces, thereby enabling selective binding, separation, catalysis, or response within a complex chemical environment.

In embodiments herein described in situ functionalization is performed in a dope comprising a dispersion of already-synthesized particles to covalently attach new functional groups which provide the particle with the capability of selective interaction following the surprising finding that selected functional groups that are structurally and electronically configured to exhibit preferential association, binding, or exchange with specific ionic or molecular species can be attached in situ with reagents that are compatible with the symmetric skinless membrane and still remain reactive with respect to the polymeric particle within the dope solution.

In particular in situ functionalization of symmetric skinless membrane adsorber is based on the surprising finding that a specific class of functional reagents, which are structurally and electronically configured to exhibit preferential association, binding, or exchange with specific ionic or molecular species are organic-compatible, meaning they are uniquely soluble and reactive with respect to the polymeric particles within the organic dope solution, and that the corresponding in-situ chemical modification is surprisingly compatible with the subsequent membrane formation process.

Functionalizing reagents for the in situ functionalization comprise any reagent which is organic-compatible soluble or miscible in the organic dope solution and comprise a reactive moiety capable of covalently bonding to the inherently functional polymeric microparticles (e.g., by reacting with the amine groups of a polymer particle such as PEI particle or with functional groups presented on the crosslinker). The reagent itself is consumed and/or washed away, leaving the final functional group attached to the particle.

Such groups comprise, strong base anion exchange groups, strong acid cation exchange groups, chelating groups, hydrophobic interaction chromatography groups, fluorine groups and other reactive sites recognizable to a person skilled in the art of polymer chemistry and materials functionalization.

The term “anion exchange groups” or “Anion Exchange” or “AEX” groups as used herein refer to functional groups that are capable of selectively interacting with, or binding to, negatively charged species such as anions or acidic functional groups. These groups typically contain positively charged or basic nitrogen atoms capable of forming ionic pairs or electrostatic interactions with anionic species. Examples include primary, secondary, tertiary, and quaternary amines, which may be present as amine or ammonium functionalities. In their protonated or quaternized forms, such amine-based groups bear positive charges that facilitate the reversible exchange of anions such as chloride, sulfate, phosphate, or carboxylates. The strength and selectivity of the interaction depend upon the pKa of the amine, the degree of protonation, and the nature of the anionic species. These groups are commonly employed in ion exchange resins, separation membranes, and functionalized polymer particles designed for adsorption or catalysis.

The term “strong base” or “SB” “anion exchange group” or Anion Exchange” or “AEX” groups as used herein indicates a specific type of anion exchange group, distinguished from the “weak base” (i.e., primary, secondary, or tertiary amine) groups by a pH-independent positive charge. Structurally, in the context of this disclosure, this group comprises a quaternary ammonium cation, which is a positively charged nitrogen atom covalently bonded to four non-hydrogen atoms (e.g., four carbon atoms). This permanent positive charge is the key quantitative differentiator.

Therefore, a membrane comprising “strong base anion exchange groups” is defined as a membrane that exhibits a high anion exchange capacity over a wide operational pH range. As a quantifiable threshold, such a membrane retains at least 80% of its maximum anionic Dynamic Binding Capacity (DBC), for example for bovine serum albumin, when the operating buffer is changed from a neutral pH (e.g., pH 7.0) to a high pH, for example pH 9.0 or greater. In embodiments herein described These strong base groups are formed during the in-situ functionalization step via a quaternization reaction, for example, by reacting the tertiary amines of the base particles with an organic-compatible alkylating reagent such as bromoethane.

The term “cation exchange groups” of “Cation Exchange” or “CEX” groups refer to functional groups capable of selectively interacting with, or binding to, positively charged species such as metal cations, ammonium ions, or other basic groups. Cation exchange groups typically include acidic functionalities such as carboxylates, sulfonates, phosphonates, or similar anionic moieties that can dissociate to yield negatively charged sites. The deprotonated form of these groups provides coordination or electrostatic interaction sites for cations, enabling reversible ion exchange or complex formation. The selectivity and capacity of cation exchange groups depend on the acidity of the functional group, the valency and size of the cation, and the dielectric environment of the polymeric matrix. Such groups are often employed to modulate ionic conductivity, adsorption of metal ions, or crosslinking behavior within a polymeric system.

The term “strong acid”: SA″ “cation exchange group” “Cation Exchange” or “CEX” groups as used herein indicates a specific type of cation exchange group, distinguished from “weak acid” groups (e.g., carboxylates) by a pH-independent negative charge. Structurally, in the context of this disclosure, this group comprises a sulfonate anion (—SO3-) or a phosphonate (—PO4 2-) anion. These groups possess a very low pKa (e.g., less than 2) and thus remain fully deprotonated and negatively charged even in highly acidic solutions. This permanent negative charge is the key quantitative differentiator.

Therefore, a membrane comprising “strong acid cation exchange groups” is defined as a membrane that exhibits a high cation exchange capacity over a wide operational pH range. As a quantifiable threshold, such a membrane retains at least 80% of its maximum cationic Dynamic Binding Capacity (DBC), for example for lysozyme, when the operating buffer is changed from a neutral pH (e.g., pH 7.0) to a low pH, for example pH 4.0 or lower. In embodiments herein descibed these strong acid groups are formed during the in-situ functionalization step by reacting the base particles with an organic-compatible reagent, such as a sultone (e.g., 1,3-propanesultone), which covalently attaches the sulfonate group.

The term “chelating groups” refers to functional groups or combinations of groups that are capable of coordinating a metal ion or multivalent cation through two or more donor atoms, thereby forming a chelate complex. Chelating groups may include ligands containing pairs or sets of donor atoms such as nitrogen, oxygen, or sulfur, arranged to simultaneously interact with a single metal center. Typical chelating groups include, without limitation, aminocarboxylates (e.g., ethylenediaminetetraacetic acid (EDTA)-like moieties), hydroxamates, iminodiacetates, catecholates, thiolates, or phosphine-based ligands. Chelating groups exhibit high specificity for particular metal ions and are used to control ion capture, catalytic activity, or sequestration of trace metals within a polymeric material or functional particle.

The term “chelating group” as used in the context of the in-situ functionalized membrane adsorbers herein is further defined by its high binding affinity and specificity for a target metal ion (such as a transition metal, heavy metal, or precious metal ion) over a common background ion (such as Na+ or Ca2+). This function is distinct from a standard Cation Exchange group, which non-selectively binds all cations. The objective, quantifiable parameter that identifies this high specificity is the Selectivity Coefficient (kTarget Ion/Background Ion). As a quantifiable threshold, a “chelating group” as used herein is defined as a functional group that exhibits a Selectivity Coefficient for a target metal ion (e.g., Cu2+) over a common background ion (e.g., Ca2+) of 100 or greater. This class includes both monodentate ligands (such as thiolate groups, which are highly selective for heavy metals) and polydentate ligands (such as iminodiacetate groups), all of which provide high-affinity, selective metal binding. In the present disclosure, these high-affinity chelating groups are formed during the in-situ functionalization step (e.g., step (a) (ii)) by reacting the base particles with a specific organic-compatible reagent.

The term “hydrophobic interaction chromatography” or “Hydrophobic Interaction Chromatography” or “HIC” groups refers to functional groups that are non-polar and are capable of selectively interacting with, or binding to, target solutes via hydrophobic association. This binding mechanism is distinct from charge-based or affinity-based interactions and relies on the attraction between the non-polar HIC group and non-polar regions on a target solute (e.g., hydrophobic patches on a protein). This binding is typically modulated by the ionic strength of the surrounding fluid; binding is promoted at high salt concentrations (e.g., high ionic strength), and elution or release is promoted at low salt concentrations. Typical HIC groups comprise non-polar aliphatic or aromatic moieties, such as butyl, phenyl, or octyl groups. These groups are commonly employed in HIC to separate molecules based on their surface hydrophobicity, such as separating protein aggregates from monomers in bioprocessing.

The term “Hydrophobic Interaction Chromatography (HIC) group” as used herein is further defined by its hydrophobic (water-repelling) and oleophilic (oil-attracting) nature. This objectively distinguishes an HIC group from a “fluorophilic group,” which is hydrophobic but oleophobic (oil-repelling). This distinction can be quantified by measuring the static contact angle of a non-polar oil on a surface functionalized with said groups. As a quantifiable threshold, a surface exhibiting “Hydrophobic Interaction” as described herein is defined as a surface that demonstrates (a) a static water contact angle of 90 degrees or greater, AND (b) a static oil contact angle (e.g., using hexadecane) of 20 degrees or less, which indicates that the oil readily wets the surface. In the present disclosure, these HIC groups are formed during the in-situ functionalization step (e.g., step (a) (ii)) by reacting the base particles with an organic-compatible reagent, such as a terminal epoxide (e.g., styrene oxide or 1,2-epoxybutane), which covalently attaches the non-polar moiety.

As used herein, the term “fluorine groups” refers to functional chemical moieties that are optionally added to the polymeric microparticles and/or nanoparticles to create a specific, non-charge-based affinity. These groups are characterized by the presence of one or more fluorine atoms covalently bonded to a carbon atom, and typically comprise a fluoralkyl group, but can also comprise perfluoroalkyl or polyfluoroalkyl chains, such as perfluoroethyl, perfluorobutyl, or longer chains, wherein most or all of the hydrogen atoms on an alkyl backbone are replaced by fluorine atoms. The addition of these fluorine groups does not create an ion-exchange group, but rather imparts a distinct chemical property to the particles. This functionalization creates a surface that is simultaneously highly hydrophobic (water-repelling) and lipophobic (oil-repelling), a property known as fluorous-phase affinity. These fluorous-phase affinity groups can be used to separate molecules in a specialized form of affinity chromatography, which is distinct from separations based on charge, such as anion or cation exchange.

The term “fluorous-phase affinity” as used herein is further defined by this unique “omniphobic” (i.e., both hydrophobic and lipophobic/oleophobic) nature, which is an objective and quantifiable property. This property distinguishes a “fluorophilic” group from a standard Hydrophobic Interaction Chromatography (HIC) group, as an HIC group (e.g., a phenyl group) is hydrophobic (water-repelling) but also oleophilic (oil-attracting). This distinction can be quantified by measuring the static contact angle of both water and a non-polar oil on a surface functionalized with said groups. As a quantifiable threshold, a surface exhibiting “fluorous-phase affinity” as described herein is defined as a surface that demonstrates (a) a static water contact angle of 90 degrees or greater, AND (b) a static oil contact angle (e.g., using hexadecane) of 50 degrees or greater. This unique, dual-repellency is the defining characteristic of this functional group and is the mechanism for its selective interaction with fluorinated solutes, such as Per- and Polyfluoroalkyl Substances (PFAS). In membrane adsorbers of the present disclosure, this affinity is created during the in-situ functionalization step by reacting the base particles with an organic-compatible fluorinated reagent, such as a fluorinated aromatic halide or a fluorinated alkyl halide.

Functionalizing reagents for in situ functionalization of microparticle and/or nanoparticle in membrane adsorber herein described with Strong Base (SB) Anion Exchange (AEX) groups comprise alkylating reagents, such as alkyl halides (e.g., bromoethane, methyl iodide, or butyl bromide), alkyl sulfonates, alkyl triflates, and alkyl sulfates. These reagents are electrically neutral, organic-soluble liquids that are miscible in the dope solution and subsequently react with the tertiary amines of a polymeric particle such as PEI particles to form the charged quaternary ammonium group in-situ.
Functionalizing reagents for the creation of Cation Exchange (CEX) groups are likewise selected for their “dual ability,” delivering an acidic group from an electrically neutral, organic-compatible precursor. Functionalizing reagents for in situ functionalization of microparticle and/or nanoparticle in membrane adsorber herein described with Cation Exchange (CEX) groups, can be selected from classes that deliver an acidic group in an electrically neutral, organic-compatible form. A preferred class of reagents is sultones, such as 1,3-propanesultone. A sultone is a neutral, cyclic ester of a sulfonic acid. It is soluble in the organic dope and undergoes a ring-opening reaction with the groups of the polymeric particles such as PEI particles to covalently attach the final, negatively-charged sulfonate group. Other suitable reagents include lactones, which similarly deliver a carboxylic acid group via a neutral cyclic ester intermediate.

Functionalizing reagents for the creation of Hydrophobic Interaction Chromatography (HIC) groups comprise non-polar compounds that also contain a reactive moiety. A preferred class of reagents is terminal epoxides, such as epoxy-aromatics (e.g., styrene oxide) or epoxy-alkanes (e.g., 1,2-epoxybutane). These reagents are electrically neutral, non-polar liquids that are miscible in the dope, and their reactive epoxide ring undergoes a ring-opening reaction with the amine groups polymeric particles such as PEI particles to covalently attach the non-polar phenyl or alkyl group in-situ.

Similarly, functionalizing reagents for the creation of Fluorophilic groups comprise fluorinated reagents that are organic-compatible. These comprise fluorinated alkyl halides (e.g., monofluoro or perfluoroalkyl iodides) or fluorinated epoxides. These reagents are electrically neutral, non-polar fluorocarbons that are soluble in the organic dope and utilize their halide or epoxide moiety, respectively, to react with the amine groups of the PEI particles and covalently attach the fluoroalkyl chain in-situ.

In embodiments herein described, in-situ functionalization is performed in a dope solution comprising a dispersion of already-synthesized particles to covalently attach the functional groups which the particles with the capability of selective interaction, such as Strong Base (SB) AEX, Cation Exchange (CEX), Hydrophobic Interaction Chromatography (HIC), Chelating or Fluorophilic functionalities. The resulting chemically-altered dope, now containing highly charged or highly hydrophobic groups, surprisingly still exhibits the delicate thermodynamic balance required for the controlled, gradual demixing to form the symmetric and skinless morphology.

Additional reactive sites identifiable by a skilled person encompasses any additional chemical groups or moieties that possess defined reactivity or affinity toward specific target species through covalent, ionic, or coordinative mechanisms. Such reactive sites may include, for example, epoxy, anhydride, isocyanate, hydroxyl, aldehyde, thiol, or haloalkyl groups capable of undergoing coupling, grafting, or crosslinking reactions with complementary functionalities. These reactive sites may be introduced deliberately to enable post-functionalization, immobilization of ligands, or further derivatization of the polymer or particle surface.

Accordingly, functional groups capable of selective interaction suitable to be issued in connection with the skinless symmetric membrane adsorbers herein described include anion exchange, cation exchange, hydrophobic interaction, fluorophilic, chelating, and other reactive groups that confer to a polymeric material or particle the ability to preferentially associate with, exchange, or bind selected species through electrostatic, coordinative, or covalent forces, thereby imparting controlled selectivity, reactivity, or affinity to the material as will be understood by a skilled person.

In some embodiments, the method further comprises performing membrane preparation by phase inversion casting by mixing the dope with a non-solvent, (a solvent substantially incompatible with the base polymer solvent). Note that the membrane can be casted onto a suitable support (e.g. a glass plate) and then peeled off to form a self-supporting membrane. Alternatively, the membrane can be casted onto a microporous [e.g. polyethylene terephthalate (PET)] support, a layer of a multilayered membrane or another membrane (e.g. a mesh) to form a bicomposite membrane herein described.

In embodiments herein described the method comprises casting the dope dispersion to form a nascent membrane and subsequently inducing phase separation to solidify the membrane.

As used herein, the term “nascent membrane” refers to the state of the dope dispersion after it has been cast but before phase separation and solidification are complete. The nascent membrane exists as a uniform liquid film of the dope dispersion, which has been spread onto a suitable substrate, such as a glass plate or a porous polymeric support like a non-woven polyethylene terephthalate (PET) fabric. The thickness of this cast liquid film is typically controlled, for example, by using a casting knife or doctor blade set to a specific air gap, such as 300 μm. This nascent membrane is the intermediate article that is subsequently subjected to the controlled, gradual demixing process, such as by immersion in a coagulation bath or exposure to a nonsolvent vapor, to induce phase separation and form the final solid filtration membrane.

The formation of the final solid membrane from the nascent membrane, and the detection thereof, is characterized by the completion of the phase separation and solidification process. This transition is detectable by a physical change in the material, wherein the nascent membrane transforms from a viscous liquid dispersion, which may be cloudy, into a solid, opaque film. This solidified state is evidenced by the membrane gaining mechanical integrity, such that it can be handled, immersed in subsequent washing baths (e.g., ethanol or fresh water), and ultimately “removed from the glass” or support substrate as a self-supporting or supported film. The final solidified structure of the membrane, confirming the transformation from the nascent state, can be characterized and confirmed using microscopic techniques. For example, a sample of the dried, solidified membrane may be cryogenically fractured and examined by Scanning Electron Microscopy (SEM) to visualize the resulting porous polymeric body and the embedded microparticles, thereby confirming that solidification has occurred.

In embodiments herein described the phase separation is directed to the formation of skinless symmetric membranes, the phase separation is induced by a controlled, gradual demixing process, which stands in contrast to conventional methods that employ “hard” nonsolvents, such as liquid water for a polyvinylidene fluoride (PVDF) and triethyl phosphate (TEP) dope, which cause a kinetically-driven phase separation at the membrane-nonsolvent interface. Such kinetically driven demixing is known to create an undesirable asymmetric structure characterized by a dense, flow-restricting skin layer.

The controlled, gradual demixing process of the present method intentionally delays or slows the precipitation kinetics, favoring a more uniform, thermodynamically-driven solidification, such as solid-liquid demixing, throughout the bulk of the membrane. This controlled process is specifically designed to produce a filtration membrane having a symmetric and skinless morphology as will be understood by a skilled person upon reading of the present disclosure.

In some embodiments of the skinless and symmetric filtration membrane, the membrane can further comprise a functional polymer covalently and/or non-covalently linked to the embedded microparticles and/or nanoparticles to form a polymer network of the filtration membrane.

In those embodiments, the method further comprises adding a functionalizing polymer precursor to the blend, and/or to the membrane casting solution comprising the polymeric microparticles and/or nanoparticles to obtain a dope wherein the microparticles and/or nanoparticles are linked to the functional polymers forming a polymeric network. Addition of the functionalizing polymer can be performed concurrently or preferably following addition of the crosslinker and/or initiator and in particular following beginning of the particle formation. Expected polymer network precursors include acrylates, epoxides, isocyanates, acyl chlorides and anhydrides. Preferred functionalizing polymers include diepoxides, diacrylates and diacyl chlorides and others that be can be polymerized in the membrane dope solutions comprising microparticles and/or nanoparticles dispersion to prepare polymer networks that are linked to the larger molecular weights (e.g. Mn of 1000-1000,000+).

In some embodiments, the polymer network precursor can have a molecular weight (Mn) of 100-1000. In some embodiments, the polymer network precursor can have a smaller molecular weight (e.g. (Mn of 90-300)) included at higher concentration to form the network polymer. In some embodiments the polymer network precursor are also crosslinkers with respect to the particle formation. In some embodiments the polymer network formed in situ is covalently linked to the polymeric particles. In some embodiments the polymer network formed in situ is crosslinked to the polymeric particles. In some embodiments the polymer network formed in situ is non-covalently linked to the polymeric particles through interactions between moieties and in particular functional groups of the network polymer and the polymeric material of the polymeric particles.
In some embodiments, the functional polymer comprises one or more linear or branched polymers forming a polymeric network component of the polymer matrix and comprising repeating structural unit forming chains of various lengths (e.g. 10 nm and 100 nm chain length) with or without branches or cross-linked structures.

The term “polymeric network”, “polymeric network component” as used herein refers to an arrangement of interconnected polymers which forms a polymer matrix embedded in the polymeric aggregate to form an interlaced polymeric structure within the polymeric aggregates. In particular, the functionalizing polymer is formed by a linear or branched polymers presenting functional groups capable of covalently or non-covalently attach polymeric microparticles and/or nanoparticles embedded in the polymer matrix and more particularly in the polymeric porous aggregate of the matrix. In some embodiments, the functionalizing polymer can be hydrophilic Exemplary polymer matrices with aggregate, polymeric network and microparticles and/or nanoparticles can be seen for example, in

The term “polymer matrix” as used herein refers to three-dimensional network of a polymer component of the membrane. The term “polymer component” as used herein refers to one or more linear polymers forming a polymeric aggregate of the polymer matrix and comprising repeating structural unit forming long chains without branches or cross-linked structures. In some instances molecular chains of a linear polymer can be intertwined, but in absence of modification or functionalization the forces holding the polymer together are physical rather than chemical and thus can be weakened by energy applied in the form of heat. In particular, polymers forming the polymeric component in the sense of the disclosure comprise substituted or unsubstituted aliphatic polymer, a substituted or unsubstituted unsaturated polymer and a substituted or unsubstituted aromatic polymer identifiable by a skilled person upon reading of the present disclosure.

In particular, in some embodiments, the pores provided by the polymer aggregate of the polymer matrix can permit the passage of some molecules (e.g. solvent molecules such as water) while preventing the passage of others (e.g. solute molecules such as proteins) thus configuring the membrane to act as a size-exclusion membrane.

In some embodiments herein described, at least one polymer of the polymers forming the polymer component of the polymer matrix has a functional group capable of interacting with a corresponding functional group on the polymeric microparticles and/or nanoparticle.

In embodiments herein described, polymeric material forming the microparticles and/or the nanoparticles can thus be attached to the functionalizing polymer through covalent link between corresponding functional groups presented on the functionalizing polymer and polymeric material of the particle. In some embodiments the attachment between functionalizing polymer and polymeric material of the microparticles and/or nanoparticles can occur by crosslinking. In some embodiments polymeric material forming the microparticles and/or the nanoparticles is attached to the functionalizing polymer through non-covalent interactions between moieties and in particular functional groups presented in the microparticles and/or nanoparticles and the functionalizing polymer.

In some embodiments herein described nanoparticles are functionalized with one or more functionalizing polymers forming the polymer network of the polymeric matrix in accordance with the disclosure, wherein the functionalizing polymers attach the microparticles and/or nanoparticles through covalent link of one or more functional groups to the microparticle and/or nanoparticles polymer. In particular, terminal functional groups or other functional groups presented on the functionalizing polymer can be covalently linked and/or crosslinked to the polymeric material forming the particles.

The configuration of the polymeric network on the microparticles and/or nanoparticles depends on the relative dimension between functionalizing polymer and microparticle or nanoparticle. In particular a dimension of the polymeric particles in the filtration membrane herein described range from about 10-100 nm to about 2-4 micron and in particular can be from 10 to 100 nm or from 500 nm to 2 micron or 4 micro, depending on the specific combination of base polymer network polymer and polymeric particle precursor as well as related solvents and condition of preparation as will be understood by a skilled person upon reading of the present disclosure.

In some embodiments, the functional group covalently linking to microparticles and/or nanoparticles can be at one or both terminal ends of a linear functionalizing polymer. In some embodiments the functional group covalently linking to microparticles and/or nanoparticles can be at at least one end of a branched functionalizing polymer.

In some embodiments, the functional groups of the functionalizing polymer covalently attaching the microparticles and/or nanoparticles can be an acrylate, a methacrylate, an epoxide, a halide, an isocyanate, an acyl chloride, an anhydride, preferably epoxides, halides, acyl chlorides and anhydrides functional groups.

In some embodiments the functionalizing polymer can be a hydrophilic polymer, wherein a hydrophilic polymer is a polymer substantially soluble in water.

The functionalizing polymer can be comprised in some embodiments in a length from 10 nm to 100 nm in length and is attached to the related microparticles and/or nanoparticles in configurations (e.g. loop, network and/or interparticle crosslinking) which are dependent on the relative proportion between functional polymer length and particles dimensions as will be understood by a skilled person. In particular the higher the ratio between particles dimension and functional polymer length the higher the percentage of the functionalizing polymer in an interparticle crosslinking configuration, where instead lower ratios increase the percentage of functionalizing polymer in a network or loop configuration as will be understood by a skilled person.

In some embodiments, the concentration of base polymer in the membrane is not less than about 40%, and preferable not less that about 50%, In some embodiments the concentration of polymeric particles and functional polymer network is about 50% possibly about 60%. In some embodiments the concentration of polymeric particles and functional polymer network not more than 60% to conserve the support to the membrane provided by the porous polymeric aggregate formed by the base polymer.

In some embodiments, determination and control of the concentration of the various membrane components can be performed based on the reactivity of the functional groups presented on those components and in particular on the functionalizing polymer and polymeric particles. In particular, calculation of the final concentration of base in the can be performed by calculating the proportion of the molar amounts of based on the reactive groups presented in the various component of the membrane according to reaction occurring stoichiometrically (see Example 25 of related application U.S. Ser. No. 14/447,574 published as US20150053610 incorporated herein by reference). Exemplary stoichiometric reactions among functional groups comprise reaction between epoxy groups and amine groups and various types of click chemistry as will be understood by a skilled person.

In some embodiments, the polymer that will form the porous polymer aggregate can be selected based on desired features such as morphology, structural strength, and others known to a skilled person [7] as well as compatibility based on thermodynamic parameters identifiable to a skilled person. For example, one desired feature can be the presence of skin layers on either side of the membrane when observed in cross section (see e.g. FIG. 6 of related application U.S. Ser. No. 13/754,883 published as US20130213881). In particular, the thickness of one of the skin layers can be decreased by increasing the amount of polymer to form the polymeric nanoparticles in the blend of polymer to form the polymeric nanoparticles and polymer to form the polymer matrix (see, e.g. Example 2 and FIG. 6 of related application U.S. Ser. No. 13/754,883 published as US20130213881). For example, another desired feature can be particle size. In particular, the size of the nanoparticles can be decreased by increasing the amount of polymer to form the polymeric nanoparticles in the blend of polymer to form the polymeric nanoparticles and polymer to form the polymer matrix (e.g. membranes made with 7.45 wt % PEI in the blend showed particle size as low as 400 nm whereas membranes formed with 5.39 wt % and 3.49 wt % in the blend showed particle sizes ranging from 1000-3000 nm; see, e.g. Example 2 and FIG. 6 and FIG. 7 related application U.S. Ser. No. 13/754,883 published as US20130213881). For example, another desired feature can be porosity as determined by imaging (e.g. with SEM) of the surface of the membrane. In particular, the number of pores can be increased by increasing the amount of polymer to form the polymeric nanoparticles in the blend of polymer to form the polymeric nanoparticles and polymer to form the polymer matrix (see, e.g. Example 2 and FIG. 7 of related application U.S. Ser. No. 13/754,883 published as US20130213881).

Factors to be considered comprise having a solubility parameter (see, e.g., [1, 8, 9]) similar to that of polymer that will form the polymeric nanoparticles, as well as favorable interactions between the comprising the polymer that will form the polymer matrix and the polymer that will form the polymeric nanoparticles. In particular, the similarity of solubility parameters can ensure that the polymer forming the polymeric nanoparticles is sufficiently distributed in the blend of polymer that will form the polymeric nanoparticles and polymer that will form the polymer matrix (as determined, for example, by inspection of the turbidity and viscosity of the blend) such that a membrane with a desired concentration of nanoparticles is obtained. For example, in embodiments, wherein a concentration of greater than about 20 wt % is desired, PVDF or other non-fluorinated polymer can be chosen as the polymer for the polymer matrix. In another example wherein a membrane with similar features is desired a poly(ether sulfone) polymer or other polymer with ether groups and/or sulfonyl and/or carbonyl groups can be chosen as the polymer for the polymer matrix thus providing a homogeneous blend adapted to form particles, and in particular discrete particles, in situ when a cross-linker is added to the blend form a dope with homogeneously distributed discrete to form the membrane as described herein (see, Examples 1-3 and 21 of related application U.S. Ser. No. 13/754,883 published as US20130213881).

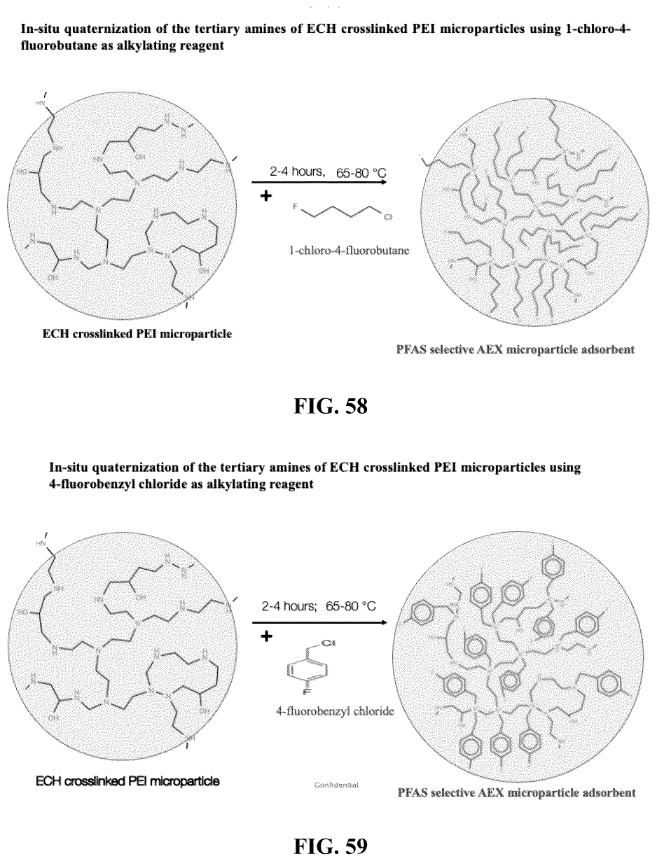

In particular, the in situ formation of the microparticles and/or nanoparticles can be controlled by parameters such as relative concentration of the polymers to form the matrix and nanoparticles and cross linker (see, e.g. Examples 1 and 2 of related application U.S. Ser. No. 14/447,574 published as US20150053610 incorporated herein by reference and Example 21 of related application U.S. Ser. No. 13/754,883 published as US20130213881) such that the membranes produced have discrete particles in which formation of nanoparticle clusters is minimized (see e.g. FIG. 58B of related application U.S. Ser. No. 13/754,883 published as US20130213881) as well as fractal growth as can occur in membranes when the particles are preformed and blended with the polymer that will form the polymer matrix. In particular, the membranes with in situ generated nanoparticles can have nanoparticles in concentrations exceeding about 20 wt % and in particular, exceeding about 40 wt %. For example, when a blend of 3.49 wt % PEI and 13.45 wt % PVDF is combined with 2.30 wt % ECH cross-linker, membranes with a concentration of nanoparticles greater than about 30 wt % are produced, and when the amount of PEI is increased (with a constant ratio of cross linker) to a blend of 7.45 wt % PEI and 12.42 wt % PVDF which is combined with 4.90 wt % ECH cross-linker, the concentration of nanoparticles in the membrane produced increases to about 50 wt % (see, e.g. Example 2 and FIG. 7 of related application U.S. Ser. No. 13/754,883 published as US20130213881). In addition, the membranes formed with the 3.49 wt % PEI and 13.45 wt % PVDF blend combined with 2.30 wt % ECH cross-linker and with the 7.45 wt % PEI and 12.42 wt % PVDF blend combined with 4.90 wt % ECH cross-linker both show discrete particles embedded in the polymer matrix without homogeneous distribution of particles and discrete particles devoid of clustering by fractal growth (see, e.g. Example 2 and FIG. 6 of related application U.S. Ser. No. 13/754,883 published as US20130213881).

In particular, in some embodiments, membrane compositions, methods and applications herein described comprise (i) a linear polymer (e.g. poly(vinylidinefluoride) [PVDF]) as base membrane polymer, (ii) a polyamine (e.g. branched polyethyeleneimine [PEI]) as polymeric particle precursor, (iii) a crosslinker, (e.g. an epoxide such as epichlrohydrin [ECH])) (iv) an initiator (e.g. hydrochloric acid (HCl) 0 and (v) a linear or branched polymer functionalized at the ends (e.g. a diepoxide such as poly(ethylene glycol) diglycidyl ether (PEGDE) and 4-arm polyethylene gycol (PEG) branched polymer as polymer network precursors.

In other embodiments, in situ functionalized symmetric skinless membrane adsorbers herein described can be formed by a process wherein nanoparticles can be added to the membrane ex situ in addition or in the alternative to nanoparticles formed with the in-situ method. In particular, in some of these embodiments, the nanoparticles can be performed by cross linking suitable polymeric nanomaterial separately from the polymer forming the matrix (see e.g. Examples 4, 5, and 14 of related application U.S. Ser. No. 13/754,883 published as US20130213881) and then mixed with the polymer that will form the polymer matrix to form a dope with preformed polymeric nanoparticles. The method can further comprise casting the dope to form the membranes as described herein (see, e.g., Examples 1 and 20 of related application U.S. Ser. No. 14/447,574 published as US20150053610 incorporated herein by reference. In particular, the membranes made with preformed nanoparticles in the dope can have clusters of nanoparticles (see e.g. FIG. 58B of related application U.S. Ser. No. 13/754,883 published as US20130213881) from fractal growth. In particular, the membranes with ex situ generated preformed nanoparticles can have nanoparticles in concentrations between about 1 wt % and about 10 wt %.

In some embodiments, the based polymer of the polymeric body can be formed by a polymer having a formula

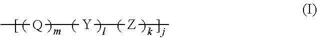

wherein:
Q, Y, and Z comprise saturated aliphatic hydrocarbon, aromatic hydrocarbon, or unsaturated aliphatic hydrocarbons;
m, l, and k independently are integers ranging between 0-50;
at least one of m, l, k is not equal to zero;
j is an integer ranging between 50-500; and
at least one of Q (when Q≠0), Y (when Y≠0), or Z (when Z≠0), comprises the polymer corresponding functional group.

The term “saturated aliphatic hydrocarbon” as used herein refers to a hydrocarbon comprising, carbon atoms that are joined together in straight chains, branched chains, or non-aromatic rings in which the carbon-carbon bonds are saturated with hydrogen (e.g. methane, ethane, propane, isobutane, and butane). For example, in saturated aliphatic hydrocarbons have a general formula of CₙH₂ₙ₊₂ for acyclic saturated aliphatic hydrocarbons and CₙH₂ₙ cyclic saturated aliphatic hydrocarbons. Saturated aliphatic hydrocarbon can be substituted with one or other elements, for example, N, O, S, P, F, Cl, Br, and I.

The term “aromatic hydrocarbon” as used herein refers to a hydrocarbon comprising a conjugated ring of unsaturated bonds, lone pairs, and/or empty orbitals which can exhibit a stabilization stronger than expected by the stabilization by conjugation alone. An exemplary aromatic compounds is benzene which is a six-membered ring having alternating double and single bonds between carbon atoms. Aromatic hydrocarbons can be monocyclic (MAH) (e.g. benzene) or polycyclic (PAH) (e.g. naphthalene, anthracene, pyrene). Aromatic hydrocarbons can be substituted with one or other elements, for example, N, O, S, P, F, Cl, Br, and I.

The term “unsaturated aliphatic hydrocarbon” as used herein refers to a hydrocarbon comprising carbon atoms that are joined together in straight chains, branched chains, or non-aromatic rings and comprise at least one of a double or a triple bond between adjacent carbon atoms, referred to as “alkenes” and “alkynes”, respectively. An unsaturated hydrocarbon can comprise one or more of double or triple bonds. In hydrocarbons having more than one double or triple bond, the unsaturated hydrocarbon can be conjugated (e.g. 1,4-hexadiene) or can be isolated (e.g. 1,5-hexadiene). In hydrocarbons comprising internal alkenes, the alkenes can be in a “cis” or a “trans” configuration (e.g. trans-2-butene or cis-2-butene). Unsaturated aliphatic hydrocarbon can be substituted with one or other elements, for example, N, O, S, P, F, Cl, Br, and I.

In particular in some embodiments, Q, Y, and Z in formula (I) can independently selected from the following formulas:

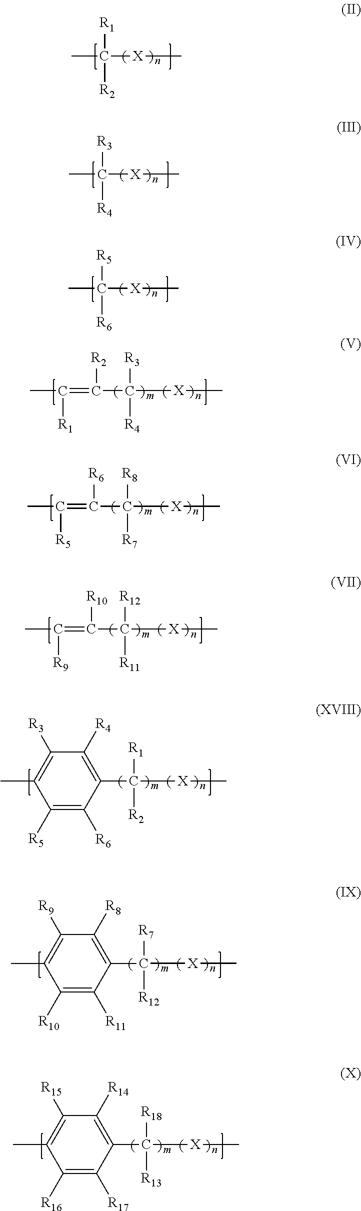

wherein:
n=0 or 1;
mₗ is an integer ranging from 0-15;
X is a functional group comprising an atom selected from O, S, N, P, or F; and
R₁-R₁₈ are independently selected from: the polymer component functional group; hydrogen; C₁-C₂₀ linear, branched, saturated, unsaturated, or aryl hydrocarbon which are either substituted or unsubstituted with O, N, B, S, P; or substituted O, N, B, S, or P;
and at least one of R₁-R₁₈ is the polymer corresponding functional group attaching the dendrimer component.

Exemplary linear polymer materials for producing a polymeric aggregate made from linear polymers herein described comprise polysulfone (PS), polyether sulfone (PES), poly(vinylidene) fluoride (PVDF), poly(tetrafluoroethylene) (PTFE), poly(acrylonitrile) (PAN), poly(methacrylic acid) (PMAA), poly(acrylic acid) (PAA), poly(vinyl methyl ketone), and poly(ethylene terephthalate) (PET).

In some embodiments herein described, the polymeric network of the polymer matrix is formed by a functional polymer of formula (XVI)

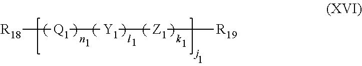

wherein:
   R₁₈ and R¹⁹ are selected from
Y2

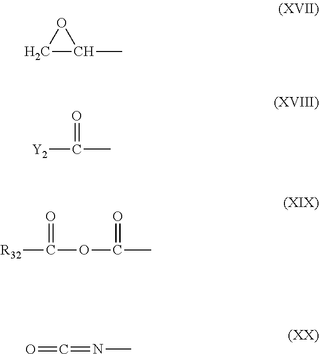

in which Y2 is F, Cl, Br or I
R₃₂ is H or CH3
nₗ, lₗ, and kₗ independently are integers ranging between 0-50;
at least one of nₗ, lₗ, and kₗ is not equal to zero;
jₗ is an integer ranging between 50-500; and
and wherein
   Q1, Y1, and Z1 independently comprise saturated aliphatic hydrocarbon, aromatic hydrocarbon, or unsaturated aliphatic hydrocarbons optionally independently substituted with hydrophilic such as COOH and OH groups or are independently selected from the following formulas

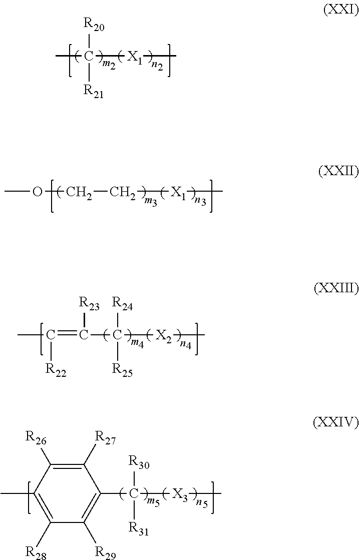

in which
   n₂ n₃ n₄ and n₅=are independently 0 or 1;
   m₂ m₃ and m₄ are independently an integer ranging from 0-15;
   X₁, X₃ and X₃ is a functional group comprising an atom selected from O, S, N, or P, and
   R₂₀-R₃₁ are independently selected from: a polymer component functional group; hydrogen; C₁-C₂₀ linear, branched, saturated, unsaturated, or aryl hydrocarbon which are either substituted or unsubstituted with O, N, B, S, P; or substituted O, N, B, S, or P, or substituted with one or more groups selected from or can be Y2, or a group of Formulas (XXI) to (XXIV);
   and optionally at least one of R₂₀-R₃₁ is a polymer corresponding functional group attaching the dendrimer component.

In some embodiments R₂₀-R₃₁ can be a C₁-C₂₀ linear, branched, saturated, unsaturated, or aryl hydrocarbon can independently comprise one or more groups selected from: —COOH, —CH₂—CH₂OH, —(CHOH)₂—CH₂OH, —CH₂—CHOH—CH₂OH, —C(O)O—NH₂, —C(O)—N(CH₃)₂ and

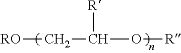

XXVII
   wherein R is H, CH3 or an alkyl group, R′ is H, CH3 or an alkyl group, R″ is H or an alkyl group.

In some embodiments, the functionalizing polymers can have formula

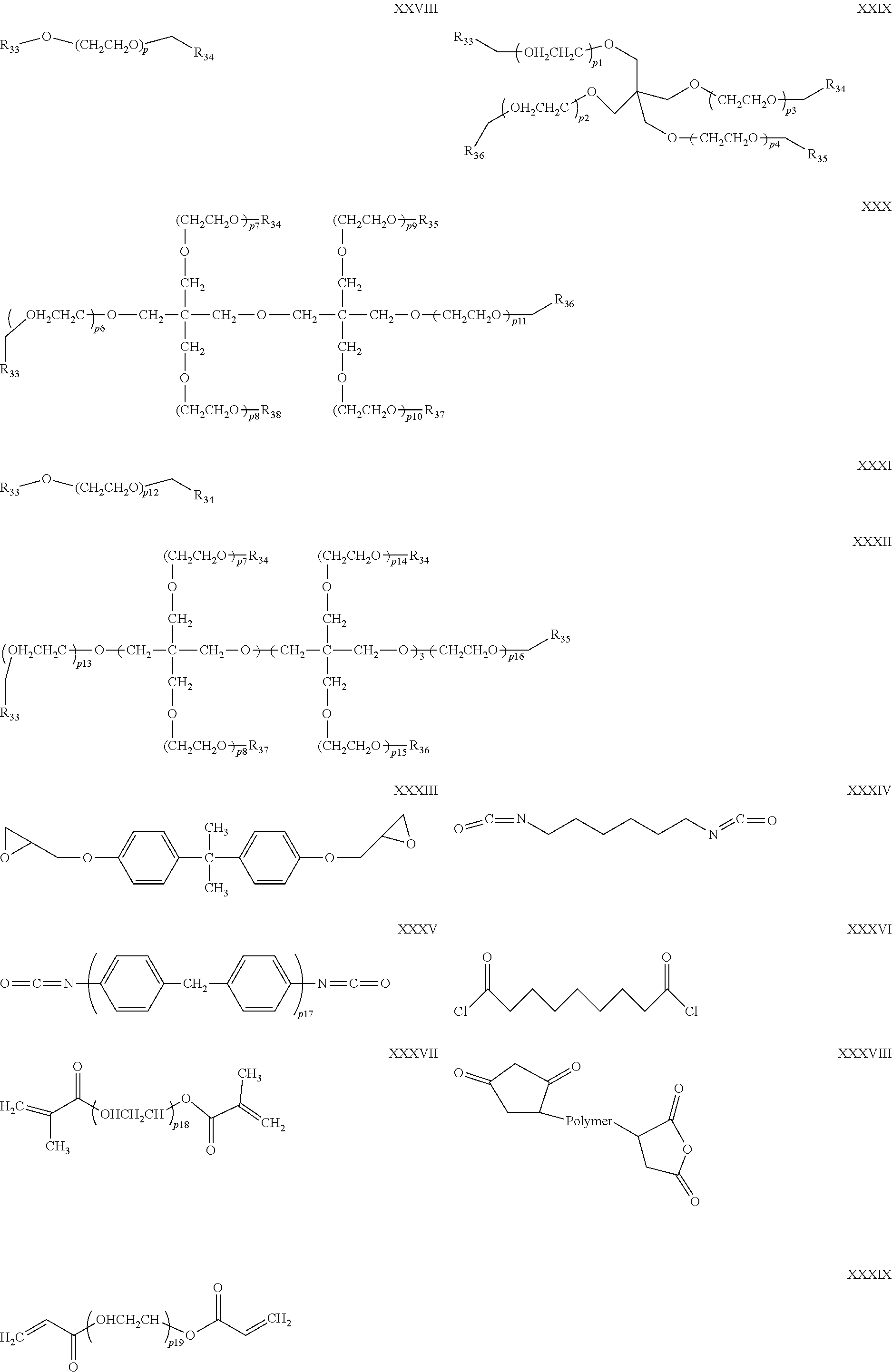

wherein
p1 to p19 can independently be 50 to 500 and in particular 100 to 300
R33 to R35 can independently be
Y₂

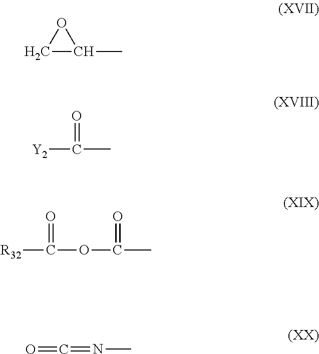

in which Y2 is F, Cl, Br or I
R₃₂ is H or CH3

In some embodiments the functionalizing polymer is a hydrophilic polymer. In some of those embodiments, Q1, Y1 and Z1 can be selected to form a Poly(N-isopropylacrylamide) (PNIPAM), a Polyacrylamide (PAM), a Poly(2-oxazoline), a Polyethylenimine (PEI), a Poly(acrylic acid), a polymethacrylate and/or other Acrylic Polymers, Poly(ethylene glycol), Poly(ethylene oxide), Poly(vinyl alcohol) (PVA) and/or copolymers, Poly(vinylpyrrolidone) (PVP) and/or copolymers, Poly(styrenesulfonate) (PSS) and/or copolymers, Polyacrylamide (PAM)-based Polyelectrolytes, Poly(acrylic acid) (PAA), Poly(allylamine hydrochloride), Poly(vinyl acid), Maleic Anhydride Copolymers, and/or Polyethers.

In some embodiments, at least one functional group of the functionalizing polymer, in particular two or possibly three functional groups can be independently selected from or can be Y2, or a group of Formulas (XXI) to (XXIV). In some embodiments, functional group of the functionalizing polymer can be selected from or can be Y2, or a group of Formulas (XXI) to (XXIV). In some embodiments the functional groups presented in the functionalizing polymer are the same

In some embodiments, functionalizing polymer R18 and R¹⁹ or other terminal functional groups can be selected to provide a functionalizing polymer which is a diacrylate, dimethacrylate, diepoxide, dihalide, diisocyanate, diacyl halide, triacyl halides, and dianhydride.

In some embodiments functionalizing polymers can be formed by epoxy resins (see the Polymeric Materials Encyclopedia © 1996 CRC Press Inc. and in particular Epoxy resins overview section [10], and Epoxy Handbook Nils Malmgreen Ab third edition 2004 [11], and Dow Liquid Epoxy resins product literature available at the website epoxy.dow.com/resources/literature.htm at the date of filing of the present disclosure) [12].

In some embodiments, the polymer forming the polymeric microparticles and/or nanoparticles embedded in the polymer matrix can be one or more polymers of formula (I) covalently linked (e.g. by a suitable initiator to form microparticles and/or nanoparticles). In particular, exemplary linear polymer materials for producing polymeric nanoparticles made from linear polymers herein described comprise polysulfone (PS), polyether sulfone (PES), poly(vinylidene) fluoride (PVDF), poly(tetrafluoroethylene) (PTFE), poly(acrylonitrile) (PAN), poly(methacrylic acid) (PMAA), poly(acrylic acid) (PAA), poly(vinyl methyl ketone), and poly(ethylene terephthalate) (PET). Additional polymers suitable as a polymer component herein described comprise polymers which can be used as base polymers in the fabrication of commercial UF/MF membranes, polymer which is either partially soluble or can be dispersed in solvents with different physicochemical properties together with nanoparticles according to the disclosure, and polymers which can be functionalized, which are identifiable by a skilled person upon reading of the present disclosure (see e.g. [1, 6, 8]).

Suitable polymeric nanoparticles according to embodiments herein described can be selected for a given polymer matrix based on compatibility with the polymer aggregate and polymeric network components of the matrix which can be determined based on the presence of corresponding functional group capable of attachment as well as possibly other features such as solubility of the polymer that forms the polymeric nanoparticles for in situ nanoparticle formation (or solubility of the preformed polymeric nanoparticles for preformed nanoparticle formation) together with the polymer that forms the polymer matrix in a particular solvent or mixture of solvents, affinity of the dendritic component for polymeric component, and/or stability of the dendritic component in a solvent to be used in the fabrication of the membrane. By way of example, compatibility can be determined by the polymeric nanoparticle possessing functional groups (e.g. amine groups or carboxylic acid or hydroxyl groups) capable of interacting with functional groups on the polymer matrix (e.g. fluoride atoms or oxygen atoms) and/or by the polymers used to make the polymer matrix and polymeric nanoparticles having similar solubility parameters (see e.g. [1, 6, 8]). In particular, if the polymeric nanoparticle possesses amine groups (e.g. PMAM, PPI, or PEI) then a polymer to form the polymer matrix can be chosen which possesses fluoride atoms; if the polymeric nanoparticle possesses carboxylic acid or hydroxyl groups (e.g. MPA or bis-MPA polyester-16-hydroxyl) then a polymer to form the polymer matrix can be chosen which possesses oxygen atoms (e.g. a poly(sulfone) or poly(ether sulfone) polymer).

In some embodiments the polymers to form the polymeric microparticles and/or nanoparticles can be a highly branched dendritic macromolecule forming the dendritic nanomaterial and in particular to the highly branched dendritic macromolecule according to general formula (XI)

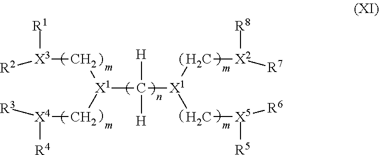

wherein:
n and m are integers ranging from 2-5;
R¹-R⁸ are independently selected from hydrogen or hyperbranched polymer moieties;
   X¹ is N; and
   X²-X⁵ are selected from amine, amide, imide, and carbamate.

In particular, in some embodiments, the highly branched dendritic macromolecule according to some embodiments have the general formulas XII and XIII below:

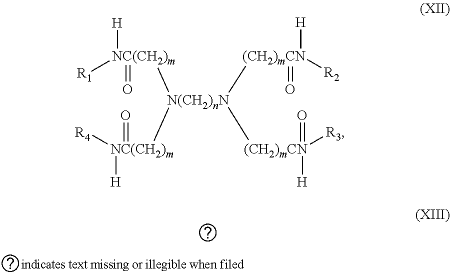

wherein n and m are integers from 2-5, and wherein R₁-R₄ can be independently hydrogen or hyperbranched polymer moieties including, but not limited to, polyethyleneimine (PEI) and derivatives thereof.

In some embodiments, the highly branched dendritic macromolecule to form polymeric nanoparticles according to some embodiments comprises a core, a plurality of arms extending from the core, the arms having a hyperbranched structure, and within the hyperbranched structure, a plurality of units satisfying having the formula:

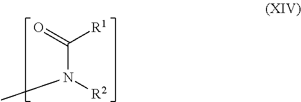

where R¹ comprises no nitrogen atoms that are simultaneously bound to two or more carbon atoms, for example, secondary and tertiary amines or amides.

In some embodiments the dendritic component comprises the formula:

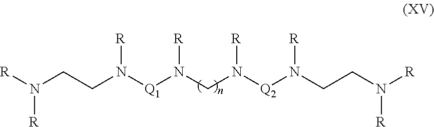

where n is an integer ranging from 2-5, each of Q₁ and Q₂ comprises hyperbranched polymer moiety, and R is selected from hydrogen, an alkyl group, or a 2-hydroxyalkyl group.

In particular, in some embodiments, when groups R¹-R⁸ and Q of formulas XI-XV comprise hyperbranched polymer moieties with amino and/or alcohol groups, the molecules can be converted to nano/microparticles by cross linking the molecules with cross-linking reagents described herein (e.g. 1,3-dibromopropane or epichlorohydrin) using inverse micelles as described herein (see e.g. Example 14 of related application U.S. Ser. No. 14/447,574 published as US20150053610 incorporated herein by reference). In particular, in some embodiments, the formation of the particles can occur by blending polymers that comprise the polymer matrix with polymers that form the polymeric nanoparticles, an in particular dendritic nanoparticles to form a blend, and adding a cross-linker to form a dope with in situ generated polymeric nanoparticles, and in particular dendritic nanoparticles as described herein (see, e.g. Examples 1 and 2 of related application U.S. Ser. No. 14/447,574 published as US20150053610 incorporated herein by reference).

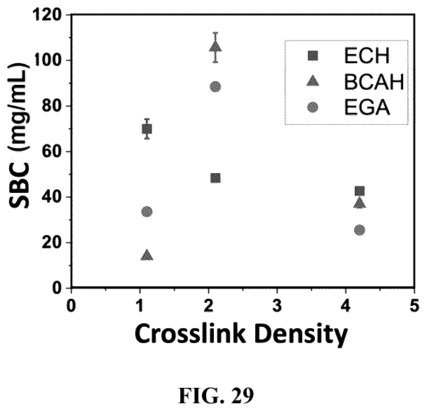

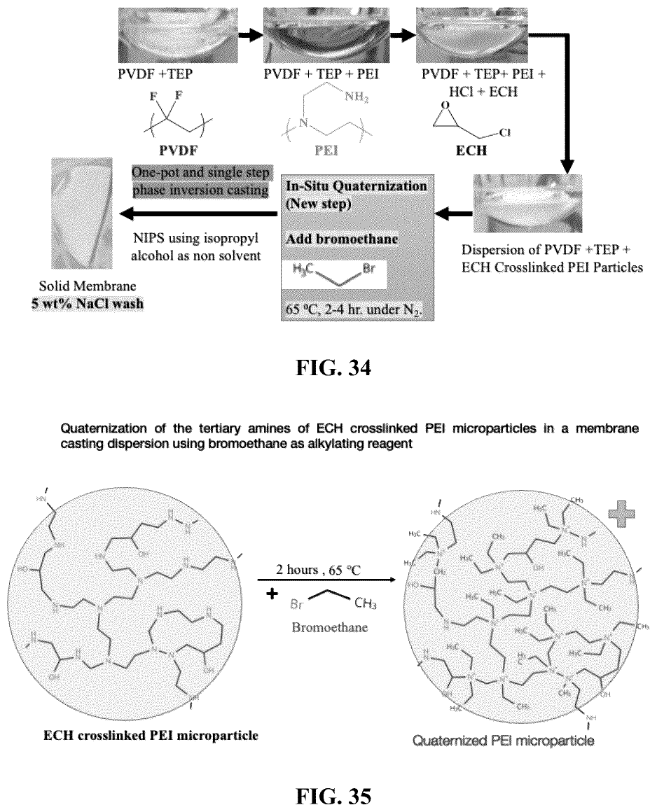

In particular, in some embodiments, the highly branched dendritic macromolecule to form polymeric nanoparticles can comprise various monodisperse generations of poly(amidoamine) (PAMAM) dendrimers (for example, G3, G4, or G5 PAMAM; see e.g. FIG. 29 of related application U.S. Ser. No. 13/754,883 published as US20130213881) or micro and/or nano aggregates thereof; monodisperse generations of poly(propyleneimine) (PPI) (for example, G3, G4, or G5 PPI; see e.g. FIG. 29 of related application U.S. Ser. No. 13/754,883 published as US20130213881) or micro and/or nano aggregates thereof; monodisperse generations of poly(bis(methylol) propionic acid) (MPA) (for example, G3, G4, or G5 MPA) or micro and/or nano aggregates thereof; or monodisperse generations of poly(ethyleneimine) (PEI) (for example, G3, G4, or G5 PEI) or micro and/or nano aggregates thereof. In other embodiments, the dendritic component can be polydisperse hyperbranched PEI. Hyperbranched PEI can be prepared, for example, by ring opening polymerization of aziridine also known as ethylene imine. Additional dendritic components can be selected, for example, based on compatibility with a polymeric component as described herein (see, e.g., FIG. 34 of related application U.S. Ser. No. 13/754,883 published as US20130213881.

Suitable polymer components comprising the polymer matrix can be selected for a given dendrimer component based on compatibility which can be determined based on the presence of corresponding functional group capable of attachment as well as possibly other features such as thermodynamic parameters such as solubility of the polymer component together with the dendrimer component in a particular solvent or mixture of solvents, affinity of the polymer component for the dendrimer component (e.g. the ability to hydrogen bond or have an electrostatic attraction), and/or stability of the polymer component in a solvent to be used in the fabrication of the membrane.

In the in situ functionalized symmetric skinless membrane adsorbers herein described, nanoparticles formed by a linear or dendritic polymers, are attached to the polymer component of the polymer matrix typically through a covalent and/or a hydrogen bond. For example, in some embodiments, when the polymeric components of formulas I-XI comprise fluorine and/or sulfonyl groups (e.g. PVDF or PES), dendritic components of formulas XII-XV comprising amino groups can attach to the polymeric component through hydrogen bonds from the amino hydrogen atoms to the fluorine or carbonyl oxygen atoms. In other embodiments, when the polymeric components comprise oxygen groups (e.g. ethers, carbonyls, and sulfonyls), dendritic components comprising hydroxyl or carboxylic acid groups can attach to the polymeric component through formation of hydrogen bonds.

In particular in embodiments of the in situ functionalized symmetric skinless membrane adsorbers herein described, the nanomaterial and in particular nanoparticles and/or the polymeric network component of the matrix are embedded in the polymer aggregate of the polymer matrix to present reactive sites in the membrane.

The term “present” as used herein with reference to a compound or functional group indicates attachment performed to maintain the chemical reactivity of the compound or functional group as attached. Accordingly, a functional group presented on a surface, is able to perform under the appropriate conditions the one or more chemical reactions that chemically characterize the functional group.

The term “reactive site” as used herein refers to a chemical functional group capable of attracting, rejecting, and/or binding to a chemical of interest. In particular, reactive sites herein described are able to attract, reject or bind selectively a chemical to be filtered. Exemplary functional groups suitable as reactive sites include, but are not limited to, amines, quaternary ammonium groups, amides, hydroxyl groups, ethers, carboxylates, esters, sulfonates, sulfiniates, sulfonate esters, sulfinate esters, sulfonamides, sulfonamides, phosphates, carbamates, ureas, imidines, guanidines, oximes, imidazoles, pyridines, thiols, thioethers, thiocarboxylates, and phosphines.

In particular, in some embodiments, the reactive sites can be located on the functional groups of the linear polymer forming the polymeric nanoparticles. By way of example, the reactive sites can comprise carboxylic acid groups in polymeric nanoparticles formed with a linear polymer such as poly(methacrylic acid).

In particular, in some embodiments, the reactive site can be located on a highly branched dendritic macromolecule forming the polymeric nanoparticles (for example, amino groups on PEI or carboxylic acid groups on MPA) without any chemical transformation being necessary. In other embodiments, one or more reactive sites can be introduced into the dendritic component after a chemical transformation. Exemplary chemical transformations suitable for the introduction of a reactive site comprise reductive amination of amine groups to form alkylated amino groups, alkylation of amines to form quaternary ammonium groups, alkylation of hydroxyl groups to form ethers, reaction of amines or hydroxyls with haloalkyl carboxylic acids and/or derivatives (such as, for example, 2-chloroacetic acid or methyl 2-chloroacetate) to form carboxylic acids and/or derivatives, reaction of amines or hydroxyls with haloalkyl sulfonic acids and/or derivatives (such as, for example, 2-(chloromethyl) sulfonic acid or methyl 2-(chloromethyl) sulfonate to form sulfonic acids and/or derivatives, and reaction of amines with epoxides to form alcohols. Other transformations are identifiable to a skilled person upon a reading of the present disclosure (see, for example, US 2010/0181257 and US 2011/0315636 each incorporated by reference in its entirety). In some embodiments, the chemical transformation of the reactive site on the dendritic component can be performed before the dendritic component is associated with the polymeric component as herein described. In other embodiments, the chemical transformation of the reactive site on the dendritic component can be performed after the dendritic component is associated with the polymeric component as herein described.

In particular, in some embodiments where dendritic nanoparticles are formed in situ, the dendritic nanoparticles can be functionalized when the particles are formed in the polymer blend and before casting of the membrane. In other embodiments where dendritic nanoparticles are formed in situ, the dendritic nanoparticles can be functionalized after the casting of the membranes, for example by contacting the membrane with the functionalization reagents to functionalize the nanoparticles and then rinsing the membrane. For example, if a cation-rejecting membrane with a cation-binding nanoparticle concentration of greater than about 20 wt % is desired, PEI nanoparticles or other polymeric nanoparticles with amine groups can be formed in situ in the dope and the particles quaternized using an alkyl iodide or bromide (see, e.g. FIG. 49 and Example 15 of related application U.S. Ser. No. 13/754,883 published as US20130213881) by treating the dope with the alkyl iodide or bromide, casting the membrane and rinsing the membrane to produce a cation-binding membrane with a nanoparticle concentration of greater than about 20 wt %. If a cation-rejecting membrane with a cation-rejecting nanoparticle concentration of between about 1 and about 10 wt % is desired, PEI nanoparticles or other polymeric nanoparticles with amine groups can be formed ex situ (see, e.g., Example 14 of related application U.S. Ser. No. 13/754,883 published as US20130213881) and quaternized using an alkyl iodide or bromide (see, e.g. FIG. 49 and Example 15 of related application U.S. Ser. No. 13/754,883 published as US20130213881) and then mixed with the polymer to form the polymer matrix to form a dope for casting a membrane with a cation-binding nanoparticle concentration of between about 1 and about 10 wt % (see, e.g. Examples 3 and 9 of related application U.S. Ser. No. 14/447,574 published as US20150053610 incorporated herein by reference). As another example, if a cation-selective membrane with a cation-selective nanoparticle concentration of greater than about 20 wt % is desired, PEI nanoparticles or other polymeric nanoparticles with amine groups can be formed in situ in the dope and the particles functionalized with N, O, and S donors (see, e.g., Example 17 and FIG. 51 of related application U.S. Ser. No. 13/754,883 published as US20130213881).

In particular, in some embodiments, the cross-linking of polymers in the polymer blend herein described to form polymeric nanoparticles as described herein can result in the formation of additional reactive sites in addition to those already present on the polymer forming the polymeric nanoparticle. For example, if the polymer comprises carboxylic acids groups (e.g., as in poly(methacrylic acid) or MPA) and the cross-linker used is a diamine, the cross-linking can give rise to amide reactive sites in addition to the carboxylic acid reactive sites.

In some embodiments reactive sites can be introduced in the functionalizing polymer, and/or polymeric particles post membrane formation e.g., as described in related application U.S. Ser. No. 13/754,883 published as US20130213881.

In embodiments herein described of in situ functionalized symmetric skinless membrane adsorbers herein described the reactive site can be selected and configured on the polymer forming the polymeric nanoparticles and/or the polymeric network component of the matrix to provide selective filtration of one or more chemicals of interest. In particular, in some embodiments, the reactive site can be selected to separate the one or more chemicals of interest in the rejection stream, permeate stream and/or retentate of the membrane. In particular, the dimension, chemical nature, and electrical charge of the reactive site as well as the location on the dendrimer component can be selected based on the dimensions, chemical nature and electrical charge of the chemical to be selectively filtered.

In some embodiments, the in-situ functionalized membrane adsorbers described herein, which possess a symmetric skinless morphology, can be further utilized as catalytic membranes. The diverse, in-situ functionalized groups, such as the Strong Base (SB) Anion Exchange (AEX) groups, Cation Exchange (CEX) groups, Hydrophobic Interaction Chromatography (HIC) groups, fluorophilic and chelating groups, provide a robust platform for immobilizing a wide range of catalysts for use in flow-through applications. For example, in one embodiment, an in-situ functionalized CEX membrane comprising sulfonate groups can be used directly as a solid acid catalyst. In another embodiment, the CEX membrane can be used as an ion-exchange support to immobilize a target catalytic cation, such as Cu2+or Ni2+, which is then used in a reaction. In a further embodiment, an in-situ functionalized HIC membrane, comprising non-polar groups, can be used as a support to adsorb and immobilize a hydrophobic organocatalyst, allowing it to be used in a continuous flow-through process. In yet another embodiment, a membrane functionalized with chelating groups, such as thiolate groups, can be used to immobilize specific heavy metal or precious metal catalysts for catalysis. These examples illustrate how the in-situ functionalization platform (e.g., step (a) (ii)) enables the creation of a diverse family of catalytic membranes tailored for specific chemical transformations.

In some embodiments, the in-situ functionalized membrane adsorbers provide for the selective release, or elution, of the bound retentate. This release mechanism is a key operational feature and is dependent on the specific functionality created during the in-situ functionalization step (e.g., step (a) (ii)). For example, in embodiments where the membrane is an in-situ functionalized Strong Base (SB) AEX or Cation Exchange (CEX) membrane, the bound retentate, such as proteins, DNA, or viral particles, is selectively released by contacting the membrane with a solution of high ionic strength, such as a high salt concentration (e.g., 1M NaCl). Conversely, in embodiments where the membrane is an in-situ functionalized Hydrophobic Interaction Chromatography (HIC) membrane, the bound retentate, such as protein aggregates, is selectively released by contacting the membrane with a solution of low ionic strength. This ability to create a platform of membranes with different, well-controlled, salt-based elution mechanisms from a single manufacturing process is a key advantage for designing efficient, scalable, and robust purification systems.

The in-situ functionalized polymeric microparticles and/or nanoparticles of the present disclosure are adsorbers of a diverse and tunable range of target solutes. The specific target solute is determined by the functional group selected during the in-situ functionalization step (e.g., step (a) (ii)). In bioprocessing applications, the Strong Base (SB) Anion Exchange (AEX) particles are adsorbers of negatively charged impurities such as host cell proteins (HCPs), DNA, viruses, and endotoxins, and are capable of operating at high pH. The Cation Exchange (CEX) particles, comprising negatively charged groups such as sulfonates, are adsorbers of positively charged species, such as protein aggregates or specific monoclonal antibody (mAb) products. The Hydrophobic Interaction Chromatography (HIC) particles, comprising non-polar groups such as phenyl rings, are adsorbers of molecules with exposed hydrophobic patches, and are also highly effective for the removal of protein aggregates. In environmental remediation applications, the Fluorophilic particles, comprising fluorinated functional groups, are adsorbers of persistent fluorinated contaminants, such as Per- and Polyfluoroalkyl Substances (PFAS), including long chain, short chain, and ultra-short chain PFAS.

In particular in some embodiments, the highly branched dendritic macromolecule forming the polymeric nanoparticles can comprise hyperbranched PEI macromolecules, water-soluble branched macromolecules with functional N groups including for example, Gx-NH₂ PPI dendrimers, Gx-NH₂ PAMAM dendrimers, hyperbranched and dendrigraft lysine macromolecules, Hybrane hyperbranched polymers can be used as building blocks separation layers for the filtration membranes disclosed in this disclosure. Similarly, polymers such as polysulfone (PS), polyethersulfone (PES), and/or poly(vinyl) alcohol can be used in making polymer matrix of the in situ functionalized symmetric skinless membrane adsorbers described herein.

The in-situ functionalized membrane adsorbers herein described can be configured to selectively bind biological materials, such as bacteria, viruses, host cell proteins, and DNA, by using the in-situ functionalized groups. In one embodiment, an in-situ functionalized Strong Base (SB) AEX membrane, comprising pH-independent quaternary ammonium groups, is used for the high-capacity binding and removal of viruses or viral vectors, with the advantage of allowing for selective elution using a high-salt buffer rather than a pH shift. In another embodiment, an in-situ functionalized Hydrophobic Interaction Chromatography (HIC) membrane is used for the selective capture of specific biological materials, such as protein aggregates or viral particles, based on their surface hydrophobicity. In further embodiments, the polymeric microparticles and/or nanoparticles are chemically modified in-situ (e.g., in step (a) (ii)) with a functionalizing polymer, which is a linear or branched polymer that forms a polymeric network component within the membrane. This functionalizing polymer can be selected to covalently or non-covalently attach the microparticles to the base polymer matrix, creating a robust, interlaced polymeric structure that further enhances the mechanical stability and performance of the membrane adsorber.

In some embodiments, the dendritic nanomaterial can be made by cross-linking highly branched dendritic macromolecules by using a cross linking agent. For example, a dendritic nanomaterial comprising amine groups can be combined with a cross linking agent which is capable of cross linking proximate amine groups (amine-amine cross linking agents). The amine-amine cross linking agents can be bifunctional (e.g. two sites which can form covalent bonds with amines) or multifunctional (e.g. three or more sites which can form covalent bonds with amines). The cross linking agents can include but are not limited to primary bifunctionalized alkanes having the general formula (XXV) or (XXVI) below:

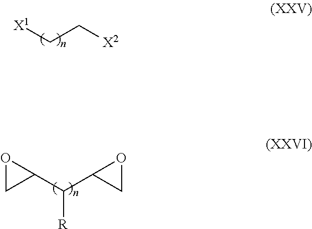

wherein X¹ and X², by way of example, can be independently selected from (COCl, COBr, COI, Cl, Br, I, OSOCH₃, OSOCH₇, n can range from 1-15, and wherein R can be H, alkyl, or epoxy substituted alkyl. Crosslinking agents can also include imidoesters (e.g. dimethyl adipimidate·2HCl (DMA), dimethyl pimelimidate·2HCl (DMP), dimethyl suberimidate·2HCl (DMS), dimethyl 3,3′-dithiobispropionimidate·2HCl (DTBP)), N-hydroxy succinimide (NHS)-esters (e.g. disuccinimidyl suberate (DSS), bis(sulfosuccinimidyl) suberate (BS3), disuccinimidyl glutarate (DSG)), and 1,5-difluoro-2,4-dinitrobenzene (DFDNB). Exemplary amine cross linking agents comprise in particular, trimesoyl chloride (TMC), 1,3-dibromopropane (DBP), and epichlorohydrin (EPC) to form dendritic nanoparticles.

In some embodiments, in situ functionalized symmetric skinless membrane adsorbers can be fabricated by casting a mixture of the polymer component, the dendrimer component, one or more solvents, and a cross-linking agent onto porous polymeric MF membrane supports [13].

Targeted atomistic molecular dynamics (MD) simulations of anion and/or cation binding to a dendritic component (e.g. PAMAM, PPI, and MPA) can be carried out using a Dreiding III force field (FIG. 26 of related application U.S. Ser. No. 13/754,883 published as US20130213881) [7] to develop and validate a computer-aided molecular design framework that can be used to guide the synthesis of high capacity and recycle low-cost ion-selective dendritic polymers.

In some embodiments, the in situ functionalized symmetric skinless membrane adsorbers with embedded in situ functionalized symmetric skinless nanoparticles as described herein can comprise a polymeric matrix with polymeric nanoparticles made from cross-linked linear polymers. In some embodiments, the membranes with embedded nanoparticles as described herein can comprise a polymeric matrix made from poly(vinylidene) fluoride (PVDF) with polymeric nanoparticles made from cross-linked linear polymers (e.g. polyamine) functionalized with an epoxy polyacrylate forming the polymer network of the matrix.

In some embodiments, the in situ functionalized symmetric skinless membrane adsorbers with embedded in situ functionalized nanoparticles as described herein can comprise a polymeric matrix made from poly(vinylidene) fluoride (PVDF) with polymeric nanoparticles made from cross-linked poly(methacrylic acid) (PMAA) and functionalized with epoxy polyacrylate as a functionalizing polymer forming the polymer network of the matrix.

In some embodiments, the in situ functionalized symmetric skinless membrane adsorbers with embedded in situ functionalized nanoparticles as described herein can comprise a polymeric matrix made from polyether sulfone (PES) with polymeric nanoparticles made from cross-linked linear polymers functionalized with diepoxypolyethylene glycol and/or an acyl chloride.

In some embodiments, the in situ functionalized symmetric skinless membrane adsorbers with embedded in situ functionalized nanoparticles as described herein can comprise a polymeric matrix made from polyether sulfone (PES) with polymeric nanoparticles made from cross-linked poly(methacrylic acid) (PMAA), functionalized with diepoxypolyethylene glycol and/or an acyl chloride.

In some embodiments, the in situ functionalized symmetric skinless membrane adsorbers with embedded in situ functionalized nanoparticles as described herein can comprise a polymeric matrix made from poly(acrylonitrile) (PAN) with polymeric nanoparticles made from cross-linked linear polymers functionalized with diepoxypolyethylene glycol and/or an acyl chloride.

In some embodiments, the in situ functionalized symmetric skinless membrane adsorbers with embedded in situ functionalized nanoparticles as described herein can comprise a polymeric matrix made from poly(acrylonitrile) (PAN) with polymeric nanoparticles made from cross-linked poly(methacrylic acid) (PMAA) functionalized with diepoxypolyethylene glycol and/or an acyl chloride.

In some embodiments, the in situ functionalized symmetric skinless membrane adsorbers with in situ functionalized embedded nanoparticles as described herein can comprise a polymeric matrix made from poly(ethylene terephthalate) (PET) with polymeric nanoparticles made from cross-linked linear polymers functionalized with diepoxypolyethylene glycol and/or an acyl chloride forming the polymer network.

In some embodiments, the in situ functionalized symmetric skinless membrane adsorbers with embedded in situ functionalized symmetric skinless nanoparticles as described herein can comprise a polymeric matrix made from poly(ethylene terephthalate) (PET) with polymeric nanoparticles made from cross-linked poly(methacrylic acid) (PMAA) functionalized with diepoxypolyether and/or epoxy polyamide

In some embodiments, the in situ functionalized symmetric skinless membrane adsorbers with embedded in situ functionalized nanoparticles as described herein can comprise a polymeric matrix with polymeric nanoparticles made from cross-linked highly branched dendritic macromolecule.

In some embodiments, the in situ functionalized symmetric skinless membrane adsorbers with embedded in situ functionalized nanoparticles as described herein can comprise a polymeric matrix made from poly(vinylidene) fluoride (PVDF) with polymeric nanoparticles made from cross-linked highly branched dendritic macromolecule functionalized with diepoxypolyethylene glycol forming the polymer network of the matrix.

In some embodiments, the in situ functionalized symmetric skinless membrane adsorbers with embedded in situ functionalized nanoparticles as described herein can comprise a polymeric matrix made from poly(vinylidene) fluoride (PVDF) with polymeric nanoparticles made from cross-linked poly(ethyleneimine) (PEI), functionalized with an acyl chloride forming the polymer network of the matrix.

In some embodiments, the in situ functionalized symmetric skinless membrane adsorbers with embedded in situ functionalized nanoparticles as described herein can comprise a polymeric matrix made from poly(vinylidene) fluoride (PVDF) with polymeric nanoparticles made from cross-linked poly(bis(methylol) propionic acid) (MPA) (for example, G3, G4, or G5 MPA) functionalized with diepoxypolyethylene glycol and/or an acyl chloride forming the polymer network of the matrix.

According to a further embodiment of the disclosure, a method of making a in situ functionalized symmetric skinless membrane adsorber with embedded polymeric in situ functionalized nanoparticles is described. The method comprises contacting a polymeric component, a dendritic component, and a solvent to provide a blend, contacting the blend with a cross-linking component, for a time and under a condition to permit the in situ formation of dendritic nanoparticles to provide a membrane casting dispersion commonly referred to as dope or dope solution; comprising a microparticles and/or nanoparticles dispersion and casting the dope solution to provide a filtration membrane with embedded dendritic nanoparticles.

In particular, in some embodiments, polymeric particle can be synthesized by adding to the blend a particle precursor having a portion substantially insoluble in the base polymer solvent is used which can form a dispersion of segregated domains in the base polymer solvent following the addition of catalytic and low amounts of acids, bases or initiators.

In particular, in some embodiments, contacting a polymeric component, a dendritic component, and a solvent to provide a blend is performed by mixing a solution of the base polymer of the polymeric component in a suitable solvent—the suitable solvent chosen based on parameters such as solubility parameters (see e.g. [1,8]), compatibility of the dendritic component with the polymer component (e.g. hydrogen bonding between amine groups and fluoride groups or interaction of hydroxyl/carboxylic acid groups with oxygen atoms), or other chemical and thermodynamic parameters identifiable to a skilled person—for approximately 1-24 hours at 25-85° C.—or other times and temperatures capable of producing a homogeneous solution without decomposing the polymeric component as would be identifiable to a skilled person—and then adding a solution of the dendritic component and mixing to form a homogeneous blend (see, e.g., Examples 1 and 2 of related application U.S. Ser. No. 14/447,574 published as US20150053610 incorporated herein by reference). In some embodiments, a functionalizing polymer presenting a functional group capable to react with a corresponding group in the dendrimer component can be added into the blend and is allowed to react for a time depending on the reactivity of the functional polymer end group (e.g. 1-10 hrs) and preferably between 1 hr or 2 hrs. In particular, in some embodiments, that the concentration of the dendritic component is between about 3.5 wt % and 7.5 wt % of the blend.

In particular, in some embodiments, the contacting of the blend with a cross linking component can be performed by mixing a crosslinking catalyst and cross-linking component—the cross-linking catalyst and cross linking component chosen based on the functional groups on the dendritic component as would be identifiable to a skilled person (e.g., if the dendritic component has amine groups, the cross linking component can be an epoxide such as epichlorohydrin or dihaloalkane such as 1,3-dibromopropane and the catalysts can be HCl; if the dendritic component has carboxylic acid groups, the cross-linking component can be a diamine such as 1,3-diamino propane and the cross-linking catalyst can be 1-ethyl-3-(3-dimethylaminopropyl) carbodiimide) (EDC))—for 1-24 hours at approximately 25-85° C.—or other times and temperatures capable of producing a homogeneous dope without decomposing either the polymeric or dendritic components as would be identifiable to a skilled person—to provide a dope solution comprising a dispersion od dendritic nanoparticles formed in situ (see, e.g., Examples 1 and 2 of related application U.S. Ser. No. 14/447,574 published as US20150053610 incorporated herein by reference). A functionalizing polymer which also present at least one epoxide group can then be added into the blend and is allowed to react to form a polymer network for a time and under condition that depend on the reactivity of 1 hr or 2 hr (see Examples 1 and 2 of related application U.S. Ser. No. 14/447,574 published as US20150053610 incorporated herein by reference) In particular, in some embodiments, the dendritic component is at a concentration of about 1.5 times the concentration of the cross-linking component

In some embodiments herein described the microparticles and/or nanoparticles of the dispersions included in the dope solutions comprise polymeric particles that are inherently functional, for example, possessing weak-base anion exchange (AEX) groups from the amine-containing precursors and crosslinkers.

In embodiments herein described, however, the microparticles and/or nanoparticles dispersed in the dope solution are further functionalized by a further in situ functionalization step performed before dope casting or electrospinning. In embodiments herein described the dope dispersion is further processed prior to casting by contacting the dispersions of in-situ synthesized microparticles or nanoparticles with a functional reagent or a mixture of functional reagents for a time and under a condition to permit the formation of in-situ microparticles or nanoparticles in the membrane casting dispersions which are further functionalized as a reason of the use of the functional reagents.

In particular, embodiments herein described are based on specific selection of the functional reagents that enable the in-situ functionalization platform. These reagents are selected to possess a specific “dual ability” or set of features that a person of ordinary skill in the art would not expect to find. First, the functional reagent is an “organic-compatible” reagent, meaning it is sufficiently soluble or miscible in the organic dope solution (the medium used for casting the membrane), which is a feature not possessed by standard aqueous-based functionalization reagents. Second, the functional reagent does not react with other components in the dope mixture in a manner that interferes with the subsequent, delicate membrane formation process.

[A skilled person will recognize that any organic-compatible electrophile can be used capable of reacting with the nucleophilic groups of the polymeric particles (e.g., amines) within the dope solvent environment may be utilized. Accordingly, suitable functional reagents include: (i) alkylating agents (e.g., alkyl halides, sulfates, sulfonates) for creating charge-positive quaternary ammonium sites; (ii) strained-ring electrophiles (e.g., epoxides, aziridines, episulfides, lactones, sultones) that undergo ring-opening reactions to attach functional moieties without releasing small-molecule byproducts; (iii) activated double bonds (e.g., vinyl sulfonates, acrylates, acrylamides) capable of reacting via Michael addition; and (iv) halogenated or fluorinated analogs thereof.

The selection of the specific functional reagent is governed by the desired interaction mechanism (electrostatic, hydrophobic, or affinity-based) and the requirement that the reagent remains soluble in the dope solution without precipitating the base polymer.

Exemplary functionalizing reagents have been surprisingly identified by the inventors which can be used for the functionalization of microparticles and/or nanoparticles with Strong Base (SB) Anion Exchange (AEX) groups, Cation Exchange (CEX) groups, Hydrophobic Interaction Chromatography (HIC) groups, Fluorophilic groups and Chelating groups, for a time and under conditions identifiable by a skilled person upon reading of the present disclosure.

For example in those embodiments, contacting the dope dispersion can be performed with a functional reagent, or a mixture of functional reagents, for a time and under a condition, for example for 2 to 4 hours at 65° C. to 80° C., sufficient to permit the formation of in-situ functionalized microparticles and/or nanoparticles. This optional in-situ functionalization step modifies the inherent functionality of the particles. Suitable reagents comprise for example an alkylating reagent such as bromoethane to convert weak-base tertiary amines to strong-base (SB) quaternary ammonium groups, or by using a reagent such as styrene oxide to convert the particles to hydrophobic interaction chromatography (HIC) adsorbers. The final dope dispersion, comprising either the inherently functional or the in-situ functionalized particles, is then cast to form a nascent membrane.

In some embodiments, the in-situ functionalization step can comprises a fluorination reaction to impart hydrophobic, lipophobic, or fluorous-phase affinity properties to the polymeric microparticles and/or nanoparticles. This functionalization is achieved by contacting the dope dispersion, which contains the inherently functional polymeric microparticles, with a fluorine-containing functional reagent for a time and under a condition sufficient to permit the reaction. For example, where the inherently functional particles comprise amine groups, such as in cross-linked polyethyleneimine (PEI) particles, the fluorine-containing functional reagent may be a fluorinated epoxide, such as a perfluoroalkyloxirane, or a fluorinated alkyl halide, such as a perfluoroalkyl iodide or bromide. This reaction covalently attaches the fluorinated moieties, such as perfluoroalkyl groups, to the particles within the dope dispersion prior to the casting and phase separation steps.

In some embodiments, the in-situ functionalization step can comprise a reaction with fluorinated reagents to impart and tune hydrophobic, lipophobic, or fluorophilic (fluorous-phase affinity) properties to the polymeric microparticles and/or nanoparticles. This functionalization is achieved by contacting the dope dispersion, which contains the inherently functional polymeric microparticles, with an organic-compatible fluorine-containing functional reagent for a time and under a condition sufficient to permit the reaction. For example, where the inherently functional particles comprise amine groups, such as in cross-linked polyethyleneimine (PEI) particles, the fluorine-containing functional reagent may be a fluorinated epoxide (such as a perfluoroalkyloxirane) or a fluorinated alkyl halide (such as a monofluoroalkyl iodide or bromide or a perfluoroalkyl iodide or bromide). This reaction covalently attaches the fluorinated moieties, such as monofluoroalkyl or perfluoroalkyl groups, to the particles within the dope dispersion prior to the casting and phase separation steps. This step is a key component of the platform, as it enables the creation of tuned, multi-modal adsorptive surfaces. For example, a multi-modal surface can be engineered by controlling the degree of fluorination and/or by combining it with other functionalities (such as the inherent electrostatic amine groups of the PEI) to create a specific combination of electrostatic, hydrophobic, and fluorophilic interactions. This tuned selectivity is particularly advantageous for the targeted removal of complex environmental contaminants, such as different chain-lengths of Per- and Polyfluoroalkyl Substances (PFAS).

In some embodiments, the in-situ functionalization step can comprise an alkylation or quaternization reaction to impart Strong Base (SB) anion exchange properties to the polymeric microparticles and/or nanoparticles. This functionalization is achieved by contacting the dope dispersion, which contains the inherently functional polymeric microparticles, with an organic-compatible alkylating reagent for a time and under a condition sufficient to permit the reaction, for example, at approximately 65° C. for 24 hours. For example, where the inherently functional particles comprise tertiary amine groups, such as in cross-linked polyethyleneimine (PEI) particles, the alkylating reagent may be an alkyl halide, such as bromoethane, methyl iodide, or butyl bromide. This reaction covalently attaches alkyl groups to the tertiary amines, converting them into quaternary ammonium groups within the dope dispersion prior to the casting and phase separation steps.

In other embodiments, the in-situ functionalization step can comprise a reaction to impart Cation Exchange (CEX) properties to the polymeric microparticles and/or nanoparticles. This functionalization is achieved by contacting the dope dispersion, which contains the inherently functional polymeric microparticles, with an organic-compatible CEX-forming functional reagent for a time and under a condition sufficient to permit the reaction, for example, at approximately 65° C. for 24 hours. For example, where the inherently functional particles comprise amine groups, such as in cross-linked polyethyleneimine (PEI) particles, the functional reagent may be a sultone, such as 1,3-propanesultone. This method utilizes the organic-soluble, neutral sultone, which subsequently undergoes a ring-opening reaction with the amine groups to covalently attach the final sulfonate groups to the particles within the dope dispersion prior to the casting and phase separation steps.

In further embodiments, the in-situ functionalization step can comprise a reaction to impart Hydrophobic Interaction Chromatography (HIC) properties to the polymeric microparticles and/or nanoparticles. This functionalization is achieved by contacting the dope dispersion, which contains the inherently functional polymeric microparticles, with an organic-compatible hydrophobic functional reagent for a time and under a condition sufficient to permit the reaction, for example, at approximately 80° C. for 4 hours. For example, where the inherently functional particles comprise amine groups, such as in cross-linked polyethyleneimine (PEI) particles, the hydrophobic functional reagent may be a terminal epoxide, such as an epoxy-aromatic (e.g., styrene oxide) or an epoxy-alkane (e.g., 1,2-epoxybutane). This method utilizes the organic-soluble neutral epoxide, which then undergoes a ring-opening reaction with the amines to covalently attach the hydrophobic moieties, such as phenyl groups or alkyl groups, to the particles within the dope dispersion prior to the casting and phase separation steps.

In some embodiments, a high degree of functionalization is desired so that the resulting in-situ functionalized symmetric skinless membrane adsorber has a sufficiently-high capacity to absorb the desired species, for example, to be competitive with alternative methods such as resins. This high degree of functionalization is a key process parameter that is controlled by the stoichiometric molar ratio of the functional reagent (e.g., used in step (a) (ii)) to the inherent reactive sites on the base polymeric particles (e.g., the total moles of nitrogen atoms in a PEI precursor).

In some embodiments, the molar ratio of the functional reagent to the precursor's reactive sites is between 0.1 and 5.0, preferably between 0.5 and 2.0, and in some specific embodiments, is approximately 1.5. This allows the degree of functionalization to be precisely “tuned” to control the final adsorptive properties and selectivity of the membrane.

A key aspect of the in situ functionalized symmetric skinless membrane adsorbers herein described, and related compositions, devices methods and systems, is the selection of an organic-compatible functional reagent that is soluble in the casting solvent to the necessary concentration, which can be from 0.0001-2M. For example, the functional reagent bromoethane is fully miscible with the organic solvent TEP due to their chemical similarity. Alternatively, a functional reagent that is insoluble in the primary solvent, such as sodium 4-vinylbenzene sulfonate which is insoluble in TEP, may be used. In this case, the casting solvent mixture is first adjusted to include a co-solvent, such as DMSO, to retain solubility of the functional reagent. For example, the solvent mixture can be adjusted from 100% TEP to 90/10 TEP: DMSO v/v, such that no precipitation of the functional reagent is observed.

In some embodiments, the inherent reactive sites on the base polymeric particles, which are the sites for the subsequent in-situ functionalization, are provided by the precursor polymer itself. For example, cross-linked PEI particles retain a high concentration of nucleophilic functionality due to unreacted primary, secondary, and/or tertiary amine groups.

In other embodiments, the cross-linker itself (e.g., used in step (a) (i)) can be chosen to bear additional chemical functionality that serves as the reactive site. This chemical reactivity may be of a similar nature to that of the cross-linking reaction, for example amine groups (e.g., in BCAH) or alcohol groups (e.g., in ECH), where these groups may serve as nucleophilic sites for reaction with the electrophilic functional reagent in the subsequent in-situ functionalization step (e.g., step (a) (ii)).

In yet other embodiments, the cross-linker may bear additional functional groups that undergo orthogonal reactions to the cross-linking reaction between PEI particles. For example, the cross-linker may feature azide groups that react with alkyne groups on the functional reagent via a “Click” reaction or, alternatively, the cross-linker may bear alkyne groups that react with azide groups on the functional reagent.

In one embodiment, the in-situ functionalized symmetric skinless membrane adsorber is functionalized with Strong Base (SB) Anion Exchange (AEX) groups (e.g., as described in Example 20). As defined herein, a “strong base” group comprises a quaternary ammonium cation (a nitrogen atom bound to four carbon atoms) which carries a pH-independent positive charge. This distinguishes it from “weak base” (WB)amine groups, which have a pH-dependent charge. As a quantifiable threshold, a strong base membrane retains at least 80% of its maximum anionic Dynamic Binding Capacity (DBC) when the operating buffer is changed from a neutral pH (e.g., pH 7.0) to a high pH (e.g., pH 9.0 or greater).

In some embodiments, these Strong Base groups are introduced into the in-situ functionalized symmetric skinless membrane adsorber by the in-situ reaction (e.g., step (a) (ii)) between amine species in the intermediate dope solution that act as nucleophiles and an organic-compatible functional reagent that acts as an electrophile. For example, using ECH as a crosslinker (in step (a) (i)) results in cross-linked PEI particles bearing amines that can be quaternized (in step (a) (ii)) with electrophilic functional reagents such as bromoethane (see, e.g., Example 20).

Suitable electrophilic functional reagents for SB AEX formation include, but are not limited to, alkyl chlorides, alkyl bromides, alkyl iodides, alkyl sulfonates, alkyl triflates, and alkyl sulfates.

In another embodiment, the in-situ functionalized symmetric skinless membrane adsorber is functionalized with Hydrophobic Interaction Chromatography (HIC) groups (e.g., as described in Example 21). As defined herein, an HIC group is non-polar and is both hydrophobic (water-repelling) and oleophilic (oil-attracting). As a quantifiable threshold, a surface functionalized with HIC groups exhibits a static water contact angle of 90 degrees or greater AND a static oil contact angle (e.g., using hexadecane) of 20 degrees or less.

In some embodiments, these HIC groups are introduced into the in-situ functionalized symmetric skinless membrane adsorber by the in-situ reaction (e.g., step (a) (ii)) between amine species in the intermediate dope solution that act as nucleophiles and an organic-compatible functional reagent that acts as an electrophile. For example, the free amine groups of cross-linked PEI particles can react with terminal epoxides substituted with alkyl or aryl groups, such as styrene oxide (see, e.g., Example 21).

Suitable electrophilic functional reagents for HIC formation include, but are not limited to, styrene oxide, epoxyalkanes (e.g., 1,2-epoxybutane), alkyl chlorides, alkyl bromides, alkyl iodides, alkyl sulfonates, alkyl triflates, and alkyl sulfates.

In yet another embodiment, the in-situ functionalized symmetric skinless membrane adsorber is functionalized with Strong Acid Cation Exchange (CEX) groups (e.g., as described in Example 22). As defined herein, a “strong acid” group comprises a s a sulfonate anion (—SO3-) or a phosphonate (—PO4 2-) anion, which carries a pH-independent negative charge. This distinguishes it from “weak acid” groups (e.g., carboxylates). As a quantifiable threshold, a strong acid CEX membrane retains at least 80% of its maximum cationic Dynamic Binding Capacity (DBC) when the operating buffer is changed from a neutral pH (e.g., pH 7.0) to a low pH (e.g., pH 4.0 or lower).

In a preferred embodiment, these Strong Acid CEX groups are introduced into the in-situ functionalized symmetric skinless membrane adsorber by the in-situ reaction (e.g., step (a) (ii)) between amine species in the intermediate dope solution and a specific, organic-compatible functional reagent. A preferred reagent is a sultone, such as 1,3-propanesultone. This neutral, cyclic reagent is soluble in the organic dope and undergoes a ring-opening reaction with the amine groups to covalently attach the final sulfonate group in-situ (see, e.g., Example 22).

Suitable functional reagents for CEX formation include, but are not limited to, sultones (such as 1,3-propanesultone). In other embodiments, reagents such as 4-vinylbenzene sulfonic acid and its salts, or acrylic acid and its salts, may be used, for example, in combination with a co-solvent system such as DMSO, to retain solubility of the functional reagent. For example, the solvent mixture can be adjusted from 100% TEP to 90/10 TEP: DMSO v/v, such that no precipitation of the functional reagent is observed.

In yet another embodiment, the in-situ functionalized symmetric skinless membrane adsorber is functionalized with Fluorophilic groups (e.g., as described in Example 23). As defined herein, a “fluorophilic” or “fluorous-phase” group is characterized by its “omniphobic” (both water- and oil-repelling) nature. As a quantifiable threshold, a surface functionalized with fluorophilic groups exhibits (a) a static water contact angle of 90 degrees or greater, AND (b) a static oil contact angle (e.g., using hexadecane) of 50 degrees or greater. In preferred embodiments, these groups comprise polyfluoroalkyl and/or perfluoroalkyl chains (i.e., comprising CF2 and/or CF3 groups) which impart said fluorous-phase affinity.

In some embodiments, these Fluorophilic groups are introduced into the in-situ functionalized symmetric skinless membrane adsorber by the in-situ reaction (e.g., step (a) (ii)) between nucleophilic species in the intermediate dope solution (such as amine groups) and an organic-compatible, fluorine-bearing functional reagent that acts as an electrophile, such as a fluorinated epoxide or a fluorinated alkyl halide.

In some embodiments, suitable functional fluorine-bearing reagents for fluorophilic interaction group formation include fluoroalkyl electrophiles such as perfluoroalkyl iodides or perfluoroalkyl bromides. In other embodiments, a less-fluorinated reagent, such as 1-chloro-2-fluoroethane, 1-chloro-4-fluorobutane, 4-fluorobenzyl chloride, 1-bromo-2-fluoroethane, 1-bromo-4-fluorobutane, 1-iodo-2-fluoroethane and 1-iodo-4-fluorobutane may be used. In certain embodiments the fluorine-bearing species does not comprise CF2 and/or CF3 groups in addition to a C—F bond.

In yet another embodiment, the in-situ functionalized symmetric skinless membrane adsorber is functionalized with multi-modal groups (e.g., as described in Example 23). For example, a membrane may be functionalized with both alkyl or aryl species of low polarity and fluorine-bearing species to serve as a tunable PFAS-selective membrane. These different species can be introduced simultaneously or sequentially by reacting the nucleophilic species in the dope dispersion with a mixture of functional electrophiles, such as a mixture of alkyl bromides and fluoroalkyl halides, to create a final surface with a specific, tuned combination of electrostatic, hydrophobic, and fluorophilic interactions.

To assist in the design of specific membrane adsorbers, the selection of the appropriate functional reagent is determined based on the target solute and process goal.

For example, in embodiments where the adsorber is configured for the removal of negatively charged impurities, including DNA, viruses, endotoxins, and host cell proteins, an alkylating reagent such as bromoethane or methyl iodide is selected. This mechanism converts weak-base tertiary amines into permanent, pH-independent strong base quaternary ammonium cations, which is used when the adsorber maintains high binding capacity at high pH, for example at a pH greater than 8, or when salt tolerance is required for viral clearance.

In another exemplary embodiments where the adsorber is configured for the removal of positively charged impurities, such as protein aggregates, basic proteins, and monoclonal antibodies, a sultone such as 1,3-propanesultone or an activated sulfonate such as sodium 4-vinylbenzene sulfonate is selected. This mechanism covalently attaches a strong acid sulfonate group and is used for cation exchange polishing steps where the target impurity is positively charged; if the reagent is insoluble in the primary solvent, such as triethyl phosphate, a co-solvent like dimethyl sulfoxide is added to the dope.

In further exemplary embodiments where the adsorber is configured for the removal of aggregates via hydrophobic interaction, a hydrophobic epoxide such as styrene oxide, 1,2-epoxybutane, or phenyl glycidyl ether is selected. This mechanism attaches a non-polar moiety, such as a phenyl or alkyl chain, via ring-opening and is used when the separation requires binding based on surface hydrophobicity rather than charge, typically in high-salt feed streams such as post-Protein A elution where traditional ion exchange is ineffective. Styrene oxide, being aromatic, provides stronger hydrophobic interaction than aliphatic options like epoxybutane.

In an additional exemplary embodiment where the adsorber is configured for the removal of fluorinated contaminants such as Per- and Polyfluoroalkyl Substances (PFAS), a fluorinated electrophile such as a monofluoroalkyl iodide, perfluoroalkyl iodide, fluorinated epoxide, or fluorobenzyl chloride is selected. This mechanism attaches a fluorous tail to create fluorophilic affinity, which is used specifically for environmental remediation of persistent fluorinated chemicals, wherein the chain length of the fluorinated reagent is selected to match the chain length of the target PFAS, for example using C8 fluorinated reagents for perfluorooctanoic acid (PFOA) and perfluorooctane sulfonic acid (PFOS).

In particular, in membranes cast with in situ generated nanoparticles, which comprise in situ functionalized particles, presenting or not presenting a polymer network, aggregates and clusters of nanoparticles that form for example through fractal growth are not detectable contrary to membranes cast with nanoparticles that are preformed (compare, e.g., FIG. 6 of related application U.S. Ser. No. 14/447,574 published as US20150053610 incorporated herein by reference and FIG. 6 of related application U.S. Ser. No. 13/754,883 published as US20130213881 with FIG. 53 and FIG. 58B of related application U.S. Ser. No. 13/754,883 published as US20130213881) resulting in discrete nanoparticles being distributed in membranes with nanoparticles formed in situ. In particular, in some embodiments, the nanoparticles can be present in the membrane at a concentration of greater than about 20 wt %, and more particularly at a concentration of greater than about 35% and from 50% to 60%.

In particular, in some embodiments, the dope dispersion with in situ formed dendritic nanoparticles can be cast to provide a polymeric membrane with embedded with dendritic nanoparticles. In particular, in some embodiments, the membrane can be cast by phase inversion casting (see, e.g. [6]). In particular, in some embodiments, the casting can be performed by pouring the hot dope dispersion onto a glass surface or porous support and allowing it to air dry at room temperature and then immersing it into water for a time to form a nascent membrane as would be identifiable to a skilled person. The nascent membrane can then be immersed in fresh water and then immersed in ethanol to remove impurities as would be identifiable to a skilled person. The membranes can then be removed from the glass and dried to provide a polymeric membrane with pores, the pores embedded with dendritic nanoparticles. In other embodiments, the dope dispersion with in situ formed dendritic nanoparticles can be cast onto a polymer support (e.g. a poly(ethylene terephthalate) non-woven fabric) in place of glass to provide a polymeric membrane with pores, the pores embedded with dendritic nanoparticles wherein the polymeric membrane is layered on top of the polymer support.

According to further embodiments, a method of making a polymeric membrane with a polymeric network with embedded preformed polymeric nanoparticles is described. The method comprises contacting a polymeric component, preformed polymeric nanoparticles, and a solvent for a time and under a condition to provide a dope solution comprising a dispersion of nanoparticles; and casting the dope solution to provide a polymeric membrane with pores, the pores embedded with the preformed polymeric nanoparticles. In some embodiments, the polymeric component is within a dope wherein a base polymer is comprised together with polymeric particle precursors functionalized with a functionalizing polymer forming a polymeric network of the matrix.

In particular, in some embodiments, the preformed polymeric nanoparticles can be performed by cross-linking a polymer (e.g. PEI or poly(methacrylic acid)) to form polymeric nanoparticles for example by inverse micelle cross-linking (see, e.g., Example 14 of related application U.S. Ser. No. 13/754,883 published as US20130213881)

In particular, in some embodiments, contacting a polymeric component, preformed polymeric nanoparticles, and a solvent for a time and under a condition to provide a dope solution comprising a dispersion of polymeric nanoparticles is performed by mixing a solution of the polymeric component in the solvent for 1-24 hours at approximately 25-85° C.—or other times and temperatures capable of producing a homogeneous solution without decomposing the polymeric component as would be identifiable to a skilled person—and then adding a solution of the preformed polymeric nanoparticles and mixing the solution for 1-24 hours at approximately 25-85° C.—or other times and temperatures capable of producing a homogeneous blend without decomposing either the polymeric or dendritic components as would be identifiable to a skilled person to provide a dope solution comprising a dispersion of polymeric nanoparticles with preformed polymeric nanoparticles. A functionalizing polymer can then be added into the blend and is allowed to react to form the polymer network (see Examples 2 and 3 of related application U.S. Ser. No. 14/447,574 published as US20150053610 incorporated herein by reference)

In particular, in some embodiments, the dope solution comprising a dispersion of preformed dendritic nanoparticles can be cast to provide a polymeric membrane with embedded with dendritic nanoparticles. In particular, in some embodiments, the membrane can be cast by phase inversion casting (see, e.g. [6]). In particular, in some embodiments, the casting can be performed by pouring the hot dope solution comprising the dendritic nanoparticle dispersion onto a glass surface or porous support and allowing it to air dry at room and then immersing it into water for a time to form a nascent membrane as would be identifiable to a skilled person. The nascent membrane is then immersed in fresh water and then immersed in ethanol to remove impurities as would be identifiable to a skilled person. The membranes can then be removed from the glass and dried to provide a polymeric membrane with pores, the pores embedded with dendritic nanoparticles. In other embodiments, the dope solution comprising a dispersion of preformed dendritic nanoparticles can be cast onto a polymer support (e.g. a poly(ethylene terephthalate) non-woven fabric) in place of glass to provide a polymeric membrane with pores, the pores embedded with dendritic nanoparticles wherein the polymeric membrane is layered on top of the polymer support.

In embodiments herein described the phase separation is directed to the formation of skinless symmetric membranes, the phase separation is induced by a controlled, gradual demixing process, In particular, in embodiments herein described a controlled, gradual demixing process is characterized by at least one quantifiable condition selected from the group consisting of: (a) a thermodynamically-controlled process, (b) a time-controlled process, and/or (c) a temperature-controlled process.

In embodiments herein described, the thermodynamically-controlled process, also referred to as “soft” nonsolvent induced phase separation (NIPS), comprises contacting the nascent membrane with a liquid nonsolvent. Said liquid nonsolvent is selected to have a nonsolvent Hildebrand solubility parameter (δns), such that the absolute difference between said (δns), and the base polymer solvent's Hildebrand solubility parameter (δs), is 7 (cal/cm³)½ or less. This low thermodynamic difference between the solvent and nonsolvent, for example when using isopropyl alcohol (IPA) as the nonsolvent for a TEP-based dope, necessitates “longer diffusion times” to induce phase separation. This “delayed demixing” prevents the formation of a skin layer and promotes the desired symmetric, solid-liquid demixing.

In some embodiments thermodynamically-controlled process can be performed with any liquid nonsolvents that also meet this “soft” thermodynamic criteria, such as other alcohols.

In some embodiments, for a base polymer solvent such as triethyl phosphate (TEP), having a δs of approximately 10.9 (cal/cm³)½, a “soft” nonsolvent can be a liquid having a δns in the range of approximately 3.9 to 17.9 (cal/cm³)½. In some of those embodiments such a “soft” nonsolvent is isopropyl alcohol (IPA). Other nonsolvents that meet this “soft” thermodynamic criterion include, but are not limited to, other alcohols such as n-propyl alcohol, n-butyl alcohol, ethanol, and methanol; glycols such as propylene glycol and ethylene glycol; ketones such as acetone and methyl ethyl ketone (MEK); esters such as ethyl acetate; ethers such as tetrahydrofuran (THF) and diethyl ether; polar aprotic solvents such as dimethylformamide (DMF) and dimethyl sulphoxide (DMSO); and hydrocarbon solvents such as toluene and cyclohexane.

In some embodiments thermodynamically-controlled process the composition of the dope solution, can include additives such as pore formers (e.g., polyethylene glycol (PEG), polyvinylpyrrolidone (PVP), or lithium chloride (LiCl)) that can alter the phase separation behavior. Another variation involves controlling the temperature of the “soft” nonsolvent coagulation bath, for example, by using a bath at a temperature below ambient (e.g., 0° C. to 20° C.) or above ambient (e.g., 25° C. to 70° C.) to further tune the demixing kinetics. This process can also be combined with a temperature-controlled process (TIPS-NIPS) by immersing a hot cast dope into a cold “soft” nonsolvent bath.

In embodiments here described, the time-controlled process, also referred to as vapor induced phase separation (VIPS), comprises contacting the nascent membrane with a nonsolvent vapor, such as water vapor, for an exposure time of at least 5 minutes. In some embodiments, the exposure time is between 5 minutes and 60 minutes. This process is inherently slow due to the reduced mass transfer rate of a gaseous nonsolvent diffusing into the liquid dope dispersion, thereby achieving the controlled, gradual demixing necessary to form a symmetric and skinless membrane.

In some embodiments the Vapor Induced Phase Separation (VIPS), can comprise exposing the nascent membrane to a nonsolvent vapor for a controlled duration, for example, at least 5 minutes. The base example involves exposing the nascent membrane to a controlled-humidity environment, such as a water vapor “mist,” for a period of 5 to 60 minutes.

In some embodiments, the Vapor Induced Phase Separation process can include controlling the concentration of the nonsolvent vapor, for example, by controlling the relative humidity of the environment from a low relative humidity to a high relative humidity (e.g., 50% to 100% RH). Another key variation is controlling the temperature of the vapor environment, which the documents specify can range, for example, from 25° C. to 70° C. The chemical nature of the vapor may also be varied; while water vapor is a primary example, other nonsolvent vapors, such as alcohol vapors (e.g., methanol or ethanol vapor), can be used. A significant process variation is a VIPS-NIPS hybrid, wherein the nascent membrane is first exposed to the nonsolvent vapor for the prescribed time (the time-controlled step) and is subsequently immersed in a liquid coagulation bath to complete the solidification process.

In embodiments herein described the temperature-controlled process, also referred to as thermally induced phase separation (TIPS), comprises casting the dope dispersion at an elevated temperature and gradually cooling the nascent membrane. The elevated temperature of the dope dispersion is, for example, ranging from 70° C. to 90° C. The phase separation is induced by cooling the nascent membrane to a final ambient temperature, for example at temperature ranging from 25° C. and 70° C., at a controlled cooling rate. Said controlled cooling rate ranges from 0.5 K/min to 11 K/min. In a preferred embodiment, said cooling rate is 0.5 K/min to 2.5 K/min. This gradual reduction in temperature provides the controlled, thermodynamically-driven solidification required to prevent skin formation and produce the symmetric, porous morphology.

In some embodiments herein described the method comprises inducing phase separation by delayed demixing performed via nonsolvent induced phase separation (NIPS) or vapor induced phase separation (VIPS) by contacting the cast dope solution comprising a microparticles and/or nanoparticles dispersion with a nonsolvent in a coagulation bath (NIPS) or water vapor in an environmental chamber with RH of 50-100% (VIPS) to form the membrane.

Accordingly, in some embodiments, the controlled, gradual demixing is achieved via Evaporation-Induced Phase Separation (EIPS), wherein the cast nascent membrane is exposed to a controlled atmosphere to allow partial evaporation of the solvent or a volatile co-solvent prior to solidification, thereby increasing the polymer concentration at the interface gradually to favor solid-liquid demixing.

In other embodiments, the demixing is controlled via Additive-Modulated Phase Separation, wherein agents are added to the dope solution (e.g., inorganic salts such as LiCl, weak nonsolvents such as glycerol or PEG, or viscosity modifiers) to thermodynamically stabilize the solution or kinetically retard the diffusional exchange rate between solvent and nonsolvent upon immersion.

In yet other embodiments, Multi-Stage Coagulation is employed, wherein the nascent membrane is first immersed in a ‘conditioning bath’ containing a high concentration of the base polymer solvent (e.g., >30% solvent) or a mild nonsolvent to initiate slow solidification without skin formation, followed by subsequent immersion in a second bath (e.g., a neat nonsolvent bath) to complete the phase separation. All such methods that effectively suppress the kinetic formation of a dense skin layer to yield the symmetric morphology defined herein are contemplated.

In various embodiments, the selection of the specific controlled demixing method is governed by factors including the specific polymer chemistry, the desired manufacturing throughput, and the necessity of preventing skin formation to ensure high flux. A thermodynamically-controlled process, often referred to as soft nonsolvent induced phase separation, is typically selected when the manufacturing priority is achieving a consistent, symmetric spherulitic structure with high water flux without the need for complex environmental chambers. This method is specifically chosen when a soft nonsolvent is available that shares a Hildebrand solubility parameter within 7 (cal/cm³)½ of the base polymer solvent. For example, in a polyvinylidene fluoride and triethyl phosphate system, isopropyl alcohol is selected over water because the low thermodynamic difference delays demixing, thereby preventing the skin layer formation that is characteristic of hard nonsolvents like water. This method is particularly suitable for generating membranes with pure water flux exceeding 1000 L/m²/hr.

Alternatively, a time-controlled process, or Vapor Induced Phase Separation, is chosen when it is desirable to use a hard nonsolvent, such as water, for final solidification due to cost or safety considerations, provided that the immediate skinning effects of liquid immersion are avoided. This method is selected when the process allows for a longer formation time, specifically requiring an exposure of at least 5 minutes to a nonsolvent vapor. Vapor Induced Phase Separation is particularly advantageous for tuning the surface porosity independent of the bulk, as the slow diffusion of vapor into the dope suppresses liquid-liquid demixing at the interface. This method is suitable when environmental parameters such as relative humidity, for example between 50% and 100%, and temperature can be strictly controlled.

A temperature-controlled process, or Thermally Induced Phase Separation, is selected when the polymer system requires high temperatures for dissolution, such as 70° C. to 90° C., or when precise control over the polymer crystallization rate is required to dictate the pore structure. This method is preferred when the phase separation needs to be driven by cooling rather than solvent exchange to ensure uniform solid-liquid demixing throughout the bulk. The cooling rate is the critical control parameter in this embodiment, wherein a rate between 0.5 K/min and 2.5 K/min is selected to allow sufficient time for crystallization, thereby preventing skin formation.

In further embodiments, a combination of methods is selected to balance process efficiency with morphological control. For example, a hybrid process combining vapor induced phase separation and nonsolvent induced phase separation is chosen to initiate the skinless surface formation using a slow vapor exposure step corresponding to a time-controlled process, followed by immersion in a liquid coagulation bath to rapidly complete the bulk solidification corresponding to a thermodynamic control. This combination is particularly useful to reduce the total manufacturing time compared to a pure vapor induced process while avoiding the skinning associated with a pure nonsolvent induced process using hard nonsolvents. Similarly, a hybrid approach combining thermally induced phase separation and nonsolvent induced phase separation may be used by immersing a hot dope into a cold soft nonsolvent bath to leverage both thermal and solvent gradients for delayed demixing.

A temperature-controlled process, or Thermally Induced Phase Separation, is selected when the polymer system requires high temperatures for dissolution, such as 70° C. to 90° C., or when precise control over the polymer crystallization rate is required to dictate the pore structure. This method is preferred when the phase separation needs to be driven by cooling rather than solvent exchange to ensure uniform solid-liquid demixing throughout the bulk. The cooling rate is the critical control parameter in this embodiment, wherein a rate between 0.5 K/min and 2.5 K/min is selected to allow sufficient time for crystallization, thereby preventing skin formation1.

In further embodiments, a combination of methods is selected to balance process efficiency with morphological control. For example, a hybrid process combining vapor induced phase separation and nonsolvent induced phase separation is chosen to initiate the skinless surface formation using a slow vapor exposure step corresponding to a time-controlled process, followed by immersion in a liquid coagulation bath to rapidly complete the bulk solidification corresponding to a thermodynamic control. This combination is particularly useful to reduce the total manufacturing time compared to a pure vapor induced process while avoiding the skinning associated with a pure nonsolvent induced process using hard nonsolvents15. Similarly, a hybrid approach combining thermally induced phase separation and nonsolvent induced phase separation may be used by immersing a hot dope into a cold soft nonsolvent bath to leverage both thermal and solvent gradients for delayed demixing.

In general, the method selected needs to be compatible with the components of the system. For example, a temperature-induced method needs to be compatible with the thermal stability of the materials and their functional groups such that any elevated temperature exposure is chosen such that these components retain their chemical structure throughout. Similarly, the timescale of the process needs to be selected accordingly such that exposure of the components to elevated temperatures or to solvents for extended periods is compatible with their chemical stability and the formation of a skinless membrane. To illustrate this concept, quaternary ammonium groups such as those in AEX functional membranes of certain compositions are not stable at elevated temperatures for long periods, for example quaternary ammonium structures subject to beta-elimination such as ethyltrialkylammonium groups that decompose at temperatures above 90° C. Thus, the maximum temperature needs to be less than 90° C. and/or the rate of cooling from the high temperature point needs to be increased.

The suitability of a particular method or combination of methods and the necessary temperature and exposure time limits may be assessed by evaluating the resulting membrane by optical and spectroscopic methods such as visual inspection, electron microscopy and infrared spectroscopy to confirm the membrane structure and chemical functionality is retained using the chosen conditions.

Membrane formation methods can be combined to adjust for varying stabilities of the component materials; for example when using a temperature-based method the cooling rate can be increased to reduce thermal exposure, followed by final curing in a vapor-induced separation method to finish membrane structure formation. Here, the final cure time should be sufficient to enable high-quality symmetric membrane formation without being too long such that deposits on the surface of the membrane form on continued exposure.

In one embodiment, the term non-solvent refers to a liquid or gaseous medium (e.g., liquid water or water vapor) that does not dissolve a given polymer but is at least partially miscible with the solvent or vehicle used to dissolve or disperse that polymer during membrane formation. The non-solvent is thus a liquid that is thermodynamically unfavorable for polymer solvation yet capable of interacting with the polymer solution in such a way as to induce phase separation, polymer precipitation, or solidification of the polymeric matrix.

In the context of polymeric membrane formation, a non-solvent serves as a demixing agent or coagulation medium. When a polymer solution (comprising a polymer dissolved in one or more solvents) comes into contact with a non-solvent—such as by immersion in a coagulation bath, vapor exposure, or solvent exchange—the non-solvent diffuses into the polymer solution while the solvent diffuses out. This exchange alters the local thermodynamic conditions of the mixture, reducing the solvent quality and driving the polymer out of solution to form a solid phase. The resulting structure is a polymeric membrane in which the distribution and size of pores are governed by the kinetics of solvent-non-solvent exchange and the relative affinities of the polymer for each liquid component.

The non-solvent therefore satisfies two criteria: it is miscible or at least diffusively compatible with the solvent system used to dissolve the polymer, and it is non-solvating or only weakly solvating to the polymer itself. Typical non-solvents include water (liquid and vapor), alcohols, glycols, dimethyl isosorbide (DMI), 2-methyltetrahydrofuran, ethyl(−)-L-lactate cyclopentyl methyl ether and γ-valerolactone (GVL). or other polar liquids when the polymer is dissolved in an organic solvent such as triethyl phosphate (TEP), N-methyl-2-pyrrolidone (NMP), dimethylformamide (DMF), dimethylacetamide (DMAc), 1-butylpyrrolidin-2-one or dihydrolevoglucosenone. Conversely, when the polymer solution employs water or a polar medium as the solvent, the non-solvent may be an organic liquid of low polarity such as an aliphatic hydrocarbon.

The use of a non-solvent (e.g., liquid water or vapor) in membrane fabrication allows controlled formation of microporous structures by regulating the rate and extent of phase separation. The non-solvent determines the location of the phase boundary between polymer-rich and polymer-lean regions, thereby defining the membrane's morphology, pore connectivity, and areal void fraction. In summary, a non-solvent is a liquid or a gas (water vapor) that, while compatible with the polymer solvent, destabilizes the polymer solution to precipitate the polymer and form the solid porous structure of the membrane.

In embodiments herein described the nonsolvent refers to a liquid used to induce phase separation of the cast dope solution comprising a microparticles and/or nanoparticles dispersion to form the membrane. This process is known as nonsolvent induced phase separation, or NIPS, and typically involves immersing the cast dope solution comprising a microparticles and/or nanoparticles dispersion into a coagulation bath containing the nonsolvent. A nonsolvent is selected based on its thermodynamic properties relative to the base polymer solvent, which has a Hildebrand solubility parameter (δs) In some embodiments, a nonsolvent is a liquid that is substantially incompatible with the base polymer.

The nonsolvent is selected to have a nonsolvent Hildebrand solubility parameter (δns) wherein the absolute difference between (δs) and (δns) is 7 (cal/cm³)^{1/2} or less, thereby providing a skinless symmetric filtration membrane with embedded microparticles and/or nanoparticles. In some embodiments, contacting the blend further comprises contacting the blend with a functionalizing polymer and/or a functionalizing polymer precursor for a time and under condition to allow in situ formation of microparticles and/or nanoparticles attaching a functionalizing polymer.

This controlled difference in solubility parameters promotes a more gradual, thermodynamically driven phase separation that prevents the formation of a dense skin layer. Such a nonsolvent may be referred to as a “soft” nonsolvent. For example, isopropyl alcohol (IPA) can be used as a “soft” nonsolvent for a PVDF/TEP system, resulting in delayed demixing that prevents skin layer formation and promotes a symmetric, sponge-like, and open porous structure characteristic of microfiltration membranes. In contrast, distilled water can be used as a “hard” nonsolvent for the same system. Water causes instantaneous, kinetically driven phase separation, resulting in an asymmetric morphology characterized by a dense, flow-restricting skin layer typical of ultrafiltration membranes. In other examples, a mixture, such as 50% N-methylpyrrolidone (NMP) and 50% water by volume, can be used as the nonsolvent, resulting in unique morphologies that may be dependent on particle loading.

Exemplary nonsolvent in the sense of the disclosure comprise “hard” nonsolvents such as distilled or deionized water (or H2O) and “soft” nonsolvents including alcohols (e.g., isopropyl alcohol (IPA) and mixtures of water (10-50 wt %)+solvents (90-50 wt %) such as methylpyrrolidone (NMP), DMF, DMSO and TEP, etc. that are used to dissolve the base polymer (e.g., PVDF) used to prepare the starting membrane dope solution. Fundamentally, water vapor can be considered as a “soft” nonsolvent because its lower rate of dissolution and exchange with the base polymer solvent in a VIPS environmental chamber with RH of 50-100%.

In particular, membranes cast with preformed nanoparticles can possess aggregates and clusters of nanoparticles that form through fractal growth unlike the discrete particles embedded in membranes when the particles are formed in situ (compare, e.g., FIG. 53 and FIG. 58B of related application U.S. Ser. No. 13/754,883 published as US20130213881 and FIG. 6 of related application U.S. Ser. No. 13/754,883 published as US20130213881).

In some embodiments, the membranes with embedded nanoparticles as described herein can comprise a polymeric matrix comprising a polymer network with polymeric nanoparticles made from cross-linked linear polymers made by using preformed nanoparticles. In some embodiments, the preformed particles can be added to a membrane also including microparticles and/or nanoparticles formed in situ.

In some embodiments, the membranes with embedded nanoparticles as described herein can comprise a polymeric matrix made from poly(vinylidene) fluoride (PVDF) as a base polymer, and epoxy polyethylene glycol as a functionalizing polymer with polymeric nanoparticles made from cross-linked poly(methacrylic acid) (PMAA). In particular, when the particles are premade, the PMMA can be cross-linked with either EGDMA or PEGDMA with an AIBN initiator (see, e.g., Example 14 of related application U.S. Ser. No. 13/754,883 published as US20130213881).

In some embodiments, the membranes with embedded nanoparticles as described herein can comprise a polymeric matrix made from polyether sulfone (PES) with polymeric nanoparticles made from cross-linked poly(methacrylic acid) (PMAA). In particular, when the particles are premade, the PMMA can be cross-linked with either EGDMA or PEGDMA with an AIBN initiator (see, e.g., Example 14 of related application U.S. Ser. No. 13/754,883 published as US20130213881).

In some embodiments, the membranes with embedded nanoparticles as described herein can comprise a polymeric matrix made from poly(acrylonitrile) (PAN) with polymeric nanoparticles made from cross-linked poly(methacrylic acid) (PMAA). In particular, when the particles are premade, the PMAA can be cross-linked with either EGDMA or PEGDMA with an AIBN initiator (see, e.g., Example 14 of related application U.S. Ser. No. 13/754,883 published as US20130213881).

In some embodiments, the membranes with embedded nanoparticles as described herein can comprise a polymeric matrix made from poly(ethylene terephthalate) (PET) with polymeric nanoparticles made from cross-linked poly(methacrylic acid) (PMAA). In particular, when the particles are premade, the PMAA can be cross-linked with either EGDMA or PEGDMA with an AIBN initiator (see, e.g., Example 14 of related application U.S. Ser. No. 13/754,883 published as US20130213881).

In some embodiments, the membranes with embedded nanoparticles as described herein can comprise a polymeric matrix with a polymer network component and polymeric nanoparticles made from cross-linked highly branched dendritic macromolecules made by either in situ particle formation or by using preformed nanoparticles.

In some embodiments, the membranes with embedded nanoparticles as described herein can comprise a polymeric matrix made from poly(vinylidene) fluoride (PVDF) with polymeric nanoparticles made from cross-linked poly(ethyleneimine) (PEI). In particular, when the particles are made in situ, the PEI can be cross-linked with either epichlorohydrin or 1,3-dibromopropane with a catalytic amount of HCl at 80° C. for 1 hour to form a dope with nanoparticles of cross-linked PEI. Functionalizing polymers such as epoxypolyethylene glycol or an acyl chloride can then be added under conditions allowing to link with cross-linked PEI particles.

In some embodiments, the membranes with embedded nanoparticles as described herein can comprise a polymeric matrix made from poly(vinylidene) fluoride (PVDF) with polymeric nanoparticles made from cross-linked poly(bis(methylol) propionic acid) (MPA) (for example, G3, G4, or G5 MPA). In particular, when the particles are made in situ, the MPA can be cross-linked with 1,3-diaminopropane and 1-ethyl-3-(3-dimethylaminopropyl) carbodiimide) (EDC) to form a dope with nanoparticles of cross-linked MPA. Functionalizing polymers such as epoxypolyethylene glycol or an acyl chloride can then be added under conditions allowing to link with cross-linked PEI particles.

In some embodiments, the membranes with embedded nanoparticles as described herein can comprise a polymeric matrix made from poly(methacrylic acid) (PMAA) and epoxy polyacrylate as a functionalizing polymer with polymeric nanoparticles made from cross-linked poly(ethyleneimine) (PEI). In particular, when the particles are made in situ, the PEI can be cross-linked with either epichlorohydrin or 1,3-dibromopropane with a catalytic amount of HCl at 80° C. for 1 hour to form a dope with nanoparticles of cross-linked PEI.

In some embodiments, the membranes with embedded nanoparticles as described herein can comprise a polymeric matrix made from poly(methacrylic acid) (PMAA) and epoxy polyethylene glypolyacrylate as a functionalizing polymer with polymeric nanoparticles made from cross-linked poly(bis(methylol) propionic acid) (MPA) (for example, G3, G4, or G5 MPA). In particular, when the particles are made in situ, the MPA can be cross-linked with 1,3-diaminopropane and 1-ethyl-3-(3-dimethylaminopropyl) carbodiimide) (EDC) to form a dope with nanoparticles of cross-linked MPA.

In some embodiments a dope comprising a polymer forming the polymer matrix herein described including a polymer network component in which polymeric nanomaterial is embedded can be used to provide nanofibers and/or microfibers.

In particular, in some embodiments the dope solution comprising a dispersion of microparticles and/or nanoparticles herein described can be used in a method of making a nano and/or micro fibers with embedded polymer nanoparticles, and in particular with embedded dendritic nanoparticles, herein described.

In some embodiments, the method comprises contacting a polymeric component, a dendritic component, a cross-linking component, and a solvent for a time and under a condition to permit the in situ formation of dendritic nanoparticles to provide a dope solution; comprising a dispersion of microparticles and/or nanoparticles and spinning the dope solution to provide a nanofiber or microfiber herein described. In particular, in some embodiments, the polymeric component and dendritic component are contacted to form a blend and the cross-linking agent is added to the blend to allow in situ formation of dendritic nanoparticles and obtain the dope before the spinning. In some embodiments, the nanoparticles are preformed and then added to the polymer for an ex situ formation according to methods and systems herein described to provide a dope dispersion that is then spun to provide a nano-fiber and/or microfiber herein described.

In some embodiments, the nanofibers with embedded polymeric nanoparticles can be electrospun onto a support layer (e.g. a PET non-woven fabric; see e.g. Example 2 of related application U.S. Ser. No. 14/447,574 published as US20150053610 incorporated herein by reference). Then a nanofibrous composite membrane can be fabricated as described in U.S. Ser. No. 13/570,221 published as US20130112618 incorporated by reference in its entirety.

A “support layer” in the sense of the present disclosure is an aggregate material comprising a polymer component configured to strengthen the membrane structure. Suitable polymers to be included in support layers comprise, for example, poly(vinylidene) fluoride (PVDF), poly(tetrafluoroethylene) (PTFE), poly(acrylonitrile) (PAN), poly(methyl methacrylate) (PMMA), poly(methacrylic acid) (PMAA), poly(acrylic acid) (PAA), poly(vinyl methyl ketone), and poly(ethylene terephthalate) (PET) which can be aggregated by inverse casting the polymer or by electrospinning. In some embodiments the support layer includes pores. In some embodiments, the support layer can be functionalized with a dendrimer component. In other embodiments, after a nanofibers and/or microfibers with embedded dendritic nanoparticles are electrospun onto a support layer, a further support layer can be electrospun to provide a top support layer for providing additional strength or for creating a bipolar membrane. In some embodiments, the support layer can comprise or be formed by a polymer matrix with embedded polymer nanoparticles, and in particular dendritic nanoparticles, in accordance with the present disclosure.

Accordingly, in some embodiments a filtration membrane can comprise a plurality of nano and/or micro fibers, wherein at least one of the nano and/or micro fibers comprises polymeric nanoparticles embedded in a polymeric component. The plurality of nano and/or micro fibers can be attached to a support layer and/or a polymer matrix comprising embedded polymer nanoparticles and in particular dendritic nanoparticles herein described. Additional layers such as a separation layer or a further support layer can also be comprised as will be understood by a skilled person.

In some embodiments a filtration membrane can comprise a polymer matrix comprising embedded polymeric microparticles and/or nanoparticles herein described attaching a nano- and/or microfiber. Additional layers such as a separation layer or a further support layer can also be comprised as will be understood by a skilled person.

In some embodiments, the nanofiber and/or microfiber can comprise a polymeric nanoparticle embedded in a polymeric component as described herein. In some embodiments other kind of nanofibers and/or microfibers can be comprised in filtration membranes herein described in the alternative or in addition to a nano fiber and/or microfiber with embedded nanoparticles. In particular in some of those embodiments, another kind of nano-fiber and/or microfiber that can be comprised in a filtration membrane herein described can comprise a scaffold component providing a supporting framework for one or more additional components attached to the scaffold providing functionalities to the scaffold and in particular to a dendrimer component as described in U.S. patent application Ser. No. 13/570,221, published as US20130112618 incorporated by reference in its entirety. The scaffold component and the additional components define features of the nanofiber and microfiber such as a diameter (or radius), a mechanical strength, chemical stability, functionalization and chemical properties which are detectable using techniques and process identifiable by a skilled person. Additional details concerning the nano-fiber and/or microfiber comprising a scaffold component and a dendrimer component are described in U.S. patent application Ser. No. 13/570,221 published as US 21013 0112618 incorporated by reference in its entirety.

In some embodiments the polymeric nanoparticles embedded in the polymeric component of the nanofiber or microfiber and/or presented on the scaffold component of the nano-micro-fiber can comprise reactive sites, and the reactive sites can be positively and/or negatively charged.

In some embodiments, in the filtration membrane, the plurality of nanofibers and/or microfibers can be arranged in a mesh structure forming a layer comprised in the membrane, alone or in combination with additional layers. In some embodiments, the plurality of nanofibers and/or microfibers are arranged in a substantially parallel configuration, in particular in some of these embodiments, one or more nanofibers and/or microfibers of the plurality of the nanofibers and/or microfibers are hollow.

In particular, in some embodiments microfiber and/or nanofiber herein described can be comprised as a composite material layer having a mesh structure comprised in the filtration membrane alone or in combination with one or more additional layers.

The term “composite material” as used herein refers to a heterogeneous material made from two or more different materials, the materials having different chemical and/or physical properties and remaining as separate and distinct materials within the composite material. For example, according to embodiments herein described, a composite material can comprise a polymer component and a dendritic nanoparticle which is structurally different from the polymer component and is embedded in the polymer component. The composite material according to some embodiments can comprise a semi-permeable barrier made of overlapping strands of nanofibers.

In particular, the composite material comprising a plurality of nanofibers and/or microfibers can comprise a plurality of a same type of fiber or of two or more different types of fibers. In some embodiments, fibers can be covalently cross-linked to one another. In some embodiments, nanofibers and/or microfibers comprised in the composite material can comprise hollow fibers herein described.

In embodiments herein described, wherein a membrane comprise a mesh, the features of the mesh such as dimension of the pores of the mesh structure, the strength and resistance of the mesh and chemical compatibility of the mesh can be controlled by selection of the diameter of the nanofiber or microfiber, number and configuration of the nanofiber and/or microfiber forming the mesh and the specific polymer component and dendrimer component of each fiber as will be understood by a skilled person upon reading of the present disclosure.

Also described herein is a bicomposite membrane, which comprises a plurality of nanofibers and/or microfibers herein described attached to a polymer matrix formed by a porous polymeric aggregate comprising polymeric nanoparticles. In particular, in some embodiments, the polymeric nanoparticles are embedded in the porous polymer aggregate (e.g., by in situ particle formation as herein described).

In particular, in some embodiments, the nanofibers and/or microfibers in the bicomposite membrane can comprise dendritic nanoparticles embedded (e.g. through in situ particle formation as herein described) in a polymer matrix as described herein. In some embodiments, the nanofibers and microfibers comprising embedded nanoparticles can be hollow. In some embodiments the polymeric nanoparticles embedded in the polymeric component of the nanofiber or microfiber comprises reactive sites, and the reactive sites can be positively and/or negatively charged.

In particular, in some embodiments, the nanofibers and/or microfibers in the bicomposite membrane comprise a scaffold component providing a supporting framework for one or more additional components attached to the scaffold providing functionalities to the scaffold. The scaffold component and the additional components define features of the nanofiber and microfiber such as a diameter (or radius), a mechanical strength, chemical stability, functionalization and chemical properties which are detectable using techniques and process identifiable by a skilled person. The features of nanofibers and microfibers in the sense of the present disclosure which can also be controlled by modifying the chemical composition and structure of the fiber during manufacturing of the fiber according to techniques identifiable by a skilled person upon reading of the present disclosure. In particular, in some embodiments, the scaffold component comprises a polymeric component providing a fiber scaffold and the additional component comprises a dendritic component attached to the polymeric component to present reactive sites on the fiber scaffold (see, e.g., FIG. 63 of related application U.S. Ser. No. 13/754,883 published as US20130213881).

In some embodiments, in the bicomposite membrane, the plurality of nanofiber and/or microfiber are arranged in a mesh structure forming a layer comprised in the membrane, alone or in combination with additional layers. In some embodiments, the plurality of nanofiber and/or microfibers are arranged in a substantially parallel configuration, in particular in some of these embodiments, one or more nanofibers and/or microfibers of the plurality of the nanofibers and/or microfibers are hollow.

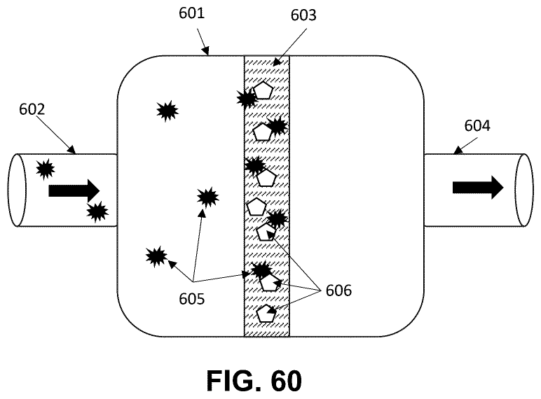

In particular, in some embodiments, the plurality of nanofibers and/or microfibers is directly attached to polymer matrix formed by a porous polymeric aggregate comprising polymeric nanoparticles (e.g. by forming a polymer aggregate comprising polymeric nanoparticles by in situ particle formation as herein described and electrospinning the nanofibers and/or microfibers directly only the polymer aggregate comprising polymeric nanoparticles). In other embodiments, the plurality of nanofibers and/or microfibers is attached to a support layer (e.g. a PET non-woven fabric) and the support layer is further attached to porous polymeric aggregate comprising polymeric nanoparticles (e.g. by casting a membrane comprising porous polymeric aggregate with embedded polymeric nanoparticles on a support layer and then electrospinning the nanofibers and/or microfibers onto the side of support layer opposite to the membrane comprising porous polymeric aggregate with embedded polymeric nanoparticles; see e.g. Examples 1 and 2 of related application U.S. Ser. No. 14/447,574 published as US20150053610 incorporated herein by reference and for the casting procedure in in situ methods Examples 2, 20 and FIGS. 59 and 60 of related application U.S. Ser. No. 13/754,883 published as US20130213881).

In some embodiments a filtration membrane comprises a layer of the composite material according to the disclosure in combination with one or more additional layers. The additional layers can include, for example, a support layer and/or a separation layer (see e.g. Examples 22-24 and FIGS. 62 and 63 of related application U.S. Ser. No. 13/754,883 published as US20130213881). In embodiments wherein filtration membrane herein described comprise one or more composite material layers and one or more additional layers, the one or more composite material layers and the additional layers can be comprised in the filtration membrane in various configurations as will be understood by a skilled person upon reading of the present disclosure.

For example in some embodiments one or more composite layers can be comprised between two functionalized or unfunctionalized supporting layers. In some embodiments, one or more composite layers can be comprised between a supporting layer and a coating layer. In some of these embodiments a functionalized supporting layer can be further attached to the coating layer. In some embodiments a coating layer can be comprised between one or more composite layers a functionalized supporting layer. Additional configurations can be identified by a skilled person. In particular, selection of a configuration of the membrane can be performed by a skilled person in view of the polymer component and dendrimer component forming the composite material and/or the support layer and/or coating layer and in view of a desired selection of one or more chemicals to be filtered. (see e.g. U.S. patent application Ser. No. 13/570,221 published as US 2013 0112318).

In some embodiments, where the filtration membrane comprises a composites material layer with one or more additional layers, the polymer component and the dendritic component of the one or more composite material layers and/or of the one or more additional layer can be either the same or different. In some of these embodiments, the polymer component can be polysulfone (PS), polyether sulfone (PES), poly(vinylidene) fluoride (PVDF), poly(acrylonitrile) (PAN), poly(methyl methacrylate) (PMMA), poly(methacrylic acid) (PMAA), poly(acrylic acid) (PAA), and/or poly(vinyl methyl ketone). In some of these embodiments the dendrimer component can be a highly branched dendritic macromolecule selected from the group consisting of generation-3 poly(amidoamine) (PAMAM) dendrimer, generation-4 poly(amidoamine) (PAMAM) dendrimer, generation-5 poly(amidoamine) (PAMAM) dendrimer, generation-3 poly(propyleneimine) (PPI) dendrimer, generation-4 poly(propyleneimine) (PPI) dendrimer, generation-5 poly(propyleneimine) (PPI) dendrimer, generation-3 poly(bis(methylol) propionic acid) (MPA) dendrimer, generation-4 poly(bis(methylol) propionic acid) (MPA) dendrimer, generation-5 poly(bis(methylol) propionic acid) (MPA) dendrimer, generation-3 poly(ethyleneimine) dendrimer, generation-4 poly(ethyleneimine) dendrimer, generation-5 poly(ethyleneimine) dendrimer, and hyperbranched poly(ethyleneimine), or aggregate nanostructures and/or microstructure thereof.

In situ functionalized symmetric skinless membrane adsorbers of the disclosure can be used in connection with a method and a system for removing target solutes from a fluid.

The “target solutes” are defined as the specific chemical, ionic, or biological species within a fluid that the membrane adsorber is engineered to capture and remove. Generically, this category includes any substance for which the in-situ functionalized microparticles have a high selective affinity. The nature of the target solute is therefore determined by the specific functional groups installed on the microparticles during the in-situ functionalization step. For example, membranes functionalized with Strong Base (SB) Anion Exchange (AEX) groups target negatively charged solutes, such as host cell proteins (HCPs), DNA, viruses, and endotoxins. Conversely, membranes with Cation Exchange (CEX) groups target positively charged solutes, including protein aggregates or, in some applications, monoclonal antibody (mAb) products. Membranes with Hydrophobic Interaction Chromatography (HIC) groups target solutes with exposed hydrophobic regions, such as protein aggregates, while membranes with Fluorophilic groups target fluorinated compounds, notably environmental contaminants like Per- and Polyfluoroalkyl Substances (PFAS).

The method comprises providing an in-situ functionalized skinless symmetric membrane adsorber as described herein, said membrane adsorber comprising a porous polymeric body having a symmetric skinless microfiltration (MF) morphology and a plurality of in-situ functionalized polymeric microparticles embedded therein. Said in-situ functionalized microparticles comprise functional groups selected from the group consisting of: Strong Base (SB) Anion Exchange (AEX) groups, Cation Exchange (CEX) groups, Hydrophobic Interaction Chromatography (HIC) groups, Chelating groups and Fluorophilic groups.

The method further comprises contacting said membrane adsorber with a fluid containing one or more target solutes, such as proteins, DNA, host cell impurities, viruses, or Per- and Polyfluoroalkyl Substances (PFAS). The fluid is passed through the membrane adsorber, wherein the symmetric skinless microfiltration (MF) morphology provides a low-fouling, open structure that permits the fluid to pass via high-speed convective transport at a low operating pressure. The target solutes, which can be substantially smaller than the microfiltration-scale pores of the membrane, are thereby transported to the embedded functionalized particles and are removed from the fluid by adsorption onto said functional groups. This method combines the high-throughput, low-fouling advantages of microfiltration with the high-capacity, selective binding of a membrane adsorber.

The system for removing target solutes from a fluid comprises, as its central component, an in-situ functionalized skinless symmetric membrane adsorber. Said membrane adsorber comprises a porous polymeric body having a symmetric skinless microfiltration (MF) morphology and a plurality of in-situ functionalized polymeric microparticles embedded therein, wherein said in-situ functionalized microparticles comprise functional groups selected from the group consisting of: Strong Base (SB) Anion Exchange (AEX) groups, Cation Exchange (CEX) groups, Hydrophobic Interaction Chromatography (HIC) groups, Chelating groups and Fluorophilic groups.

The system further comprises a housing configured to hold said membrane adsorber, an inlet in fluid communication with a first side of the membrane adsorber to receive a fluid containing one or more target solutes (e.g., proteins, DNA, host cell impurities, viruses, or Per- and Polyfluoroalkyl Substances (PFAS)), and an outlet in fluid communication with a second side of the membrane adsorber to discharge a permeate stream having a reduced preferably minimized concentration of said one or more target solutes.

In operation, the symmetric skinless microfiltration (MF) morphology of the membrane adsorber permits the fluid to be passed through the system via high-speed convective transport at a low operating pressure, thereby mitigating fouling, while the target solutes are removed from the fluid by adsorption onto the high-capacity, in-situ functionalized polymeric microparticles. In some embodiments, the system further comprises a pump to drive the fluid through the membrane adsorber. In other embodiments, the system is configured as a chromatography cartridge, a spin-filter, or a cross-flow filtration module.

According to a further embodiment of the disclosure, a filtration system is described. The filtration system comprises a plurality of modules, each module comprising one or more of the filtration membranes for pretreatment of water according to embodiments herein described, charged particle rejection of water, and charged particle adsorption of water is described.

The term “module” as used herein refers to a compartment comprising a filtration membrane according to the disclosure, adapted to be used in connection with other modules to perform parallel and/or sequential filtrations.

In particular, in some embodiments, a module herein described can comprise one of the filtration membranes herein described through which water can pass. For example, if the membrane in a module is charged particle rejecting, it can remove charged particles from the water passing through the membrane in the module such that the charged particles are reduced and/or substantially eliminated from water exiting the membrane. As another example, if the membrane in a module is charged particle absorbing, it can absorb charged particles from the water passing through the membrane in the module such that the charged particles are reduced or eliminated from water exiting the membrane.

−>Na₂SO₄, respectively.

In some embodiments, in particular when one or more functionalizing polymer are hydrophilic membranes according to the disclosure can be fouling resistant and high flux membranes with respect to known conventional membrane. Mixed matrix membranes (MMMs) with embedded functional nanomaterials/particles can carry out multiple functions (e.g. retention, sorption, catalysis and charge transport) with improved properties and performance including higher permselectivity and flux, greater mechanical strength and lower fouling propensity in water filtration applications and in particular in application where harvesting of microalgae and possibly subsequent downstream processing into a useful product (e.g. biofuel) is desired.

In some embodiments, the filtration membranes and related compositions methods and systems herein described can be provided without the addition of the functionalizing polymers to provide a polymer matrix formed by a porous polymeric aggregate of the base polymer in which polymeric microparticles and/or nanoparticles are embedded. In particular in embodiments where the polymeric network formed by the functionalizing polymers are absent can include microparticles and/or nanoparticles formed in situ and/or ex situ as described in U.S. patent application Ser. No. 13/570,221 published as US 2013 0112318 incorporated herein by reference in its entirety.

Further advantages and characteristics of the present disclosure will become more apparent hereinafter from the following detailed disclosure by way or illustration only with reference to an experimental section.

### Examples

The polymeric membranes with embedded polymeric micro/nanoparticles and polymeric network and related methods and systems herein described are further illustrated in the following examples, which are provided by way of illustration and are not intended to be limiting.

In particular, the following examples illustrate exemplary symmetric skinless polymeric membranes with embedded polymeric micro/nanoparticles and related methods and systems. A person skilled in the art will appreciate the applicability and the necessary modifications to adapt the features described in detail in the present section, to additional polymeric membranes with embedded polymeric micro/nanoparticles and related methods and systems according to embodiments of the present disclosure.

In particular Examples 1~4 are provided to illustrate the influence of nonsolvent and mixed matrix composition on membrane morphology with the following materials and methods

Materials; Polyvinylidene Fluoride (PVDF; Kynar 761, 400 kg/mol) was obtained from Arkema. Hyperbranched polyethylenimine (PEI; 600 g/mol) was purchased from Polysciences. The following chemicals were purchased from Sigma Aldrich: Epichlorohydrin (ECH), Isopropanol (IPA), Triethyl phosphate (TEP), and N-methylpyrrolidone (NMP). Nonwoven PET support (Nonwoven media 3324; https://www.kavonfilter.com/product/hollytex-nonwoven-media-item⁻³³²⁴/) was purchased from Hollytex. All chemicals were used as received.

Membrane Synthesis; To begin a typical membrane synthesis, 5.91 g of PVDF was added to an empty 3-neck flask. The flask was then outfitted with an overhead mechanical stirrer and the necessary greased connectors. Next, 30 mL of TEP was added to the flask and then the remaining openings were sealed using rubber septa. The PVDF/TEP mixture was heated to 80° C. for an hour with no mixing before the mixing speed was set to 60 rpm. The resulting solution was mixed overnight at 60 rpm and 80° C. During the heating of the PVDF/TEP mixture, the PEI/TEP solution was prepared by adding the desired mass of PEI (Table 5) to a scintillation vial followed by 5 mL of TEP. The mixture was vortexed until the solution was homogeneous and clear, and then it was left to equilibrate overnight at room temperature.

Once the solutions were equilibrated, the flask was purged with N₂ for 7 minutes, and the mixing speed was increased to 250 rpm. With the N₂ flow still on, the PEI solution was added dropwise to the flask using a glass Pasteur pipette over the course of 4 minutes. The resulting solution was left to mix for 5 minutes before adding 17 drops of concentrated HCl (37% solution), after which the solution turned cloudy. Following the addition of the HCl, the flask was incubated for 15 minutes at 80° C. with the mixing speed maintained at 250 rpm. The required amount of ECH (Table 5) was then added to the flask, the N₂ flow was turned off, and the polymerization reaction was allowed to proceed for 4 hours.

TABLE 5
Membrane formulation for different PEI loadings

| | PVDF | PEI | TEP | ECH |
|---|---|---|---|---|
| Formulation | (g) | (g) | (mL) | (mL) |
| Neat | 5.66 | — | 30 | — |
| 06 | 5.91 | 0.26 | 35 | 0.14 |
| 21 | 5.91 | 1.1 | 35 | 0.60 |
| 38 | 5.91 | 2.6 | 35 | 1.4 |
| 48 | 5.91 | 3.9 | 35 | 2.1 |
| 54 | 5.91 | 5.0 | 35 | 2.7 |
| 60 | 5.91 | 6.5 | 35 | 3.5 |

After the 4-hour reaction time, the flask was put under in-house vacuum for 10 minutes to remove entrapped gas. The dope dispersion was then cast either on glass to prepare samples for structural characterization (SEM and X-ray scattering) or on a nonwoven PET support for transport measurements. The mixture was spread uniformly using a doctor blade with a blade height of 300 μm. The cast mixture was left at room temperature for 30 seconds before immersion into a coagulation bath at room temperature. The coagulation bath comprised one of the following: distilled water, Isopropanol, or 50 v % N-methylpyrrolidone solution in water (abbreviated as NMP:H2O here after). After two hours, the solidified membranes were moved to distilled water baths prior to storage in distilled water.

SEM characterization The membrane top surface and cross-section were imaged using a Field Emission Scanning Electron Microscope (FE SEM-Zeiss 1550 VP). In preparation for imaging, the membrane samples were first dried at room temperature for 24 hours. Next, the samples were dried under house vacuum for 24 hours. To prepare the cross-section view, the chosen samples were immersed in liquid nitrogen for 2 minutes and then fractured. All samples were then coated with a Pt/Pd conductive layer on the surface of interest prior to imaging. The resulting micrographs were used to characterize sample morphology and, for cross-sections, estimate sample thickness. Mean particle size and particle size distribution of each condition was then determined by measuring the diameter of 100 particles in the cross-section images.

X-ray scattering X-ray scattering measurements were performed at beamline 5-ID-D of the Advanced Photon Source at Argonne National Laboratory. The beamline collects both wide-angle x-ray scattering (WAXS) and small-angle x-ray scattering (SAXS) patterns simultaneously. The optimum exposure time for the samples scanned being 0.5 s and 0.005 s, respectively. The membrane samples were cut into coupons approximately 10 mm×10 mm and mounted onto a backing board in preparation for the measurements, five point on each sample. The first measurement near the center of the sample, and the next four at points on a circle of radius 2.5 mm about the center in 90° increments, moving clockwise. Background scans as empty sample openings were taken at regular intervals.

Water flux measurements Samples for flux measurements were prepared by cutting a 45 mm×90 mm rectangular coupon from a membrane cast on the nonwoven PET support. The samples were then loaded into a cross-flow filtration chamber with an active area of 18.75 cm². The membranes were conditioned for 90 minutes at a pressure of 3 bar and a cross-flow rate of 1.7 L/min using distilled water to permit any compaction to occur and stabilize prior to measurement. Following membrane compaction, the operating pressure was changed to 2 bar while the cross-flow rate was maintained constant. The permeate mass was measured every 5 minutes for 90 minutes, and recorded values were used to calculate membrane flux. All samples were tested using distilled water as feed.

Examples 5-9 are provided to illustrate the mixed membrane chromatography performed with exemplary symmetric skinless membranes of the present disclosure with the following materials and methods.

Materials Polyvinylidene Fluoride (PVDF; Kynar 761, 400 kg/mol) was obtained from Arkema. Hyperbranched polyethylenimine (PEI; 600 g/mol) was purchased from Polysciences. The following chemicals were purchased from Sigma Aldrich: Epichlorohydrin (ECH), Di(ethylene glycol) diacrylate (EGA), Bis(2-chloroethyl)amine hydrochloride (BCAH), Isopropanol (IPA), Triethyl phosphate (TEP), Dimethyl sulfoxide (DMSO), TRIShydrochloride (TRIS), Glycerol, and Bovine Serum Albumin (BSA). The 1×PBS solution (Corning 21-040-CV) was purchased from VWR. All chemicals and materials were used as received. All buffers were prepared using indicated chemicals and distilled water.

Membrane Synthesis To begin a typical membrane synthesis, 5.91 g of PVDF was added to an empty 3-neck round bottom flask. The flask was fitted with an overhead mechanical stirrer and the necessary greased connectors. Thirty mL of TEP was then added to the flask and the remaining openings were sealed using rubber septa. The PVDF/TEP mixture was heated to 80° C. for an hour before the mixing speed was set to 60 rpm. The resulting solution was left to equilibrate overnight. A PEI/TEP solution was prepared by adding 5 g of PEI to a scintillation vial followed by 5 mL of TEP. The mixture was vortexed until a homogeneous clear solution was obtained and then it was left to equilibrate overnight at room temperature. For membranes with BCAH as the crosslinker, the crosslinker solution was prepared by weighing the required amount of BCAH into a scintillation vial and then adding the corresponding volume of DMSO (Table 6).

TABLE 6
Crosslinker solution composition with the corresponding
Normalized Crosslink Density and membrane formulation.

| | | Crosslinker | | Volume of |
|---|---|---|---|---|
| Formulation | Crosslinker | mass(g) | NCD | DMSO (mL) |
| 54A | ECH | 3.2 | 1 | — |
| 54B | ECH | 1.6 | 0.5 | — |
| 54C | ECH | 0.8 | 0.25 | — |
| 54D | EGA | 7.4 | 1 | — |
| 54E | EGA | 3.7 | 0.5 | — |
| 54F | EGA | 1.8 | 0.25 | — |
| 54G | BCAH | 6.2 | 1 | 8 |
| 54H | BCAH | 3.1 | 0.5 | 5 |
| 54I | BCAH | 1.6 | 0.25 | 2.5 |

DMSO was chosen as the solvent due to its compatibility with the other components of the dope dispersion and TEP's inability to dissolve BCAH. The resulting mixture was incubated overnight at room temperature to fully dissolve the BCAH.

The crosslink density (CD), defined as the molar ratio of ECH to PEI, was used as a surrogate for the degree of crosslinking of the PEI microparticles in the membrane casting dispersions. The initial CD was taken from Kotte and Diallo and kept constant to examine the effects of nonsolvent and PEI loading: all formulations in Table 6 have CD≈4, corresponding to a 28 wt. % ECH crosslinker in the PEI microparticles. This CD value was taken as a reference value (ref) and used to define a normalized crosslinked density (NCD) as given below:

$$NCD = \frac{[ Moles of crosslinker ] / [ Moles of PEI ]}{[ Moles of crosslinker ] ref / [ Moles of PEI ] ref}$$

Once the solutions were equilibrated, the flask was purged with N₂ for 7 minutes and the mixing speed was increased to 250 rpm. With the N₂ flow still on, the PEI solution was then added dropwise to the flask using a glass Pasteur pipette over the course of 4 minutes. The resulting solution was left to mix for 5 minutes before adding 0.43 mL of concentrated HCl (37% solution). Following the addition of the HCl, the flask was incubated for 15 minutes at 80° C. with the mixing speed maintained at 250 rpm. The crosslinker solution corresponding to the desired normalized crosslink density (NCD) in Table 6, calculated using the equation above, was then added to the flask and the polymerization reaction was allowed to proceed for 4 hours. After the 4-hour reaction time, the flask was put under in-house vacuum for 10 minutes to remove entrapped air. The membranes were then cast on glass plates using a doctor blade with a blade height of 300 μm. The cast membranes were left at room temperature for 30 seconds before being immersed in an Isopropanol coagulation bath. After two hours, the solidified membranes were moved to distilled water baths prior to storage.

SEM characterization the same SEM characterization method used for the first set of experiments were used for the second set of experiments.

Protein binding experiments: Static protein binding experiments were performed for all formulations in Table 6. The two formulations with the highest binding (54E & 54H) were then used to test salt tolerance in water and the buffers listed in Table 7.

TABLE 7
Composition of buffers used during salt tolerance measurements.

| | T-00 | T-05 | T-10 | T-15 | T-20 | P-05 | P-10 | P-1G |
|---|---|---|---|---|---|---|---|---|
| Buffer | TRIS¹ | TRIS¹ | TRIS¹ | TRIS¹ | TRIS¹ | PBS² | PBS³ | PBS³ |
| Chemistry | | | | | | | | |
| Added NaCl | 0 | 50 | 100 | 150 | 200 | — | — | — |
| (mM) | | | | | | | | |
| Glycerol (mM) | — | — | — | — | — | — | — | 50 |
| Conductivity | 4.6 | 9.8 | 15 | 19.5 | 24.7 | 9.1 | 17.6 | 18 |
| (mS/cm) | | | | | | | | |

Table 7 describes the composition of buffers used during salt tolerance measurements. Each buffer had a pH of 7.4 and the following concentrations of the buffer chemistry: 1-50 mM TRIS, 2-0.5×PBS, and 3-1×PBS. A 1×PBS buffer contains 137 mM NaCl, 2.7 mM KCl, 10 mM Na₂HPO₄, and 1.8 mM KH₂PO₄.

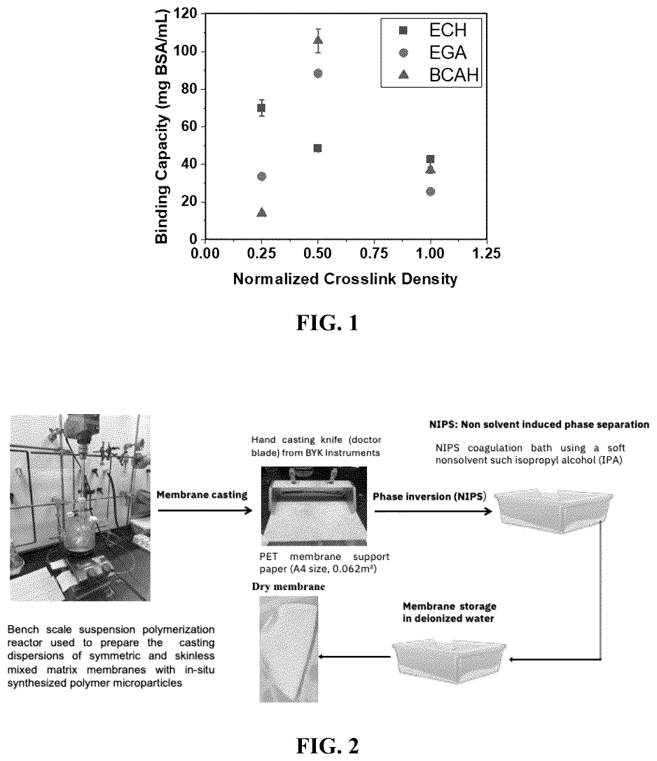

The static binding capacity (SBC) experiment operated as follows. A 2 mg BSA/mL solution was prepared by dissolving BSA in the appropriate solvent as outlined in Table 7. A 12 mm×12 mm sample token was then cut out of the membrane of interest and immersed in 5 mL of the BSA solution. The solution was rocked gently for 48 hours before the absorbance at 280 nm was measured using an Agilent 8453 UV/vis spectrometer. The concentration of BSA in the solution was then estimated using an absorbance/concentration calibration curve. The mass of BSA bound was then determined using a mass balance, while the membrane volume was calculated using the sample thickness determined via SEM imaging. Replicates of each formulation were tested with the average binding capacity and standard deviations reported in FIG. 1.

Dynamic protein binding experiments used membranes with formulation 54H because they demonstrated the best binding capacity in the presence of salt. The dynamic binding measurements were performed using a precision adsorption flow-through cell with operating volume of 80 μL from Hellmanex using time-resolved UV-vis spectroscopy. The measurements were performed as follows.

A 2 mg/mL BSA solution was prepared by dissolving BSA in 50 mM TRIS buffer with varying salt concentrations (0, 50, 100, 150, and 200 mM respectively). Flat sheet membranes were cut into circle tokens with a diameter of 25.4 mm, hereafter referred to as samples, while they were still wet. The prepared samples were stored in 50 mM TRIS buffer.

A nonwoven PET support was also cut into circles with a diameter of 25.4 mm. A control measurement was taken by loading one layer of the PET support into the sample holder and then introducing the BSA feed solution at a constant flowrate. The time-resolved absorbance at 280 nm was captured using a UV-vis spectrometer. The sample was then loaded into the sample holder on top of a fresh PET support to account for any nonspecific binding to the nonwoven support. The sample was equilibrated to the feed solution using the appropriate buffer. Once the sample was equilibrated, the BSA feed solution was introduced at a constant flowrate using a syringe pump. The flowrates investigated in these experiments were 0.3, 0.6, 1.2, & 1.5 mL/min, corresponding to 2, 4, 8, & 10 membrane volumes/minute, respectively. The lowest flowrate (0.3 mL/min, 2 MV/min) was only measured in TRIS buffer with 0 mM NaCl. The mass of BSA bound by the membrane was then calculated by taking the difference in the mass of BSA loaded between the sample and the control at 10% breakthrough.

Examples 10-19 are provided to illustrate exemplary symmetric skinless membranes of the present disclosure as a platform for flow through, high capacity, weak base and salt tolerant anion exchange membrane adsorbers for downstream bioprocessing with the following materials and methods.

Chemicals and Materials Polyvinylidene difluoride (PVDF; Kynar 761, 400 kg/mol) was provided by Arkema. Branched polyethylenimine (PEI; 600 g/mol) was purchased from Polysciences. Epichlorohydrin (ECH), diethylene glycol diacrylate (EGA), bovine serum albumin (BSA), bis(2-chloroethyl)amine hydrochloride (BCAH), triethyl phosphate (TEP), isopropanol (IPA), dimethyl sulfoxide (DMSO), and tris(hydroxymethyl)aminomethane hydrochloride (TRIS-HCl) were purchased from Millipore Sigma. Hydrochloric acid (HCl) was purchased from EMD Millipore. Nonwoven polyethylene terephthalate (PET) membrane support (approximately 135 μm thick) was purchased from Hollytex. All chemicals and materials were used as received. All aqueous solutions were prepared using distilled water. The following series of buffered (pH 7.4) salt solutions were prepared using TRIS-HCl and distilled water: “T-00”, 50 mM TRIS; “T-05”, 50 mM TRIS+50 mM NaCl; “T-10”, 50 mM TRIS+100 mM NaCl; “T-15”, 50 mM TRIS+150 mM NaCl; and “T-20”, 50 mM TRIS+200 mM NaCl.

Membrane Preparation The preparation of the mixed matrix PVDF-PEI membrane adsorbers with in-situ synthesized PEI microparticles was carried out by adapting and modifying the one-pot and single step phase inversion casting process of Kotte and Diallo [14, 15] as described by Bateman [16].

### Casting Solutions

A typical membrane casting solution was prepared by first adding 5.91 g of Kynar 761 PVDF polymer to an empty three-neck round-bottom flask outfitted with an overhead EUROSTAR 60 control mechanical stirrer from IKA with a speed range of 0/30-2000 rpm. The flask was immersed in an oil-bath placed on top of a Chemglass Optichem hot plate. Next, 30 mL of triethyl phosphate (TEP) was added to the flask which was sealed with a rubber septum. The PVDF+TEP mixture was heated to 80° C. for 1 hour without mixing followed by overnight mixing at 60 rpm and 80° C.

### In-Situ Generation of PEI Microparticles in the Casting Solutions

In a typical casting experiment, a solution of the functional particle precursor, branched polyethyleneimine (PEI) with a molar mass of 600 g/mol, was first prepared by adding the required amount of PEI polymer to a scintillation glass vial containing 5 mL of TEP. Next, the vial was placed on a VWR Scientific Vortex-Genie 2 mixer and homogenized to produce a clear solution of PEI+TEP which was left to equilibrate overnight at room temperature. Prior to the initiation of the in-situ generation of the PEI microparticles, the volumetric flask containing the PVDF+TEP casting solution was purged with nitrogen (N₂) gas for ~10 minutes at 250 rpm and 80° C. The PEI+TEP solution was then added dropwise to the flask containing the casting solution with N₂ purge still ongoing over the course of ~5 minutes using a glass Pasteur pipette. After mixing for 5 minutes, a catalytic amount of hydrochloric acid (HCl; 0.7 mL of a 12.1 M HCl solution) was added dropwise to the casting solution of PVDF+PEI+TEP (~40 m¹) using a glass Pasteur pipe, after which the solution turned cloudy. Following the addition of the HCl, the casting dispersion was incubated for 15 minutes at 250 rpm and 80° C. with the N₂ purge still ongoing. For the preparation of a mixed matrix PVDF membrane with in-situ generated and ECH crosslinked PEI particles, the desired amount of epichlorohydrin (ECH) crosslinker was added to the PVDF+PEI+TEP casting solution. The final PVDF+PEI+ECH+TEP casting dispersion was left to react under continuous mixing at 250 rpm for 4 hours with the N₂ purge turned off. A similar procedure was utilized to prepare the casting dispersions for other crosslinkers [diethylene glycol diacrylate (EGA) or bis(2-chloroethyl)amine hydrochloride (BCAH)]. Because attempts to dissolve BCAH in TEP were not successful, dimethyl sulfoxide was selected (DMSO) as the solvent for BCAH due to its compatibility with the other components of the membrane casting dispersions. Therefore, for mixed matrix PVDF membranes with BCAH crosslinked PEI particles, the crosslinker was added as to the casting dispersions as a solution in DMSO (i.e., by dissolving the desired amount of BCAH into a vial containing the required amount of DMSO.

### Membrane Casting

Nonsolvent induced phase separation (NIPS) with distilled water or isopropanol (IPA) as nonsolvent to prepare a series of mixed matrix PVDF-PEI membranes. These membranes were prepared with and without PET nonwoven fabric supports. To prepare a PVDF-PEI membrane without PET support, a casting dispersion with in-situ synthesized PEI particles was poured onto a clean glass plate. A film casting knife (lab doctor blade) from BYK Instruments (with a blade height of 300 μm) was used to uniformly coat the casting dispersion onto the glass plate. The nascent membrane was kept at room temperature for 30 seconds before immersion into a coagulation bath at room temperature. After 2 hours of immersion into the coagulation bath, the solidified membrane was removed from the glass plate and stored in distilled water. Membranes without PET supports were used for morphology studies. A similar procedure was used to prepare a membrane with PET support: a PET support (approximately 135 μm thick) was placed on a clean glass plate, the casting dispersion was poured onto the PET support and a doctor blade with a blade height of 300 μm was used to uniformly coat the PET support, the cast membrane was kept at room temperature for 30 s and then immersed into the coagulation bath to solidify for 2 hours, then stored in distilled water. Membranes with PET supports were used for both flux measurements and the protein binding measurements. FIG. 2 shows a chart with photographs illustrating the bench scale equipment and NIPS procedure used to fabricate symmetric skinless mixed matrix membranes with in-situ synthesized and functionalized polymeric microparticles. FIG. 3 shows photographs illustrating the alternative VIPS procedure and bench scale system used to produce symmetric skinless mixed matrix membranes with in-situ synthesized and functionalized polymeric microparticles in this method.

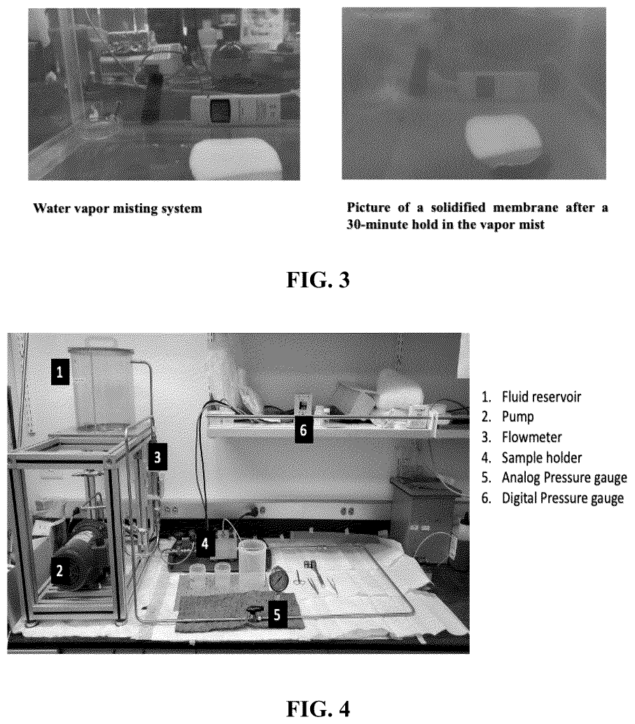

Membrane Characterization and Evaluation The PVDF-PEI membranes were imaged using a Field Emission Scanning Electron Microscope (FE SEM-Zeiss 1550 VP). For the SEM imaging studies, the membranes were cast without PET supports. Following imaging, the resulting SEM micrographs were used to 1) characterize the surface and cross-section morphologies of the PVDF-PEI membranes and 2) estimate their dry thicknesses. The membrane mean particle diameters were estimated by measuring and averaging the particle diameters obtained using a sample of 100 PEI particles from each membrane SEM cross-section image. A custom-made crossflow filtration system (FIG. 4) with an active area of 18.75 cm² was employed to measure the water fluxes of the PVDF-PEI membranes using the protocol and procedures of Kotte and Diallo [14]. The feed flowrate was kept constant at 1.7 liters (L) per minute during all the water filtration experiments. The membrane samples for the water flux measurements were prepared by cutting 45 mm×90 mm rectangular coupons from PVDF-PEI membranes cast onto PET nonwoven fabric supports. For the water filtration experiments, each membrane coupon was first compacted by running distilled water through the membrane for 90 minutes at room temperature and pressure of 3 bar. Following membrane compaction, the mass of water permeating through each membrane coupon was measured at 2 bar and recorded every 5 minutes for 90 minutes, and the recorded values were used to estimate membrane water flux.

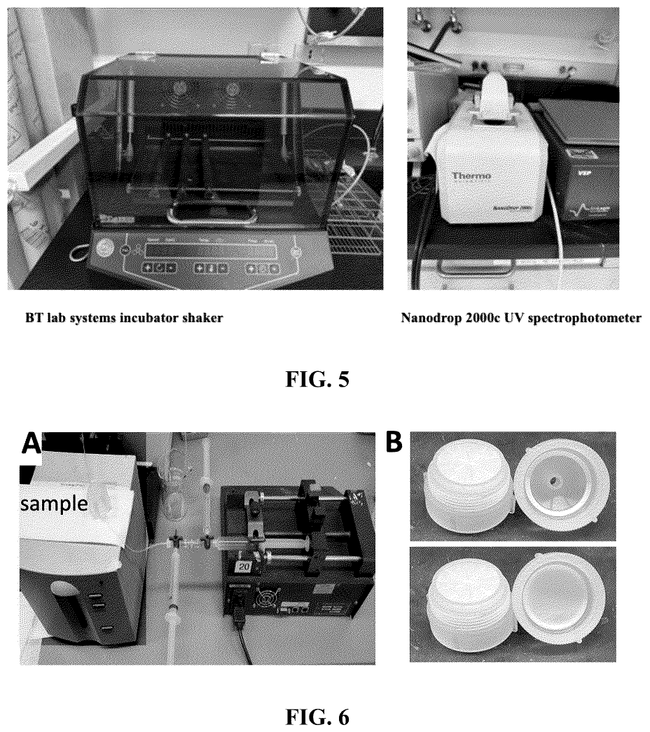

Protein Binding Studies Following the completion of the SEM characterization and water filtration studies, the protein static and dynamic binding capacities of selected PVDF-PEI membranes were measured in distilled water and TRIS buffer solutions with varying salt (NaCl) concentrations using bovine serum albumin (BSA) as model protein. Based on the results of the SBC measurements, a PVDF-PEI membrane formulation with the high BSA binding capacity in the TRIS saline buffer solutions was selected to prepare membrane adsorber candidates for the dynamic binding capacity (DBC) measurements. For the DBC experiments, PVDF-PEI membranes cast onto PET nonwoven fabric supports were evaluated in 50 mM TRIS buffer solutions as a function of salt concentration (NaCl). Because we did not have access to a fast protein liquid chromatography system, we designed and built a flow through membrane adsorption system coupled to a time-resolved UV/Vis spectrophotometer using a dead-end filtration mode (without crossflow) at various flow rates: 0.3, 0.6, 1.2 and 1.5 m¹ of BSA solution per minute (corresponding to 2, 4, 8, and 10 MV/min, respectively, where MV denotes membrane volume). FIG. 5 shows photographs of the bench scale lab incubator system and UV spectrophotometer used to conduct the measurements of membrane protein static binding capacity (SBC).

FIG. 6 shows a picture of a custom-built DBC measurement system which consists of a syringe pump, three polypropylene syringes (Syringes 1, 2 and 3) connected using three-way luer lock connectors, and a membrane sample holder connected by Teflon tubing to a precision flow-through UV Hellma cell with an operating volume of 80 μL. The UV cell was placed inside an Agilent 8453 UV/vis adsorption spectrophotometer to measure the UV absorbance at 280 nm of the effluent BSA buffer solutions as the feed solutions are pumped through the membrane (or PET nonwoven fabric in the case of control tests). The UV-vis sampling rate was adjusted such that a measurement was taken for every 20 μL of effluent (e.g., a measurement was taken every 4 seconds for a BSA feed solution with a flow rate of 0.3 mL/min). Prior to each measurement, the UV/Vis spectrometer was calibrated using the appropriate buffer solutions. Syringe 1 was used to load the feed solutions which consisted of 50 mM TRIS buffer solutions containing 2 mg/mL of BSA and a specific concentration NaCl. Syringe 2 was loaded with the corresponding 50 mM TRIS buffer and used to flush the measurement system after completion of BSA loading. Syringe 3 was loaded with 50 mM TRIS saline buffer solution with 1.0 M of NaCl and used to purge the measurement system from any remaining BSA after the completion of a DBC measurement.

Examples 20-24 are provided to illustrate exemplary symmetric skinless membranes of the present disclosure as a platform for flow through, high capacity, and salt-tolerant quaternized anion exchange (AEX) membrane adsorbers, HIC (Hydrophobic Interaction Chromatography) membrane adsorbers and cation exchange (CEX) membrane adsorbers for downstream bioprocessing during the manufacturing of monoclonal antibodies (mA). The core unit operations in a typical mAb manufacturing system include (1) cell culture, harvest, and clarification using centrifugation and/or depth filtration, (2) product capture and recovery using Protein-A resin chromatography, (3) virus inactivation in a low pH (3.5) hold tank, and (4) impurities removal and product polishing using CEX resin chromatography followed by AEX membrane chromatography and resin HIC to remove impurities (e.g., host cell proteins, protein aggregates, and endotoxins) [17].

General materials and methods for membrane casting and binding experiments were identical to those described for Examples 1-19 above.

Chemicals used for in situ functionalization reactions were obtained from common commercial reagent suppliers. Examples include bromoethane, styrene oxide and sodium 4-vinylbenzyl sulfonate obtained from Sigma-Aldrich, and fluoroalkyl halides and substituted epoxides obtained from Parchem, Apollo Scientific or 3M.

Contact angle measurements: The surface wettability of each membrane was determined from contact angle measurements using a Phoenix 300 contact angle analyzer. A microsyringe was utilized to place a water droplet on the surface of each membrane. After 30 and 120 s, the image was captured and analyzed using the instrument's image processing software. Each reported contact angle is the average of five different measurements.

ATR-FTIR: The surface chemical composition of each membrane was analyzed by attenuated total reflectance Fourier transform infrared spectroscopy (ATR-FTIR) using a JASCO 4100 FT-IR spectrometer (Japan). All samples were scanned from 500 cm⁻¹ to 4000 cm⁻¹ by acquiring and averaging 32 scans with a resolution of 2 cm^{-1 1} using a zinc selenide ATR crystal plate with an aperture angle of 451.

SEM: The cross-sectional and top/bottom layers of each membrane were imaged with a field emission scanning electron microscope (FESEM, Magellan Series 400 FEI Corporation) at an acceleration voltage of 2.0 kV. Before imaging, all samples were first coated with gold for 30 s followed by osmium for 30 s to minimize the charging effect. To obtain the cross-sections, the membranes were frozen and fractured following immersion in liquid nitrogen. The SEM images were subsequently analyzed to estimate membrane thickness and PEI particle size using the Image J Version 1.45 m image processing/analysis software.

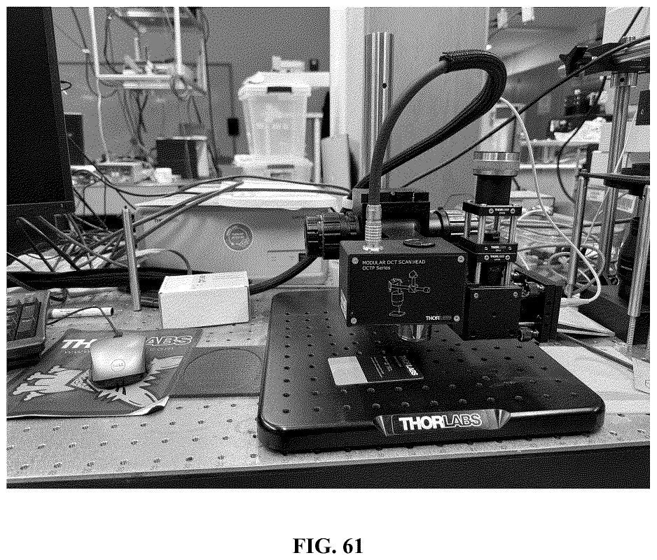

Membrane thickness measurements using optical coherence tomography (OCT): Membrane thickness was determined using optical coherence tomography (OCT) with a Thor labs Ganymede system (FIG. 61). For measurement, a membrane sample was cut into a 1.2 cm×1.2 cm section, and excess surface water was gently removed using a Kimwipe. The membrane coupon was then positioned beneath the OCT imaging head, and a linear scan was performed across its surface to obtain a cross-sectional tomogram. This procedure was repeated at three distinct locations on the same membrane to obtain replicate thickness measurements.

The resulting OCT images were analyzed using ImageJ software to calculate the membrane thickness. A rectangular region of interest (ROI) (accounting for surface irregularities) was drawn across the membrane cross-section, and the membrane thickness was calculated by dividing the area of the rectangle by its width.

### First Set of Examples Influence of Nonsolvent and Mixed Matrix Composition on Membrane Morphology (Examples 1-4)

### Example 1: Effect of PEI Loading and Nonsolvent Composition on Membrane Morphology

This example illustrates the influence of polyethyleneimine (PEI) microparticle loading and nonsolvent composition on the resulting morphology of mixed matrix membranes prepared according to the general methods described herein. Membranes were prepared using epichlorohydrin (ECH) as the crosslinker at a crosslink density (CD) of approximately 4, with varying PEI loadings, using either isopropyl alcohol (IPA), water, or a 50:50 v/v mixture of N-methylpyrrolidone and water (NMP:H2O) as the nonsolvent in the coagulation bath. Resulting morphologies were characterized by Scanning Electron Microscopy (SEM).

SEM micrographs, exemplified in FIG. 7, provide insight into the characteristics of the in-situ formed PEI microparticles. Average particle size and particle size distribution data are summarized in Table 8.

TABLE 8
Mean particle diameter (μm) and standard deviation for membranes
with different particle loadings prepared using indicated nonsolvent

| | Wt. % PEI | | | | | |
|---|---|---|---|---|---|---|
| Nonsolvent | 06 | 21 | 38 | 48 | 54 | 60 |
| IPA | 1.1 ± 0.4 | 1.6 ± 0.5 | 1.8 ± 0.7 | 0.9 ± 0.2 | 0.9 ± 0.2 | 0.9 ± 0.1 |

TABLE 8
Mean particle diameter (μm) and standard deviation for membranes
with different particle loadings prepared using indicated nonsolvent

| | Wt. % PEI | | | | | |
|---|---|---|---|---|---|---|
| Nonsolvent | 06 | 21 | 38 | 48 | 54 | 60 |
| H₂O | 1.2 ± 0.4 | 1.5 ± 0.6 | 1.8 ± 0.8 | 0.9 ± 0.2 | 0.9 ± 0.1 | 0.9 ± 0.2 |
| NMP:H₂O | — | — | 1.9 ± 0.7 | 0.9 ± 0.1 | 0.9 ± 0.1 | 0.9 ± 0.2 |

Particle size data for 6 wt. % PEI and 21 wt. % PEI membranes prepared in NMP:H2O are not included due to difficulties in clearly distinguishing between PVDF and PEI microparticles in those specific samples. As shown in Table 8, the average PEI microparticle size and corresponding distribution appear independent of the nonsolvent used (IPA, H2O, or NMP:H2O), indicating that the particle dimensions are determined by processes occurring in the dope dispersion prior to casting and phase inversion.

At lower PEI concentrations (up to 38 wt. %), the average particle size increases with increasing PEI loading (Table 8). This positive correlation ceases between PEI loadings of 38 wt. % and 48 wt. %. At higher PEI loadings (48 wt. % and above), the average particle size decreases to approximately 0.9 microns, and the particle size distribution (PSD), as indicated by the standard deviation, narrows (Table 8).

This trend in particle size is attributed to the interplay between coalescence and breakup of phase-separated PEI-rich domains during the in-situ crosslinking reaction within the stirred dope dispersion. Phase separation of PEI initiates upon addition of catalytic hydrochloric acid, which protonates PEI amine groups, reducing their compatibility with the TEP solvent and leading to the formation of PEI-rich droplets. Initially, these droplets can coalesce and break apart. At low PEI concentrations, this process appears transitory, resulting in a broad distribution of final particle sizes. At high PEI concentrations, droplet coalescence and breakup may reach a dynamic steady-state, resulting in a narrower size distribution. As the crosslinking reaction proceeds, the PEI networks stabilize, forming discrete microparticles that no longer undergo coalescence or breakup.

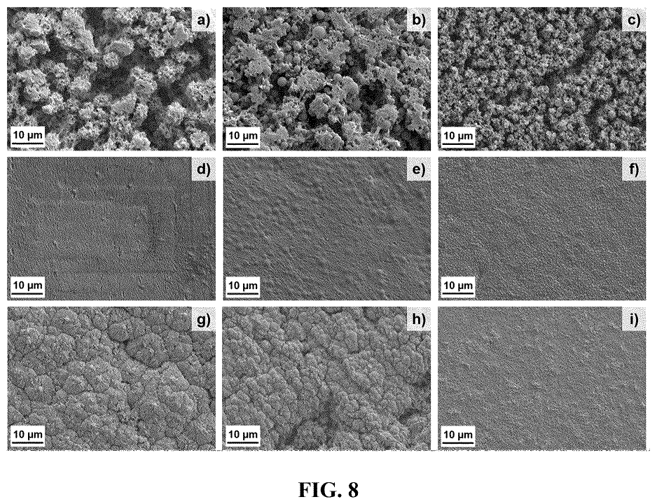

The choice of nonsolvent profoundly affects the overall membrane morphology, particularly the surface structure and symmetry, as shown in FIG. 7 (cross-sections) and FIG. 8 (surfaces).

When IPA is used as the nonsolvent (FIG. 7, panels a-c; FIG. 8, panels a-c), the resulting membranes exhibit a symmetric morphology. The polyvinylidene difluoride (PVDF) adopts a “spherulitic” structure throughout the membrane bulk and at the surface exposed to the nonsolvent. The surface morphology matches the bulk morphology, characteristic of phase separation induced gradually by a “soft” nonsolvent. No distinct skin layer is observed. At the highest PEI loading (54 wt %, FIG. 7 panel c, FIG. 8 panel c), the PVDF structure is largely obscured by the densely packed PEI microparticles.

In contrast, when water is used as the nonsolvent (FIG. 7, panels d-f; FIG. 8 panels d-f), the membranes exhibit an asymmetric morphology. A thin, dense PVDF skin layer forms at the surface exposed to the water bath. The bulk of the membrane, beneath the skin, contains PVDF spherulites (visible particularly at lower PEI loading, e.g., FIG. 7 panel d) or more complex structures at higher PEI loadings. This asymmetry, with skin layer formation, is characteristic of rapid, kinetically driven phase separation induced at the surface by a “hard” nonsolvent like water.

When a 50:50 v/v mixture of NMP:H2O is used as the nonsolvent (FIG. 7, panels g-i; FIG. 8, panels g-i), a unique morphology results. In the bulk, tight, porous spheres of PVDF are observed. At intermediate PEI content (38 wt. %, FIG. 7 panel h), these porous PVDF spheres appear decorated by the PEI microparticles. The membrane surface is relatively dense and becomes increasingly dense as PEI content increases (FIG. 8, panels g-i).

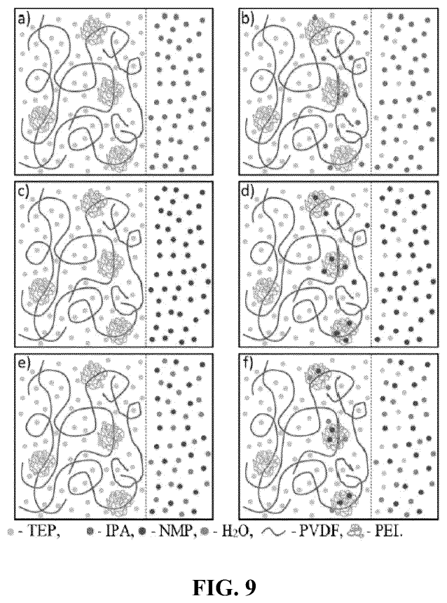

FIG. 9 provide a schematic representation of the different embodiments of the disclosure. AS water diffuses into the membrane, it is attracted to the hydrophilic PEI leading to water-rich regions around the PEI particles (FIG. 9 panels c&d). The higher water concentrations near the PEI particles promotes kinetically driven liquid-liquid demixing of the nearby PVDF, producing the lace-like structure. If the concentration of PEI particles is high enough, as seen in the 38 wt. % and 54 wt. % cases, the improved hydrophilicity and subsequent promotion of liquid-liquid demixing may extend throughout the entire thickness of the casting solution. In this situation, the direct PVDF-PEI interaction is replaced by the indirect PEI/H2O/PVDF interaction that represents a blending of the PVDF-PEI, H₂O-PEI, and H₂O-PVDF interactions. If the PEI loading is not high enough, as seen in the 6 wt. % case, the diffusion of water into the bulk of the casting solution is too slow to promote liquid-liquid demixing resulting in thermodynamic forces determining the final morphology.

The final membrane morphology arises from complex interactions during the nonsolvent induced phase separation (NIPS) process, including nonsolvent-solvent, nonsolvent-PVDF, nonsolvent-PEI microparticle, and PVDF-PEI microparticle interactions.

For IPA (a “soft” nonsolvent for PVDF), its miscibility with the solvent TEP and limited interaction with the PEI microparticles lead primarily to a slower, thermodynamically driven phase separation. The process is likely dominated by solid-liquid demixing, where PVDF crystallization drives the separation into polymer-rich (spherulites) and polymer-lean phases. The observation that PEI microparticles are often located at the boundaries of PVDF spherulites supports this mechanism, as crystallizing PVDF would tend to exclude the particles to the phase boundary.

For water (a “hard” nonsolvent for PVDF), phase separation is kinetically driven and rapid at the interface, leading to instantaneous liquid-liquid demixing and the formation of the dense PVDF skin layer. This skin layer then acts as a barrier, slowing down the ingress of water into the bulk. Deeper within the membrane, the slower increase in nonsolvent concentration allows for thermodynamically controlled solid-liquid demixing and the formation of PVDF spherulites, similar to the bulk structure in IPA-cast membranes. At low PEI loading (e.g., 6 wt %), the influence of hydrophilic PEI microparticles on water transport and phase separation appears minimal.

However, at higher PEI loadings in water-cast membranes, the hydrophilic PEI microparticles significantly influence morphology. They increase the overall hydrophilicity near the surface and attract water as it diffuses into the membrane, creating water-rich regions around the particles. This promotes faster, kinetically driven liquid-liquid demixing locally around the PEI microparticles throughout the bulk, leading to the observed lace-like PVDF structures instead of distinct spherulites (e.g., FIG. 7 panels e and f). The direct PVDF-PEI interaction becomes modulated by the presence of water (indirect PEI/H₂O/PVDF interaction).

For the mixed NMP:H₂O nonsolvent, the behavior is more complex due to NMP being a good solvent for PVDF while water is a nonsolvent. In the absence of PEI, this mixture acts as a single nonsolvent of intermediate strength, resulting in slower phase separation (compared to pure water) dominated by solid-liquid demixing, similar to using IPA. However, the presence of hydrophilic PEI microparticles introduces a driving force for the mixed nonsolvent to potentially demix locally as it interacts with the particles. NMP may accumulate at the interface between the PEI-rich microgels (which preferentially absorb water) and the surrounding TEP/PVDF-rich phase. This NMP-rich interfacial region, combined with increasing water concentration within the PEI microgel, drives PVDF phase separation nearby. While still likely dominated by solid-liquid demixing (due to the presence of NMP slowing precipitation compared to pure water), the polar environment influenced by the water-rich PEI microgels appears to promote the nucleation and growth of PVDF in a condensed globular form rather than loose spherulites. As PEI loading increases, these globular structures become dominant. This combined influence of the PEI microparticles and the mixed nonsolvent results in the distinct membrane morphology observed.

### Example 2: Influence of PEI Loading and Nonsolvent Composition on PVDF Crystalline Behavior

This example illustrates the influence of PEI microparticle loading and nonsolvent composition on the crystalline phase and degree of crystallinity of the PVDF matrix in mixed matrix membranes prepared according to the general methods. Wide-Angle X-ray Scattering (WAXS) was used to characterize the crystalline structure of membranes prepared with varying PEI loadings and using IPA, water, or NMP:H₂O as the nonsolvent. All WAXS scans discussed refer to background-subtracted data.

### PVDF Crystallinity in IPA-Cast Membranes

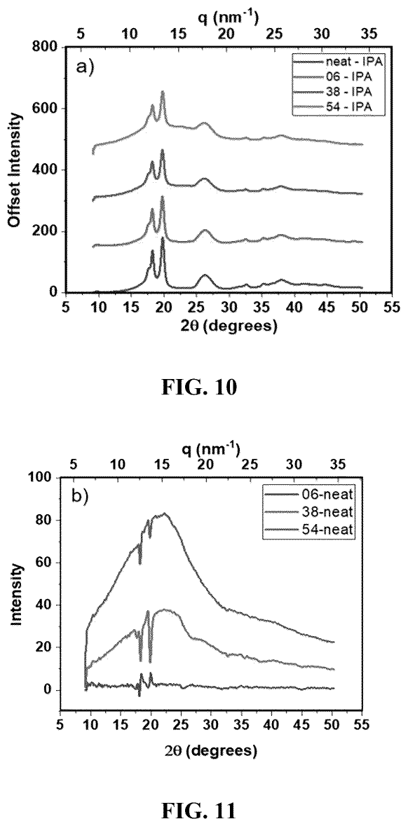

WAXS scans of membranes prepared using IPA as the nonsolvent are shown in FIG. 10. Each scan, regardless of PEI loading (neat, 6 wt. %, 38 wt. %, 54 wt. %), exhibits crystalline peaks characteristic of the α-phase of PVDF (peaks at approximately 17.6°, 18.3°, 19.9°, and 26.5° 2θ, see Table 9).

TABLE 9
Peaks associated with different crystal phases
of PVDF. Peaks provided are obtained using Cu-kα
radiation with wavelength 0.154 nm.^{22, 25, 28}

| Crystal phase | 2θ peaks (degrees) |
|---|---|
| A | 17.6, 18.3, 19.9, & 26.5 |
| B | 20.6, 36, & 40 |

This indicates that when using IPA, the PVDF crystal phase formed is largely independent of the PEI particle loading within the range studied.

This observation aligns with the SEM findings (Example 1) and the understanding of IPA as a “soft” nonsolvent. The resulting slower, solid-liquid demixing process allows PVDF sufficient time to crystallize into its thermodynamically favored α-phase. While the PVDF-PEI interactions influence the overall spherulitic morphology (Example 1), they do not appear to alter the dominant crystallization pathway towards the α-phase under these conditions.

To assess the effect of PEI loading on the degree of PVDF crystallinity in IPA-cast membranes, difference patterns were generated by subtracting the WAXS pattern of the neat PVDF membrane (scaled by PVDF weight fraction, shown in the equation below) from the patterns of the PEI-containing membranes (FIG. 11).

$$r = \frac{wt {\%}_{PVDF , sample}}{wt {\%}_{PVDF , neat}}$$

This subtraction method helps isolate changes in PVDF crystallinity and contributions from amorphous PEI. The resulting difference curves are dominated by a broad scattering peak from amorphous PEI centered around 22° 2θ.

The difference pattern for the 6 wt. % PEI membrane shows small peaks at α-phase positions (e.g., 18.3° and 19.9° 2θ), suggesting a slight increase in the degree of crystallinity relative to the neat PVDF membrane. Conversely, the difference patterns for the 38 wt. % and 54 wt. % PEI membranes show distinct valleys at these α-phase peak positions, indicating a lower degree of PVDF crystallinity compared to the neat membrane. This reduction in crystallinity at higher PEI loadings may result from PEI microgels hindering PVDF crystal growth through physical obstruction or by trapping PVDF chains within the non-crystalline microgel network-. The deeper valley for the 38 wt. % membrane compared to the 54 wt. % membrane (FIG. 11) suggests that the larger average particle size at 38 wt % PEI loading might be more effective at disrupting crystallization.

### PVDF Crystallinity in Water-Cast Membranes

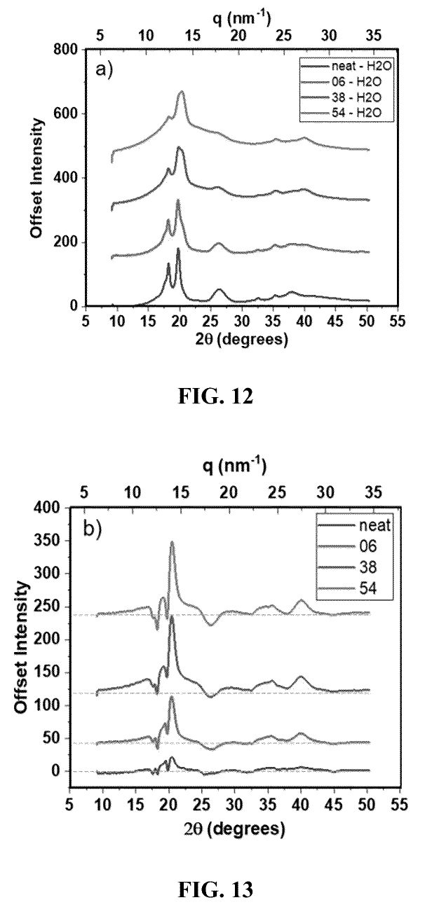

Membranes cast using water as the nonsolvent exhibit a dependence of the PVDF crystal phase on PEI concentration (FIG. 12). The neat PVDF membrane and the membrane with 6 wt. % PEI are predominantly in the α-phase, consistent with the spherulitic morphology observed in the bulk (FIG. 7 panel d). However, even at 6 wt. % PEI, a small shoulder appears near 20.6° 2θ, corresponding to the main peak of the β-phase (see Table 9). As PEI concentration increases to 38 wt. % and 54 wt. %, this β-phase peak grows significantly, indicating an increasing proportion of the electroactive β-phase.

The effect of the “hard” nonsolvent (water) versus the “soft” nonsolvent (IPA) on PVDF crystallinity was further analyzed by creating difference patterns (Water-cast scan minus IPA-cast scan for the same composition, FIG. 13). For neat PVDF, the difference pattern is weak, showing small valleys at α-phase positions and a small peak at the β-phase position (20.6° 2θ), confirming a slightly higher-content in the water-cast membrane, consistent with literature reports. [18], [19, 20]

The presence of PEI significantly enhances the formation of β-phase in water-cast membranes relative to their IPA-cast counterparts. In this respect, DPV (Difference between Peak at 20.6° and Valley at 19.9°) is defined as an indicator of this relative increase in-content. The DPV increases from 20 (neat PVDF) to 47 (6 wt. % PEI), 71 (38 wt. % PEI), and 98 (54 wt. % PEI).

This shift towards the B-phase is attributed to the interplay between the rapid, kinetically driven phase separation induced by water and the hydrophilic PEI microparticles. While rapid quenching at the surface kinetically favors B-phase formation even without PEI, the slower phase separation in the bulk typically favors the α-phase. However, at higher PEI loadings, the hydrophilic microgels facilitate faster water transport into the bulk, promoting the faster liquid-liquid demixing process throughout the membrane, which kinetically traps PVDF in the β-phase.

### PVDF Crystallinity in NMP:H₂O-Cast Membranes

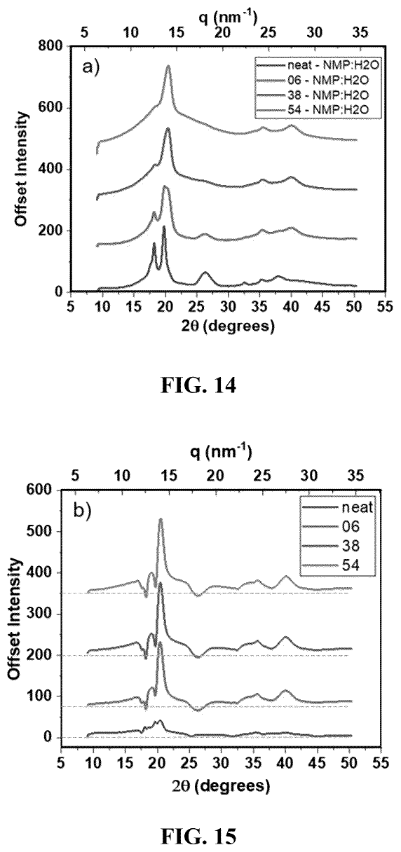

Membranes prepared using the mixed NMP:H₂O nonsolvent also show a shift from α-phase to β-phase PVDF with increasing PEI content (FIG. 14). The neat membrane is α-phase dominated. However, the shift occurs more abruptly than with pure water; a significant β-phase contribution (indicated by a plateau between 19.9° and 20.6° 2θ) is already present at 6 wt. % PEI. At 54 wt. % PEI, the membrane is predominantly in the β-phase, with α-phase peaks nearly suppressed.

Difference patterns (NMP:H₂O-cast scan minus IPA-cast scan, FIG. 15) confirm this trend. The difference pattern for neat PVDF is nearly zero, consistent with the mixed nonsolvent acting like a “soft” nonsolvent in the absence of PEI, favoring α-phase formation. For membranes containing PEI, the difference patterns show prominent valleys at α-phase positions and strong peaks at B-phase positions. The DPV values are 6 (neat), 93 (6 wt. % PEI), 117 (38 wt. % PEI), and 138 (54 wt. % PEI).

The strong shift to β-phase aligns with the unique globular PVDF morphology observed via SEM for these membranes (Example 1). The presence of NMP (a good solvent for PVDF) appears to interact synergistically with the hydrophilic PEI microparticles and water. While NMP moderates the overall precipitation rate compared to pure water, it may enhance the local concentration gradient or polar environment near the PEI/water-rich domains. This localized environment seems to thermodynamically favor the formation of the polar β-phase PVDF as globular structures surrounding the PEI microparticles. Consequently, increasing PEI concentration leads to a higher proportion of this β-phase, potentially allowing for the creation of membranes with very high β-phase content using this mixed nonsolvent system.

### Example 3: Water Flux Characteristics of Membranes with Varying Morphology

This example demonstrates the relationship between the membrane structures described in Example 1 (resulting from different PEI loadings and nonsolvent compositions) and their corresponding water flux properties, measured according to the general methods. Water flux measurements were performed at 2 bar operating pressure using membranes cast on a PET support.

### Correlation Between Membrane Structure and Water Flux

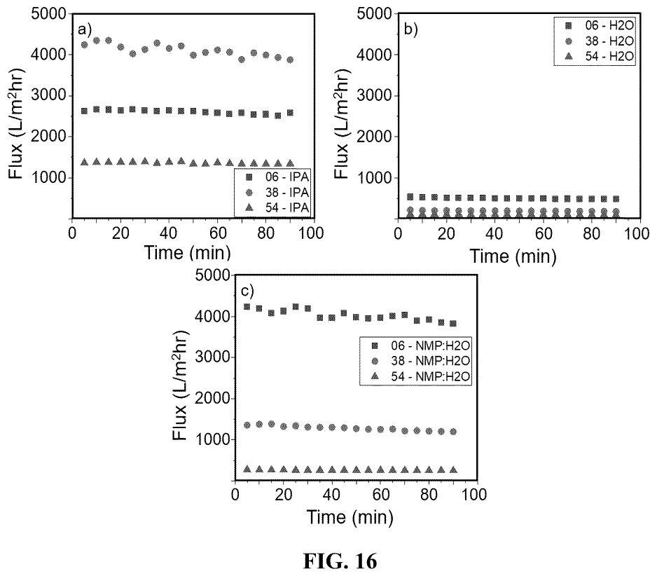

The measured water fluxes reveal a strong connection between membrane morphology and permeability (FIG. 16). Membranes prepared using IPA as the nonsolvent, which possess an open, symmetric, and spherulitic morphology without a skin layer (FIG. 7 panels α-c, FIG. 8 panels α-c), exhibit high water fluxes characteristic of microfiltration (MF) membranes, ranging from approximately 1400 to over 4000 L·m⁻²·hr⁻¹ (Lm⁻² hr⁻¹) at 2 bar (FIG. 16 panel a).

In contrast, membranes cast using water as the nonsolvent, characterized by a tight surface skin layer (FIG. 8 panels d-f), consistently show low water fluxes (FIG. 16 panel b). These low fluxes are typical of ultrafiltration (UF) membranes and are significantly lower than their IPA-cast counterparts under the same operating conditions. This confirms that the presence of the dense skin layer, formed due to rapid phase separation with the “hard” nonsolvent, controls and limits the permeability.

Membranes prepared using the mixed NMP:H₂O nonsolvent exhibit flux properties consistent with their unique morphologies (FIG. 7 panels g-i, FIG. 8 panels g-i). At the highest PEI loading tested (54 wt. %), a relatively dense surface layer forms (FIG. 8 panel i), resulting in a low water flux (FIG. 16 panel c), similar to the water-cast membranes. However, at the lowest PEI loading (6 wt. %), the surface layer is more porous (FIG. 8 panel g), and the internal structure consists of porous PVDF shells (FIG. 7 panel g). This 6 wt. % PEI membrane cast in NMP:H2O provides a high water flux (approx. 4000 Lm⁻² hr⁻¹) comparable to the high-flux membranes cast in IPA (FIG. 16 panels a, c). The membrane with intermediate PEI loading (38 wt. %) cast in NMP:H₂O shows an intermediate flux (FIG. 16 panel c).

### Effect of PEI Loading on Water Flux

The influence of PEI particle loading on water flux depends on the nonsolvent used. For membranes cast in water and NMP:H2O, increasing PEI loading generally leads to a decrease in water flux (FIG. 16, panels b, c). This is attributed to increasing congestion within the membrane structure (either the skin layer for water-cast or the overall matrix) by the swelling hydrophilic PEI microgels.

For membranes cast in IPA, the water flux exhibits a non-monotonic dependence on PEI loading, with a maximum observed at the intermediate loading of 38 wt. % (FIG. 16 panel a). This behavior is interpreted as resulting from a balance between two opposing factors: membrane hydrophilicity and available pore volume for flow. Increasing PEI loading from 6 wt. % to 38 wt. % enhances the overall membrane hydrophilicity, which facilitates water transport and increases flux. However, further increasing PEI loading to 54 wt. % increases the volume occupied by the swollen PEI microgels, which impedes mass transfer by reducing the effective pore volume available for convective flow, thus decreasing the flux. Therefore, the 38 wt. % PEI composition appears to offer an optimal balance for maximizing flux in IPA-cast membranes under these conditions.

Although the IPA-cast membrane with 54 wt. % PEI exhibits a lower flux (approx. 1400 Lm⁻² hr⁻¹) compared to the 38 wt. % version, it possesses the highest concentration of functional PEI particles while still maintaining a high flux suitable for MF applications. Consequently, membranes based on the 54 wt. % PEI composition cast in IPA were selected as the starting point for further optimization and evaluation as AEX membrane adsorbers (see subsequent Examples).

### Example 4: Summary of Structure-Property Relationships

The preceding examples demonstrate that the in situ synthesis of PEI polymeric microparticles within a PVDF dope dispersion, combined with control over phase inversion conditions, provides effective means for manipulating mixed-matrix membrane morphology and properties. The results illustrate several key factors influencing the final membrane structure and performance.

As shown in Example 1, the characteristics of the embedded PEI microparticles, specifically their size and size distribution (PSD), correlate with the initial PEI loading in the dope dispersion. This correlation is understood to arise from the dynamics of droplet coalescence and breakup of the phase-separated PEI-rich domains during the in situ crosslinking process prior to casting.

Examples 1 and 2 demonstrate that for single-component nonsolvents used during phase inversion, the final membrane morphology (including PVDF structure and crystallinity) is governed by the complex interplay between various molecular interactions: nonsolvent-solvent, nonsolvent-PVDF, nonsolvent-PEI microparticle, and PVDF-PEI microparticle interactions. The choice between a “soft” nonsolvent like IPA (leading to symmetric, skinless, α-phase dominant MF membranes) and a “hard” nonsolvent like water (leading to asymmetric, skinned, mixed a/β-phase UF membranes) highlights the critical role of these interactions in controlling the phase separation pathway and resulting structure.

Furthermore, Examples 1 and 2 show that employing a mixed nonsolvent system, such as NMP:H₂O (comprising a harsh nonsolvent for PVDF [water] and a secondary solvent for PVDF [NMP]), introduces additional complexities and interactions. These interactions, particularly in the presence of the PEI microparticles, can lead to the formation of membrane structures, such as the observed globular PVDF morphology with predominantly β-phase crystallinity.

Additionally, Example 3 demonstrates a clear correlation between the structural characteristics observed via SEM (Example 1) and WAXS (Example 2) and the resulting membrane properties, specifically water flux. The open, symmetric, skinless structures obtained with IPA yield high water fluxes suitable for microfiltration, whereas the skinned structures obtained with water result in significantly lower fluxes typical of ultrafiltration. The unique morphologies obtained with the mixed nonsolvent also exhibit distinct flux behaviors correlated with their specific structures. These findings collectively illustrate the capability to tune membrane structure and performance through controlled in situ particle synthesis and careful selection of phase inversion conditions.

### Second Set of Examples, Mixed Membrane Chromatography Performed with Exemplary Symmetric Skinless Membranes of the Present Disclosure (Examples 5-9) 3

### Example 5: Effect of Crosslinker Chemistry and Density on PEI Microparticle Morphology

This example describes the influence of different crosslinkers and varying crosslink densities on the morphology of the in situ generated PEI microparticles within the mixed matrix PVDF membranes, as observed by SEM according to the general methods. Membranes were prepared using IPA as the nonsolvent and a target PEI loading of approximately 54 wt. %.

### Effect of Crosslinker Chemistry at Constant Crosslink Density

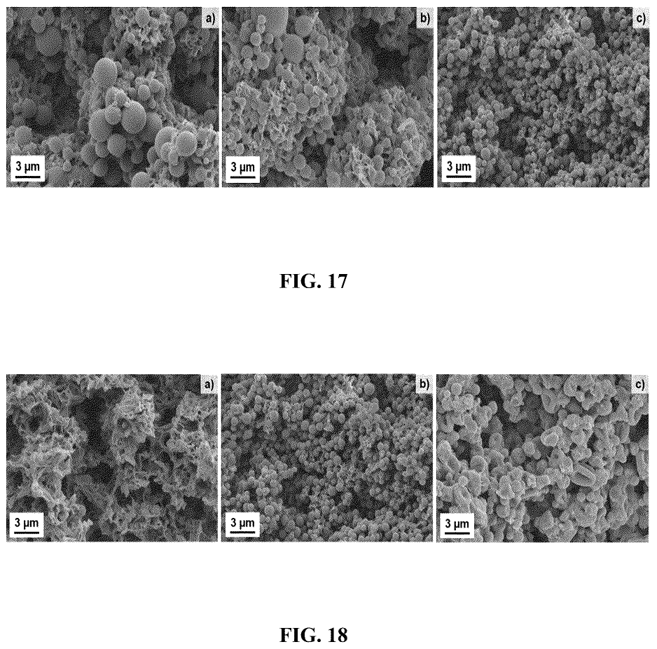

FIG. 17 presents SEM micrographs of membrane cross-sections prepared using epichlorohydrin (ECH), diethylene glycol diacrylate (EGA), or bis(2-chloroethyl)amine hydrochloride (BCAH) as the crosslinker, each at a normalized crosslink density (NCD) of approximately 0.5 (corresponding to CD≈2). Distinct morphological differences are observed depending on the crosslinker used.

When ECH is used (FIG. 17 panel a), the resulting PEI microgels form discrete spherical particles in the dry state, but exhibit a relatively broad size distribution (ranging from approximately 0.5 to 3 microns). This contrasts with the tighter size distribution observed when ECH is used at a higher NCD of 1.0 (CD≈4, see Example 1, FIG. 7 panel c).

When EGA is used (FIG. 17 panel b), the PEI microgels appear interconnected, lacking the distinct spherical shape observed with ECH at the same NCD.

When BCAH is used (FIG. 17 panel c), the PEI microgels exhibit the tightest size distribution among the three crosslinkers at NCD 0.5, with a smaller average particle size comparable to that produced using ECH at the higher NCD of 1.0. This suggests that factors beyond just the molar ratio of crosslinker to PEI, potentially related to reaction kinetics or specific chemical interactions (such as halide concentration, which is similar for ECH at NCD 1.0 and BCAH at NCD 0.5), play a role in determining the final particle morphology.

### Effect of Crosslink Density for BCAH Crosslinker

FIG. 18 shows SEM micrographs of membrane cross-sections prepared using BCAH as the crosslinker at varying NCDs: 0.25 (CD≈1, FIG. 18 panel a), 0.5 (CD≈2, FIG. 18 panel b), and 1.0 (CD≈4, FIG. 18 panel c). The morphology of the PEI microparticles changes significantly with NCD.

At the lowest NCD of 0.25 (FIG. 18 panel a), relatively few distinct functional particles are visible. This suggests that particle formation or retention is suppressed at low crosslink densities, possibly due to insufficient crosslinking allowing unreacted or lightly crosslinked PEI oligomers to leach out during the phase inversion and washing steps.

At the intermediate NCD of 0.5 (FIG. 18 panel b), well-defined, relatively uniform spherical microparticles are formed, as also seen in FIG. 17 panel c.

At the highest NCD of 1.0 (FIG. 18 panel c), the functional microgels exhibit a different morphology, appearing consistent with collapsed hollow spheres in the dry state. The reason for this transition at high crosslink densities with the BCAH/DMSO system requires further investigation but may involve interactions between dissolved PEI and dispersed droplets of the BCAH/DMSO solution during the in situ reaction phase.

Concurrently, the morphology of the supporting PVDF matrix also appears influenced by the BCAH NCD, specifically related to the amount of DMSO introduced with the crosslinker. Membranes prepared at NCDs of 0.25 and 0.5 show PVDF structures consistent with those formed using IPA as the sole nonsolvent (Example 1). However, the membrane prepared with NCD of 1.0, which involved the largest amount of DMSO (Table 8), exhibits a PVDF structure more reminiscent of that obtained using the mixed NMP:H₂O nonsolvent (Example 1). This suggests that at sufficiently high concentrations, DMSO acts similarly to NMP as a co-solvent/nonsolvent modifier during the PVDF phase separation process, influencing the final PVDF morphology.

### Example 6: Effect of Crosslinker Chemistry and Density on Static Binding Capacity

This example evaluates the static binding capacity (SBC) for bovine serum albumin (BSA) of mixed matrix PVDF-PEI membranes prepared with different crosslinker chemistries and crosslink densities, according to the general methods. Membranes were prepared using IPA as the nonsolvent with a target PEI loading of approximately 54 wt. %. The crosslinkers evaluated were epichlorohydrin (ECH), diethylene glycol diacrylate (EGA), and bis(2-chloroethyl)amine hydrochloride (BCAH), each tested at normalized crosslink densities (NCDs) of approximately 0.25, 0.5, and 1.0 (corresponding to CD values of approximately 1, 2, and 4, respectively). SBC was measured using BSA in distilled water. The results are conceptually depicted in FIG. 1.

### Effect of Crosslink Density for EGA and BCAH Crosslinkers

Membranes prepared using either EGA or BCAH as the crosslinker exhibit a similar trend in SBC as a function of NCD, with a distinct maximum observed at NCD 0.5 (CD≈2). Binding capacities at NCD 0.25 (CD≈1) and NCD 1.0 (CD≈4) are significantly lower for both crosslinker types.

This observed maximum at NCD 0.5 is attributed to an optimal balance between the internal network structure of the PEI microgels (affecting swelling and accessibility of binding sites) and the overall cohesion and retention of the functional PEI component within the membrane matrix. At high crosslinker concentrations (NCD 1.0/CD≈4), the PEI network within the microgels becomes tightly crosslinked. This restricts the ability of the microgels to swell in water, limiting the accessibility of internal amine binding sites to the relatively large BSA molecules, thus resulting in lower SBC.

Conversely, at low crosslinker concentrations (NCD 0.25/CD≈1), the degree of crosslinking may be insufficient to effectively immobilize all PEI chains or oligomers within the forming microgel network. This can lead to the loss of functional amine groups during the nonsolvent immersion and subsequent washing steps, resulting in a lower overall concentration of binding sites in the final membrane and consequently lower SBC. This interpretation is consistent with SEM observations (Example 5, FIG. 18 panel a) suggesting suppressed particle formation or retention at NCD 0.25 for BCAH.

At the intermediate NCD of 0.5 (CD≈2), the PEI microgel network is sufficiently crosslinked to ensure good cohesion and retention within the PVDF matrix, while remaining open enough upon swelling in water to maximize the availability and accessibility of amine functional sites for BSA binding. This balance leads to the highest observed SBC values for membranes prepared with EGA (Membrane 54E) and BCAH (Membrane 54H). The well-formed particle morphology observed via SEM at this NCD (Example 5, FIG. 18 panel b) further supports this optimal condition.

### Effect of Crosslinker Chemistry

While the trend with NCD is similar for EGA and BCAH, the specific crosslinker chemistry influences the absolute SBC values achieved. At NCDs of 0.5 and 1.0 (CD≈2 and 4), membranes synthesized with BCAH (54H and 54G) exhibit higher BSA binding capacities than those synthesized with EGA (54E and 54D) at the corresponding NCDs. This enhanced binding with BCAH is attributed to the chemical structure of the BCAH crosslinker, which incorporates an additional secondary amine group into the PEI network for each crosslinking event, thereby increasing the total density of weak base binding sites compared to EGA.

However, at the lowest NCD of 0.25 (CD≈1), the membrane prepared with EGA (54F) shows higher binding than the membrane prepared with BCAH (54I). While the reasons require further exploration, this might be related to differences in reaction kinetics or the shorter chain length of BCAH potentially leading to lower gel cohesion and greater loss of PEI material at very low crosslink densities compared to the longer EGA crosslinker under these specific conditions.

Membranes prepared with ECH exhibit a different trend, showing a decrease in SBC as NCD increases from 0.25 to 1.0 (CD≈1 to 4). ECH is a short, heterofunctional crosslinker with an epoxide group reacting significantly faster than its halide group. This difference in reactivity might lead to a more even distribution of initial crosslinks at lower NCDs, potentially improving PEI retention compared to the homofunctional crosslinkers at NCD 0.25. However, as the NCD increases, the short length of the ECH crosslinker combined with potentially more complete reaction likely results in progressively tighter, less accessible PEI microgel networks, leading to the observed decrease in BSA binding.

### Example 7: Salt Tolerance Evaluation Using Static Binding Capacity

This example evaluates the salt tolerance of selected mixed matrix PVDF-PEI membranes by measuring their static binding capacity (SBC) for BSA in buffer solutions of varying ionic strength, according to the general methods. Based on their high BSA binding capacity in water (Example 6), membranes prepared using EGA (Membrane 54E) and BCAH (Membrane 54H) as crosslinkers, both at an NCD of approximately 0.5 (CD≈2), were selected for this evaluation.

### Influence of Crosslinker Chemistry and Salinity in TRIS Buffer

SBC measurements were performed in 50 mM TRIS buffer (pH 7.4) with varying concentrations of added NaCl (0 mM, 50 mM, 100 mM, 150 mM, and 200 mM), corresponding to conductivities ranging from approximately 4.6 mS/cm to 24.7 mS/cm (Table 7).

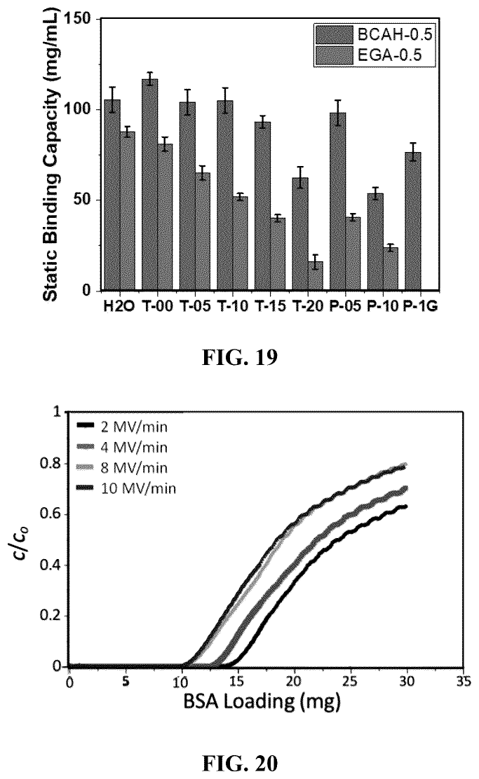

The results, depicted conceptually in FIG. 19 demonstrate the influence of both crosslinker chemistry and buffer conductivity on membrane salt tolerance.

Membrane 54E, prepared with EGA, shows a progressive decrease in BSA binding capacity as salinity increases. Compared to its binding capacity in water (Example 6), the SBC is reduced by approximately 25% in TRIS buffer containing 50 mM NaCl (T-05, 9.8 mS/cm), 40% in 100 mM NaCl (T-10, 15 mS/cm), and 80% in 200 mM NaCl (T-20, 24.7 mS/cm).

In contrast, Membrane 54H, prepared with BCAH, exhibits significantly better salt tolerance. Its SBC in TRIS buffer containing 50 mM NaCl (T-05) and 100 mM NaCl (T-10) is comparable, within experimental error, to its capacity in distilled water (Example 6). Even at higher salt concentrations, the reduction in binding capacity is less pronounced than for Membrane 54E; for example, in TRIS buffer with 200 mM NaCl (T-20), Membrane 54H retains approximately 60% of its binding capacity relative to water, whereas Membrane 54E retains less than 20%.

This divergence in performance at higher conductivities highlights the contribution of the crosslinker chemistry to salt tolerance. The superior salt tolerance of Membrane 54H (BCAH crosslinker) is attributed to the higher concentration of primary and secondary amine groups within its PEI microgels. As established in the literature [21] [22]], these weak base groups can interact with proteins through both electrostatic forces and alternative mechanisms like hydrogen bonding. While electrostatic interactions are screened at higher ionic strength, hydrogen bonding remains effective, providing sustained binding capacity. The BCAH crosslinker uniquely incorporates additional secondary amine groups during polymerization, enhancing the potential for hydrogen bonding compared to EGA or ECH, which primarily yield secondary and tertiary amines from the original PEI amines. Tertiary and quaternary amines, relying solely on electrostatic interactions, show significantly reduced binding at high salt concentrations.

### Influence of Buffer Chemistry

A comparison was also made between TRIS-based buffers and Phosphate-Buffered Saline (PBS) solutions at similar conductivities (Table 7, FIG. 19). Using PBS generally resulted in lower SBC compared to TRIS buffer at comparable conductivity for both Membrane 54E and Membrane 54H. This effect was more pronounced for Membrane 54E (EGA crosslinker), with a reduction of approximately 37% when moving from 50 mM TRIS+50 mM NaCl (T-05, 9.8 mS/cm) to 0.5×PBS (P-05, 9.1 mS/cm), compared to only a 5% reduction for Membrane 54H under the same conditions.

This buffer sensitivity suggests that the specific buffer components interact differently with the membrane and protein. TRIS, containing amine and hydroxyl groups, can participate in both electrostatic and hydrogen bonding interactions, potentially synergizing with the hydrogen bonding capabilities of the PEI microgels (especially in Membrane 54H) to maintain higher capacity even as electrostatic interactions are screened. PBS, composed primarily of inorganic phosphate salts, lacks these hydrogen bonding groups and primarily contributes to ionic strength, leading to more pronounced screening of electrostatic binding and thus lower overall capacity.

To further probe the role of hydrogen bonding from buffer components, SBC was measured in 1×PBS containing 50 mM glycerol (P-1G, conductivity ~18 mS/cm), compared to 1×PBS alone (P-10, conductivity ~17.6 mS/cm). Glycerol, a neutral molecule capable of hydrogen bonding, significantly improved the SBC (by over 40% for Membrane 54H, comparing P-1G to P-10 in FIG. 19), supporting the hypothesis that hydrogen bonding contributions from the surrounding medium can enhance protein binding capacity in these systems.

### Example 8: Dynamic Binding Capacity Evaluation Under Flow Conditions

This example evaluates the dynamic binding capacity (DBC) for BSA of a preferred mixed matrix PVDF-PEI membrane embodiment (Membrane 54H, prepared with BCAH crosslinker at NCD≈0.5 using IPA nonsolvent) under flow conditions, according to the general methods. The effects of volumetric flow rate and buffer salinity on DBC were investigated.

### Effect of Flow Rate on Dynamic Binding Capacity

DBC measurements were performed using BSA (2.0 mg/mL) in 50 mM TRIS buffer (pH 7.4, no added NaCl) at various volumetric flow rates: 2, 4, 8, and 10 membrane volumes per minute (MV/min). The resulting breakthrough curves are conceptually depicted in FIG. 20.

Unlike some traditional membrane chromatography materials where binding capacity can be independent of flow rate over a wide range the mixed-matrix membranes described herein exhibit some flow rate dependence, particularly at lower flow rates. At lower flow rates (e.g., 2 and 4 MV/min), the calculated DBC at 10% breakthrough is higher compared to higher flow rates. This is attributed to the increased residence time allowing BSA molecules more time to diffuse into and interact with binding sites within the porous, three-dimensional structure of the embedded PEI microgels.

As the flow rate increases (e.g., to 8 and 10 MV/min), the DBC at 10% breakthrough reaches a plateau and becomes less dependent on flow rate (FIG. 20). Under these higher flow conditions, mass transfer is likely dominated by convection, and binding primarily occurs at the more readily accessible surfaces or outer regions of the PEI microgels, similar to conventional membrane adsorbers.

### Effect of Salt Concentration on Dynamic Binding Capacity Under Flow

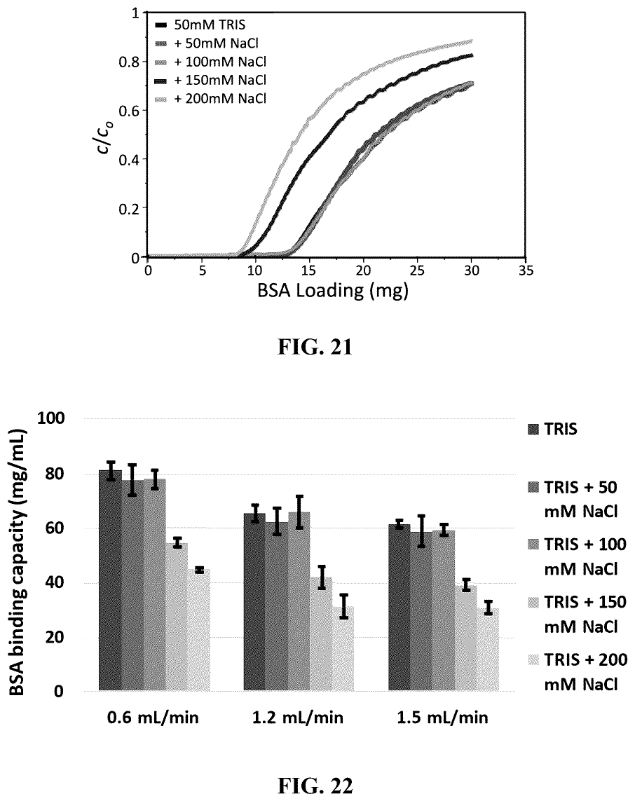

The salt tolerance of Membrane 54H was evaluated under flow conditions by performing DBC measurements at a constant flow rate (e.g., 4 MV/min, corresponding to 0.6 mL/min) using BSA (2.0 mg/mL) in 50 mM TRIS buffer (pH 7.4) with varying added NaCl concentrations (0, 50, 100, 150, and 200 mM). The resulting breakthrough curves are conceptually depicted in FIG. 21.

The salt tolerance observed under dynamic flow conditions is consistent with the trends observed in the static binding measurements (Example 7). The BSA breakthrough curves, and thus the calculated DBC at 10% breakthrough, remain essentially constant for NaCl concentrations up to 100 mM (conductivity approx. 15 mS/cm). At higher salt concentrations (150 mM and 200 mM NaCl), the breakthrough curves shift earlier (to lower BSA loading), indicating a decrease in DBC, as expected due to increased charge screening.

The effect of salt concentration on DBC was compared across different flow rates (4, 8, and 10 MV/min, corresponding to 0.6, 1.2, and 1.5 mL/min respectively), as conceptually depicted in FIG. 22. The percentage reduction in DBC when comparing the buffer with 200 mM NaCl to the buffer with 0 mM NaCl was calculated for each flow rate. The reductions were approximately 45±3% (at 4 MV/min), 52±9% (at 8 MV/min), and 50±5% (at 10 MV/min). The lack of a statistically significant difference (p-value≤0.05) between these percentage reductions across the tested flow rates suggests that the intrinsic salt tolerance mechanism (combination of electrostatic and hydrogen bonding) operates similarly throughout the accessible regions of the PEI microgels, whether probed at lower flow rates (allowing deeper penetration) or higher flow rates (favoring surface interactions).

### Example 9: Structure-Function Relationships for Optimized Membrane Adsorbers

The preceding examples investigated the influence of crosslinker chemistry and crosslink density on the morphology and functional properties (volumetric binding capacity and salt tolerance) of the mixed matrix PVDF-PEI membranes prepared using IPA as the nonsolvent.

As demonstrated in Example 6, the volumetric static binding capacity (SBC) for BSA exhibits a non-linear relationship with crosslink density, and this relationship is dependent on the specific crosslinker chemistry employed. For homofunctional crosslinkers like EGA and BCAH, an optimal binding capacity was observed at an intermediate normalized crosslink density (NCD) of approximately 0.5 (CD≈2). This optimum represents a balance between achieving sufficient crosslinking for particle cohesion and PEI retention, while maintaining an open microgel network structure conducive to protein binding (Example 5 and Example 6). In contrast, the heterofunctional crosslinker ECH showed decreasing SBC with increasing NCD under the conditions tested (Example 6). Notably, changing the crosslinker chemistry from ECH to specific homofunctional crosslinkers like BCAH at the optimal NCD (0.5) yielded significantly higher maximum binding capacities (e.g., >100 mg/mL SBC for BCAH, Membrane 54H) (Example 6).

The optimized membrane formulation exhibiting high SBC (Membrane 54H, using BCAH at NCD≈0.5) was further evaluated for salt tolerance and dynamic binding performance (Example 7 and Example 8). Static binding measurements confirmed excellent salt tolerance for Membrane 54H, maintaining high binding capacity (comparable to binding in water or low salt buffer) in 50 mM TRIS buffer with up to 100 mM added NaCl (Example 7).

Dynamic binding capacity (DBC) measurements revealed a flow-rate dependency at lower flow rates (e.g., 2-4 MV/min), where longer residence times likely allow for greater diffusion and utilization of binding sites within the PEI microgels, similar in principle to resin chromatography (Example 8). At higher flow rates (e.g., ≥8 MV/min), the DBC reached a plateau, becoming less dependent on flow rate, consistent with convection-dominated transport typical of membrane adsorbers (Example 8). Importantly, the DBC measurements validated the excellent salt tolerance under flow conditions, with Membrane 54H maintaining a high percentage (e.g., >90%) of its binding capacity in buffers containing up to 100 mM added NaCl across the flow rates tested (Example 8)

### Third Set of Examples Symmetric Skinless Membranes as a Platform for Flow Through, High Capacity, Weak Base and Salt Tolerant Anion Exchange Membrane Adsorbers for Downstream Bioprocessing (Examples 10-19)

### Example 10: Overview and Rationale for Symmetric Skinless Mixed Matrix AEX Membrane Adsorbers

The growth of the monoclonal antibody (mAb) therapeutic market necessitates improvements in downstream bioprocessing, particularly for mAb purification and polishing. Membrane chromatography (MC) presents advantages over traditional resin-based column chromatography for product polishing, including higher processing rates and suitability for single-use systems-[6], [9]-[10] [28][9] [29] [10] R. Jacquemart, 2016 #118} Anion exchange (AEX) membrane adsorbers are particularly useful for removing negatively charged impurities (e.g., host cell proteins, DNA, viruses) while allowing mAb product to flow through-[8].

TABLE 10
List and specifications of selected commercial anion exchange (AEX) membrane
adsorbers used in downstream bioprocessing to remove product impurities
including host cell proteins (HCP), viruses, DNAs, etc..[30]

| Membrane | BSA dynamic | Membrane Substrate and Ligand | Product Specification |
|---|---|---|---|
| Tradename | binding capacity | Chemistry | and Manufacturer |
| Sartobind Q | ¹BSA: 29 mg/ml | Regenerated cellulose (RC) flat sheet | Strong base AEX |
| | | microfiltration (MF) membrane (>3 μm | membrane adsorber |
| | | pore diameter) functionalized with | (Sartorius) |
| | | quaternary amine ligands | |
| Sartobind STIC | ¹BSA: 36 mg/mL in | RC flat sheet MF membrane (>3 μm pore | Weak base and salt |
| | 200 mM NaCl | diameter) functionalized with primary | tolerant AEX membrane |
| | | amine ligands | adsorber (Sartorius) |
| Mustang Q | ¹BSA: 70 mg/ml | Polyethersulfone MF membrane (0.8 μm | Strong base AEX |
| | | pore diameter) functionalized with | membrane adsorber (Pall). |
| | | quaternary amine ligands | This membrane is now a |
| | | | product of Cytiva. |
| ChromaSorb | ²BSA: 63 mg/mL | ¹Polyethylene (PE) MF membrane (0.65 | Weak base and salt |
| | | μm pore diameter) functionalized with | tolerant AEX membrane |
| | | poly allylamine ligands | adsorber (Millipore) |
| QyuSpeed D | ¹BSA: >40 mg/ml | PE hollow-fiber MF membrane (0.3 μm | Weak base AEX and salt |
| | | pore diameter) functionalized with diethyl | tolerant membrane |
| | | amine ligands | adsorber (Asahi Kasei |
| | | | Medical) |
| NatriFlo HD-Q | ¹BSA: >200 mg/ml | ³Functionalized 3D hydrogel with | ⁴Strong base AEX |
| | | quaternary amine ligands prepared by the | membrane adsorber |
| | | polymerization of trimethylammonium | (Natrix). This membrane |
| | | chloride (APTAC) within and around a | is now being sold under |
| | | polypropylene (PP) MF membrane (0.45 | the tradename of |
| | | μm pore diameter) using N,N′- | “Natrix Q chromatography |
| | | methylenebisacrylamide (MBAm) as | membrane” by Millipore. |
| | | crosslinker. | |

¹The membrane product specifications and BSA dynamic binding capacity (DBC) data were taken from [17]
²The membrane BSA DBC data were taken from [31]]
³U.S. Pat. No. 8,206,982 [32] provides a detailed description of the methods and procedures used to prepare the NatriFlo HD-Q membrane adsorber. See also Teepakorn, 2016 #116}
⁴Natrix Q membrane.[33]

Key challenges in AEX membrane adsorber development include achieving high volumetric binding capacity and sufficient salt tolerance to handle bioprocessing streams without extensive buffer exchange [34] Early AEX membranes had limited capacity, and strong-base AEX membranes (e.g., using quaternary amines) exhibit sensitivity to salt due to charge screening, [35] While weak base (WB) AEX membranes (e.g., using primary/secondary amines) offer improved salt tolerance via mechanisms like hydrogen bonding, prior examples often had limited binding capacity under relevant salt conditions (e.g., <50 mg/mL BSA in ~100 mM NaCl). [22]] [36] [35] [21] [31] [34] Furthermore, previous fabrication methods typically involved complex, multi-step processes. Thus, a need exists for efficient, scalable methods to produce high-capacity, salt-tolerant WB AEX membranes.

Foundational studies described a one-pot, single-step phase inversion casting process for preparing mixed matrix polyvinylidene difluoride (PVDF) ultrafiltration (UF) membranes with in-situ synthesized and crosslinked polyethyleneimine (PEI) microparticles using epichlorohydrin (ECH) as a crosslinker. This method overcomes limitations of traditional mixed matrix membrane preparation, achieving stable, high loadings (27-48 wt %) of functional PEI particles within an asymmetric PVDF matrix. The in-situ process involves dissolving PVDF and PEI in a solvent (triethyl phosphate, TEP), adding catalytic acid (HCl) to induce phase separation into PEI-rich droplets, crosslinking the PEI within these droplets using ECH, and casting the resulting dope dispersion via nonsolvent induced phase separation (NIPS) using water as the nonsolvent. The resulting UF membranes were asymmetric with dense skin layers.

While these prior UF membranes demonstrated protein binding capacity (e.g., 105 mg/mL BSA SBC), their structure presented critical shortcomings for use as flow-through AEX adsorbers in downstream bioprocessing. Specifically, the dense skin layer resulted in low water permeability (~23 L/m²/hr/bar) and susceptibility to fouling during protein filtration, inconsistent with the high flux requirements (MF range, >1000 L/m²/hr at 2 bar) for efficient membrane chromatography.

To meet the operational requirements for high-performance AEX membrane adsorbers (high flux, high capacity, salt tolerance), modifications to the in-situ synthesis and casting process were investigated. Key requirements include achieving symmetric, microporous membrane morphologies without a skin layer, preserving or enhancing weak base (primary/secondary amine) functionality for salt tolerance, and ensuring an open microgel structure within the PEI particles for accessibility.

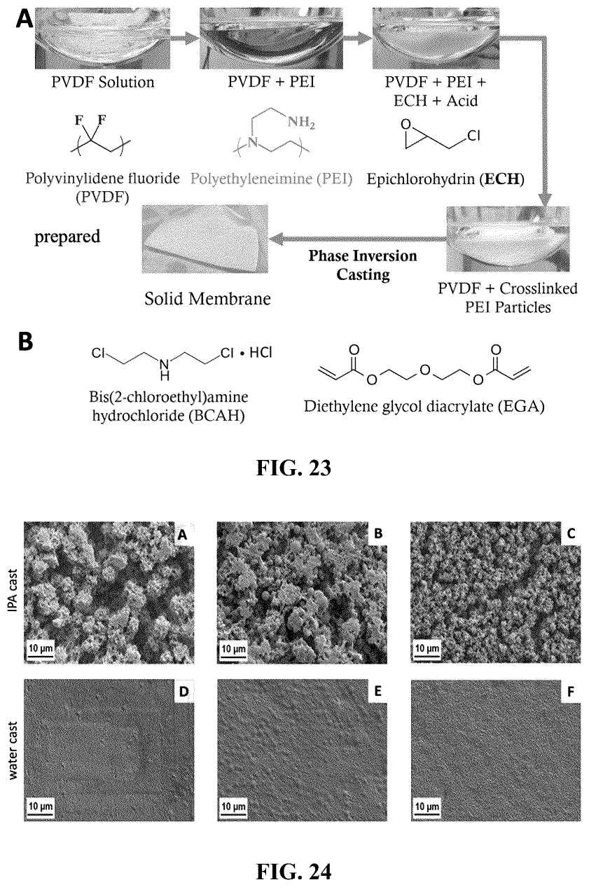

The in-situ PEI particle generation method can modify the NIPS step by using isopropyl alcohol (IPA), a “soft” nonsolvent, instead of water (“hard” nonsolvent). Additionally, alternative crosslinkers such as diethylene glycol diacrylate (EGA) and bis(2-chloroethyl)amine hydrochloride (BCAH), can be used as an alternative ECH (conceptually shown in FIG. 23). Both EGA and BCAH can potentially yield more open PEI microgel networks compared to the shorter ECH crosslinker. Significantly, BCAH incorporates an additional secondary amine group upon reaction, potentially compensating for amine consumption during crosslinking and enhancing salt tolerance (FIG. 23).

As demonstrated in subsequent examples based on this study, utilizing NIPS with IPA as the nonsolvent successfully produces mixed matrix PVDF-PEI membranes with open, symmetric morphologies suitable for operation in the microfiltration (MF) regime, exhibiting high water flux (>1000 L/m²/hr at 2 bar). Static binding capacity (SBC) measurements suggest that using longer or more hydrophilic crosslinkers (EGA, BCAH) can result in more open PEI microgel networks favoring protein binding Furthermore, SBC measurements confirm that using BCAH as the crosslinker significantly improves salt tolerance. Dynamic binding capacity (DBC) measurements indicate that an optimized membrane (high loading of BCAH-crosslinked PEI particles, e.g., ~51 wt %) functions as a high-capacity (e.g., ~60 mg/mL BSA DBC at 10 MV/min) and salt-tolerant (effective up to ~100 mM NaCl) WB AEX membrane adsorber. These results establish that the modified one-pot, single-step process using specific nonsolvents (e.g., IPA) and crosslinkers (e.g., BCAH) provides a promising platform for scalable production of advanced membrane adsorbers for downstream bioprocessing.

Accordingly, certain aspects of the disclosure are new mixed matrix PVDF-PEI membranes suitable for use as flow-through, high-flux (microfiltration regime, e.g., >1000 L/m²/hr at 2 bar), high-capacity, and salt-tolerant WB AEX membrane adsorbers. The membrane microstructure can be tuned, for example by modifying the nonsolvent used during phase inversion casting to move away from the previously studied “tight” UF regime (low water permeability of ~23 L/m²/hr/bar). Additionally, the structure and composition of the embedded PEI microgels can be optimized by varying PEI particle loading, the degree of crosslinking, and the chemistry/molecular structure of the crosslinkers (conceptually shown in FIG. 23).

### Example 11: Effect of Nonsolvent Selection on Membrane Morphology

The membrane structure for downstream bioprocessing applications can be optimized by varying, the nonsolvent selection and PEI microparticle loading on the physicochemical properties and microstructures of mixed matrix PVDF-PEI membranes. Membranes were prepared according to the general methods using in-situ synthesized PEI microparticles crosslinked with ECH at a constant crosslink density (CD) of approximately 4 (corresponding to approx. 28 wt % ECH in the PEI particles). A series of membranes with varying target PEI loadings (6, 21, 38, 48, and 54 wt % in the final membrane, see Table 11 for formulation details) were prepared using nonsolvent induced phase separation (NIPS) with either water or isopropyl alcohol (IPA) as the nonsolvent in the coagulation bath. Membrane morphologies were characterized by SEM, and resulting thicknesses and mean particle diameters were determined (Table 11).

TABLE 11
Composition and physicochemical properties of dry PVDF-PEI membranes prepared
using ECH as crosslinker as a function of PEI content and choice of nonsolvent,
either water or isopropyl alcohol (IPA), used in the coagulation bath.

| ¹Wt % | ²Casting | ²Casting | | | Mean | Mean |
|---|---|---|---|---|---|---|
| of PEI | dispersion | dispersion | Dry | Dry | particle | particle |
| particles | composition: | composition: | Thickness: | Thickness: | diameter: | diameter: |
| in the dry | PEI | ECH | water cast | IPA cast | water cast | IPA cast |
| membrane | (g) | (g) | (μm) | (μm) | (μm) | (μm) |
| 6 | 0.26 | 0.17 | 215.5 ± | 378.6 ± | 1.2 ± | 1.1 ± |
| | | | 3.7 | 1.9 | 0.4 | 0.4 |
| 21 | 1.10 | 0.71 | 253.9 ± | 384.6 ± | 1.5 ± | 1.6 ± |
| | | | 2.1 | 5.9 | 0.6 | 0.5 |
| 38 | 2.58 | 1.65 | 264.9 ± | 375.5 ± | 1.8 ± | 1.8 ± |
| | | | 9.2 | 6.2 | 0.7 | 0.7 |
| 48 | 3.88 | 2.48 | 290.9 ± | 379.3 ± | 0.9 ± | 0.9 ± |
| | | | 4.7 | 6.3 | 0.2 | 0.2 |
| 54 | 5.00 | 3.20 | 316.1 ± | 401.4 ± | 0.9 ± | 0.9 ± |
| | | | 5.7 | 5.2 | 0.2 | 0.2 |

¹The mass fraction of crosslinked polyethyleneimine (PEI) microparticles in the dry PVDF-PEI membrane is estimated assuming that the crosslinking reaction of PEI with epichlorohydrin (ECH) releases one HCl molecule (not incorporated into the membrane). The remainder of the dry mass is polyvinylidene difluoride (PVDF).
²Each casting dispersion was prepared with fixed amounts of triethyl phosphate (TEP, 37.45 g) and polyvinylidene difluoride (PVDF, 5.91 g). The ECH:PEI ratio was approximately constant with a crosslink density (CD) of 4.16 ± 0.02 mole ECH per mole PEI, for which ECH contributes 28 wt % of the dry crosslinked PEI particles.

Surface Morphology: Skinless Vs. Skinned Structures

The most significant effect observed related to the choice of nonsolvent was the presence or absence of a dense skin layer on the membrane surface exposed to the coagulation bath (FIG. 24). Membranes cast using IPA as the nonsolvent uniformly exhibited open surface structures without a discernible skin layer, regardless of PEI particle loading (FIG. 24 panels A-C). In contrast, all membranes cast using water as the nonsolvent developed dense PVDF skin layers at their surfaces, again regardless of PEI particle loading (FIG. 24 panels D-F).

This difference is attributed to the nature of the nonsolvent and its interaction with the PVDF/TEP system during NIPS. Water acts as a “hard” nonsolvent for PVDF, causing instantaneous phase separation (demixing) at the interface upon immersion. This rapid, kinetically driven process leads to the formation of the observed asymmetric structure with a “tight” PVDF skin layer. This skin layer then acts as a barrier, slowing nonsolvent ingress and solvent egress deeper within the film, where solidification occurs more gradually, often resulting in a sponge-like matrix formed via nucleation and growth of PVDF spherulites. The formation of such skin layers in water-cast PVDF systems, including mixed matrix membranes with in-situ synthesized particles, is consistent with previous reports [37] [38] [39].] [3, 40, 41] [42] [43] [44]

Membranes exhibiting these tight PVDF skin layers typically function as UF membranes with lower water permeability, which can limit their suitability for high-throughput AEX membrane chromatography applications

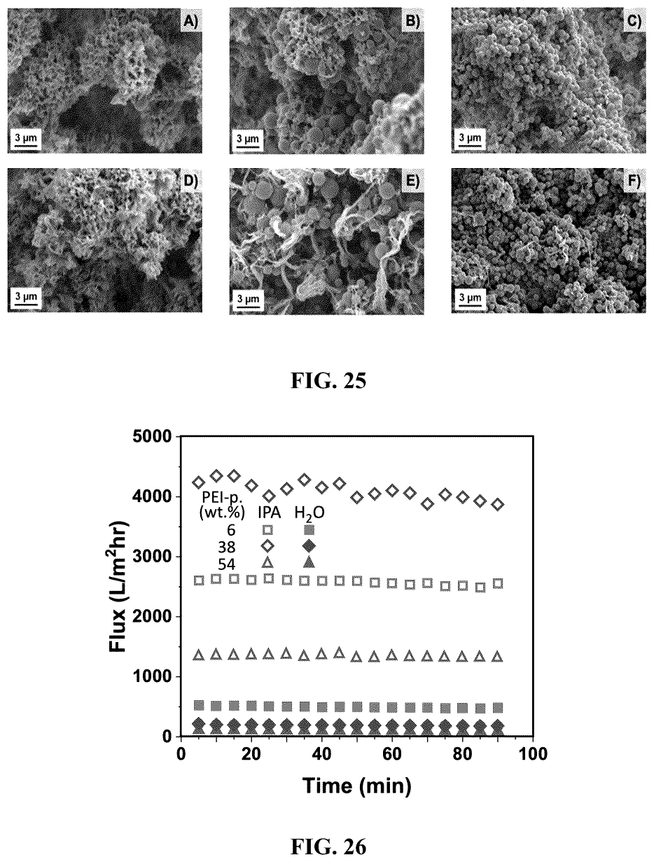

Isopropyl alcohol (IPA), conversely, acts as a “soft” nonsolvent for the PVDF/TEP system, requiring a higher concentration and longer diffusion times to induce phase separation. This results in delayed demixing at the interface. The slower phase separation kinetics prevents the formation of a distinct skin layer and promotes a more uniform solidification process throughout the membrane thickness, leading to a symmetric membrane structure with a sponge-like microstructure (FIG. 24 panels A-C). The internal, bulk morphologies observed in the cross-sections of water-cast membranes (formed under conditions of gradual solidification beneath the skin) often resemble the symmetric morphology observed throughout the IPA-cast membranes (compare FIG. 25 top and bottom).

PEI Particle Diameter Independence from Nonsolvent

As shown in Table 11, the average diameter of the embedded ECH-crosslinked PEI microparticles appears independent of whether IPA or water was used as the nonsolvent in the coagulation bath. This suggests that the final particle size distribution (PSD) is primarily established during the in-situ crosslinking reaction phase within the dope dispersion, prior to the NIPS casting step. Based on related studies Ford, 2021 #131}, the PSD likely results from the dynamics of coalescence and breakup of phase-separated PEI-rich domains (formed upon acid addition) during the ECH-PEI crosslinking reaction.

### Example 12: Effect of PEI Loading on PEI Microparticle Morphology

This example describes the influence of the initial weight fraction of PEI in the membrane casting dispersion on the characteristics of the resulting in-situ synthesized ECH-crosslinked PEI microparticles within the final mixed matrix PVDF-PEI membranes, prepared according to the general methods and characterized via SEM. The membranes discussed in this example were prepared using ECH as the crosslinker at a constant crosslink density (CD) of approximately 4. The number density and mean diameter of the embedded PEI microparticles depend significantly on the target PEI loading. At lower target PEI loadings (defined here as up to and including 38 wt % in the final membrane), both the apparent particle number density observed in SEM micrographs (FIG. 24 and FIG. 25) and the measured mean particle diameter (Table 11) increase as the PEI weight fraction increases. For instance, the mean diameter increases from approximately 1.1-1.2 μm at 6 wt % PEI loading to 1.8 μm at 38 wt % PEI loading (Table 11).

Concurrently, the polydispersity in particle size, indicated by the standard deviation of the measured diameters (Table 11), also appears to increase as the PEI loading increases from 6 wt % to 38 wt % 5. This behavior at lower PEI loadings is consistent with expectations for a two-phase dispersion (PEI-rich droplets in PVDF/TEP continuous phase) undergoing coalescence and breakup under shear. Factors such as increased dispersed phase concentration (favoring coalescence), increased dispersed phase viscosity due to crosslinking (favoring larger droplets), and potentially increased interfacial tension likely contribute to the observed increase in average size and polydispersity within this loading regime.

However, at higher target PEI loadings (48 wt % and 54 wt %), this trend unexpectedly reverses. The average particle diameter drops significantly to approximately 0.9 μm, and the particle size distribution (PSD) becomes narrower (Table 11).

A possible explanation for the formation of smaller, more uniform particles at these high PEI loadings involves a shift in the nucleation and growth dynamics during the in-situ crosslinking process Several factors could contribute: (i) reaction kinetics may become significantly faster at higher concentrations of both PEI and ECH; (ii) the ECH-PEI reaction releases HCl, which could potentially induce a more rapid and deeper quench into the two-phase regime, causing sudden and widespread nucleation of many small PEI-rich droplets simultaneously; and (iii) the extent of crosslinking may increase rapidly, quickly stabilizing the droplets and preventing further coalescence or breakup while they are still relatively small. Further investigation is needed to fully elucidate the mechanisms controlling particle size at these high loadings.

From the perspective of designing AEX membrane adsorbers for applications like mAb polishing, the formation of smaller PEI microparticles (as observed at 48-54 wt % loading) can be advantageous. [22] Smaller particles potentially reduce the intraparticle diffusion distance required for target impurity molecules (e.g., host cell proteins) to access the weak base amine binding sites distributed throughout the PEI microgel network, which could lead to improved binding kinetics or efficiency under flow conditions.

### Example 13: Water Flux Performance in Relation to Membrane Composition and Morphology

This example evaluates the water flux performance of mixed matrix PVDF-PEI membranes prepared with different nonsolvents and PEI particle loadings, correlating flux with the structural characteristics described in previous examples. The objective was to assess the impact of membrane composition and microstructure on water permeability under conditions relevant to downstream bioprocessing (low pressure, ~2 bar) and to benchmark against prior UF membranes,

Water flux measurements were conducted using membranes prepared according to the general methods, specifically those described in Example 11 using ECH as the crosslinker (CD≈4) with target PEI particle loadings of 6, 38, and 54 wt. %. Both membranes cast using IPA as the nonsolvent (resulting in symmetric, skinless MF structures) and membranes cast using water as the nonsolvent (resulting in asymmetric, skinned UF structures) were tested. Flux was measured at a constant pressure of 2 bar and room temperature using a crossflow filtration system (FIG. 4), following the procedures detailed in the general methods. Results are conceptually depicted in FIG. 26.

Effect of Nonsolvent (IPA Vs. Water)

Membranes cast using IPA as the nonsolvent consistently exhibited significantly higher water fluxes compared to their counterparts cast using water (FIG. 26). The fluxes measured for IPA-cast membranes (ranging from >1000 to ≥4000 L/m²/hr (LMH) at 2 bar) fall within the typical range reported for microfiltration (MF) membranes (approx. 500-10,000 LMH/bar) In contrast, the fluxes measured for water-cast membranes were much lower, falling within the range typical for ultrafiltration (UF) membranes (approx. 50-800 LMH/bar)

This difference directly correlates with the membrane morphology established in Example 11. The high flux of the IPA-cast membranes is attributed to their symmetric, open, and skinless microstructure. The low flux of the water-cast membranes is attributed to the presence of the dense, flow-restricting skin layer formed during rapid phase separation. The high flux achieved with the IPA-cast membranes confirms their suitability for potential use as flow-through adsorbers

### Results: Effect of PEI Loading

The influence of PEI particle loading on water flux differed between the two types of membranes. For water-cast membranes, the flux decreased as the PEI loading increased from 6 wt % to 54 wt % (FIG. 26). This trend is consistent with previous findings and is likely due to increased congestion or blocking of the nanopores within the surface skin layer by the hydrophilic, swellable PEI microgels at higher loadings.

For the IPA-cast (skinless) membranes, the water flux exhibited a non-monotonic dependence on PEI loading (FIG. 26). Flux was moderately high at 6 wt % PEI, increased to a maximum at 38 wt % PEI (≥4000 LMH at 2 bar), and then decreased at 54 wt % PEI (though still ≥1000 LMH).

This non-monotonic behavior for the IPA-cast membranes is interpreted as reflecting a balance between membrane hydrophilicity and available pore volume for flow. Increasing PEI loading from 6 wt % to 38 wt % increases overall membrane hydrophilicity, which facilitates water transport and tends to increase flux. However, further increasing PEI loading from 38 wt % to 54 wt % significantly increases the volume fraction occupied by the swollen PEI microgels within the membrane matrix. This reduces the effective pore volume available for convective water flow, thereby impeding mass transfer and decreasing the overall flux, despite the potentially higher hydrophilicity. The 38 wt % PEI loading appears to represent an optimal balance, yielding the highest flux under these conditions.

### Example 14: Rationale for Optimization of Crosslinker Chemistry and Density

The initial mixed matrix PVDF-PEI membranes characterized in the preceding examples utilized epichlorohydrin (ECH) as the crosslinker at a relatively high crosslink density (CD≈4). While effective in forming stable PEI microparticles, it was hypothesized that modifications to the crosslinking strategy could potentially enhance membrane performance, particularly BSA binding capacity, accessibility of binding sites, and salt tolerance.

Specifically, a high crosslink density using ECH could present potential disadvantages for protein binding. First, the high ratio of ECH reactive groups relative to PEI primary amine groups (at CD≈4) might lead to extensive conversion of primary amines first to secondary amines, and subsequently to tertiary amines. This could significantly deplete the number of primary and secondary amine groups within the PEI microgels, which are believed to be crucial for achieving salt tolerance through both electrostatic and hydrogen-bonding interactions with target protein impurities (e.g., host cell proteins).

Second, a high degree of crosslinking might result in a very dense network structure within the PEI microgels. Such a dense network could physically hinder the diffusion of larger molecules like proteins (e.g., BSA, host cell proteins) into the microgel interior, rendering a significant portion of the amine binding sites inaccessible during operation, particularly under flow conditions.

Therefore, to potentially improve performance, subsequent experiments explored alternative crosslinking approaches. These included preparing membranes using lower crosslink densities with ECH (e.g., CD≈2 and CD≈1). Additionally, two alternative crosslinkers were investigated: one selected to potentially offset the loss of hydrogen-bonding capable amines during crosslinking (BCAH), and another selected to potentially increase the distance between crosslinks (EGA), aiming to produce AEX membrane adsorbers with more open and accessible PEI microgel structures. The results of these investigations are presented in the following examples.

### Example 15: Preparation and Morphological Characterization of Weak Base AEX Membranes with Varying Crosslinkers and Crosslink Densities

Based on the preceding examples demonstrating the suitability of IPA-cast membranes for high-flux MF applications, a series of mixed matrix PVDF-PEI membranes were prepared to investigate the effects of crosslinker chemistry and crosslink density on membrane properties relevant to AEX adsorption, including protein binding capacity (evaluated in subsequent examples). BSA was selected as the model protein for evaluation, consistent with standard practices in membrane chromatography

### Baseline Formulation and Rationale

The IPA-cast membrane formulation containing approximately 54 wt. % PEI microparticles crosslinked with ECH at CD≈4 (described in Examples 11-13, see Table 11) was chosen as a “baseline” reference. This selection was based on two key factors: (1) this formulation exhibited the highest loading of functional PEI particles while maintaining high water flux (~1400 LMH at 2 bar, FIG. 26), suitable for MF operation; and (2) SEM analysis (FIG. 24 panel C, FIG. 25 panel C) indicated that at this high PEI loading, the PEI particles appeared to completely cover the underlying PVDF spherulitic structure, potentially minimizing non-specific interactions and facilitating mass transport.

### Experimental Design: Varying Crosslinkers and Crosslink Densities

Nine membrane adsorber candidates were prepared using the general in situ synthesis and NIPS casting method with IPA as the nonsolvent, maintaining a fixed high target PEI loading (approx. 5.00 g PEI per batch, aiming for ~50-60 wt % in the final membrane depending on crosslinker weight). Three different crosslinkers were evaluated
Epichlorohydrin (ECH): A short, heterofunctional crosslinker containing reactive epoxide and chloro groups, yielding hydroxyl groups upon reaction
Bis(2-chloroethyl)amine hydrochloride (BCAH): A medium-length, homofunctional crosslinker containing two reactive chloro groups and incorporating a secondary amine group into the network upon reaction.
Diethylene glycol diacrylate (EGA): A longer, homofunctional crosslinker containing two reactive acrylate groups (undergoing Aza-Michael addition) and incorporating a hydrophilic glycol moiety into the network

For each crosslinker, three different crosslink densities (CD), defined as the molar ratio of crosslinker to PEI, were targeted: CD≈1, CD≈2, and CD≈4 (corresponding NCDs 0.25, 0.5, 1.0 relative to the baseline CD≈4 condition). The crosslink density serves as a surrogate for the degree of crosslinking within the PEI microgels, which is expected to influence particle swelling, network openness, and mechanical strength-[19], [32]-[33], 1026-1027]. The specific amounts of each crosslinker used to achieve these target CDs, along with calculated final membrane compositions, are detailed in Table 12.

TABLE 12
Compositions of the casting dispersions used to prepare
PVDF-PEI membrane adsorber candidates with in-situ generated
PEI particles using nonsolvent induced phase separation
(NIPS) (with isopropyl alcohol as nonsolvent) and different
crosslinkers and crosslinker densities

| | | | | | ⁵Wt % |
|---|---|---|---|---|---|
| | | ³Cross- | | ⁵Wt % | PEI |
| | ²Cross- | linker | ⁴Crosslink | crosslinker | particles |
| ¹Membrane | linker | mass | density | in PEI | in the |
| Formulation | Chemistry | (g) | (CD) | particles | membranes |
| 54A | ECH | 3.2 | 4 | 28 | 54 |
| 54B | ECH | 1.6 | 2 | 16 | 50 |
| 54C | ECH | 0.8 | 1 | 9 | 48 |
| 54D | EGA | 7.4 | 4 | 59 | 67 |
| 54E | EGA | 3.7 | 2 | 42 | 59 |
| 54F | EGA | 1.8 | 1 | 26 | 53 |
| 54G | ⁶BCAH | 6.2 | 4 | 32 | 56 |
| 54H | ⁶BCAH | 3.1 | 2 | 19 | 51 |
| 54I | ⁶BCAH | 1.6 | 1 | 11 | 49 |

¹The formulation with 54 wt % ECH-crosslinked polyethyleneimine (PEI) particles (CD ≈ 4) in the dry membrane (Table 11) was selected as the “baseline”.
²Epiclohydrin (ECH), bis(2-chloroethyl)amine hydrochloride (BCAH) and diethylene glycol diacrylate (EGA) were used as crosslinkers.
³The crosslinker was added to fixed amounts of PEI (5.00 g), PVDF (5.91 g) and TEP (37.45 g).
⁴Crosslink Density, defined as the ratio of moles crosslinker to moles PEI in the membrane casting dispersion, nominal values 4, 2 and 1 correspond to actual values 4.16 ± 0.02, 2.07 ± 0.01 and 1.04 ± 0.03, respectively.
⁵Crosslinker wt. % in the PEI particles and wt % PEI particles in the membranes are calculated assuming crosslinking reactions of PEI with ECH, BCAH, and EGA respectively release one HCl, three HCl, and two protons (H⁺) into the membrane casting dispersions; otherwise, we assume that all the PEI and crosslinker in the casting dispersion are incorporated into the membrane.
⁶For membranes prepared using BCAH, DMSO was used as solvent to dissolve BCAH prior to addition in the membrane casting dispersions using 8 mL, 5 mL, and 2.5 mL of DMSO for CD ≈ 4, 2 and 1, respectively.

Membranes were prepared following the general procedures, including dissolving BCAH in DMSO prior to addition due to its limited solubility in TEP.

### Morphological Characterization by SEM

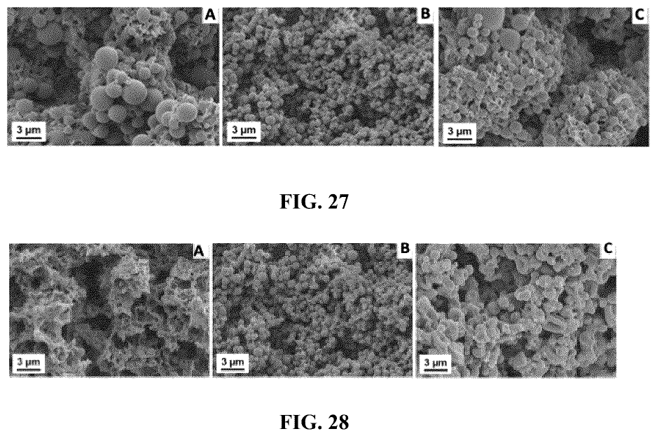

SEM analysis was performed on the cross-sections of the resulting membranes to assess the morphology of the embedded PEI microparticles. FIG. 27 shows representative micrographs comparing the morphologies obtained using the three different crosslinkers at a fixed intermediate crosslink density (CD≈2/NCD 0.5). Significant differences were observed. ECH (FIG. 27 panel A) produced relatively distinct spherical particles but with a broad size distribution (approx. 0.5-3 μm), differing from the more uniform particles seen with ECH at CD≈4 (FIG. 24 panel C). EGA (FIG. 27 panel C) resulted in particles that appeared more interconnected. BCAH (FIG. 27 panel B) produced particles with a notably smaller average size and tighter size distribution under these conditions, resembling the morphology seen with ECH at the higher CD≈4.

FIG. 28 specifically shows the effect of varying the crosslink density (CD≈1, 2, and 4) for membranes prepared using BCAH as the crosslinker. At the lowest CD of 1 (FIG. 28 panel A), few distinct particles were visible, suggesting suppressed particle formation or retention. At CD≈2 (FIG. 28 panel B), well-defined particles with a relatively tight size distribution were observed¹³. At the highest CD of 4 (FIG. 28 panel C), the particles exhibited a morphology consistent with collapsed hollow spheres in the dry state. Additionally, the morphology of the surrounding PVDF matrix in the CD≈4 sample appeared altered, potentially due to the higher concentration of DMSO co-solvent introduced with the BCAH, similar to effects observed with NMP/water mixtures (Example 11). These morphological variations resulting from changes in crosslinker chemistry and density are expected to influence the functional performance of the membranes, as evaluated in subsequent examples

### Example 16: Evaluation of Static Binding Capacity in Aqueous Solution

This example evaluates the static binding capacity (SBC) for BSA of the nine mixed matrix PVDF-PEI membrane adsorber candidates prepared in Example 15 (formulations 54A-54I, Table 12), investigating the combined effects of crosslinker chemistry (ECH, EGA, BCAH) and crosslink density (CD≈1, 2, and 4). SBC measurements were performed in distilled water according to the general methods, using BSA as the model protein.

The measured SBC values for the nine membrane candidates are conceptually depicted in FIG. 29. Each data point represents the average of three or more measurements, with error bars indicating standard deviations. The results reveal distinct relationships between SBC, crosslinker chemistry, and crosslink density.

### Effect of Crosslink Density for EGA and BCAH Crosslinkers

Membranes prepared using the homofunctional crosslinkers EGA and BCAH both exhibit a maximum in SBC at the intermediate crosslink density of CD≈2 (corresponding to NCD 0.5). Specifically, Membrane 54E (EGA, CD≈2) showed an SBC of approximately 88±3 mg BSA/mL, and Membrane 54H (BCAH, CD≈2) showed an SBC of approximately 105±7 mg BSA/mL. These values are significantly higher than those obtained at lower (CD≈1) or higher (CD≈4) crosslink densities for the respective crosslinkers.

This optimal performance at CD≈2 is attributed to a balance influencing the PEI microgel structure: sufficient crosslinking to ensure particle cohesion and retention within the membrane, yet maintaining a relatively open network structure that allows for adequate swelling in water and accessibility of internal amine binding sites to BSA molecules. At higher crosslink densities (CD≈4, Membranes 54D and 54G), the PEI network becomes too tightly crosslinked, limiting swelling and site accessibility, thus reducing SBC. At lower crosslink densities (CD≈1, Membranes 54F and 54I), insufficient crosslinking likely leads to poor particle cohesion or formation, resulting in the loss of functional PEI material during membrane processing and consequently lower SBC.

### Effect of Crosslinker Chemistry

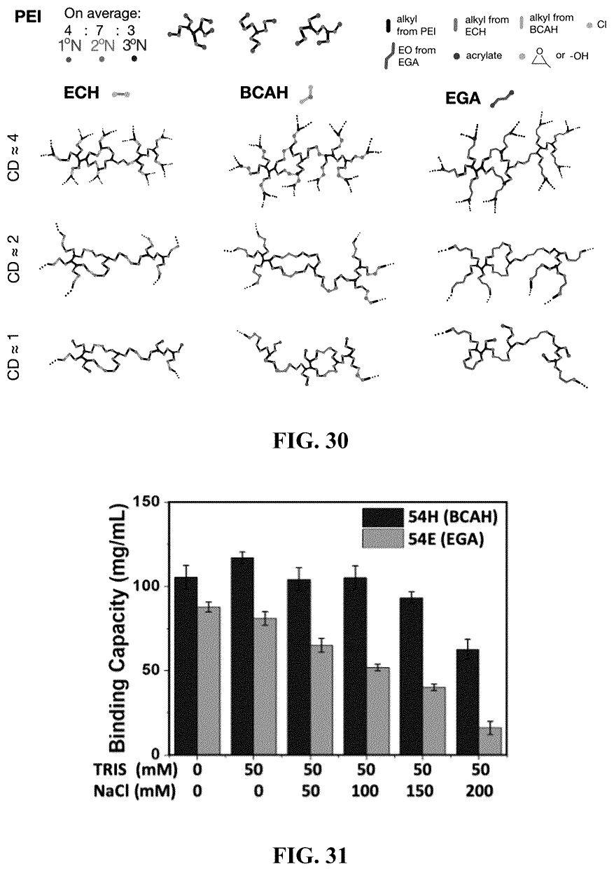

Comparing the different crosslinkers at the same CD reveals the impact of chemical structure. At CD≈2 and CD≈4, membranes crosslinked with BCAH (54H and 54G) consistently show higher SBC than those crosslinked with EGA (54E and 54D). This is attributed to the BCAH molecule incorporating an additional secondary amine group into the PEI network during crosslinking (FIG. 30), thereby increasing the overall density of potential binding sites compared to EGA.

An exception occurs at the lowest density, CD≈1, where the EGA-crosslinked membrane (54F) exhibits higher SBC than the BCAH-crosslinked membrane (54I). The reason for this reversal is not fully determined but may relate to potential differences in reaction kinetics or the structural integrity of the lightly crosslinked networks formed with the shorter BCAH molecule versus the longer EGA molecule, potentially leading to greater loss of PEI material with BCAH under these specific low-crosslinking conditions

### Trend for ECH Crosslinker

Membranes crosslinked with ECH (54A, 54B, 54C) display a different trend, with SBC decreasing as the crosslink density increases from CD≈1 to CD≈4 (FIG. 29). This may be related to ECH being a short, heterofunctional crosslinker. The different reactivities of its epoxide and chloro groups might influence the network formation process. While potentially leading to better PEI retention at the lowest CD compared to BCAH/EGA, the short length and increasing crosslinking at higher CDs likely result in progressively tighter, less accessible PEI networks, explaining the observed decrease in SBC.

Each SBC value in FIG. 29 represents the average value of measurements from three (3) or more experiments with the error bars taken as the standard deviations. Table 13 summarizes the results of the BSA static binding capacity measurements in distilled water and saline TRIS buffer solutions.

Table 13. BSA static binding capacity of the IPA-cast membranes 54H and 54E (using bis(2-chloroethyl)amine hydrochloride (BCAH) and diethylene glycol diacrylate (EGA) as crosslinkers, respectively, with a crosslink density CD≈2) in 50 mM TRIS buffer (pH 7.4) as a function of added salt (NaCl) concentration. The membranes were prepared using the formulations listed in Table 12.

TABLE 13

| | | |
|---|---|---|
| NaCl | | Static binding capacity |
| Concentration | Conductivity | (mg BSA) / (ml membrane) |

| (mM) | (mS/cm) | BCAH | EGA |
|---|---|---|---|
| 0 | 4.6 | 117 ± 3 | 81 ± 4 |
| 50 | 9.8 | 103 ± 7 | 65 ± 4 |
| 100 | 15.0 | 105 ± 7 | 52 ± 2 |
| 150 | 19.5 | 84 ± 4 | 40 ± 2 |
| 200 | 24.7 | 62 ± 6 | 16 ± 4 |

The trends and data depicted in FIG. 29 and Table 13 provide key insights into the relationships between the chemistry of the crosslinker, the crosslink density (CD), and the BSA static binding capacity of the PVDF-PEI membrane adsorber candidates listed in Table 12

For the membranes 54E and 54H prepared using CD≈2.0, and EGA and BCAH as crosslinkers respectively (Table 12), we hypothesize that their crosslinked PEI particles are open enough to maximize water swelling and the availability of the membrane primary/secondary amine groups to bind BSA macromolecules while having sufficient amounts of crosslinkers in the casting dispersions (Table 12) to maximize particle formation (concentrations and size distributions) and particle cohesiveness. This interplay between particle formation, and particle openness (extent of swelling in water), and cohesiveness could be the reason behind the observed maximum BSA binding capacities of the membrane formulations 54H and 54E (FIG. 29 and Table 13). However, more in-depth investigations will be required to validate this hypothesis.

FIG. 29 also highlights the effect of crosslinker chemistry on the static BSA binding capacity of the membrane formulations prepared using EGA and BCAH as crosslinkers. It is noteworthy that membranes 54G and 54H prepared using BCAH and CD values of ~2.0 and ~4.0 respectively (Table 12) have higher BSA binding capacities (FIG. 29) than the membranes 54D and 54E prepared using EGA as crosslinker with CD values of ~2.0 and ~4.0 respectively (Table 12). Conversely, membrane 54F prepared using EGA as a crosslinker and a lower CD value of ~1.0 (Table 12) has a higher BSA binding capacity (FIG. 29) than membrane 54I prepared using BCAH as crosslinker with a CD~1.0. We attribute the higher BSA binding capacity of the membranes 54G and 54H prepared using BCAH as crosslinkers and CD values of ~2.0 and ~4.0 (FIG. 29) to the incorporation of additional secondary amine (NH) groups into their PEI particles during the crosslinking reactions (FIG. 30). At the present time, we do not have a detailed explanation as to why membrane 54F prepared using EGA as crosslinker with a CD value of ~1.0 has a higher BSA binding capacity than membrane 54I prepared using BCAH as crosslinker with a CD value of ~ 1.0 (Table 12). We speculate that the utilization of a lower CD value (~1.0) and a crosslinker (BCAH) with slower reaction kinetics and shorter chain length in the preparation of membrane 54F could adversely impact both the extent of particle formation (concentrations and size distributions) in the casting dispersions and cohesiveness of the final membrane PEI particles (FIG. 27, Panel A) resulting in a lower BSA binding capacity (FIG. 29).

Finally, we would like to mention that differences in crosslinker chemistry and reactivity could also explain the decrease of the BSA binding capacity of the membranes (54A, 54B and 54C) prepared using ECH as their CD values increase (FIG. 29). In contrast to BCAH and EGA, ECH is a short hetero-bifunctional crosslinker containing two functional groups with its more reactive epoxide groups first undergoing ring opening at 80° C. to react with the primary/secondary amine groups of branched PEI molecules followed by the nucleophilic displacement of the ECH chloro groups by the remaining amino groups of the PEI molecules. We hypothesize the differences in the reaction rates of the ECH epoxide and chloro groups would control the extent of particle formation (concentrations and size distributions) in the membrane casting dispersions and the cohesiveness and openness of the membrane PEI particles resulting in lower extent of particle water swelling and BSA binding capacity (FIG. 29) in distilled water for the PVDF-PEI membranes (FIG. 27 C-D) prepared using ECH as crosslinker and higher CD values. However, more in-depth investigations will be required in this case to validate our hypothesis.

### Example 17: Evaluation of Static Binding Capacity Salt Tolerance

This example evaluates the salt tolerance of selected high-performing mixed matrix PVDF-PEI membrane adsorber candidates by measuring their BSA static binding capacity (SBC) in buffer solutions of varying salinity. Based on the SBC results in distilled water (Example 16, FIG. 29), Membrane 54H (prepared using BCAH crosslinker, CD≈2) and Membrane 54E (prepared using EGA crosslinker, CD≈2) were chosen for this evaluation due to their high binding capacities

Static binding capacity measurements were performed according to the general methods using BSA (2.0 mg/mL) dissolved in 50 mM TRIS-HCl buffer (pH 7.4) containing varying concentrations of added sodium chloride (NaCl): 0 mM (T-00), 50 mM (T-05), 100 mM (T-10), 150 mM (T-15), and 200 mM (T-20). The compositions and corresponding conductivities of these buffer solutions are detailed in Table 13.

The measured SBC values for Membranes 54H and 54E as a function of NaCl concentration in 50 mM TRIS buffer are presented in Table 13 and conceptually depicted in FIG. 31. Each value represents the average of three or more experiments, with error bars indicating standard deviation.

Membrane 54E (EGA crosslinker) exhibited a clear dependence on salt concentration6. Compared to its binding capacity in distilled water (approx. 88 mg/mL, Example 16), the SBC decreased progressively with increasing salinity: by approx. 25% at 50 mM NaCl, 40% at 100 mM NaCl, 54% at 150 mM NaCl, and 82% at 200 mM NaCl (Table 13, FIG. 31).

In contrast, Membrane 54H (BCAH crosslinker) demonstrated significantly enhanced salt tolerance. Its SBC in the presence of 50 mM NaCl (T-05) and 100 mM NaCl (T-10) remained high, comparable within experimental error to its capacity in distilled water (approx. 107 mg/mL, Example 16) (Table 13, FIG. 31). Even at higher salinities, the reduction in SBC was less severe compared to Membrane 54E. For instance, at 150 mM NaCl (T-15), the SBC decreased by only approx. 20%, and at 200 mM NaCl (T-20), it decreased by approx. 40% (Table 13, FIG. 31). These results demonstrate the superior salt tolerance imparted by the use of the BCAH crosslinker.

### Impact of Crosslinker Chemistry

The significant difference in salt tolerance between Membrane 54H and Membrane 54E highlights the impact of crosslinker chemistry. The improved performance of Membrane 54H is attributed to the presence of a higher concentration of primary and, crucially, secondary amine groups within its PEI microgels. As discussed previously and supported by literature-[36] [34, 45] these weak base amines facilitate protein binding through both electrostatic interactions and hydrogen bonding. While electrostatic interactions are increasingly screened by salt ions at higher conductivity, hydrogen bonding interactions remain effective, thus preserving binding capacity.

The crosslinking reaction consumes primary and secondary amines of the PEI precursor, generating secondary and tertiary amines, respectively. Tertiary amines primarily rely on electrostatic interactions and thus contribute less to binding at high salt concentrations. While both EGA and BCAH crosslinking consume precursor amines, the BCAH molecule uniquely incorporates an additional secondary amine group into the network structure for each crosslinking event (FIG. 30). Consequently, Membrane 54H possesses a significantly higher density of amine groups capable of hydrogen bonding compared to Membrane 54E (EGA crosslinker), leading to its enhanced salt tolerance.

### Example 18: Evaluation of Dynamic Binding Capacity and Salt Tolerance Under Flow

This example evaluates the dynamic binding capacity (DBC) for BSA of the preferred mixed matrix PVDF-PEI membrane embodiment (Membrane 54H, prepared with BCAH crosslinker at CD≈2 using IPA nonsolvent) under flow conditions. The effects of feed flow rate and buffer salinity on DBC were investigated, and the performance was benchmarked against selected commercial AEX membrane adsorbers. Membrane 54H was selected based on its superior static binding capacity and salt tolerance identified in Examples 16 and 17.

BC measurements were performed according to the general methods using Membrane 54H (approx. 380 μm dry thickness, morphology shown conceptually in FIG. 28 panel B). Experiments evaluated DBC as a function of feed flow rate (2, 4, 8, and 10 MV/min) using 2.0 mg/mL BSA in 50 mM TRIS buffer (pH 7.4, no added NaCl) 3. Salt tolerance was evaluated by performing DBC measurements at a constant feed flow rate (4 MV/min) using 2.0 mg/mL BSA in 50 mM TRIS buffer (pH 7.4) with varying added NaCl concentrations (0, 50, 100, 150, and 200 mM)⁴. Additional salt tolerance data were collected at 8 MV/min and 10 MV/min flow rates⁵. Physical dimensions and operational parameters are further detailed in Table 14.

TABLE 14
Operational parameters for the coupons
of PVDF-PEI membrane adsorber 54H.

| Feed Flow | Feed Flow | |
|---|---|---|
| Rate | Rate | Flux |
| (ml/min) | (MV/min) | (LMH) |
| 0.3 | 2 | 47 |
| 0.6 | 4 | 95 |
| 1.2 | 8 | 189 |
| 1.5 | 10 | 237 |

The Operational parameters for the coupons of PVDF-PEI membrane adsorber 54H reported in Table 14 were evaluated during the BSA dynamic binding capacity (DBC) measurements. The thickness, area and volume of each membrane coupon are, respectively, equal to 380 microns (0.38 mm), 380 mm², and 0.144 m¹

In particular, Table 14 reports the operational parameters (feed flow rate and flux) of the coupons of PVDF-PEI membrane adsorber 54H that were evaluated during the BSA dynamic binding capacity (DBC) measurements. The thickness, area and volume of each membrane coupon are, respectively, equal to 380 microns (0.38 mm), 380 mm², and 0.144 m¹.

### Effect of Flow Rate on DBC

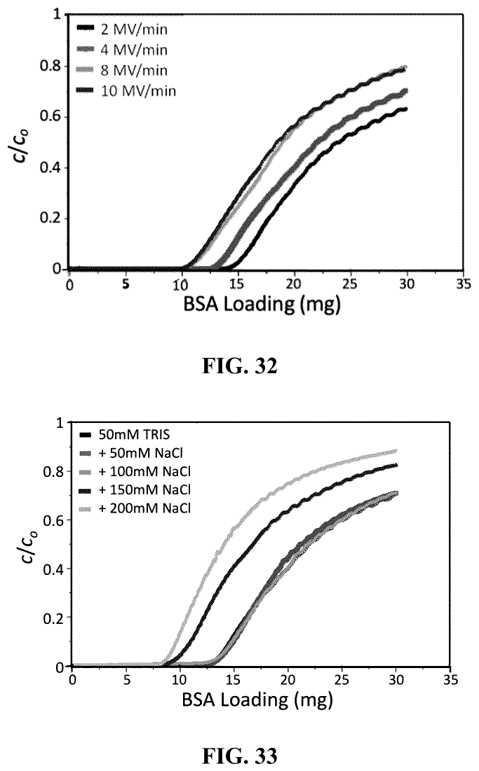

The BSA breakthrough curves for Membrane 54H at different feed flow rates in 50 mM TRIS buffer (no added NaCl) are conceptually depicted in FIG. 32. The calculated DBC values at 10% breakthrough are listed in Table 15 (first row). At lower feed flow rates (2 and 4 MV/min), the DBC exhibited flow rate dependence, decreasing as the flow rate increased (e.g., from 81±3 mg/mL at 4 MV/min to 66±3 mg/mL at 8 MV/min). This behavior is attributed to the mixed matrix structure; longer residence times at lower flow rates allow more time for BSA to diffuse into and utilize binding sites within the PEI microgels8.

At higher feed flow rates (8 and 10 MV/min), the DBC reached a plateau (66±3 mg/mL at 8 MV/min and 62±2 mg/mL at 10 MV/min, respectively), becoming less dependent on flow rate (FIG. 32, Table 16). Under these conditions, binding likely occurs primarily on the more readily accessible surfaces of the PEI microgels, with mass transfer dominated by convection, similar to typical membrane adsorber behavior, [34], 3271-3272].

### Salt Tolerance Under Flow

Breakthrough curves for Membrane 54H at a constant feed flow rate (4 MV/min) with varying NaCl concentrations are conceptually depicted in FIG. 33. The DBC values at 10% breakthrough for different flow rates and salinities are listed in Table 15.

TABLE 15
Effects of salt and flow rate.

| | |
|---|---|
| NaCl | Dynamic binding capacity |
| Concentration | (mg BSA) / (ml membrane) |

| (mM) | 4 MV/min | 8 MV/min | 10 MV/min |
|---|---|---|---|
| 0 | 81 ± 3 | 66 ± 3 | 62 ± 2 |
| 50 | 78 ± 6 | 62 ± 5 | 59 ± 6 |
| 100 | 78 ± 3 | 66 ± 6 | 59 ± 2 |
| 150 | 55 ± 2 | 42 ± 4 | 39 ± 2 |
| 200 | 45 ± 2 | 31 ± 4 | 31 ± 2 |

Table 15 describes the Effects of salt and flow rate on BSA dynamic binding capacity (DBC) of the IPA-cast PVDF-PEI membrane 54H with PEI particles crosslinked using bis(2-chloroethyl)amine hydrochloride (BCAH) as crosslinker with a constant crosslinked density (CD) of 2. The DBC measurements were conducted in 50 mM TRIS buffer solutions as a function of added NaCl concentration at three feed flow rates (MV denotes membrane volume). Membrane 54H was prepared using the formulation listed in Table 12.

Consistent with static measurements (Example 17), Membrane 54H demonstrated excellent salt tolerance under flow. At 4 MV/min, the breakthrough curves and calculated DBC (approx. 78 mg/mL) remained essentially constant in TRIS buffer containing up to 100 mM NaCl (FIG. 33, Table 15). DBC decreased at higher salt concentrations (150 mM and 200 mM NaCl), as expected. Similar trends of high DBC maintained up to 100 mM NaCl were observed at flow rates of 8 MV/min and 10 MV/min (Table 15).

The percentage reduction in DBC at 200 mM NaCl compared to 0 mM NaCl was calculated for flow rates of 4, 8, and 10 MV/min, yielding reductions of approximately 44%, 53%, and 50%, respectively. The lack of a statistically significant difference suggests that the intrinsic salt tolerance mechanism operates consistently across accessible binding sites within the microgels, irrespective of flow rate affecting penetration depth. The reduction observed under flow (e.g., 44% at 4 MV/min) is comparable to that observed in static measurements (approx. 40%, Example 17, Table 13), suggesting that differences between static and dynamic capacities are primarily due to mass transfer limitations rather than different salt tolerance mechanisms.

### Benchmarking Against Commercial Membranes

The performance of Membrane 54H was compared to reported BSA DBC data for selected commercial AEX membrane adsorbers (Table 16), 3279-3280.

TABLE 16
Benchmarking the BSA dynamic binding capacities (DBC)
of PVDF-PEI membrane adsorber (54H) in TRIS buffer at
three concentrations of added salt against three commercial
AEX membrane adsorbers (flat sheet format).

| | Dynamic | Dynamic | Dynamic | Dynamic | Dynamic |
|---|---|---|---|---|---|
| | Binding | Binding | Binding | Binding | Binding |
| | Capacity | Capacity | Capacity | Capacity | Capacity |
| Membrane | (0 mM) | (50 mM) | (100 mM) | (125 mM) | (150 mM) |
| ¹Membrane | 81 ± 3 | 78 ± 6 | 78 ± 3 | ³66 | 55 ± 2 |
| 54H (4 | | | | | |
| MV/min) | | | | | |
| ¹Membrane | 62 ± 2 | 59 ± 6 | 59 ± 2 | ³49 | 39 ± 2 |
| 54H (10 | | | | | |
| MV/min) | | | | | |
| ²Membrane | 39 | 41 | 38 | 36 | ⁴NA |
| 3-PA (10 | | | | | |
| MV/min) | | | | | |
| ²Membrane | 45 | 40 | 36 | 35 | ⁴NA |
| 4-PA (10 | | | | | |
| MV/min) | | | | | |
| ²NatriFlo | 242 | 192 | 86 | 48 | ⁴NA |
| HD-Q (10 | | | | | |
| MV/min) | | | | | |

¹This mixed matrix PVDF-PEI weak base AEX adsorber (54H) was prepared using a one pot and single step phase inversion casting process. The dynamic binding capacity (DCB) measurements for membrane 54H were carried out in 50 mM TRIS buffer solutions (pH 7.4) containing 2.0 mg/mL of BSA and varying concentrations of salt (NaCl).
²The BSA DBC data were taken from Reference 35. The DCB measurements for the two commercial weak base AEX membrane adsorbers (Membrane 3-PA and Membrane 4-PA) and the strong base AEX membrane adsorber (NatriFlo HD-Q) were carried out in 25 mM TRIS buffer solutions (pH 8.0) containing 1.0 mg/mL of BSA and varying NaCl concentrations.
³Estimated by linear interpolation using the measured DBC values of Membrane 54H in the saline TRIS buffer solutions containing 100 mM and 150 mM of NaCl.
⁴NA (Not applicable). No DCB measurements were carried out in saline TRIS buffer solutions containing 150 mM of NaCl.

Compared to commercial weak base, salt-tolerant adsorbers (“Membrane 3-PA” and “Membrane 4-PA”), Membrane 54H exhibited higher BSA DBC under comparable saline conditions (e.g., at 10 MV/min in buffer containing approx. 125 mM NaCl, Membrane 54H DBC~ 49 mg/mL, vs. 36 mg/mL and 35 mg/mL for Membrane 3-PA and 4-PA, respectively)

Comparison was also made to a commercial high-capacity strong base adsorber (NatriFlo HD-Q/Natrix Q)—While Natrix Q shows very high DBC in low salt buffer (approx. 242 mg/mL), its capacity drops sharply with increasing salinity due to charge screening, decreasing to approx. 48 mg/mL at 125 mM NaCl (10 MV/min). Notably, the DBC of Membrane 54H at 10 MV/min (approx. 49 mg/mL) is comparable to Natrix Q under these saline conditions, and at a lower flow rate of 4 MV/min, the DBC of Membrane 54H (approx. 66 mg/mL) exceeds that of Natrix Q (Table 16).

In addition to the performance advantages, the one-pot, single-step phase inversion casting method used for Membrane 54H offers potential advantages in scalability and manufacturing cost compared to the multi-step fabrication processes typically used for commercial AEX membrane adsorbers, including Natrix Q

Based on the unique microstructure where PEI particles cover the PVDF (FIG. 28 panel B) and related literature on similar functionalized PVDF membranes, it is hypothesized that Membrane 54H would exhibit low non-specific binding of positively charged target molecules (like mAbs) while effectively binding negatively charged impurities during flow-through polishing operations, although direct experimental validation with mAb streams is required.

Overall, the dynamic binding results indicate that Membrane 54H, prepared via the described methods, functions as a high-capacity, salt-tolerant weak base AEX membrane adsorber with performance characteristics suitable for downstream bioprocessing applications and potential advantages over existing commercial options.

### Example 19: High-Performance Weak Base AEX Membrane Adsorber Preparation and Performance

The preceding examples collectively demonstrate an approach for preparing advanced anion exchange (AEX) membrane adsorbers suitable for downstream bioprocessing applications, such as monoclonal antibody (mAb) polishing. Addressing the need for improved efficiency, capacity, and salt tolerance in membrane chromatography (MC), a one-pot, single-step phase inversion casting process was developed.

This process yields mixed matrix polyvinylidene fluoride (PVDF) microfiltration (MF) membranes containing in-situ synthesized polyethyleneimine (PEI) microparticles. Crucially, the use of bis(2-chloroethyl)amine hydrochloride (BCAH) as a crosslinker during the in-situ particle synthesis results in membranes with a high content of functional weak base (WB) primary and secondary amine groups. Furthermore, employing isopropyl alcohol (IPA) as the nonsolvent during nonsolvent induced phase separation (NIPS) allows for the preparation of membranes with advantageous structural characteristics.

Specifically, as shown in the examples, by optimizing PEI concentration and BCAH crosslink density, and using IPA as the nonsolvent, mixed matrix PVDF-PEI MF membranes can be produced possessing (i) a relatively uniform, open, and skinless microstructure where PEI particles substantially cover the PVDF matrix structure (Example 11, Example 15), (ii) high water flux suitable for flow-through applications (e.g., >1000 L/m²/hr at 2 bar) (Example 13), and (iii) a high loading of BCAH-crosslinked PEI microparticles (e.g., approx. 51 wt % for Membrane 54H) rich in weak base amine groups (Example 15, Table 12).

Protein binding evaluations (Examples 16-18) demonstrate that optimized membranes prepared via this method function as effective flow-through, high-capacity, and salt-tolerant WB AEX membrane adsorbers. For instance, Membrane 54H exhibited a dynamic binding capacity (DBC) for bovine serum albumin (BSA) of approximately 60 mg BSA per mL of membrane (at 10% breakthrough, 10 MV/min flow rate) in a 50 mM TRIS buffer containing 100 mM NaCl (approx. 15 mS/cm conductivity), demonstrating both high capacity and robust performance under relevant saline conditions (Example 18, Table 15, Table 16).

These overall results indicate that mixed matrix PVDF-PEI MF membranes prepared with in-situ synthesized, BCAH-crosslinked PEI microparticles using the described NIPS process with a soft nonsolvent represent a promising platform for the design, preparation, and scalable manufacturing of a new generation of high-performance WB AEX membrane adsorber materials for applications like downstream bioprocessing The process is conceptually illustrated in FIG. 23A.

In summary, to capitalize on the advantages of AEX membrane adsorbers in mAb product polishing during downstream bioprocessing (e.g., fast flow rates and low operating pressures), this work addressed key drawbacks of such membranes including (i) low volumetric protein binding capacity in high salinity effluents from mAb bioreactor harvests and (ii) costly multi-step fabrication processes including the activation of the surface of commercial microfiltration membranes (e.g., regenerated cellulose or polyethylene) produced by phase inversion casting followed by surface/pore activation and the subsequent covalent coating or grafting of ligands with weak base (WB) primary amine groups to improve their protein binding salt tolerance. The described one-pot, single-step phase inversion casting process provides a new family of mixed matrix PVDF MF membranes with in-situ synthesized PEI microparticles suitable as high-capacity, salt-tolerant WB AEX membrane adsorbers. Two key features demonstrated are (1) the utilization of BCAH as a crosslinker in the casting dispersions to increase the concentration of weak base groups (secondary amine) in the membrane PEI particles, enhancing salt tolerance, and (2) the use of isopropyl alcohol (IPA) as a nonsolvent in the coagulation bath to tune membrane morphology and prepare symmetric and microporous PVDF-PEI membranes with relatively uniform and open microstructures in which the PEI particles completely cover the PVDF spherulites present at the membrane surfaces and cross sections. By varying the concentration of PEI and BCAH in the casting dispersions, this NIPS process successfully utilized nonsolvent induced phase separation (NIPS) with isopropyl alcohol as nonsolvent to prepare a mixed matrix PVDF-PEI MF membrane with (i) a high-water flux (>1000 L/m²/hr at 2 bar) and (ii) a high loading of BCAH crosslinked PEI particles (e.g., 51 wt %) containing weak base primary, secondary and tertiary amine groups. Protein binding measurements confirm their function as high-capacity, salt-tolerant AEX adsorbers (e.g., BSA dynamic binding capacity of approx. 59±1.9 mg/mL in a 50 mM TRIS buffer containing 100 mM NaCl (15 mS/cm) at 10% breakthrough and flow rate of 10 MV/min).

The overall results suggest that these mixed matrix PVDF-PEI MF membranes with in-situ synthesized and BCAH crosslinked PEI microparticles serve as a platform for the design, preparation, and scale up of flow through, high capacity, and salt tolerant WB AEX membrane adsorbers (e.g., in flat sheet format) for downstream bioprocessing.

### Example 20: Preparation, Characterization and Evaluation of a Skinless Symmetric Mixed Matrix Membrane with In-Situ Synthesized SB AEX PEI Microparticles

The skinless symmetric mixed matrix (MM) membrane with in-situ synthesized AEX PEI microparticles was synthesized by in-situ quaternization of a casting dispersion used to fabricate MM membranes with in-situ synthesized ECH crosslinked PEI microparticles (FIG. 34). This new AEX membrane adsorber was prepared by adapting and modifying the one-pot and single step phase inversion casting process of Kotte and Diallo [15]. For the proof-of concept studies listed in this patent application, a mixed matrix AEX membrane adsorber (QPEI100) with in-situ synthesized and quaternized SB AEX PEI microparticles was prepared using bromoethane as alkylation reagent (FIG. 34), the membrane formulation 54 listed in Table 5 and 0.7 mL of a 12.1 M HCl aqueous solution as initiator.

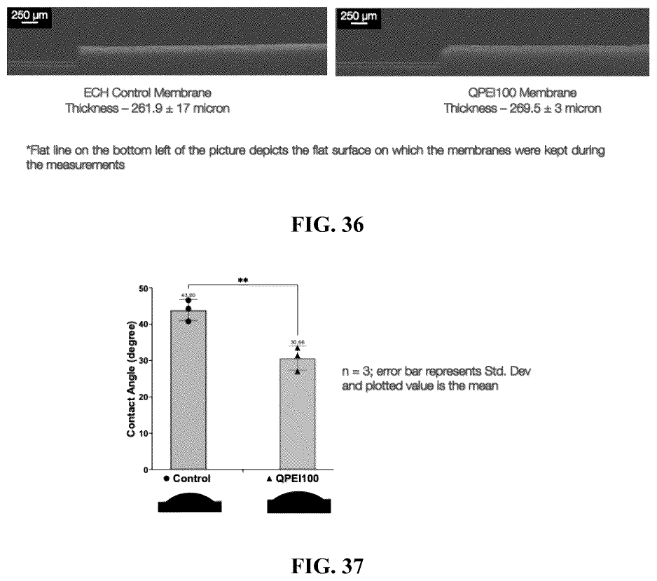

FIG. 35 lists the in-situ alkylation reaction scheme used to synthesize the quaternized ECH crosslinked PEI microparticles in the membrane casting dispersion. FIG. 36 shows a chart illustrating the use of optical coherence tomography (OCT) to measure the thickness of the QPEI100 AEX membrane adsorber. Table 17 lists the measured thicknesses of the QPEI100 membrane adsorber and the baseline WB membrane adsorber (ECH Control) with in-situ synthesized ECH crosslinked microparticles using the membrane formulation 54 listed in Table 5 and 0.7 mL of a 12.1 M HCl aqueous solution as initiator. To Fourth set of examples showing functionalized symmetric skinless membranes of the present disclosure as a platform for flow through, high capacity separations enable the comparison between the SEM estimated membrane dry thickness obtained using formulation 54 (Table 11), the thickness of the PET support (135 μm) was subtracted from the OCT measured thicknesses listed in Table 17.

TABLE 17
OCT measured thicknesses of the “QPEI100”
and “ECH Control” membranes following immersion
in the TRIS buffer solutions used to estimate their
protein (BSA) static binding capacities (SBC)

| | Buffer | | | Membrane |
|---|---|---|---|---|
| Membrane | Condition | Sample | Thickness | Volume |
| Type | (for binding) | Number | (μm) | (cm³) |
| ECH | 50 mM TRIS | 1 | 326.6 ± 18 | 0.047 |
| Control | | 2 | 261.9 ± 17 | 0.038 |
| | | 3 | 316.0 ± 05 | 0.046 |
| | 50 mM TRIS | 4 | 265.7 ± 14 | 0.038 |
| | 100 mM NaCl | 5 | 335.0 ± 06 | 0.048 |
| | | 6 | 273.8 ± 24 | 0.039 |
| QPEI100 | 50 mM TRIS | 1 | 224.6 ± 33 | 0.032 |
| | | 2 | 272.2 ± 09 | 0.039 |
| | | 3 | 216.9 ± 25 | 0.031 |
| | 50 mM TRIS | 4 | 269.5 ± 03 | 0.039 |
| | 100 mM NaCl | 5 | 241.7 ± 03 | 0.035 |
| | | 6 | 258.2 ± 12 | 0.037 |

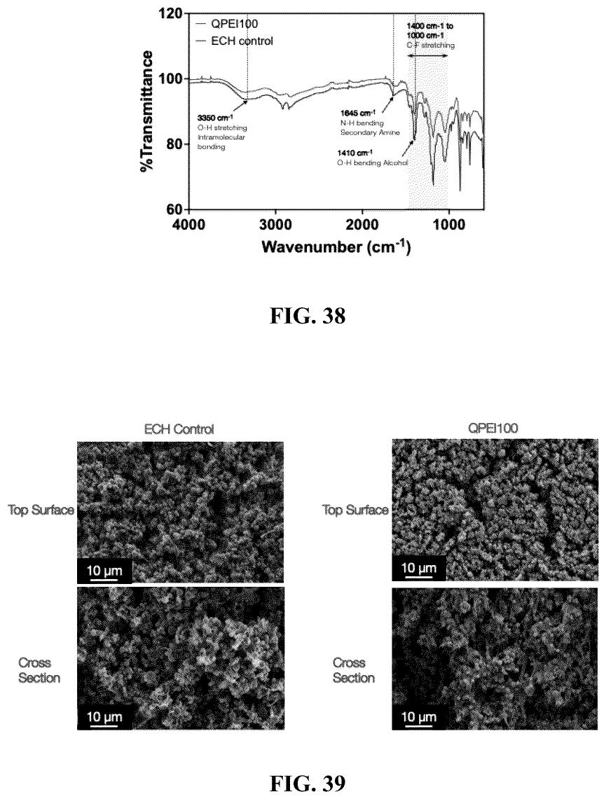

FIGS. 37-39 show charts illustrating the characterization of the “QPEI100” and “ECH Control” membranes using (1) contact angle measurements, (2) FTIR-ATR spectroscopy and (3) SEM imaging, respectively, as previous implemented by Kotte and Diallo [14].

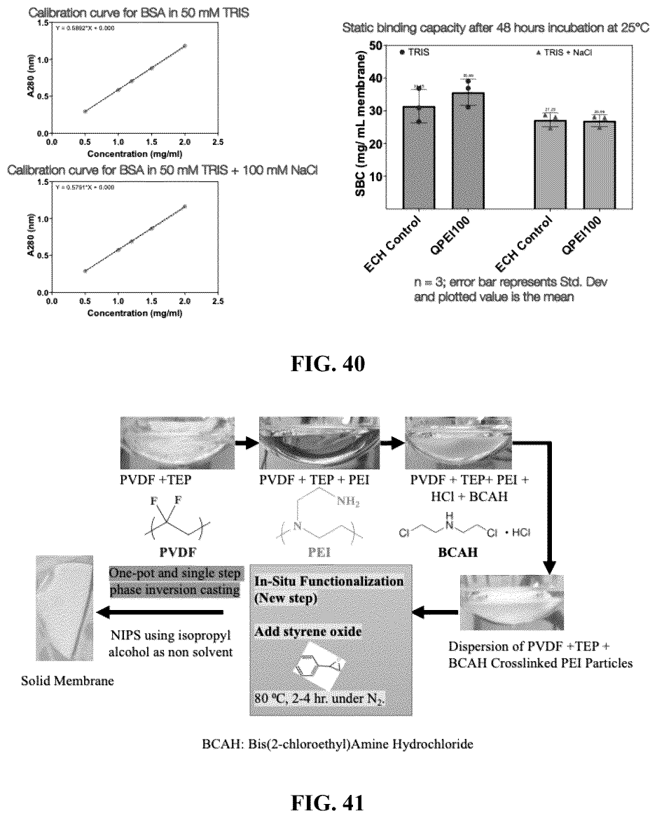

FIG. 40 shows a chart summarizing the results of the protein (BSA) SBC measurements in 50 mM TRIS buffer and saline TRIS buffer (50 mM TRIS+100 mM NaCl). The data in FIG. 40 confirm that the new “QPE100” membrane adsorber is a salt-tolerant SB AEX membrane adsorber with a BSA SBC of 36 mg/mL of membrane. Compared to the NatriFlo HD-Q membrane adsorber, the leading commercial SB AEX with quaternary amine groups which is currently being marketed as the highest capacity membrane adsorber to remove mAb product impurities under the tradename of “Natrix Q chromatography membrane” by MilliporeSigma (Table 16), the “QPE100” membrane adsorber maintains 75% of its nominal BSA binding capacity (SBC) in a saline TRIS buffer (50 mM TRIS+100 mM NaCl). In contrast, the NatriFlo HD-Q membrane adsorber maintains only 35% of its nominal BSA binding capacity (DBC) in a 50 mM TRIS+100 mM NaCl).

Collectively taken together, the supporting data provided in Example 20 provide strong supporting evidence that the in-situ alkylation reaction scheme shown in FIG. 35 provides a one-pot, single-step, and scalable route to the fabrication of a new class of quaternized SB AEX and salt-tolerant membrane adsorbers that can remove mAb impurities in saline solutions across a wider pH range compared to the WB AEX membrane adsorbers that were disclosed in this patent application.

### Example 21: Preparation, Characterization and Evaluation of a Skinless Symmetric Mixed Matrix Membrane with In-Situ Synthesized HIC Microparticle Adsorbers

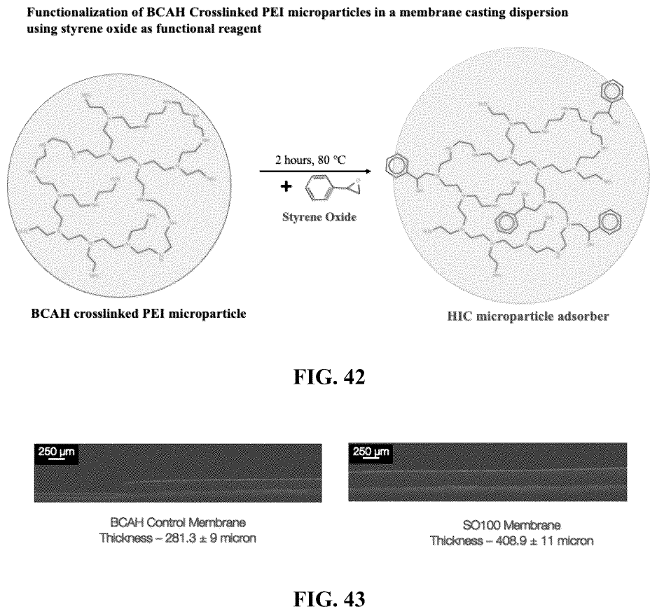

The skinless symmetric membrane adsorber with in-situ synthesized HIC microparticles were synthesized by in-situ functionalization of the casting dispersion used to fabricate a MM membrane with in-situ synthesized BCAH crosslinked PEI microparticles (FIG. 41). This new HIC membrane adsorber was prepared by adapting and modifying the one-pot and single step phase inversion casting process of Kotte and Diallo [15]. For the proof-of concept studies listed in this patent application, a mixed matrix membrane (SO100) with in-situ synthesized HIC microparticle adsorbers was prepared using styrene oxide (epoxy benzene) as a functionalizing reagent (FIG. 42), the membrane formulation 54H listed in Table 12 and 0.7 mL of a 12.1 M HCl aqueous solution as initiator.

FIG. 43 lists the in-situ reaction scheme used to functionalize the BCAH crosslinked PEI microparticles with styrene oxide (SO) in the membrane casting dispersion. FIG. 43 shows a chart illustrating the use of OCT to measure the thickness of the SO100 HIC membrane adsorber. Table 18 lists the measured thicknesses of the SO100 membrane adsorber and the baseline WB membrane adsorber (BCAH Control) with in-situ synthesized BCAH crosslinked microparticles using the membrane formulation 54H listed in Table 12 and 0.7 mL of a 12.1 M HCl aqueous solution as initiator. To enable the comparison between the SEM estimated membrane dry thickness obtained using formulation 54H (Table 12), the thickness of the PET support (135 μm) was subtracted from the OCT measured thicknesses listed in Table 18.

TABLE 18
OCT measured thicknesses of the “SO100” and
“BCAH Control” membranes following immersion
in DI water and the saline TRIS buffer solution used
to estimate their protein (BSA) static binding capacities (SBC)

| | Buffer | | | Membrane |
|---|---|---|---|---|
| Membrane | Condition | Sample | Thickness | Volume |
| Type | (for binding) | Number | (μm) | (cm³) |
| BCAH | DI Water | 1 | 284.3 ± 22 | 0.041 |
| Control | | 2 | 242.9 ± 54 | 0.035 |
| | | 3 | 292.3 ± 20 | 0.042 |
| | 50 mM TRIS | 4 | 286.5 ± 62 | 0.041 |
| | 1M (NH₄)₂SO₄ | 5 | 281.3 ± 09 | 0.041 |
| | | 6 | 206.0 ± 23 | 0.030 |
| SO100 | 50 mM TRIS | 1 | 408.9 ± 11 | 0.059 |
| | | 2 | 289.9 ± 21 | 0.042 |
| | | 3 | 428.4 ± 33 | 0.062 |
| | 50 mM TRIS | 4 | 413.1 ± 33 | 0.059 |
| | 1M (NH₄)₂SO₄ | 5 | 417.1 ± 14 | 0.060 |
| | | 6 | 440.9 ± 31 | 0.063 |

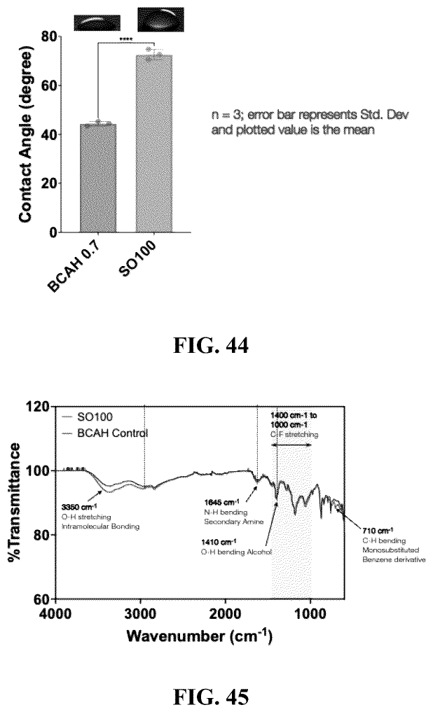

FIGS. 44-46 show charts illustrating the characterization of the “SO100” and “BCAH Control” membranes using (1) contact angle measurements, (2) FTIR-ATR spectroscopy and (3) SEM imaging, respectively. FIG. 47 shows a chart summarizing the results of the protein (BSA) SBC measurements in DI water and 50 mM TRIS+1.0 M ammonium sulfate [(NH₄)₂SO₄], a widely used buffer in HIC to facilitate the adsorption of hydrophobic protein domains onto membrane adsorbers

FIG. 47 shows that the “SO100” membrane is a salt-tolerant HIC membrane adsorber with a protein (BSA) static binding capacity (SBC) of 20 mg/mL in a 50 mM TRIS+1.0 M (NH₄)₂SO₄ saline buffer. It is noteworthy that the BSA SBC of the “SO100” HIC membrane adsorber is which is 2× larger than the reported BSA dynamic binding capacity (DBC) [10 mg/mL of the commercial Sartobind Phenyl HIC membrane in a 50 mM TRIS+1.0 M (NH₄)₂SO₄ saline buffer [46]. Collectively taken together, the supporting data provided in Example 21 show that the reaction scheme shown in FIG. 41 provides a versatile and scalable route to the fabrication of a new class of high capacity and salt-tolerant HIC membrane adsorbers for downstream bioprocessing.

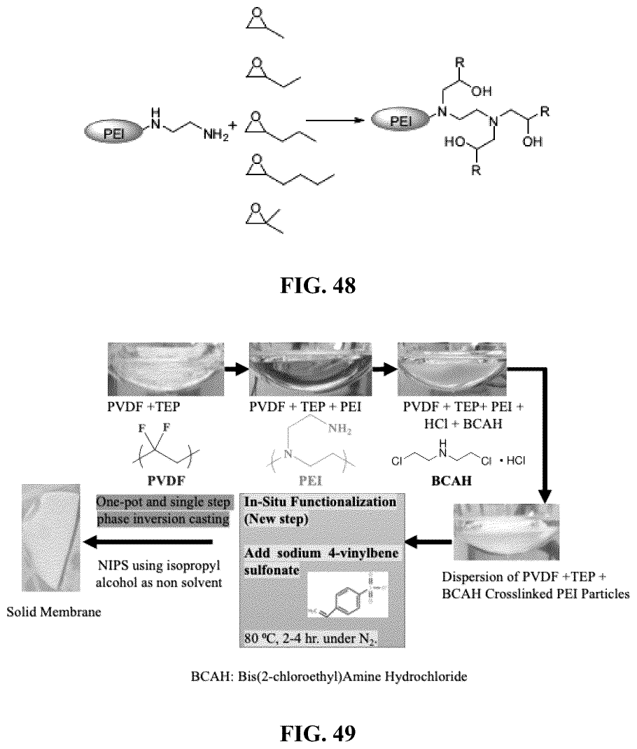

FIG. 48 illustrates additional and commercially available epoxy alkanes that can be used as functional reagents to tune and modulate the hydrophobicity of the symmetric and skinless mixed matrix membranes of the disclosure with in-situ synthesized HIC microparticle adsorbers.

### Example 20: Preparation, Characterization and Evaluation of a Skinless Symmetric Mixed Matrix Membrane with In-Situ Synthesized and Quaternized AEX PEI Microparticles

The skinless symmetric mixed matrix (MM) membranes with in-situ synthesized AEX PEI microparticles were synthesized by in-situ quaternization of the casting dispersions used to fabricate MM membranes with in-situ synthesized ECH crosslinked PEI microparticles (FIG. 34). These new CEX membrane adsorbers were preparation by adapting and modifying the one-pot and single step phase inversion casting process of Kotte and Diallo [M. Rao Kotte, T. Hwang, J.-I. Han, M. S. Diallo. A One-Pot Method for the Preparation of Mixed Matrix Polyvinylidene Fluoride Membranes with In-situ Synthesized and PEGylated Polyethyleneimine Particles. J. Membr. Sci. 474, 277-2 (2015)]. For the proof-of concept studies listed in this patent application, a mixed matrix AEX membrane adsorber (QPEI100) with in-situ synthesized and quaternized strong-base (SB) AEX PEI microparticles was prepared using bromoethane as alkylation reagent (FIG. 34), the membrane formulation 54 listed in Table 5 and 0.7 mL of a 12.1 M HCl aqueous solution as initiator.

FIG. 35 lists the in-situ alkylation reaction scheme used to synthesize the quaternized ECH crosslinked PEI microparticles in the membrane casting dispersion. FIG. 36 shows a chart illustrating the use of optical coherence tomography (OCT) to measure the thickness of the QPEI100 AEX membrane adsorber. Table 17 lists the measured thicknesses of the QPEI100 membrane adsorber and the baseline WB membrane adsorber (ECH Control) with in-situ synthesized ECH crosslinked microparticles using the membrane formulation 54 listed in Table 5 and 0.7 mL of a 12.1 M HCl aqueous solution as initiator. To enable the comparison between the SEM estimated membrane dry thickness obtained using formulation 54 (Table 11), the thickness of the PET support (135 μm) was subtracted from the OCT measured thicknesses listed in Table 17.

TABLE 17
OCT measured thicknesses of the “QPEI100”
and “ECH Control” membranes following immersion
in the TRIS buffer solutions used to estimate their
protein (BSA) static binding capacities (SBC)

| | Buffer | | | Membrane |
|---|---|---|---|---|
| Membrane | Condition | Sample | Thickness | Volume |
| Type | (for binding) | Number | (μm) | (cm³) |
| ECH | 50 mM TRIS | 1 | 326.6 ± 18 | 0.047 |
| Control | | 2 | 261.9 ± 17 | 0.038 |
| | | 3 | 316.0 ± 05 | 0.046 |
| | 50 mM TRIS | 4 | 265.7 ± 14 | 0.038 |
| | 100 mM NaCl | 5 | 335.0 ± 06 | 0.048 |
| | | 6 | 273.8 ± 24 | 0.039 |
| QPEI100 | 50 mM TRIS | 1 | 224.6 ± 33 | 0.032 |
| | | 2 | 272.2 ± 09 | 0.039 |
| | | 3 | 216.9 ± 25 | 0.031 |
| | 50 mM TRIS | 4 | 269.5 ± 03 | 0.039 |
| | 100 mM NaCl | 5 | 241.7 ± 03 | 0.035 |
| | | 6 | 258.2 ± 12 | 0.037 |

FIGS. 37-39 show charts illustrating the characterization of the “QPEI100” and “ECH Control” membranes using (1) contact angle measurements, (2) FTIR-ATR spectroscopy and (3) SEM imaging, respectively, as previous implemented by Kotte and Diallo [47].

FIG. 40 shows a chart summarizing the results of the protein (BSA) SBC measurements in 50 mM TRIS buffer and saline TRIS buffer (50 mM TRIS+100 mM NaCl). FIG. 40 shows that the new “QPE100” membrane adsorber is a salt-tolerant SB AEX membrane adsorber with a BSA SBC of 36 mg/mL of membrane. Compared to the NatriFlo HD-Q membrane adsorber, the leading commercial SB AEX with quaternary amine groups which is currently being marketed as the highest capacity membrane adsorber to remove mAb product impurities under the tradename of “Natrix Q chromatography membrane” by MilliporeSigma (Table 16), the “QPE100” membrane adsorber maintains 75% of its nominal BSA binding capacity (SBC) in a saline TRIS buffer (50 mM TRIS+100 mM NaCl). In contrast, the NatriFlo HD-Q membrane adsorber maintains 35% of its nominal BSA binding capacity (DBC) in a 50 mM TRIS+100 mM NaCl). Collectively taken together, a skilled person would recognize that the supporting data provided in Example 20 show that the in-situ alkylation reaction scheme shown in FIG. 35 provides a versatile and scalable route to the fabrication of a new class of quaternized SB AEX and salt-tolerant membrane adsorbers that can remove mAb impurities in saline solutions across a wide pH range.

### Example 21: Preparation, Characterization and Evaluation of a Skinless Symmetric Mixed Matrix Membrane with In-Situ Synthesized HIC Microparticle Adsorbers

The skinless symmetric membrane adsorber with in-situ synthesized HIC microparticles were synthesized by in-situ functionalization of the casting dispersion used to fabricate a MM membrane with in-situ synthesized BCAH crosslinked PEI microparticles (FIG. 41). This new HIC membrane adsorber was prepared by adapting and modifying the one-pot and single step phase inversion casting process of Kotte and Diallo [48]. For the proof-of concept studies listed in this patent application, a mixed matrix membrane (SO100) with in-situ synthesized HIC microparticle adsorbers was prepared using styrene oxide (epoxy benzene) as a functionalizing reagent (FIG. 42), the membrane formulation 54H listed in Table 12 and 0.7 mL of a 12.1 M HCl aqueous solution as initiator.

FIG. 42 lists the in-situ reaction scheme used to functionalize the BCAH crosslinked PEI microparticles with styrene oxide (SO) in the membrane casting dispersion. FIG. 43 shows a chart illustrating the use of OCT to measure the thickness of the SO100 HIC membrane adsorber. Table 18 lists the measured thicknesses of the SO100 membrane adsorber and the baseline WB membrane adsorber (BCAH Control) with in-situ synthesized BCAH crosslinked microparticles using the membrane formulation 54H listed in Table 12 and 0.7 mL of a 12.1 M HCl aqueous solution as initiator. To enable the comparison between the SEM estimated membrane dry thickness obtained using formulation 54H (Table 12), the thickness of the PET support (135 μm) was subtracted from the OCT measured thicknesses listed in Table 18.

TABLE 18
OCT measured thicknesses of the “SO100” and “BCAH Control”
membranes following immersion in the TRIS buffer solutions used
to estimate their protein (BSA) static binding capacities (SBC)

| | Buffer | | | Membrane |
|---|---|---|---|---|
| Membrane | Condition | Sample | Thickness | Volume |
| Type | (for binding) | Number | (μm) | (cm³) |
| BCAH | DI Water | 1 | 284.3 ± 22 | 0.041 |
| Control | | 2 | 242.9 ± 54 | 0.035 |
| | | 3 | 292.3 ± 20 | 0.042 |
| | 50 mM TRIS | 4 | 286.5 ± 62 | 0.041 |
| | 1M (NH₄)₂SO₄ | 5 | 281.3 ± 09 | 0.041 |
| | | 6 | 206.0 ± 23 | 0.030 |
| SO100 | 50 mM TRIS | 1 | 408.9 ± 11 | 0.059 |
| | | 2 | 289.9 ± 21 | 0.042 |
| | | 3 | 428.4 ± 33 | 0.062 |
| | 50 mM TRIS | 4 | 413.1 ± 33 | 0.059 |
| | 1M (NH₄)₂SO₄ | 5 | 417.1 ± 14 | 0.060 |
| | | 6 | 440.9 ± 31 | 0.063 |

FIGS. 44-46 show charts illustrating the characterization of the “SO100” and “BCAH Control” membranes using (1) contact angle measurements, (2) FTIR-ATR spectroscopy and (3) SEM imaging, respectively. FIG. 47 shows a chart summarizing the results of the protein (BSA) SBC measurements in DI water and 50 mM TRIS+1.0 M ammonium sulfate [(NH₄)₂SO₄], a widely used buffer in HIC to facilitate the adsorption of hydrophobic protein domains onto membrane adsorbers [49].

FIG. 47 shows that the “SO100” membrane is a salt-tolerant HIC membrane adsorber with a protein (BSA) static binding capacity (SBC) of 20 mg/mL in a 50 mM TRIS+1.0 M (NH₄)₂SO₄ saline buffer. It is noteworthy that the BSA SBC of the “SO100” HIC membrane adsorber is which is 2× larger than the reported BSA dynamic binding capacity (DBC) [10 mg/mL of the commercial Sartobind Phenyl HIC membrane in a 50 mM TRIS+1.0 M (NH₄)₂SO₄ saline buffer [49]. Collectively taken together, the supporting data provided in Example 21 show that the reaction scheme shown in FIG. 41 provides a versatile and scalable route to the fabrication of a new class of high capacity and salt-tolerant HIC membrane adsorbers for downstream bioprocessing. FIG. 48 lists additional commercially available epoxy alkanes that could be used as functional reagents to tune and modulate the hydrophobicity of the new class of symmetric and skinless mixed matrix membranes described with in-situ synthesized HIC microparticle adsorbers.

### Example 22: Preparation, and Characterization of a Skinless Symmetric Mixed Matrix Membrane Adsorber with In-Situ Synthesized Strong-Base (SB) CEX Microparticles

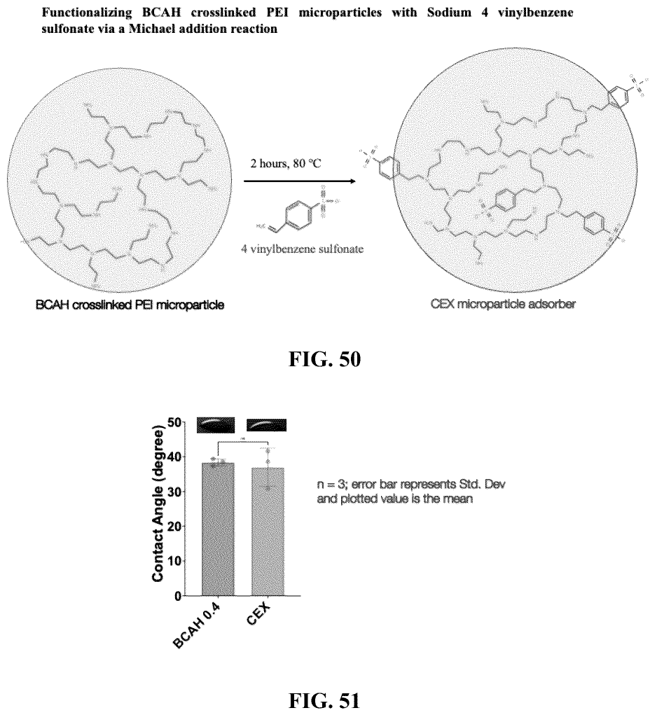

The skinless symmetric mixed matrix (MM) membranes with in-situ synthesized strong-acid (SA) microparticles were synthesized by in-situ functionalization of the casting dispersions used to fabricate MM membranes with in-situ synthesized BCAH crosslinked PEI microparticles (FIG. 49). These new CEX membrane adsorbers were preparation by adapting and modifying the one-pot and single step phase inversion casting process of Kotte and Diallo [M. Rao Kotte, T. Hwang, J.-I. Han, M. S. Diallo. A One-Pot Method for the Preparation of Mixed Matrix Polyvinylidene Fluoride Membranes with In-situ Synthesized and PEGylated Polyethyleneimine Particles. J. Membr. Sci. 474, 277-2 (2015)]. For the proof-of concept studies listed in this patent application, a mixed matrix membrane adsorber (CEX) with in-situ synthesized and SA CEX microparticles was prepared using sodium 4-vinylbenzyl sulfonate as functional reagent (FIG. 50), the membrane formulation 54H listed in Table 12, 0.4 mL of a 12.1 M HCl aqueous solution as initiator and DMSO as the solvent to dissolve the functional reagent prior to its addition in the membrane casting dispersion.

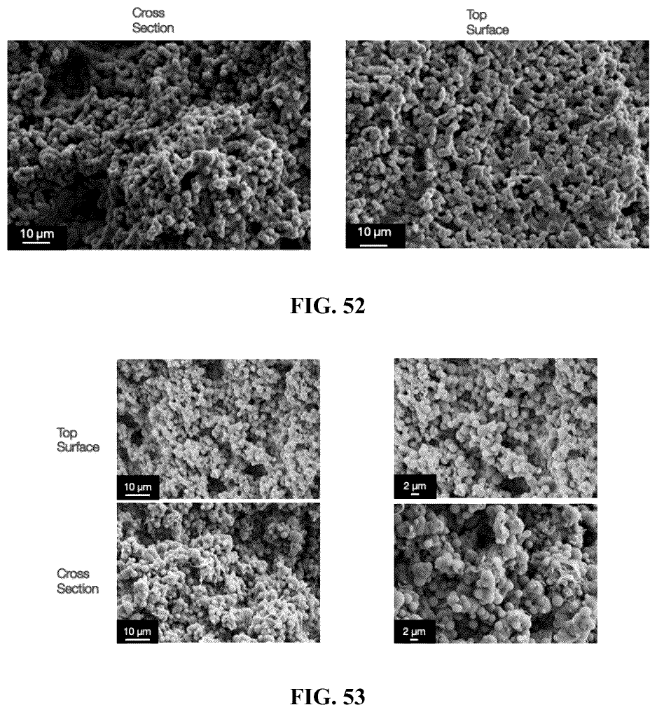

FIG. 50 lists the in-situ reaction scheme used to functionalize the BCAH crosslinked PEI microparticles sodium 4-vinylbenzyl sulfonate in the membrane casting dispersion. FIGS. 51-52 show charts illustrating the characterization of the “CEX” and “BCAH Control” membranes using (1) contact angle measurements and (2) SEM imaging, respectively. Based on the chemistry and composition of the membrane CEX microparticles (FIG. 50) and the references listed below, a skilled person would recognize that the CEX membrane adsorber with 4-vinylbenzyl sulfonate has great potential to serve as a high capacity and salt-tolerant membrane adsorber for the removal of positively charged impurities from the effluents of Protein-A resin columns following mAb capture and elution from bioreactor harvests including host cell proteins (HCPs), aggregates, and viral particles. [50][51] [52 {, 2025 #145]

### Example 23: Preparation, and Characterization of a Skinless Symmetric Mixed Matrix Membrane Adsorber with In-Situ Synthesized WB AEX Microparticles Using VIPS

In commercial membrane manufacturing, the vapor induced phase separation (VIPS) is widely used to fabricate symmetric and skinless membranes {Zhao, 2018 #148} The VIPS process comprises casting the dope onto a glass plate or a porous support and inducing phase separation by contacting the nascent membrane with water vapor in an environmental chamber with controlled humidity [e.g., RH (relative humidity) of 50-90%], temperature (e.g., 25-70° C.) and exposure time (e.g., 5-60 minutes). In the VIPS process, the non-solvent (water) diffuses and mix the membrane casting dope from a vapor phase. Fundamentally, the VIPS process is equivalent to a NIPS process with slower rates of mass transfer due to the documented slower rates of gaseous non-solvent exchanges with liquid solvents during the solidification of cast and nascent polymeric membranes

A custom designed VIPS box with an atomizer was used [FIG. 3] to fabricate a symmetric and skinless mixed matrix membrane with in-situ synthesized crosslinked PEI microparticles using BCAH as a crosslinker, the membrane formulation 54H listed in Table 12, and 0.7 mL of a 12.1 M HCl aqueous solution as initiator.

To implement the VIPS process, the PET cast mixed matrix membrane was placed inside the humidity box for 30 minutes with the water atomized turned on until the humidity (RH) reaches 90%. Following this, the atomizer was turned off with the membrane left to stay in the box for an additional 30 minutes. Following the completion of the VIPS process, the as-prepared membrane was stored overnight in DI water and characterized using SEM (FIG. 53). The SEM micrographs of the membrane top surface and cross sections (FIG. 53) show no noticeable differences in microstructures and morphologies thereby confirming that VIPS can be utilized to fabricate symmetric and skinless mixed matrix membranes with in-situ synthesized PEI microparticles.

### Example 24: Design and Preparation of Skinless Symmetric Mixed Matrix Membranes with In-Situ Synthesized PFAS-Selective AEX PEI Microparticles

Poly- and perfluoroalkylated substances (PFAS) have been manufactured in the United States from the 1940s until the present. Across the US, widespread PFAS contamination of drinking water is a “Grand Challenge” in water quality that will adversely impact the sustainable supply of potable/clean water for decades. These fluorinated chemicals are used as surfactants in consumer products (e.g., “Scotchguard” water and stain repellant) and industrial applications (e.g., semiconductor manufacturing). In the environment, PFAS bioaccumulate in higher organisms and resist both chemical and biological degradation. Among the PFAS compounds identified as materials of high concern, two surfactants-perfluorooctanoic acid (PFOA) and perfluorooctane sulfonic acid (PFOS) are the “poster” molecules of PFAS as “forever chemicals” that are mobile, persistent, (bio) accumulative, and hazardous to ecosystem and human health. Epidemiological evidence shows an association of adverse health effects with PFOA/PFOS exposure via ingestion of contaminated drinking water, including kidney cancer, liver/thyroid disease, and impaired immune response [54].

To protect the US population from PFAS exposure via contaminated drinking water, the EPA set parts-per-trillion thresholds for six fluorinated surfactants in its National Primary Drinking Water Regulations on Apr. 10, 2024, including PFOA, PFOS, and four additional toxic PFAS surfactants: perfluorohexane sulfonic acid (PFHxS), perfluorobutane sulfonic acid (PFBS), perfluorononanoic acid (PFNA) and hexafluoropropylene oxide dimer acid (HFPO-DA) [55]. EPA estimates that 4100-6700 public water systems will need to comply with the new national (EPA) and legally enforceable PFAS drinking water maximum contaminant limits (MCLs) by 2031 including the installation of new treatment systems to remove PFAS from their drinking water sources including groundwater and surface water from lakes and rivers.

The leading commercial technologies that are being deployed to treat PFAS contaminated drinking water are media filtration using granular activated carbon (GAC) or styrene divinyl benzene (STY-DVB) anion exchange (AEX) resins [56]. The Orange County Water District (OCWD), a national leader in PFAS water remediation, conducted a Phase I pilot scale column tests to evaluate and compare the PFAS removal capacity of 14 commercially available sorbents consisting of eight granular activated carbon (GAC) adsorbents, four anion exchange (AEX) resins, and two new sorbents including a cyclodextrin-based sorbent from Cyclopure and a surface-modified bentonite sorbent (FS200) from CETCO [57]. FIG. 54 shows a chart with pictures of the AEX resins, GAC and new adsorbents that were tested by the OCWD. Based on the results of these column studies, the OCWD selected the Dow AEX perchlorate selective resin (PSR) beads, now rebranded as DuPont AmberLite PSR2 Plus resin with “exceptional selectivity for perchlorate” and a “high affinity for a variety of PFAS” for deployment in 22 lead-lag pressure vessels as single-use, disposable media to treat contaminated groundwater at the Yorba Linda Water District treatment plant which is currently the largest PFAS water remediation plant

in the US with a treatment capacity of 19 million gallons/day [59].

TABLE 19
National (EPA) PFAS drinking water
maximum contaminant limits (MCLs)

| | | |
|---|---|---|
| Contaminant | Chemical Name | MCL |

Long chain PFAS

| | | |
|---|---|---|
| PFOA | Perfluorooctanoic acid | 4.0 ppt |
| PFOS | Perfluorooctane sulfonic acid | 4.0 ppt |
| PFNA | Perfluorononanoic acid | 10 ppt |

Short chain PFAS

| | | |
|---|---|---|
| PFHxS | Perfluorohexane sulfonic acid | 10 ppt |
| PFBS | Perfluorobutane sulfonic acid | 10 ppt |
| HPO-DA | Hexafluoropropylene oxide dimer acid | 10 pppt |

Although AEX with single-use and disposable resins has emerged as the leading technology for the treatment of PFAS contaminated drinking sources [56], the leading commercial single-use DuPont AmberLite PSR2 Plus resin has several limitations that adversely impact the effectiveness and overall cost of PFAS water remediation using AEX. 1) First, the PSR2 Plus IX resin consists of styrene-divinylbenzene spherical (STY-DVB) beads (~700 μm diameter) that are functionalized with strong-base tri-n-butyl amine groups. 2) The size of the bead imposes a diffusion distance that requires very low flow rates to provide sufficient time for PFAS to diffuse to binding sites in the interior of the bead (feed flow rate <60 BV (bed volume) per hour or 7 gallons per minute (gpm) per ft3 of resin). 3) The reliance on a single type of functional group limits the range of PFAS structures that it removes, better for PFOS than for PFAS species with fewer fluoroalkyl units or branched structure, e.g., PFBS or HPO-DA (Table 19). 3) PSR2 Plus IX resin has a low exchange capacity (ca. 0.7 eq/L). 4) The medium cannot be regenerated (single-use, disposable) and represents a recurring expense (~$400 per cubic ft). Because of this, to meet their capacity goals PFAS AEX water remediation plants are designed and built around a series of paired lead-lag pressure vessels which increase the CapEX and OPEX for building and operating such plants. Thus, US water utilities have a critical need for new technologies to lower the additional treatment cost required to comply with the new EPA PFAS drinking water regulations.

Regenerable microfiltration (MF) AEX membrane adsorbers have emerged as promising technologies that offer more efficient, sustainable and cost-effective alternatives than AEX resins or GAC media to remove PFAS from drinking water sources:

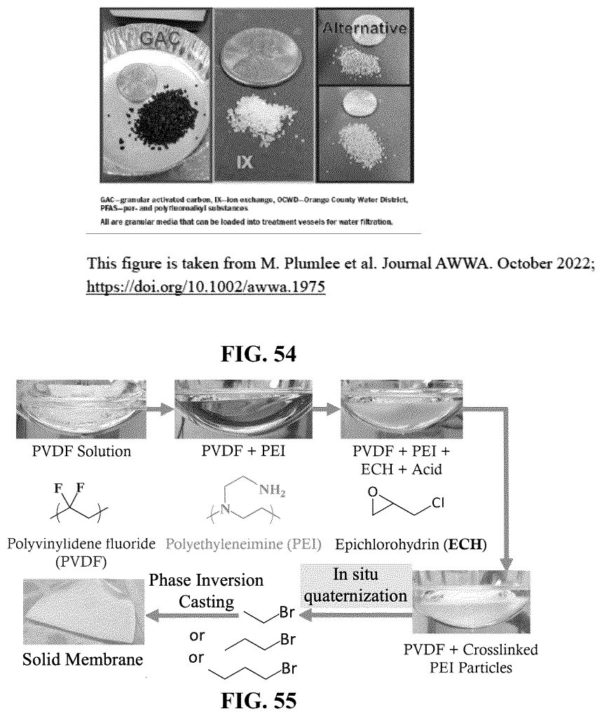

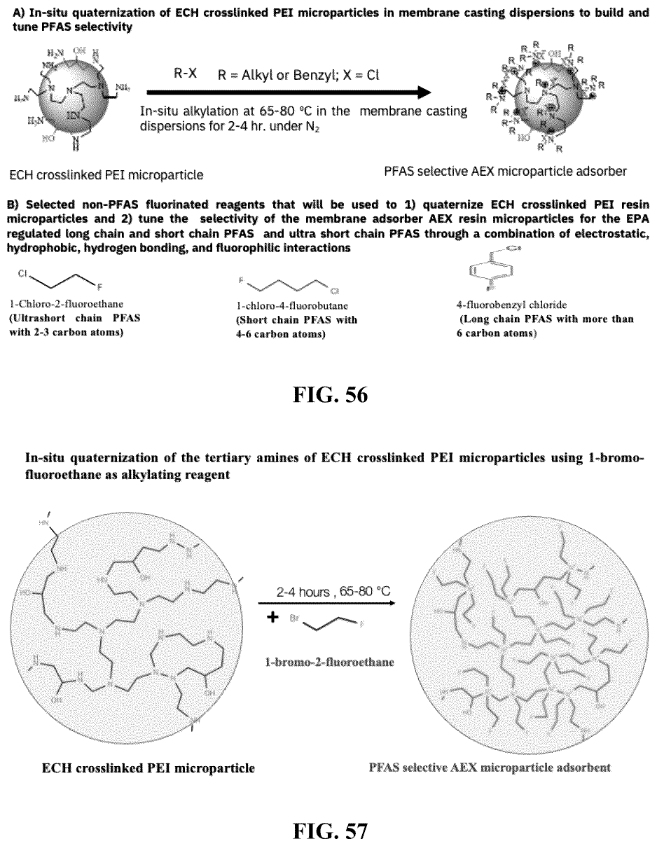

However, the membrane adsorbers highlighted in these are challenging and costly to manufacture at scale as they require a multistep process involving the preparation of MF membranes by phase inversion casting (e.g., using PVDF as base polymers) followed by membrane surface and/or pore activation and subsequent functionalization with ligands or polymers containing strong-base (SB) groups. A skilled person would recognize the membrane compositions and one-pot and single-step fabrication routes provided in this patent application can be readily adapted and optimized (FIG. 34 and FIG. 35) to fabricate new classes of high capacity AEX MF membrane adsorbers with tunable anion (PFAS) selectivity using standard commercial alkylating reagents (e.g. bromo alkanes) FIG. 55. FIG. 56 lists selected alkylating reagents that will be used to tune the PFAS selectivity of the new MF membrane adsorbers described including non PFAS fluorinated alkylating reagents that will can be used to 1) quaternize ECH crosslinked PEI resin microparticles and 2) tune the selectivity of the membrane adsorber AEX resin microparticles for the EPA regulated long chain and short chain PFAS and ultra short chain PFAS through a combination of electrostatic, hydrophobic, hydrogen bonding, and fluorophilic interactions (FIGS. 57-59) by leveraging the latest advances in the design of PFAS selective adsorbents as summarized in the cited references [64]: [66], [67] and [68].

### Example 25—An Exemplary System for Removing Target Solutes from a Fluid

FIG. 60 shows an example of a system (not to scale) for removing target solutes from a fluid, comprising a housing (601) with an inlet (602) and outlet (604) for fluid transfer, the fluid in the inlet (602) containing target solutes (605) to be removed from the fluid in the housing (601).

The housing (601) contains a functionalized skinless symmetric membrane adsorber (603) being a porous polymeric body having a symmetric skinless microfiltration (MF) morphology and a plurality of in-situ functionalized polymeric microparticles (606) embedded therein for adsorption of the target solutes (605).

The housing and inlets/outlets can be metal, ceramic, plastic, glass, or any other material suitable based on the type of fluid and target solutes involved. There can be multiple inlets and/or outlets for a given housing, and multiple housings can be chained together (outlet to inlet) to have multiple stages of filtration.

The membrane can be a single sheet, multiple sheets, blocks, honeycomb, spiral, or other adsorption filtration design known to one in the art.

In summary Described herein are in-situ functionalized symmetric and skinless membrane adsorbers, along with related compositions, systems, and methods. The membrane adsorbers comprise a porous polymeric body, such as polyvinylidene fluoride (PVDF), having a symmetric and skinless microfiltration (MF) morphology that enables high fluid flux. Embedded within this porous body is a plurality of polymeric microparticles, such as cross-linked polyethyleneimine (PEI). A method for their fabrication involves the in-situ synthesis of intermediate microparticles within an organic dope solution, followed by a novel in-situ functionalization step. This step uses an organic-compatible functional reagent (e.g., bromoethane, styrene oxide, 1,3-propanesultone, or fluorinated alkyl halides) to covalently attach a diverse and tunable range of functional groups to the particles before casting. This creates a platform of selective adsorbers, including Strong Base (SB) Anion Exchange (AEX), Cation Exchange (CEX), Hydrophobic Interaction Chromatography (HIC), Chelating, and Fluorophilic functionalities. The final functionalized dope solution is then cast and solidified using a controlled, gradual demixing process, such as using a “soft” nonsolvent like isopropyl alcohol (IPA), to form the final symmetric and skinless membrane. These high-flux adsorbers are suitable for removing target solutes from fluids, including bioprocessing impurities or environmental contaminants like PFAS.

The examples set forth above are provided to give those of ordinary skill in the art a complete disclosure and description of how to make and use the embodiments polymeric membranes with embedded polymeric micro/nanoparticles and related methods and systems of the disclosure, and are not intended to limit the scope of what the Applicants regard as their disclosure. Modifications of the above-described modes for carrying out the disclosure can be used by persons of skill in the art, and are intended to be within the scope of the following claims.

The entire disclosure of each document cited (including patents, patent applications, journal articles, abstracts, laboratory manuals, books, or other disclosures) in the Background, Summary, Detailed Description, and Examples is hereby incorporated herein by reference. All references cited in this disclosure are incorporated by reference to the same extent as if each reference had been incorporated by reference in its entirety individually. However, if any inconsistency arises between a cited reference and the present disclosure, the present disclosure takes precedence.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the disclosure claimed Thus, it should be understood that although the disclosure has been specifically disclosed by preferred embodiments, exemplary embodiments and optional features, modification and variation of the concepts herein disclosed can be resorted to by those skilled in the art, and that such modifications and variations are considered to be within the scope of this disclosure as defined by the appended claims.

It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

When a Markush group or other grouping is used herein, all individual members of the group and all combinations and possible subcombinations of the group are intended to be individually included in the disclosure. Every combination of components or materials described or exemplified herein can be used to practice the disclosure, unless otherwise stated. One of ordinary skill in the art will appreciate that methods, device elements, and materials other than those specifically exemplified can be employed in the practice of the disclosure without resort to undue experimentation. All art-known functional equivalents, of any such methods, device elements, and materials are intended to be included in this disclosure. Whenever a range is given in the specification, for example, a temperature range, a frequency range, a time range, or a composition range, all intermediate ranges and all subranges, as well as, all individual values included in the ranges given are intended to be included in the disclosure. Any one or more individual members of a range or group disclosed herein can be excluded from a claim of this disclosure. The disclosure illustratively described herein suitably can be practiced in the absence of any element or elements, limitation or limitations which is not specifically disclosed herein.

A number of embodiments of the disclosure have been described. The specific embodiments provided herein are examples of useful embodiments of the disclosure and it will be apparent to one skilled in the art that the disclosure can be carried out using a large number of variations of the devices, device components, methods steps set forth in the present description. As will be obvious to one of skill in the art, methods and devices useful for the present methods can include a large number of optional composition and processing elements and steps.

In particular, it will be understood that various modifications may be made without departing from the spirit and scope of the present disclosure. Accordingly, other embodiments are within the scope of the following claims.

### REFERENCES

1. Polymer Solutions: Solvents and Solubility Parameters. Jan. 25, 2012; Available from: www.sigmaaldrich.com/etc/medialib/docs/Aldrich/General_Information/polymer_soluti ons.Par.0001.File.tmp/polymer_solutions.pdf.
2. Brandrup, J., et al., Polymer handbook. Vol. 89. 1999: Wiley New York.
3 Liu, F., et al., Progress in the production and modification of PVDF membranes. Journal of Membrane Science, 2011. 375 (1): p. 1-27.
4. Connor, E. e. a., Pharmaceutical Compositions Comprising Crosslinked Polyamine Polymers. 2008: US.
5. Gokmen, M. T. and F. E. Du Prez, Porous polymer particles—A comprehensive guide to synthesis, characterization, functionalization and applications. Progress in Polymer Science, 2012. 37 (3): p. 365-405.
6 Strathmann, H., L. Giorno, and E. Drioli, An introduction to membrane science and technology. 2011: Wiley.
7. Liu, Y., et al., PAMAM dendrimers undergo pH responsive conformational changes without swelling. Journal of the American Chemical Society, 2009. 131 (8): p. 2798-2799.
8. van Krevelen, D. W. and K. the Nijenhuis, Properties of Polymers: Their Correlation with Chemical Structure; their Numerical Estimation and Prediction from Additive Group Contributions. 2009: Elsevier Science.
9. Frechet, J. M., Functional polymers and dendrimers: reactivity, molecular architecture, and interfacial energy. Science, 1994. 263 (5154): p. 1710-5.
10. Lichtenhan, J. and J. Salamone, Polymeric materials encyclopedia. Salamone, JC, Ed, 1996: p. 7768-7777.
11. Augustsson, C. and A. Nils Malmgren, NM Epoxy Handbook. 2004: Nils Malmgren AB.
12. Dow Liquid Epoxy resins product literature Available from: epoxy.dow.com/resources/literature.htm at the date of filing of the present disclosure.
13. Zhao, Y. H., et al., Porous membranes modified by hyperbranched polymers: I. Preparation and characterization of PVDF membrane using hyperbranched polyglycerol as additive. Journal of Membrane Science, 2007. 290 (1): p. 222-229.
14. Kotte, M. R., M. Cho, and M. S. Diallo, A facile route to the preparation of mixed matrix polyvinylidene fluoride membranes with <i> in </i><i>situ </i> generated polyethyleneimine particles. Journal of Membrane Science, 2014. 450: p. 93-102.
15. M. Rao Kotte, T. H., J.-I. Han, M. S. Diallo, A One-Pot Method for the Preparation of Mixed Matrix Polyvinylidene Fluoride Membranes with In-situ Synthesized and PEGylated Polyethyleneimine Particles. J. Membr. Sci., 2015. 474: p. 277-2
16. Bateman, O., Design and Application of Novel Membrane Materials. Dissertation (Ph.D.), California Institute of Technology. 2022.
17. Z. Liu, S. R. W., X. Qian, Membrane chromatography for protein purifications from ligand design to functionalization. Sep. Sci. Technol., 2017. 52: p. 299-319.
18. Buonomenna, M. G. M., P.; Davoli, M.; Drioli, E, Poly(Vinylidene Fluoride) Membranes by Phase Inversion: The Role the Casting and Coagulation Conditions Play in Their Morphology, Crystalline Structure and Properties. Eur. Polym. J., 2007. 43 (4): p. 1557-1572.
19. Tao, M. L., F.; Ma, B.; Xue, L., Effect of Solvent Power on PVDF Membrane Polymorphism during Phase Inversion. Desalination, 2013. 316: p. 137-145.
20. Gregorio Jr, R., Determination of the α, β, and γ Crystalline Phases of Poly (Vinylidene Fluoride) Films Prepared at Different Conditions. J. Appl. Polym. Sci., 2006. 100 (4): p. 3272-3279.
21. Fischer-Frühholz, S. Z., D.; Hirai, M., Sartobind STIC® Salt-Tolerant Membrane Chromatography. Nat. Methods, 2010. 7 (12): p. 12-13.
22. Riordan, W. H., S.; Brorson, K.; Seshadri, K.; He, Y.; Etzel, M., Design of Salt-Tolerant Membrane Adsorbers for Viral Clearance. Biotechnol. Bioeng., 2009. 103 (5): p. 920-929.
23. Ghosh, R., Protein separation using membrane chromatography: opportunities and challenges. Journal of Chromatography A, 2002. 952 (1): p. 13-27.
24. Madadkar, P. W., Q.; Ghosh, R., A Laterally-Fed Membrane Chromatography Module. J. Membr. Sci., 2015. 487: p. 173-179.
25. Bhut, B. V., S. R. Wickramasinghe, and S. M. Husson, Preparation of high-capacity, weak anion-exchange membranes for protein separations using surface-initiated atom transfer radical polymerization. Journal of Membrane Science, 2008. 325 (1): p. 176-183.
26. Bhut, B. V. H., S. M., Dramatic Performance Improvement of Weak Anion-Exchange Membranes for Chromatographic Bioseparations. J. Membr. Sci., 2009. 337 (1): p. 215-223.
27. Sun, L. D., J.; Baker, G. L.; Bruening, M. L., High-Capacity, Protein-Binding Membranes Based on Polymer Brushes Grown in Porous Substrates. Chem. Mater., 2006. 18 (17): p. 4033-4039.
28. Teepakorn, K. F. a. C. C., A review on some recent advances on membrane chromatography for biomolecules purification. J. Colloid. Sci. Biotechnol., 2016. 5: p. 32-44.
29 Odum, M. F. W. a. J., Biopharmaceutical manufacturing in the twenty-first century: the next generation manufacturing facility. Pharmaceut. Eng., 2012. 32 (2): p. 1-8.
30. Umatheva, U. A., L.; Shirataki, H.; Ogawa, S.; Kato, C.; Ghosh, R., An Annular-Flow, Hollow-Fiber Membrane Chromatography Device for Fast, High-Resolution Protein Separation at Low Pressure. J. Membr. Sci., 2019. 590: p. 117305.
31. M. Woo, N. K., J. Royce, U. Mehta, B. Gagnon, S. Ramaswamy, N. Soice, M. Morelli, K-S. Cheng., A Novel Primary Amine-Based Anion Exchange Membrane Adsorber. J. Chromatogr., 2011. A 1218 (32): p. 5386-5392.
32. Childs, R. F., et al., Composite materials comprising supported porous gels. 2008, Google Patents.
33 Natrix Q membrane. Accessed on Aug. 28, 2024.
34. H. Shirataki, C. S., T. Eshima, Y. Yokoyama, K. Okuyama, Evaluation of an anion-exchange hollow-fiber membrane adsorber containing X-ray grafted glycidyl methacrylate chains. J. Chromatogr. A., 2011. 1218: p. 2381-2388.
35. X. Han, T. H., H. Lutz, A. Becerra-Arteaga, M. Blanchard, X. Zhao, A. Hewig, V. Natarajan, K. Chefer, Performance of a Salt-Tolerant Membrane Adsorber in Flow-through Mode. BioProcess Int., 2013. 11 (2): p. 28-39.
36. J. Fan, J. L., X. Chen, Y. Wan, Facile Preparation of Salt-Tolerant Anion-Exchange Membrane Adsorber Using Hydrophobic Membrane as Substrate. J. Chromatogr. A., 2017. 1490: p. 54-62
37. Bottino, A. C.-R., G.; Capannelli, G.; Munari, S., The Formation of Microporous Polyvinylidene Difluoride Membranes by Phase Separation. J. Membr. Sci., 1991. 57 (1): p. 1-20.
38. T.-H. Young, L.-P. C., D.-J. Lin, L. Fane, W.-Y. Chuang., Mechanisms of PVDF Membrane Formation by Immersion-Precipitation in Soft (1-Octanol) and Harsh (Water) Nonsolvents. Polymer, 1999. 40 (19): p. 5315-5323.
39. Zuo, D.-y., et al., Influence of alcohol-based nonsolvents on the formation and morphology of PVDF membranes in phase inversion process. Chinese journal of polymer science, 2006. 24 (03): p. 281-289.
40. D. Zuo, Z., B.; Cao, J.; Xu, Y., Influence of Alcohol-Based Nonsolvents on the Formation and Morphology of PVDF Membranes in Phase Inversion Process. Chinese J. Polym. Sci., 2006. 24 (03): p. 281-289.
41. Lin, D.-J., et al., Formation of porous poly(vinylidene fluoride) membranes with symmetric or asymmetric morphology by immersion precipitation in the water/TEP/PVDF system. European polymer journal, 2006. 42 (7): p. 1581-1594.
42. M. H. D. A. Farahani, V. A. V., Comprehensive Study on the Performance and Antifouling Enhancement of the PVDF Mixed Matrix Membranes by Embedding Different Nanoparticulates: Clay, Functionalized Carbon Nanotube, SiO2 and TiO2. Sep. Pur. Technol., 2018. 197: p. 372-381.
43. M. R. Kotte, A. T. K., M. Cho, B. B. Mamba, M. S. Diallo, Mixed Matrix PVDF Membranes With in Situ Synthesized PAMAM Dendrimer-Like Particles: A New Class of Sorbents for Cu(II) Recovery from Aqueous Solutions by Ultrafiltration. Environ. Sci. Technol., 2015. 49 (16): p. 9431-9442.
44 M. R. Kotte, A. T. K., S. N. Talapaneni, M. Cho, A. Coskun, M. S. Diallo., A Facile and Scalable Route to the Preparation of Catalytic Membranes with in Situ Synthesized Supramolecular Dendrimer Particle Hosts for Pt(0) Nanoparticles Using a Low-Generation PAMAM Dendrimer (G1—NH2) as Precursor. ACS Appl. Mater. Interfaces, 2018. 10 (39): p. 33238-33251
45. X. Yang, A. M., R. AL-Attabi, L. F. Dumee, X. Zhang, S. H. Thang, H. Pha, L. Kong., Towards Next Generation High Throughput Ion Exchange Membranes for Downstream Bioprocessing: A Review. J. Membr. Sci., 2022. 647: p. 120325.
46. Busse, M. H. a. R., Phenyl Membrane Adsorber for Bioprocessing: Sartobind Hydrophobic Interaction Membrane Chromatography. Nov. 12, 2019.
47. Kotte, M. R., M. Cho, and M. S. Diallo, A facile route to the preparation of mixed matrix polyvinylidene fluoride membranes with in-situ generated polyethyleneimine particles. Journal of Membrane Science, 2014. 450: p. 93-102.
48. Kotte, M. R., et al., A one-pot method for the preparation of mixed matrix polyvinylidene fluoride membranes with in situ synthesized and PEGylated polyethyleneimine particles. Journal of Membrane Science, 2015. 474: p. 277-287.
49. Busse, M. H. a. R. Phenyl Membrane Adsorber for Bioprocessing: Sartobind Hydrophobic Interaction Membrane Chromatography. (Sartorius Application Note) Nov. 12, 2019; Available from: www.sartorius.com/download/89938/appl-sartobind-phenyl-membrane-adsorber-sl-4048-e-data.pdf.
50. Trnovec, H., et al., Characterization of membrane adsorbers used for impurity removal during the continuous purification of monoclonal antibodies. Journal of chromatography A, 2020. 1609: p. 460518.
51. Liu, Z., S. R. Wickramasinghe, and X. Qian, Membrane chromatography for protein purifications from ligand design to functionalization. Separation Science and Technology, 2017. 52 (2): p. 299-319.
52. Qu, Y., et al., The transition from resin chromatography to membrane adsorbers for protein separations at industrial scale. Separation & Purification Reviews, 2024. 53 (4): p. 351-371.
53. Ismail, N., et al., Investigating the potential of membranes formed by the vapor induced phase separation process. Journal of Membrane Science, 2020. 597: p. 117601.
54. NIEHS. Per-and polyfluoroalkyl substances (PFAS); 2025; Available from: at www.niehs.nih.gov/health/topics/agents/pfc.
55. EPA. Per-and Polyfluoroalkyl Substances (PFAS): Final PFAS National Primary Drinking Water Regulation; 2025; Available from: Available online at www.epa.gov/sdwa/and-polyfluoroalkyl-substances-pfas.
56. deSilva, V. and D. Deshmukh, The Cost to Remove PFAS: A Review of US Water Treatment Plants. Journal of the American Water Works Association, 2025. 117 (4): p. 54-63.
57. Plumlee, M. H., et al., Groundwater Treatment to Remove PFAS: Restoring Local Drinking Water Supply in Orange County, California. Journal: American Water Works Association, 2022. 114 (8).
58. DuPont. AmberLite PSR2 Plus resin 2025; Available from: www.dupont.com/content/dam/water/amer/us/en/water/public/documents/en/IER-AmberLite-PSR2-Plus-PDS-45-D00899-en.pdf.
59. District, Y. L. W. PFAS water remediation plant 2025; Available from: www.ylwd.com/services/your-water/water-quality/pfas-water-treatment-plant/.

60 Thompson, S., et al., Microfiltration membrane pore functionalization with primary and quaternary amines for PFAS remediation: Capture, regeneration, and reuse. Molecules, 2024. 29 (17): p. 4229.
61. Wan, H., et al., Dual-functional adsorptive membranes for PFAS removal: Mechanism, CFD simulation, and selective enrichment. Chemical Engineering Journal, 2024. 500: p. 156095.
62. Wan, H., et al., pH-Swing membrane adsorption of perfluoroalkyl substances: Anion-exchange brushes and role of water chemistry. Separation and Purification Technology, 2024. 329: p. 124800.
63. Léniz-Pizarro, F., et al., Membrane functionalization approaches toward per-and polyfluoroalkyl substances and selected metal ion separations. ACS applied materials & interfaces, 2023. 15 (37): p. 44224-44237.
64 Pezoulas, E. R., et al., Functionalized Porous Polymer Networks as High-Performance PFAS Adsorbents. Journal of the American Chemical Society, 2025.
65 Anjum, S., et al., Fluorinated Block Copolymer: An Important Sorbent Design Criteria for Effective PFOA Removal from Its Aqueous Solution. ACS Applied Polymer Materials, 2025. 7 (3): p. 1187-1193.
66. Lobitz, A., et al., Harnessing Fluorine Chemistry: Strategies for Per-and Polyfluoroalkyl Substances Removal and Enrichment. ChemPlusChem, 2025: p. 2400784.
67. Choudhary, A. and D. Bedrov, Interaction of short-chain PFAS with polycationic gels: how much fluorination is necessary for efficient adsorption? ACS Macro Letters, 2022. 11 (9): p. 1123-1128.
68. Tan, X., et al., Revealing the molecular-level interactions between cationic fluorinated polymer sorbents and the major PFAS pollutant PFOA. Macromolecules, 2022. 55 (3): p. 1077-1087.

1-26. (canceled)

27. A method of making an in-situ functionalized skinless and symmetric membrane adsorber, said method comprising:
(a) preparing a dope solution, said preparing comprising:
(i) contacting a base polymer, a base polymer solvent, and a particle precursor with a crosslinker and/or an initiator for a time and under a condition sufficient to permit the in-situ synthesis of intermediate polymeric microparticles and/or nanoparticles to form an intermediate dope solution, wherein said base polymer solvent has a base polymer solvent Hildebrand solubility parameter (delta-s); and
(ii) contacting said intermediate dope solution with an organic-compatible functional reagent for a time and under a condition sufficient to permit the in-situ functionalization of said intermediate polymeric microparticles and/or nanoparticles to form a final dope solution, wherein said in-situ functionalization forms functional groups selected from the group consisting of: Strong Base (SB) Anion Exchange (AEX) groups, Cation Exchange (CEX) groups, Hydrophobic Interaction Chromatography (HIC) groups, Chelating groups and Fluorophilic groups;
(b) casting said final dope solution to form a nascent membrane; and
(c) inducing phase separation of said nascent membrane by a controlled, gradual demixing process to form the in-situ functionalized membrane adsorber, said membrane adsorber having a symmetric and skinless morphology.

28. The method of claim 27, wherein said controlled, gradual demixing process is characterized by at least one condition selected from the group consisting of:
(A) a thermodynamically-controlled process, wherein the nascent membrane is contacted with a liquid nonsolvent having a nonsolvent Hildebrand solubility parameter (delta-ns), and wherein the absolute difference between said delta-s and said delta-ns is 7 (cal/cm³)½ or less; and
(B) a time-controlled process, wherein the nascent membrane is contacted with a nonsolvent vapor for an exposure time of at least 5 minutes; and (C) a temperature-controlled process, wherein the nascent membrane is gradually cooled at a controlled cooling rate between 0.5 K/min and 11 K/min.

29. The method of claim 28, wherein said controlled, gradual demixing process is the thermodynamically-controlled process (A).

30. The method of claim 29, wherein the liquid nonsolvent is isopropyl alcohol (IPA).

31. The method of claim 29, wherein the liquid nonsolvent is selected from the group consisting of n-propyl alcohol, n-butyl alcohol, ethanol, methanol, propylene glycol, ethylene glycol, acetone, methyl ethyl ketone (MEK), ethyl acetate, tetrahydrofuran (THF), diethyl ether, dimethylformamide (DMF), and dimethyl sulfoxide (DMSO), dimethyl isosorbide (DMI), 2-methyltetrahydrofuran, ethyl(−)-L-lactate, cyclopentyl methyl ether and γ-valerolactone (GVL).

32. The method of claim 28, wherein said controlled, gradual demixing process is the time-controlled process (B).

33. The method of claim 28, wherein said controlled, gradual demixing process is the temperature-controlled process (C).

34. The method of claim 33, wherein said controlled cooling rate is between 0.5 K/min and 2.5 K/min.

35. The method of claim 27, wherein said organic-compatible functional reagent is selected from the group consisting of: an alkylating reagent, an epoxide, a sultone, a lactone, a fluorinated epoxide, and a fluorinated alkyl halide.

36. The method of claim 35, wherein said organic-compatible functional reagent is bromoethane.

37. The method of claim 35, wherein said organic-compatible functional reagent is 1,3-propanesultone.

38. The method of claim 35, wherein said organic-compatible functional reagent is styrene oxide

39. The method of claim 27, wherein the base polymer is polyvinylidene fluoride (PVDF), the base polymer solvent is triethyl phosphate (TEP), and the particle precursor is polyethyleneimine (PEI).

40. The method of claim 27, wherein the in-situ functionalization (a) (ii) is performed at a temperature between 65° C. and 80° C.

41. The method of claim 27, wherein the in-situ functionalization (a) (ii) is performed for a time between 4 hours and 24 hours.

42. The method of claim 27, wherein the in-situ functionalization (a) (ii) is performed by adding the organic-compatible functional reagent at a stoichiometric molar ratio of 0.1 to 5.0 relative to reactive sites on the particle precursor.

43-80. (canceled)

81. The method of claim 27, wherein the crosslinker is selected from the group consisting of epichlorohydrin (ECH), diethylene glycol diacrylate (EGA), and bis(2-chloroethyl)amine hydrochloride (BCAH).

82. The method of claim 27, wherein preparing the dope solution (a) further comprises adding a co-solvent.

83. The method of claim 82, wherein the co-solvent is dimethyl sulfoxide (DMSO).

84. The method of claim 27, wherein preparing the dope solution (a) comprises adding the particle precursor at a mass ratio yielding a crosslinked microparticle concentration of between 40 wt % and 60 wt % uniformly distributed within the porous polymeric body formed in step (c).

85. The method of claim 27, wherein contacting the intermediate dope solution (a) (ii) comprises alkylating tertiary amines of the intermediate polymeric microparticles with an alkyl halide to covalently attach quaternary ammonium cations prior to casting.

86. The method of claim 27, wherein contacting the intermediate dope solution (a) (ii) comprises performing a ring-opening reaction of a sultone with amine groups of the intermediate polymeric microparticles to covalently attach sulfonate anions prior to casting.

87. The method of claim 27, wherein contacting the intermediate dope solution (a) (ii) comprises reacting a terminal epoxide comprising a non-polar aliphatic, aromatic, or fluorinated moiety with the intermediate polymeric microparticles to covalently attach hydrophobic or fluorophilic ligands prior to casting.

88. The method of claim 27, wherein inducing phase separation (c) comprises immersing the nascent membrane into a coagulation bath comprising a liquid nonsolvent to drive thermodynamically-controlled solid-liquid demixing without instantaneous liquid-liquid demixing, thereby forming a sponge-like bulk region of interconnected polymer spherulites devoid of a dense surface skin layer and wherein the liquid nonsolvent has a nonsolvent Hildebrand solubility parameter (δₙₛ), wherein the absolute difference between a base polymer solvent Hildebrand solubility parameter (delta-s) and said δₙₛ is 7 (cal/cm³)½ or less.

89. The method of claim 27, wherein preparing the dope solution (a) further comprises adding a catalytic amount of an acid to protonate the particle precursor and induce the formation of phase-separated precursor-rich droplets within the base polymer solvent prior to contacting with the crosslinker.

90. The method of claim 27, wherein contacting the intermediate dope solution (a) (ii) comprises reacting the intermediate polymeric microparticles with a mixture of functional electrophiles, simultaneously or sequentially, to covalently attach a combination of distinct functional groups prior to casting.

91. The method of claim 32, wherein contacting the nascent membrane with the nonsolvent vapor comprises exposing the nascent membrane to an environment having a controlled relative humidity between 50% and 100% and a temperature between 25° C. and 70° C.

92. The method of claim 27, further comprising immobilizing a transition metal, heavy metal, or precious metal catalyst onto the functional groups of the in-situ functionalized membrane adsorber following step (c).

93. The method of claim 84, wherein the symmetric and skinless morphology of the membrane adsorber formed in step (c) is further characterized by a local areal void fraction that varies by no more than 50% from the mean bulk areal void fraction measured at different depths across a thickness of the bulk region.

94. The method of claim 27, wherein preparing the dope solution (a) further comprises adding a functionalizing polymer precursor to covalently or non-covalently link the intermediate polymeric microparticles and/or nanoparticles, thereby forming an interconnected polymeric network within the porous polymeric body formed in step (c).

95. The method of claim 28, wherein the liquid nonsolvent is selected from the group consisting of: alcohols, glycols, ketones, esters, ethers, polar aprotic solvents, and mixtures comprising 10 to 50 wt % water and 50 to 90 wt % of the base polymer solvent.

96. The method of claim 95, wherein the liquid nonsolvent is selected from the group consisting of: n-propyl alcohol, n-butyl alcohol, ethanol, methanol, propylene glycol, ethylene glycol, acetone, methyl ethyl ketone (MEK), ethyl acetate, tetrahydrofuran (THF), diethyl ether, dimethylformamide (DMF), dimethyl sulfoxide (DMSO), dimethyl isosorbide (DMI), N,N-dimethylacetamide (DMAc), N-methyl-2-pyrrolidone (NMP), 2-methyltetrahydrofuran, ethyl(−)-L-lactate, cyclopentyl methyl ether, gamma-valerolactone (GVL), and mixtures of 10 to 50 wt % water and 50 to 90 wt % of a solvent selected from the group consisting of N-methyl-2-pyrrolidone (NMP), dimethylformamide (DMF), dimethyl sulfoxide (DMSO), and triethyl phosphate (TEP).
